(19) United States
(12) Patent Application Publication
(10) Pub. No.: US 2025/0117008 A1
(43) Pub. Date: Apr. 10, 2025

(54) UNMANNED VEHICLE SYSTEM INCLUDING HOST VEHICLE AND GUEST VEHICLE

(71) Applicant: Maritime Tactical Systems, Inc. dba MARTAC, Melbourne, FL (US)

(72) Inventors: Bruce Hanson, Melbourne, FL (US); Thomas Hanson, Ashland, MA (US)

(73) Assignee: Maritime Tactical Systems, Inc. dba MARTAC, Melbourne, FL (US)

(21) Appl. No.: 18/982,614

(22) Filed: Dec. 16, 2024

Related U.S. Application Data
(63) Continuation-in-part of application No. 18/452,362, filed on Aug. 18, 2023.
Application No. 18/452,362 is a continuation of application No. 18/051,057, filed on Oct. 31, 2022, now Pat. No. 11,733,698.
Application No. 18/051,057 is a continuation of application No. 17/164,129, filed on Feb. 1, 2021, now Pat. No. 11,507,094.
Application No. 17/164,129 is a continuation of application No. 16/449,824, filed on Jun. 24, 2019, now Pat. No. 10,908,611.
Application No. 16/449,824 is a continuation-in-part of application No. 15/609,459, filed on May 31, 2017, now Pat. No. 10,331,131.
Application No. 15/609,459 is a continuation-in-part of application No. 14/788,231, filed on Jun. 30, 2015, now Pat. No. 9,669,904.
Application No. 14/788,231 is a continuation-in-part of application No. 13/470,866, filed on May 14, 2012, now Pat. No. 9,096,106.
(60) Provisional application No. 61/485,477, filed on May 12, 2011.

(51) Int. Cl. G05D 1/00; B63B 1/04; B63B 1/20; B63B 1/32; B63B 35/00; B63G 8/22; B64C 3/38

(52) U.S. Cl. CPC G05D 1/0088; B63B 1/042; B63B 2001/206; B63B 1/322; B63B 2035/007; B63B 2035/008; B63G 8/22; B64C 3/38; B64U 2201/20

(57) ABSTRACT

An unmanned vehicle system is provided. The system may comprise a host vehicle and a guest vehicle, each of which may each include a vehicle body, a control system, a maneuvering system, and a sensor and communication system. The host vehicle may also include a securing system. The host vehicle and the guest vehicle may be in communication with one another, and the guest vehicle may be moveable between a stowed state, defined as the guest vehicle being at least partially carried by a portion of the host vehicle, and a deployed state, defined as the guest vehicle being spaced apart from the host vehicle. The securing system may be operable to move between a locked state and an unlocked state to selectively engage the guest vehicle to allow for the guest vehicle to be moved from the stowed state to the deployed state.

### RELATED APPLICATIONS

This application is a continuation-in-part application of and claims priority under 35 U.S.C. § 120 of U.S. patent application Ser. No. 18/452,362 (Attorney Docket No. 861.00038) filed on Aug. 18, 2023 and titled SYSTEMS AND METHODS FOR AUTONOMOUS SELECTION AND OPERATION OF COMBINATIONS OF STEALTH AND PERFORMANCE CAPABILITIES OF A MULTI-MODE UNMANNED VEHICLE, which in turn is a continuation application of and claims priority under 35 U.S.C. § 120 of U.S. patent application Ser. No. 18/051,057, now U.S. Pat. No. 11,733,698, issued Aug. 22, 2023 (Attorney Docket No. 861.00035) filed on Oct. 31, 2022 and titled SYSTEMS AND METHODS FOR AUTONOMOUS SELECTION AND OPERATION OF COMBINATIONS OF STEALTH AND PERFORMANCE CAPABILITIES OF A MULTI-MODE UNMANNED VEHICLE, which in turn is a continuation application of and claims priority under 35 U.S.C. § 120 of U.S. patent application Ser. No. 17/164,129, now U.S. Pat. No. 11,507,094, issued Nov. 22, 2022 (Attorney Docket No. 861.00030) filed on Feb. 1, 2021 and titled SYSTEMS AND METHODS FOR AUTONOMOUS SELECTION AND OPERATION OF COMBINATIONS OF STEALTH AND PERFORMANCE CAPABILITIES OF A MULTI-MODE UNMANNED VEHICLE, which in turn is a continuation application of and claims priority under 35 U.S.C. § 120 of U.S. patent application Ser. No. 16/449,824, now U.S. Pat. No. 10,908,611, issued Feb. 2, 2021 (Attorney Docket No. 861.00028) filed on Jun. 24, 2019 and titled SYSTEMS AND METHODS FOR SEMI-SUBMERSIBLE LAUNCH AND RECOVERY OF OBJECTS FROM MULTI-MODE UNMANNED VEHICLE, which in turn is a continuation-in-part application of and claims priority under 35 U.S.C. § 120 of U.S. patent application Ser. No. 15/609,459, now U.S. Pat. No. 10,331,131, issued Jun. 25, 2019 (Attorney Docket No. 861.00026) filed on May 31, 2017 and titled Systems and Methods for Payload Integration and Control in a Multi-Mode Unmanned Vehicle, which in turn is a continuation-in-part application of and claims priority under 35 U.S.C. § 120 of U.S. patent application Ser. No. 14/788,231, now U.S. Pat. No. 9,669,904, issued Jun. 6, 2017 (Attorney Docket No. 861.00021) filed on Jun. 30, 2015 and titled Systems and Methods for Multi-Role Unmanned Vehicle Mission Planning and Control, which in turn is a continuation-in-part application of and claims priority under 35 U.S.C. § 120 of U.S. patent application Ser. No. 13/470,866, now U.S. Pat. No. 9,096,106, issued Aug. 4, 2015 (Attorney Docket No. 861.00020) filed on May 14, 2012 and titled Multi-Role Unmanned Vehicle System and Associated Methods, which in turn is related to and claims the benefit of U.S. Provisional Patent Application Ser. No. 61/485,477 (Attorney Docket No. 861.00019) filed on May 12, 2011 and titled MARITIME MULTI-ROLE UNMANNED VEHICLE SYSTEM. The contents of these applications are incorporated herein by reference except for where they conflict with the content herein.

### FIELD OF THE INVENTION

The present invention relates generally to the field of unmanned, autonomous vehicles. In particular, the invention relates to systems and methods for advantageous employment of unmanned vehicles that are capable of operating in atmospheric, marine, and submarine environments, and that are equipped for semi-submersible launch and recovery of objects such as vessels, equipment and/or people.

### BACKGROUND OF THE INVENTION

For decades, use of unmanned vehicles, such as unmanned aircraft systems (generally referred to as drones), has been increasing as delivery, sensor, and automation technologies mature. One advantage of unmanned vehicles is the ability to establish large areas of operation with a significantly reduced number of people than would be required for a manned enterprise. Another advantage is the ability to deploy unmanned systems into operational environments that are hostile or dangerous to human beings.

The United States military is increasing its use of unmanned vehicles by all service branches and in all theaters of operation. Current examples of planned uses of unmanned vehicles in marine and submarine environments are for mine and submarine detection, maritime interdiction missions, harbor security, and intelligence, surveillance, and reconnaissance (ISR) missions. The commercial market also is also experiencing increased use of unmanned vehicles. Current examples of such use include search and rescue, drug interdiction, remote launch and recovery of external payloads, autonomous environmental testing, oil spill collection and monitoring, weather monitoring, and real time tsunami data collection and monitoring. The scope of both military and civilian uses for unmanned vehicles is expected to continue to increase significantly in the coming decade.

Conventional unmanned vehicle designs typically are each limited in scope to a particular operating environment and/or beneficial task. In the marine and submarine environments, most current unmanned vehicle designs are based on retrofits of manned vehicle designs and, as result, incur operational and performance envelope limitations built into vehicles designed for carrying people, such as described in U.S. Pat. No. 7,789,723 to Dane et. al. Alternatively, systems designed specifically as unmanned vehicles, such as described in U.S. Pat. No. 6,807,921 to Huntsman, typically are configured to achieve particular characteristics that are conducive to accomplishing a task of interest, such as, for example, endurance or underwater performance. However, these designs typically preclude achievement of a broader range of unmanned vehicle characteristics (e.g., multi-environment, multi-task) for the sake of limited-environment, limited-task characteristics.

There is a need to autonomously launch and recover various payloads, including vessels (surface and underwater), equipment and people, to perform missions covertly. There is a need for the vessels to autonomously perform the designated mission while hiding from detection by people or objects that could prevent the vessel from successfully completing its mission.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to an unmanned vehicle system comprising a host vehicle and a guest vehicle. The host vehicle includes a host vehicle body, a host vehicle control system, a host vehicle maneuvering system, a host vehicle sensor and communication system, and a securing system. The host vehicle maneuvering system may be in communication with the host vehicle control system and may be operable to provide propulsion to the host vehicle. The host vehicle sensor and communication system may be in communication with the host vehicle control system. The securing system may be carried by the host vehicle body and may be in communication with the host vehicle control system.

The guest vehicle includes a guest vehicle body, a guest vehicle control system, a guest vehicle maneuvering system, and a guest vehicle sensor and communication system. The guest vehicle control system may be positioned in communication with the host vehicle control system. The guest vehicle maneuvering system may be in communication with one or more of the guest vehicle control system and the host vehicle control system. The guest vehicle maneuvering system may be operable to provide propulsion to the guest vehicle. The guest vehicle sensor and communication system may be in communication with one or more of the guest vehicle control system and the host vehicle control system.

The guest vehicle may be moveable between a stowed state and a deployed state. The stowed state of the guest vehicle may be defined as the guest vehicle being at least partially carried by a portion of the host vehicle. The deployed state of the guest vehicle may be defined as the guest vehicle being spaced apart from the host vehicle. The securing system may be operable to move between a locked state and an unlocked state to selectively engage the guest vehicle. When the guest vehicle is in the stowed state, the securing system may be in the locked state. Movement of the securing system from the locked state to the unlocked state may allow for the guest vehicle to be moved from the stowed state to the deployed state.

Some embodiments may include a host vehicle buoyancy system that may be in communication with the host vehicle control system and may be operable to control a flow of water comprising outside environment water into and out of a portion of the host vehicle body to cause the host vehicle to move between a surfaced state and a submerged state. Some embodiments may include a guest vehicle buoyancy system that may be in communication with the guest vehicle control system and may be operable to control a flow of water comprising outside environment water into and out of a portion of the guest vehicle body to cause the guest vehicle to move between a surfaced state and a submerged state.

The host vehicle and the guest vehicle may be moveable between the surfaced state and the submerged state when the guest vehicle is in the stowed state. The guest vehicle buoyancy system may be in communication with the host vehicle control system to be operable by and responsive to command signals received from the host vehicle control system.

The command signals may include maneuvering command signals. The guest vehicle maneuvering system may be in communication with the host vehicle control system to be operable by and responsive to the maneuvering command signals received. The guest vehicle maneuvering system may be operable when the guest vehicle is in the stowed state to provide propulsion to the host vehicle. The securing system may be moveable between the locked state and the unlocked state when the host vehicle is in the submerged state to allow the guest vehicle to move between the stowed state and the deployed state when the guest vehicle is in the submerged state.

The guest vehicle may include an onboard power supply in communication with one or more of the guest vehicle control system, the guest vehicle maneuvering system, and the guest vehicle sensor and communication system. The onboard power supply may be operable to be charged by the host vehicle when the guest vehicle is in the stowed state.

The guest vehicle may comprise a plurality of guest vehicles. Each of the plurality of guest vehicles may be operable to move between the stowed state and the deployed state. One or more of the plurality of guest vehicles may be in communication with the host vehicle. Each of the plurality of guest vehicles may be operable to communicate with one another. The host vehicle is adapted to carry more than one of the plurality of guest vehicles.

The host vehicle and the plurality of guest vehicles may be in communication with a network. The host vehicle and the plurality of guest vehicles may be operable to be remotely commanded and controlled via the network. Each one of the plurality of guest vehicles may be operable to transmit command signals to each of the plurality of guest vehicles.

The communication between the host vehicle and the plurality of guest vehicles may be defined as a mesh network. The host vehicle control system and the guest vehicle control systems of each of the plurality of guest vehicles may be operable to communicate with one another via the mesh network. The host vehicle may comprise a plurality of host vehicles. Each of the plurality of host vehicles may be adapted to carry one or more of the plurality of guest vehicles. Each of the plurality of host vehicles may be in communication with one another to further define the mesh network.

The guest vehicle maneuvering system may be operable to move the guest vehicle from a turned over state to an upright state. The host vehicle maneuvering system may be operable to move the host vehicle from the turned over state to the upright state.

Some embodiments may include a plurality of housings that may each carried by the host vehicle body and/or the guest vehicle body. Each of the plurality of housings may be adapted to carry at least a portion of the host vehicle control system, the host vehicle maneuvering system, the host vehicle sensor and communication system, the securing system, the guest vehicle control system, the guest vehicle maneuvering system, and/or the guest vehicle sensor and communication system. Also, in some embodiments of the present invention, the host vehicle and the guest vehicle may each comprise a rail system. Each of the plurality housings may be adapted to slidably engage to the rail system.

Some embodiments of the present invention may be directed to an unmanned vehicle system comprising a host vehicle, a plurality of guest vehicles, and a plurality of housings. The host vehicle may include a host vehicle body, a host vehicle control system, a host vehicle maneuvering system, a host vehicle sensor and communication system, a securing system, and a host vehicle rail system. The host vehicle maneuvering system may be in communication with the host vehicle control system and may be operable to provide propulsion to the host vehicle. The host vehicle sensor and communication system may be in communication with the host vehicle control system. The securing system may be carried by the host vehicle body and may be in communication with the host vehicle control system.

Each one of the plurality of guest vehicles may comprise a guest vehicle body, a guest vehicle control system, a guest vehicle maneuvering system, a guest vehicle sensor and communication system, and a guest vehicle rail system. The guest vehicle control system may be positioned in communication with the host vehicle control system. The guest vehicle maneuvering system may be in communication with the guest vehicle control system, and the guest vehicle maneuvering system may be operable to provide propulsion to the guest vehicle. The guest vehicle sensor and communication system may be in communication with the guest vehicle control system and/or the host vehicle control system. The plurality of housings may each be carried by the host vehicle body and/or one or more of the guest vehicle bodies of the plurality of guest vehicles.

Each of the plurality of housings may be adapted to carry at least a portion of one or more of the host vehicle control system, the host vehicle maneuvering system, the host vehicle sensor and communication system, the securing system, the guest vehicle control system, the guest vehicle maneuvering system, and/or the guest vehicle sensor and communication system. Each one of the plurality of guest vehicles may be operable to be in communication with the host vehicle and with at least another one of the plurality of guest vehicles.

Each of the plurality housings may be adapted to slidably engage to the rail system. Each one of the plurality of guest vehicles may be operable to move between a stowed state and a deployed state. The stowed state of each guest vehicle may be defined as the guest vehicle being at least partially carried by a portion of the host vehicle. The deployed state of each guest vehicle may be defined as the guest vehicle being spaced apart from the host vehicle. The securing system may be operable to move between a locked state and an unlocked state to selectively engage at least one of the guest vehicles. When one or more of the plurality of guest vehicles is in the stowed state, the securing system may be in the locked state. Movement of the securing system from the locked state to the unlocked state may allow for one or more of the plurality of guest vehicles to be moved from the stowed state to the deployed state.

The host vehicle may comprise a host vehicle buoyancy system that may be in communication with the host vehicle control system and operable to control a flow of water comprising outside environment water into and out of a portion of the host vehicle body to cause the host vehicle to move between a surfaced state and a submerged state. Each guest vehicle of the plurality of guest vehicles may comprise a guest vehicle buoyancy system that may be in communication with the guest vehicle control system and operable to control a flow of water comprising outside environment water into and out of a portion of the guest vehicle body to cause the guest vehicle to move between a surfaced state and a submerged state.

The host vehicle and the plurality of guest vehicles may be moveable between the surfaced state and the submerged state when one or more of the guest vehicles of the plurality of guest vehicles is in the stowed state and when one or more of the guest vehicles are in the deployed state. The guest vehicle buoyancy systems of the plurality of guest vehicles may be in communication with the host vehicle control system to be operable by and responsive to commands received from the host vehicle control system. The command signals may include maneuvering command signals. The guest vehicle maneuverings systems may be in communication with the host vehicle control system to be operable by and responsive to the maneuvering command signals received. The guest vehicle maneuvering system of each guest vehicle of the plurality of guest vehicles may be operable when the guest vehicle is in the stowed state to provide propulsion to the host vehicle.

The securing system may be moveable between the locked state and the unlocked state when the host vehicle is in the submerged state to allow one or more of the plurality of guest vehicles to move between the stowed state and the deployed state when the at least one guest vehicle is in the submerged state. Each one of the plurality of guest vehicles may comprise an onboard power supply in communication with one or more of the guest vehicle control system, the guest vehicle maneuvering system, and/or the guest vehicle sensor and communication system. The onboard power supply may be operable to be charged by the host vehicle when the guest vehicle is in the stowed state.

The host vehicle may be adapted to carry more than one of the plurality of guest vehicles. The host vehicle and the plurality of guest vehicles may be in communication with a network. The host vehicle and the plurality of guest vehicles may be operable to be remotely commanded and controlled via the network. Each one of the plurality of guest vehicles may be operable to transmit command signals to each of the plurality of guest vehicles. The communication between the host vehicle and the plurality of guest vehicles may be defined as a mesh network. The host vehicle control system and the guest vehicle control systems of each of the plurality of guest vehicles may be operable to communicate with one another via the mesh network.

The host vehicle may comprise a plurality of host vehicles. Each of the plurality of host vehicles may be adapted to carry one or more of the plurality of guest vehicles. Each of the plurality of host vehicles may be in communication with one another to further define the mesh network. The guest vehicle maneuvering systems of each of the plurality of guest vehicles may be operable to move the guest vehicle from a turned over state to an upright state. The host vehicle maneuvering system may be operable to move the host vehicle from the turned over state to the upright state.

Some embodiments of the present invention may be directed to an unmanned vehicle system that comprises a plurality of host vehicles and a plurality of guest vehicles. Each host vehicle of the plurality of host vehicles may include a host vehicle body, a host vehicle control system, a host vehicle maneuvering system, a host vehicle sensor and communication system, a securing system, and a host vehicle buoyancy system. The host vehicle maneuvering system may be in communication with the host vehicle control system and may be operable to provide propulsion to the host vehicle.

The host vehicle sensor and communication system may be in communication with the host vehicle control system. The securing system may be carried by the host vehicle body and may be in communication with the host vehicle control system. The host vehicle buoyancy system may be in communication with the host vehicle control system and may be operable to control a flow of water comprising outside environment water into and out of a portion of the host vehicle body to cause the host vehicle to move between a surfaced state and a submerged state.

Each guest vehicle of the plurality of guest vehicles may include a guest vehicle body, a guest vehicle control system, a guest vehicle maneuvering system, a guest vehicle sensor and communication system, and a guest vehicle buoyancy system in communication. The guest vehicle control system may be positioned in communication with one or more of the host vehicle control systems. The guest vehicle maneuvering system may be in communication with the guest vehicle control system and one or more of the host vehicle control systems, and the guest vehicle maneuvering system may be operable to provide propulsion to the guest vehicle. The guest vehicle sensor and communication system may be in communication with the guest vehicle control system and one or more of the host vehicle control systems. The guest vehicle buoyancy system may be in communication with the guest vehicle control system and may be operable to control a flow of water comprising outside environment water into and out of a portion of the guest vehicle body to cause the guest vehicle to move between a surfaced state and a submerged state.

Each one of the plurality of host vehicles may be adapted to carry one of the plurality of guest vehicles. Each of the plurality of guest vehicles may be moveable between a stowed state and a deployed state. The stowed state of each guest vehicle of the plurality of guest vehicles may be defined as the guest vehicle being at least partially carried by a portion of one of the plurality of host vehicles. The deployed state of each guest vehicle of the plurality of guest vehicles may be defined as the guest vehicle being spaced apart from the plurality of host vehicles.

The securing system of each host vehicle of the plurality of host vehicles may be operable to move between a locked state and an unlocked state to selectively engage one of the plurality of guest vehicles. When one or more of guest vehicles of the plurality of guest vehicles are in the stowed state, the securing system of one or more of the plurality of host vehicles may be in the locked state. Movement of the securing systems from the locked state to the unlocked state may allow for the plurality of guest vehicles to be moved from the stowed state to the deployed state. Each of the plurality of host vehicles and the plurality of guest vehicles may be operable to communicate with one another.

Each host vehicle of the plurality of host vehicles and each guest vehicle of the plurality of guest vehicles may be moveable between the surfaced state and the submerged state when the guest vehicle is in the stowed state and when the guest vehicle is in the deployed state. Each guest vehicle buoyancy system may be in communication with one of the host vehicle control systems to be operable by and responsive to command signals received from the host vehicle control system.

The command signals include maneuvering command signals. Each guest vehicle maneuvering system may be in communication with one of the host vehicle control systems to be operable by and responsive to the maneuvering command signals received from the host vehicle control system. The guest vehicle maneuvering system of each guest vehicle of the plurality of guest vehicles may be operable when the guest vehicle is in the stowed state to provide propulsion to an associated carrier host vehicle of the plurality of host vehicles.

The securing system of each host vehicle of the plurality of host vehicles may be moveable between the locked state and the unlocked state when the host vehicle is in the submerged state to allow one or more of the plurality of guest vehicles to move between the stowed state and the deployed state when the guest vehicle is in the submerged state. Each guest vehicle of the plurality of guest vehicles may comprise an onboard power supply in communication with one or more of the guest vehicle control system, the guest vehicle maneuvering system, and/or the guest vehicle sensor and communication system of the guest vehicle. The onboard power supply may be operable to be charged by one of the plurality of host vehicles when the guest vehicle is in the stowed state.

One or more of the plurality of host vehicles may be adapted to carry more than one of the plurality of guest vehicles. The plurality of host vehicles and the plurality of guest vehicles may be in communication with a network. The plurality of host vehicles and the plurality of guest vehicles may be operable to be remotely commanded and controlled via the network. Each one of the plurality of guest vehicles may be operable to transmit command signals to each of the plurality of guest vehicles.

The communication between the plurality of host vehicles and the plurality of guest vehicles may be defined as a mesh network. Each of the host vehicle control systems and the guest vehicle control systems may be operable to communicate with one another via the mesh network. The guest vehicle maneuvering system of each guest vehicle of the plurality of guest vehicles may be operable to move the guest vehicle from a turned over state to an upright state. The host vehicle maneuvering system of each host vehicle of the plurality of host vehicles may be operable to move the host vehicle from the turned over state to the upright state.

Some embodiments may include a plurality of housings that may each carried by one or more of the host vehicle bodies and the guest vehicle bodies. Each of the plurality of housings may be adapted to carry at least a portion of one or more of the host vehicle control systems, the host vehicle maneuvering systems, the host vehicle sensor and communication systems, the securing systems, the host vehicle buoyancy systems, the guest vehicle control systems, the guest vehicle maneuvering systems, the guest vehicle sensor and communication systems, and/or the guest vehicle buoyancy systems. Each one of the plurality of host vehicles and each one of the plurality of guest vehicles may comprise a rail system. Each of the plurality housings may be adapted to slidably engage to one of the rail systems.

### BRIEF DESCRIPTION OF THE DRAWINGS

Some embodiments of the present invention are illustrated as an example and are not limited by the figures of the accompanying drawings, in which like references may indicate similar elements.

FIG. 1 is an exploded solid model view of an unmanned vehicle according to an embodiment of the present invention.

FIG. 2 is a top plan view and a side elevation view of an unmanned vehicle according to an embodiment of the present invention.

FIG. 2A is a front elevation view of an unmanned vehicle according to an embodiment of the present invention.

FIG. 3 is a table illustrating air glide parameters of an unmanned vehicle according to an embodiment of the present invention compared to air glide parameters to two exemplary aircraft known in the art.

FIG. 4 is a schematic overview of a propulsion control system of an unmanned vehicle according to an embodiment of the present invention.

FIG. 5 is a schematic overview of a propulsion system of an unmanned vehicle according to an embodiment of the present invention suitable for marine and submarine use.

FIG. 6 is a side elevation view and a bottom plan view of a ballast system of an unmanned vehicle according to an embodiment of the present invention.

FIG. 7 is a side elevation view and a top plan view of an adjustable center of gravity system of an unmanned vehicle according to an embodiment of the present invention.

FIG. 8 is a side elevation view and a top plan view of a pressurization system of an unmanned vehicle according to an embodiment of the present invention.

FIG. 9 is a solid model perspective view of control surfaces of an unmanned vehicle according to an embodiment of the present invention.

FIG. 10 is a plurality of partial perspective views of control surfaces of an unmanned vehicle according to an embodiment of the present invention.

FIG. 11 is a side elevation view and a top plan view of a retractable device rack of an unmanned vehicle according to an embodiment of the present invention.

FIG. 12 is a front elevation view representing a retractable device rack of an unmanned vehicle according to an embodiment of the present invention showing the retractable device rack in an extended position.

FIG. 13 is an exploded perspective view of an interchangeable payload deck of an unmanned vehicle according to an embodiment of the present invention including a solar panel payload module.

FIG. 14 is a top plan view and a side elevation view of an interchangeable payload deck of an unmanned vehicle according to an embodiment of the present invention including a wind sail payload module.

FIG. 15 is a schematic overview of a multi-mode navigation control system of an unmanned vehicle according to an embodiment of the present invention.

FIG. 16 is a schematic overview of an on-board control system of an unmanned vehicle according to an embodiment of the present invention.

FIG. 17 is a schematic overview of an off-board control system of a mission planning and control system according to an embodiment of the present invention.

FIG. 18 is a schematic overview of a mission planning and control system according to an embodiment of the present invention.

FIG. 19 is a flowchart of a mission control operation for an unmanned vehicle according to an embodiment of the present invention.

FIG. 20 is a flowchart of a mission management operation for an unmanned vehicle according to an embodiment of the present invention.

FIG. 21 is a flowchart of a mission planning and execution lifecycle according to an embodiment of the present invention.

FIG. 22 is a schematic overview of an exemplary three-dimensional coverage grid for a mission planning and control system according to an embodiment of the present invention.

FIG. 23 is a block diagram representation of a machine in the example form of a computer system according to an embodiment of the present invention.

FIG. 24 is a bottom plan view of an unmanned vehicle according to an embodiment of the present invention.

FIG. 25 is a side elevation view of an unmanned vehicle according to an embodiment of the present invention.

FIG. 26A is a front elevation view of an unmanned vehicle according to an embodiment of the present invention.

FIG. 26B is a rear elevation view of an unmanned vehicle according to an embodiment of the present invention.

FIG. 27 is a top plan view of an unmanned vehicle according to an embodiment of the present invention.

FIG. 28A is a side elevation view of an unmanned vehicle according to an embodiment of the present invention.

FIG. 28B is a front elevation view of an unmanned vehicle according to an embodiment of the present invention.

FIG. 29 is a schematic overview of a payload control system according to an embodiment of the present invention.

FIG. 30 is a schematic overview of a payload control system according to an embodiment of the present invention.

FIG. 31 is a schematic diagram of exemplary payload signal and power interfaces according to an embodiment of the present invention.

FIG. 32 is a schematic diagram of exemplary payload mechanical interfaces according to an embodiment of the present invention.

FIG. 33 is a schematic diagram illustrating the six degrees of freedom related to the operation of an unmanned vehicle according to embodiments of the present invention.

FIG. 34 is a schematic diagram illustrating the layout of a buoyancy control system for an unmanned vehicle according to an embodiment of the present invention.

FIG. 35 is a schematic block diagram illustrating components defining a well deck position control system for an unmanned vehicle according to an embodiment of the present invention.

FIG. 36 is a top view illustrating a semi-submersible launch and recovery unmanned vehicle according to an embodiment of the present invention.

FIG. 37 is a perspective rear view illustrating the semi-submersible launch and recovery unmanned vehicle of FIG. 36 on the surface of the water.

FIG. 38 is a perspective rear view illustrating the semi-submersible launch and recovery unmanned vehicle of FIG. 36 partially submerged below the surface of the water.

FIG. 39 is a perspective rear view illustrating the semi-submersible launch and recovery unmanned vehicle of FIG. 36 during launch and recovery of a payload object.

FIG. 40 is a more detailed rear view illustrating the semi-submersible launch and recovery unmanned vehicle of FIG. 36 during launch and recovery of a payload object.

FIG. 41 is a perspective rear view illustrating the semi-submersible launch and recovery unmanned vehicle of FIG. 36 on the surface of the water after recovery of a payload object and back on the surface of the water.

FIG. 42 is a block diagram of an autonomous hiding system.

FIG. 43 is a flowchart depicting autonomous hiding decision logic.

FIG. 44 is a flowchart depicting hiding control system logic.

FIG. 45 is a flowchart depicting navigation control system logic.

FIG. 46 is a flowchart depicting orientation control system logic.

FIG. 47 is a flowchart depicting stealth control logic.

FIG. 48a is a top plan view of a schematic diagram depicting the physical layout of buoyancy control components according to an embodiment of the invention.

FIG. 48b is a side elevation view of ballast components of FIG. 48a.

FIG. 48c is a side elevation view of floatation components of FIG. 48a.

FIG. 49 is a block diagram of an air distribution controller.

FIG. 50a is a top plan view of a schematic diagram depicting the physical layout of thermal signature suppression components according to an embodiment of the invention.

FIG. 50b is a side elevation view of the thermal signature suppression components of FIG. 50a.

FIG. 51 is a schematic depiction of the orientation of the vessel in various navigation modes.

FIG. 52 is a perspective view of an unmanned vehicle system according to an embodiment of the present invention, showing the host vehicle carrying the guest vehicle that is in the stowed state.

FIG. 53 is a perspective view of an unmanned vehicle system according to an embodiment of the present invention, showing the host vehicle carrying multiple guest vehicles that are in the stowed state.

FIG. 54A is a top plan view and schematic depiction of an unmanned vehicle system according to an embodiment of the present invention, showing the securing system of a host vehicle with the guest vehicle in the stowed state.

FIG. 54B is a rear elevation view and schematic depiction of the unmanned vehicle system illustrated in FIG. 54A.

FIG. 54C is a perspective view of the unmanned vehicle system illustrated in FIG. 54A.

FIG. 55 is a schematic depiction of an unmanned vehicle system according to an embodiment of the present invention, showing the host vehicle and guest vehicles in the submerged state and with the guest vehicle being movable between the stowed stated and the deployed state.

FIG. 56 is a schematic depiction of an unmanned vehicle system according to and embodiment of the present invention, showing the host vehicle and guest vehicle in the surfaced state and with the guest vehicle being movable between the stowed state and the deployed state.

FIG. 57 is a perspective view of an unmanned vehicle system according to an embodiment of the present invention, showing a guest vehicle in the deployed state.

FIG. 58 is a lowered perspective view an unmanned vehicle system according to and embodiment of the present invention, showing the lower sensor housing.

FIG. 59 is an elevated perspective view of an unmanned guest vehicle according to an embodiment of the present invention, showing a guest vehicle that has a slant deck.

FIG. 60 is a partial perspective view of an unmanned vehicle system according to an embodiment of the present invention, showing a rail system within an internal area of a vehicle body.

FIG. 61 is a lowered partial perspective view of an unmanned vehicle system according to an embodiment of the present invention, showing an external cooling plate.

FIG. 62 is a perspective view of an unmanned vehicle system according to an embodiment of the present invention, showing a host vehicle with a payload deployment system.

FIG. 63 is a perspective view of an unmanned vehicle system according to an embodiment of the present invention, showing a host or guest vehicle with cargo attachment members.

FIG. 64 is a perspective view of an unmanned vehicle system according to an embodiment of the present invention, showing a host vehicle with a slant deck.

FIG. 65 is a perspective view of an unmanned vehicle system according to an embodiment of the present invention, showing a host vehicle with a flat deck.

FIG. 66 is a perspective view of an unmanned host vehicle according to an embodiment of the present invention, shown with a slant deck.

FIG. 67A is a rear elevation view of an unmanned vehicle system according to an embodiment of the present invention, showing a host or guest vehicle with aft thrusters.

FIG. 67B is a side elevation view of the unmanned vehicle system illustrated in FIG. 67A, showing bow thrusters and an interface of a host or guest vehicle.

FIG. 67C is a front elevation view of the unmanned vehicle system illustrated in FIG. 67A, showing the vertical thrusters of a host or guest vehicle.

FIG. 67D is a top plan view of the unmanned vehicle system illustrated in FIG. 67A.

FIG. 68 is a perspective view of an unmanned vehicle system according to an embodiment of the present invention, showing a host or guest vehicle with an open deck and payload deployment system.

FIG. 69 is a perspective view of an unmanned vehicle system according to an embodiment of the present invention, showing the host vehicle and guest vehicle in communication with a network, a user device, an associate device, and other vehicles, and with the host vehicle and guest vehicle in a mesh configuration.

FIG. 70 is a perspective view of an unmanned vehicle system according to an embodiment of the present invention, showing a host vehicle with a with an aerial vehicle pad and with the guest vehicle comprising an aerial vehicle.

FIG. 71 is a side elevation view of an unmanned vehicle system according to an embodiment of the present invention, showing a host or guest vehicle moving from the turned-over state and the upright state.

FIG. 72 is a top plan view and schematic diagram of an unmanned vehicle system according to an embodiment of the present invention.

FIG. 73 is a top plan view and schematic diagram of an unmanned vehicle system according to an embodiment of the present invention, showing the maneuvering system.

FIG. 74 is a top plan view and schematic diagram of an unmanned vehicle system according to an embodiment of the present invention, showing the sensor and communication system.

FIG. 75 is a top plan view and schematic diagram of an unmanned vehicle system according to and embodiment of the present invention, showing the rail system and buoyancy system.

FIG. 76 is a top plan view and schematic diagram of an unmanned vehicle system according to an embodiment of the present invention, showing the securing system of a host vehicle that is carrying a guest vehicle in the stowed state.

FIG. 77 is a top plan view and schematic diagram of an unmanned vehicle system according to an embodiment of the present invention, showing the payload deployment system.

FIGS. 78-82C are flowchart diagrams of various method aspects of an unmanned vehicle system according to some embodiments of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

As a matter of definition, “mission,” as used herein, refers to an overarching goal to be achieved through some combination of human, machine, material, and machine assets. “Planning,” as used herein, refers to establishing a hierarchy of logistical and operational tasks to be accomplished using available mission assets, and to be assigned and managed at the appropriate level of abstraction. For example, and without limitation, levels of abstraction for asset assignment may include an individual unmanned vehicle being assigned a specific task, an unmanned vehicle sub-group being responsible for a mission sub-goal, and/or a full set of available assets being dedicated to an overall mission goal. Therefore, planning may involve pre-configuring missions for each unmanned vehicle as well as mapping and visualizing groups of unmanned vehicles. “Control,” as used herein, refers to asset tracking, data collection, and mission adjustments accomplished in real-time as execution of a plan unfolds and as a mission evolves. Control, in the context of unmanned vehicle use, may involve selection of deployment modes (for example, and without limitation, air, marine, and submarine) and operational timing (for example and without limitation, active, wait at location, and remain on standby).

The furtherance of the state of the art described herein is based on advantageous employment of the multi-mode capabilities of the multi-mode unmanned vehicle disclosed in U.S. patent application Ser. No. 13/470,866 by Hanson et al., which is incorporated in its entirety herein by reference. The mission planning and control system described herein applies at least in part to the transit routes of one or more unmanned vehicles, each of which may be capable of air glide, water surface (e.g., marine), and sub-surface (e.g., submarine) modes of operation. For example, and without limitation, a single unmanned vehicle may transit across multiple modes of operation within a single transit route, and the respective transit routes of multiple unmanned vehicles across air mode, water surface mode, and sub-surface mode may be coordinated by the mission planning and control system.

Mission planning and control, as used herein, involves addressing the problem of accomplishing missions by efficiently and effectively employing some number of unmanned vehicles, each capable of multi-mode operation, and all coordinated in their actions both temporally and geographically. A significant portion of mission planning and control involves coordination across large time spans and diverse global locations. For example, and without limitation, such coordination may involve off-board command and control systems that may communicate and may integrate with unmanned vehicle on-board systems. Also, for example, and without limitation, unmanned vehicles may coordinate with each other, often in sub-groups, as well as coordinate with other assets.

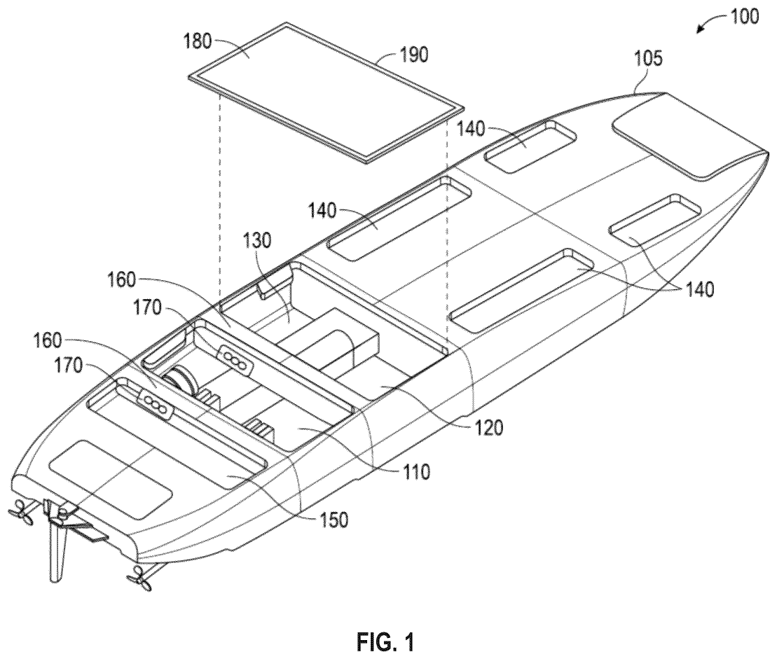

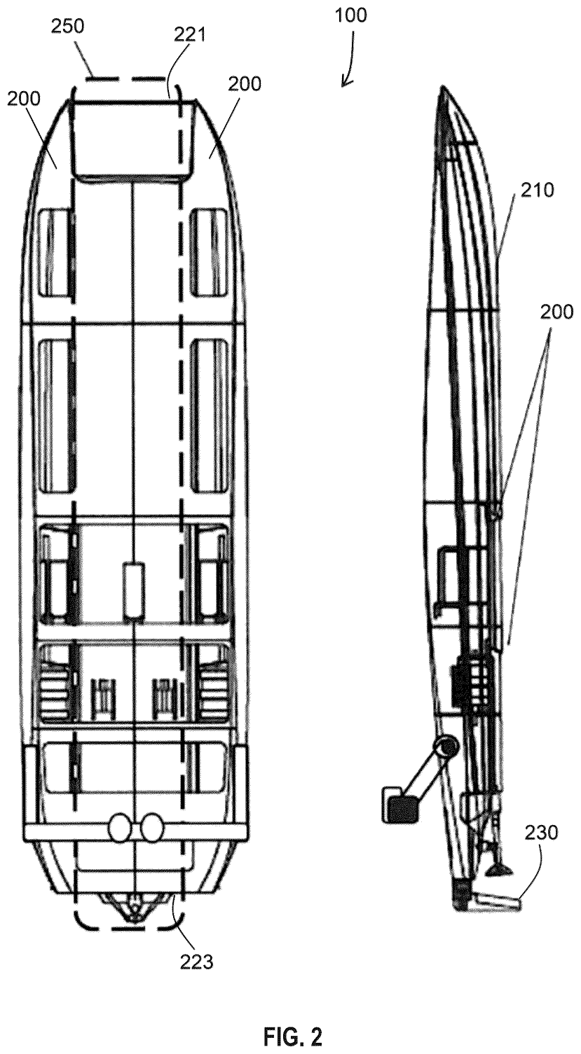

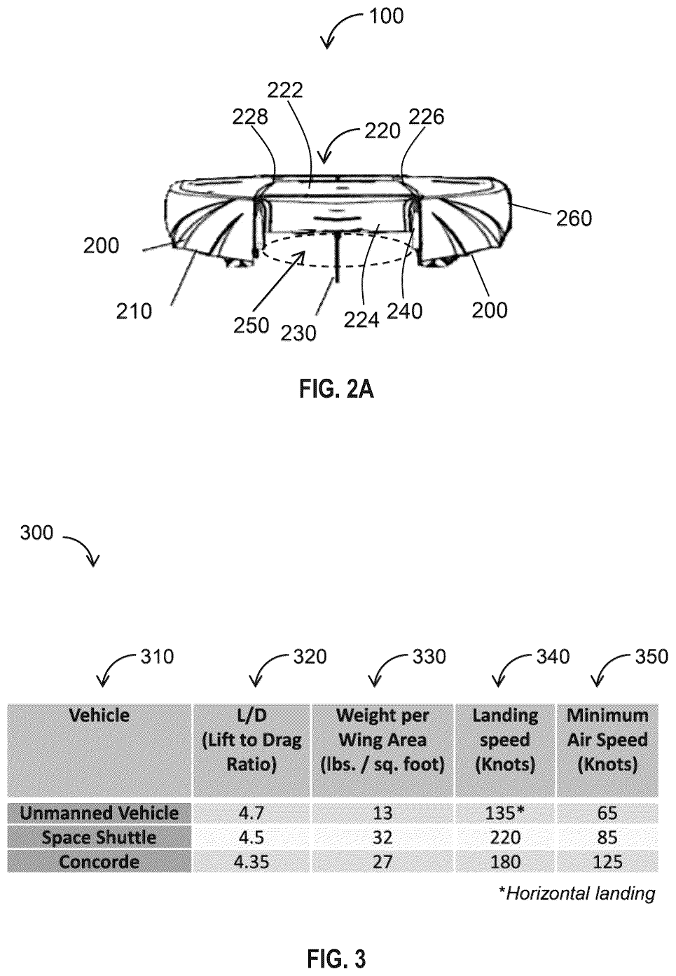

Referring now to FIGS. 1, 2, and 2A, an unmanned vehicle 100 capable of operating in the air, on the surface of the water, and underwater according to an embodiment of the present invention will now be discussed. Throughout this disclosure, the unmanned vehicle 100 may also be referred to as a vehicle, an autonomous vehicle, a vessel, or the invention. Alternate references of the unmanned vehicle 100 in this disclosure are not meant to be limiting in any way.

The unmanned vehicle 100 according to an embodiment of the present invention may include a vehicle body 105 which may be configured as an aerohydrodynamic wing, which will now be described in greater detail. The vehicle body 105 according to an embodiment of the present invention may exhibit the shape characteristics of a catamaran including two opposing and substantially-parallel sponsons 200 each having a stepped hull 210. The stepped hull design may advantageously increase the efficiency of the unmanned vehicle 100 by providing lower drag and increased stability at speed. The stepped hull 210 may also enhance maneuverability of the unmanned vehicle 100. Referring now additionally to FIG. 2A, the catamaran-style stepped hull 210 additionally may have shape characteristics that provide aerodynamic stability and control in the form of a central tunnel portion 250 and a central wing-shaped portion 220 of the vehicle body 105. The wing 220 may be characterized by a leading edge 221, a trailing edge 223, a port edge 226, a starboard edge 228, an upper surface 222, and a lower surface 224. The two sponsons 200 may be coupled to the port 226 and starboard 228 edges of the wing 220, respectively. Each sponson 200 may be characterized by a proximal wall 240 positioned adjacent the centrally-positioned wing 220 and a distal wall 260 positioned opposite the proximal wall 240. The two proximal walls 240 of the sponsons 200 and the lower surface 224 of the wing 220 may define a tunnel 250 through which fluid (for example, and without limitation, water and/or air) may pass when the vehicle 100 is in motion relative to the fluid. The central wing-shaped portion 220 of the vehicle body 105 may have varying widths according to the mission-driven aerodynamic and hydrodynamic characteristics of the unmanned vehicle 100.

Continuing to refer to FIGS. 1, 2 and 2A, aerodynamics of the unmanned vehicle 100 are now discussed in more detail. More specifically, the unmanned vehicle body 105 may be shaped such that opposing lift forces may be balanced. For example, top of vehicle 222 lift may be caused by decreased air pressure resulting from increased air velocity, while opposing rear of vehicle lift may be caused by increased air pressure resulting from decreased air velocity. An increase in angle of attack may cause increased vertical lift on the lower surface 224 of the wing defining the tunnel 250, which may result in an upward force forward of the centerline. An increased angle of attack may also cause air flow to slow and pressure to increase under the tunnel 250, which may result in increased lift with a force vector aft of the centerline. The top and rear lift vectors may result in a balanced lift rather than rotational forces, so that the vehicle body 105 may move in a controlled fashion along its central axis. The constrained air tunnel 250 with canards and trim tabs (described below) at the points where air enters (e.g., leading edge 221) and exits (e.g., trailing edge 223) may enable good control of air flow about the vehicle 100 and resulting lift

FIG. 3 summarizes wind tunnel test results 300 for an unmanned vehicle 100 characterized by the aerohydrodynamic wing design disclosed above. As illustrated in FIG. 3, the unmanned vehicle body 105 may achieve a lift to drag (L/D) ratio 320 of 4.6 to 5.0 depending on angle of attack, tunnel 250 width, and sponson 200 depth. Test conditions predicted a minimum air speed 350 before stall of 65 knots for the unmanned vehicle 100 at a maximum angle of attack, and good horizontal glide control at 135 knots (horizontal landing speed 340). Sample field results included stable laminar air flow at 225 knots and balanced forces (L/Weight, D/Thrust) at 165 knots. Demonstration of an 80-foot drop of the unmanned vehicle 100 resulted in a measured maximum air speed of 55 knots and an angle of attack of 25 degrees.

Continuing to refer to FIG. 3, the aerodynamic characteristics of the unmanned vehicle 100 are now discussed in more detail by comparison to a NASA orbiter (e.g., Space Shuttle) 310. In one exemplary embodiment, the present invention may exhibit the following dimensions:
Weight: 86 pounds
Length: 95 inches (7.92 feet)
Tunnel (wing) length: 90 inches (7.5 feet)
Tunnel (wing) width: 11 inches
Height: 12.5 inches
Total area under tunnel=6.88 square feet
Weight per wing area=12.5 pounds per square foot

For purposes of comparison 310, a representative implementation of the NASA orbiter is known to exhibit the following dimensions:
Weight: 172,000 pounds
Length: 122 feet
Wingspan: 78 feet
Height: 59 feet
Wing area=5380 square feet
Weight per wing area=32 pounds per square foot

As shown in FIG. 3, the present invention comparatively may have a slightly better L/D ratio on approach than the Space Shuttle Orbiter or, also for example, than the Concorde Supersonic Transport (SST). Moreover, the wing surface area to weight ratio 330 on the unmanned vehicle disclosed herein is more than twice as good in terms of wing loading as the ratio achieved by either the Concorde SST or the Space Shuttle Orbiter.

Those skilled in the art will recognize that the aerodynamic characteristics of the unmanned vehicle 100 operated in air mode will differ from the hydrodynamic characteristics of the same unmanned vehicle 100 operated in submarine mode. For example, and without limitation, underwater glide dynamics may differ from air glide dynamics in that water is an incompressible fluid and, therefore, lift/drag characteristics may be different when the unmanned vehicle 100 moves through water. In this regard, glide characteristics underwater may be dominated by drag characteristics as balanced across the surface area of the vehicle body 105, the glide ratio, and the efficiency of changing from positive to negative buoyancy. For example, and without limitation, the unmanned vehicle 100 may be configured for sub-surface operation that may include underwater glide that employs ballast-only motivation, powered thrust, or power-augmented (e.g., ballast and powered thrust).

Those skilled in the art will appreciate that the hull 210 of the unmanned vehicle 100 does not necessarily have to be a stepped hull but, instead, can have any other shape. More specifically, it is contemplated that the hull 210 of the unmanned vehicle 100 may be smooth, for example, or may have any other shape while still achieving the goals, features and objectives according to the various embodiments of the present invention.

Referring now back to FIG. 1, the vehicle body 105 of the unmanned vehicle 100 may carry a plurality of compartments to house propulsion and power components 110, electrical and control components 120, center of gravity adjustment actuators 130, ballast components 140, and internally stowed payloads 150. These compartments may be sealed from each other by partitions 160 integrated into the vehicle body 105 with sealed electrical and mechanical interconnections 170. All vehicle compartments are preferably sealed from the external environment by hatches 180 with pressure seals 190 designed for both submarine and atmospheric environments. The plurality of sealed compartments can be pressurized to advantageously allow for deeper submerged (e.g., submarine) operation, and may be designed to maintain sealed integrity to a submerged depth in excess of one hundred (100) feet. Those skilled in the art will appreciate that each of the above-mentioned components do not necessarily need to be positioned in separate compartments. The unmanned vehicle 100 according to an embodiment of the present invention does contemplate that the various components may be organized in combined compartments, in one single compartment, in a combination of compartments, or in any other configuration. For example, and without limitation, the plurality of sealed compartments may define an on-board environment inside one or more of the sealed compartments, and an external environment outside one or more of the sealed compartments.

The present invention may include a sensor system to collect both vehicle 100 functional systems data and also external environmental data. The sensor system may comprise a variable set of sensors of many kinds that collect a wide variety of data from disparate sources, an electronic communication network over which the sensors may send data, and a data processing and routing system for collected sensor data. In one embodiment of the present invention, data representing the condition of components in the on-board environment may be collected by functional sensors such as the following: Global Position System (GPS), electronic compass, accelerometers, roll, pitch, yaw orientation, depth, pressure, temperature, voltage, drive train revolutions per minute (RPM), vibration at multiple locations, vehicle humidity, fuel level, and charge level. External environmental data may be collected by sensors that may include a video camera with computer-controlled articulation, zoom and night vision; electro-optical/infrared imaging and an audio sensor. Optional sensors may include, but are not limited to, radar, sonar, chemical and radiation sensors. External sensors may be mounted on a retractable device rack, as described below. Sensor signals may be connected to a signal multiplexing unit that may provide signal conditioning and routing, and the multiplexing component may be connected to a sensor data processing subsystem that includes a computer software component that may be located in the vehicle's 100 central computer. The sensor system also may include a sensor data storage system comprised of digital storage components that may allow for real time data collection and for latent data processing. The system may categorize stored data by a number of attributes that may include time of capture, device, and data type.

Still referring to FIGS. 1, 2, and 2A, the vehicle body 105 may scale proportionally in three dimensions. The vehicle body 105 according to an embodiment of the present invention may advantageously have a length scaling from about 2 feet to 70 feet, a beam from about 10 inches to 15 feet, and a depth of about 4 inches to 5 feet. The vehicle body 105 according to an embodiment of the present invention can advantageously range in weight from about 5 pounds to 15,000 pounds. Alternate references of the vehicle body 105 in this disclosure are not meant to be limiting in any way. More particularly, any reference to dimensions above is meant for exemplary purposes, and not meant to be limiting in any way.

The vehicle body 105 may be constructed of various materials, including fiberglass, carbon fiber, or aramid fiber, depending on the relative importance of prevailing design factors. For example, and without limitation, if lowering construction costs of the unmanned vehicle 100 is an important design factor, the choice of fiberglass as the material for the vehicle body 105 may reduce the total cost to manufacture the unmanned vehicle 100. In another example and without limitation, if an important design factor is enhancing strength to weight characteristics in the vehicle body 105 for the unmanned vehicle 100 to withstand ambient air pressures during aerodynamic flight or glide as well as to withstand ambient water pressures when submerged in water to hundreds of feet, the choice of aramid fiber as the construction material for the vehicle body 105 may be desirable. Those skilled in the art will appreciate, however, that the unmanned vehicle 100 according to an embodiment of the present invention may be constructed of any material, and that the materials mentioned above are exemplary in nature, and not meant to be limiting. According to an embodiment of the present invention, a vehicle body 105 constructed of disclosed materials less than 0.125 inches thick may exhibit a high tensile strength to counter the pressures at hundreds of feet under water as well as to support a controllable low-pressure differential across the exterior of the vehicle body 105 during atmospheric flight.

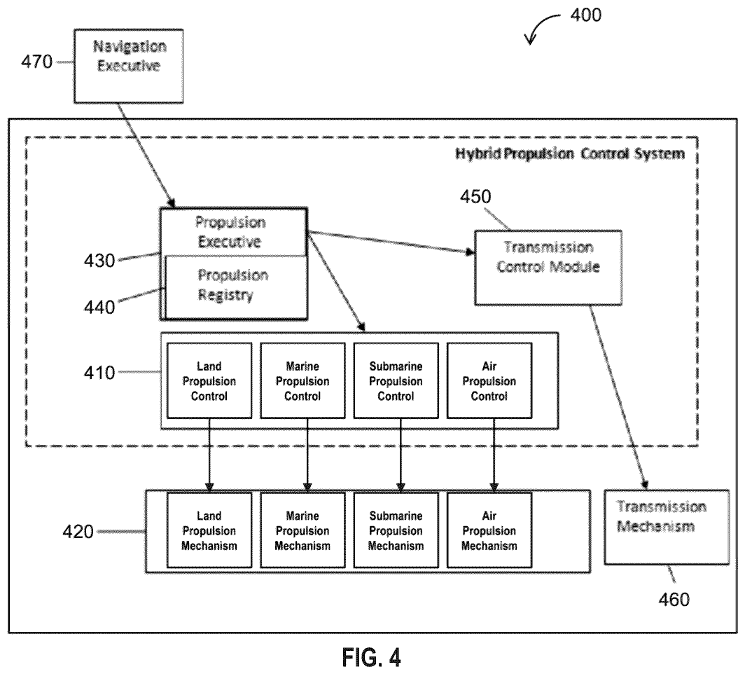

Referring now to FIG. 4, a propulsion system 400 of the unmanned vehicle 100 according to an embodiment of the present invention will now be discussed. The propulsion system 400 may include a combination of propulsion control modules 410 and propulsion mechanisms 420 that may, either autonomously or in response to remote controls, propel the unmanned vehicle 100 in the air, on the surface of the water, and underwater. The propulsion mechanisms 420 may employ vectored thrust mechanisms that may, for example and without limitation, include turbines and propellers.

Still referring to FIG. 4, the propulsion system 400 may include a propulsion executive 430, a propulsion registry 440, and a transmission control module 450. The propulsion executive 430 may accept instructions for speed and propulsion type from the navigation executive 470 and may send control signals to direct the desired propulsion mechanisms 420 to engage using the transmission mechanism 460. The instructions to the propulsion executive 430 from the navigation executive 470 may be in the form of relative changes to speed, including the ability to reverse direction, as well as to the mode of propulsion. Several different types of propulsion systems are contemplated for use in connection with the unmanned vehicle 100 according to embodiments of the present invention. Details regarding the several different types of propulsion systems are provided below.

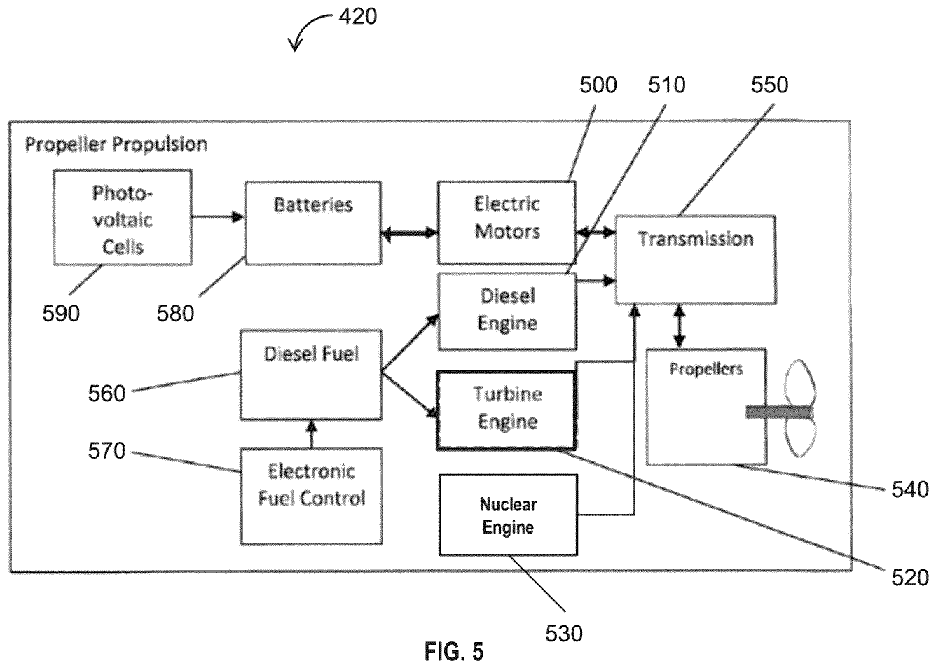

Referring now to FIG. 5, an example propulsion mechanism 420 of the unmanned vehicle 100 according to an embodiment of the present invention is discussed in greater detail. Power supplies for all modes of use of the unmanned vehicle 100 may, for example and without limitation, include a variety of motors such as electric 500, diesel 510, turbine 520, and nuclear 530. Embodiments of the unmanned vehicle 100 according to the present invention may include all or some subset of the hybrid power sources disclosed.

Still referring to FIG. 5, in some embodiments of the present invention the unmanned vehicle 100 operating in marine and submarine modes may use a plurality of propellers 540 or water jets as vectored thrust. Power may be supplied to propellers 540 by electric motors 500 or by diesel 510, turbine 520, or nuclear 530 engines through a computer-controlled transmission 550. A turbine engine 520 may be substituted for the diesel engine 510. The diesel 510 and turbine 520 engines may be fueled by, for example and without limitation, common diesel fuel 560, kerosene, and jet-x. The propulsion control system may include an electronic fuel control 570 to regulate the fuel supplied to the diesel 510 and turbine 520 engines.

Still referring to FIG. 5, the unmanned vehicle 100 according to embodiments of the present invention may make use of energy captured in storage cells such as batteries 580. Such storage cells, for example and without limitation, may include high power density lithium polymer batteries or lithium-ion batteries. The storage cells may receive energy from the electric motors 500 running as generators when the unmanned vehicle 100 is under power from another source such as diesel 510, turbine 520, or nuclear 530 engines. In another embodiment, the storage cells may receive energy from photovoltaic cells 590 that may be mounted to the vehicle body 105 in a variety of mechanical configurations. Such mounting configurations, for example and without limitation, may include axial hinges with actuators to articulate the photovoltaic cells 590 outwardly from the vehicle body 105. In one embodiment, the photovoltaic cells 590 may be wired to a computer-controlled power control and regulator module. A computer-controlled switch in the power control module may route power from the photovoltaic cells 590 to sets of batteries 580 for recharge depending on the relative charge state of the batteries 580. The regulator module may monitor and adjust the charge to the batteries 580 used in the first unmanned vehicle 100 embodiment. For example, and without limitation, another embodiment of battery 580 recharge may utilize wave motion to accomplish a low-level recharge by mounting a faraday tube along the fore-to-aft axis of the vehicle body 105. The faraday tube may be electrically connected to power lines in communication with batteries 580 through a regulator.

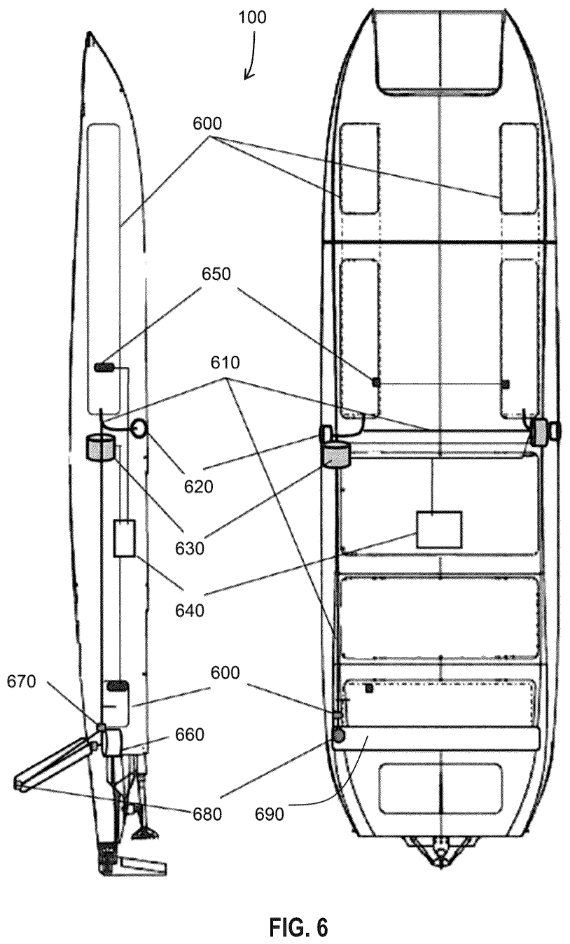

Referring now to FIG. 6, the ballast system of the unmanned vehicle 100 according to an embodiment of the present invention will be discussed. The ballast system, for example and without limitation, may contain mechanisms to control the volume of water and air in one or more ballast chambers 600 to advantageously vary the buoyancy of the unmanned vehicle 100 while submerged and to support selective submerging and re-surfacing of the unmanned vehicle 100. The ballast system may also be known as the buoyancy system because the system may provide for the selective submerging and re-surfacing of the unmanned vehicle 100 by varying buoyancy. The ballast control mechanism may comprise piping 610 and ports 620 to enable the flow of water into and out of ballast chambers 600. Electric water pumps 630 may be activated by the ballast control system 640 to control ballast levels which may be monitored by ballast sensors 650. A pressure tank 660 may be vented into the ballast chamber 600 and the air flow between the pressure tank 660 and the ballast chamber 600 may be regulated by locking electronic valves 670 that may be controlled by the ballast control system 64. The pressure tank 660 may enable fast evacuation of the ballast chamber 600 and also evacuation of the ballast chamber 600 when other means are not available rapidly.

Ballast ports 680 may be located on the bottom surface of the vehicle body 105 which may enable water to be fed into the ballast tanks 600 when the unmanned vehicle 100 is in motion, which may enable fast submersion. A ballast port 680 located on a device rack 690 positioned on the top of the vehicle body 105 may enable water to be routed into the ballast chambers 600 when the unmanned vehicle 100 is in a top-down position in the water. Filling the ballast chambers 600 while top-down may advantageously enable the unmanned vehicle 100 to autonomously self-right, both at or below the surface of the water. In another embodiment, for example and without limitation, a ballast port 680 located on a device rack 690 may allow routing of air or water to the ballast chambers 600 and, in so doing, may allow the unmanned vehicle 100 to operate underwater without fully surfacing, which may be advantageous for stealth objectives.

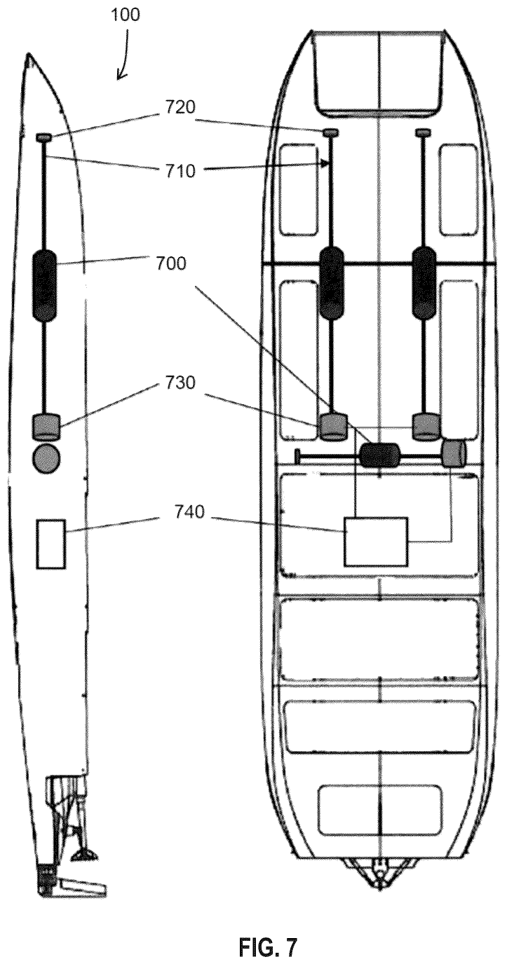

Referring now to FIG. 7, the center of gravity system of the unmanned vehicle 100 according to an embodiment of the present invention will be discussed. The center of gravity system, for example and without limitation, may include mechanisms to control the center of gravity of the unmanned vehicle 100 along the two perpendicular axes for roll and pitch. The center of gravity control system may include internally threaded weights 700 which may encase threaded actuator rods 710 that may be fixed to rotational bearings 720 on one end and electric motor actuators 730 on the other. The electric motor actuators 730 may be controlled by the center of gravity control system 740 that supplies power and signal to the electric motors. Sensors on the linear actuators provide feedback to the center of gravity control system 740 as to position and speed of motion of the controlled, internally threaded weights 700.

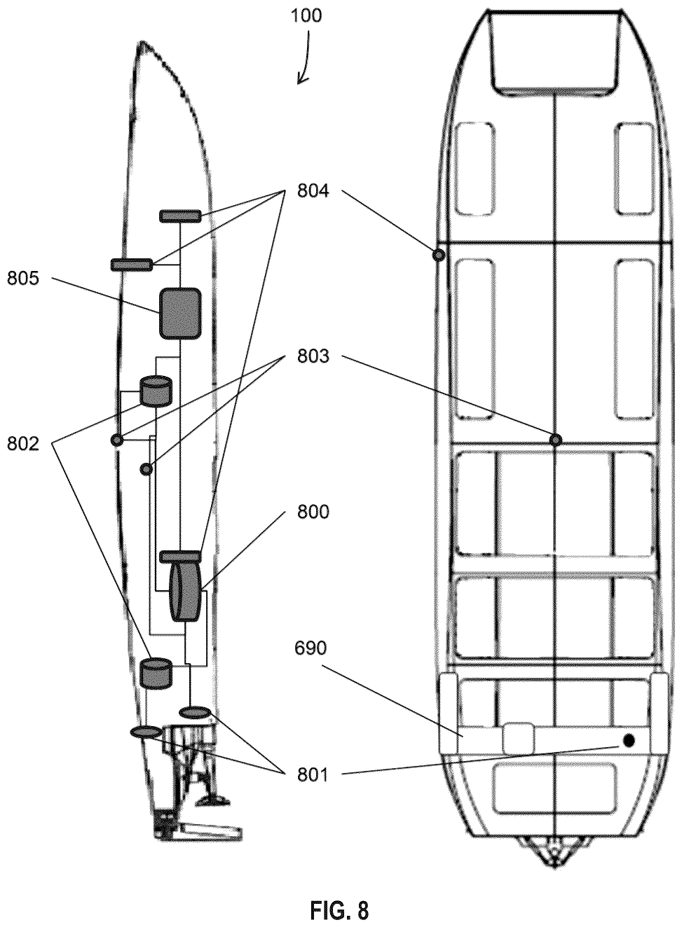

Referring now to FIG. 8, the pressurization system of the unmanned vehicle 100 according to an embodiment of the present invention will be discussed. The pressurization system, for example and without limitation, may contain a pressure tank 800 that may be able to hold gaseous material, such as air, at a minimum gas pressure of 500 PSI with a sealed hull of an unmanned vehicle 100 to advantageously enable vehicle body 105 strength-to-weight characteristics during selective operation of the unmanned vehicle in the air, on the surface of the water, and below the surface of the water. In one embodiment, the pressure tank 800 may be carried within a compartment inside the vehicle body 105. In another embodiment, the pressure tank 800 may be affixed to the inside of the sealed hull of the vehicle body 105 which itself defines a watertight chamber. Bidirectional seals in the sealed hull may be applied to any openings, vents, ports, and moving services carried by the vehicle body 105 to maintain a pressurizable space within the unmanned vehicle 100.

Still referring to FIG. 8 in a further embodiment, for example and without limitation, pressurized spaces within the vehicle body 105 may vent 801 via piping to the exterior of the vehicle body 105. In one embodiment, for example and without limitation, the piping lines may be vented to the vehicle body 105 exterior through the device rack 690. In a further embodiment, for example and without limitation, an electrically actuated air pump 802 capable of transferring air into the pressure tank 800 may be connected to an airport via piping line that may employ locking electronic valves 803 to regulate the intake of air through an airport and into the pressure tank 800.

Still referring to FIG. 8 in a further embodiment, a locking electronic valve 803 that is in the “normally closed” position may be connected to a piping line that may connect to the pressure tank 800 and may vent 801 inside the vehicle body 105. In a further embodiment, for example and without limitation, a locking electronic valve 803 that is in the “normally closed” position may be connected to a piping line that may vent 801 air from inside the vehicle body 105 to the vehicle body 105 exterior. All internal compartments in the unmanned vehicle 100 may be connected via piping lines to both external vents 801 or to internal vents between compartments.

Continuing to refer to FIG. 8, pressure sensors 804 may be affixed inside the vehicle body 105 and external to the hull of the vehicle body 105 and may send internal and ambient pressure information to the pressurization control system 805. The pressure control system 805 may be a set of software programs running on a set of microprocessors that may have control algorithms that may receive inputs from the sensors 804 previously mentioned, may calculate the differential pressure, and may produce outputs to the pressure valve 803 actuator and the air pump 802. The navigation control system (described in more detail below) may contain logic that may determine the optimal pressure differential set point and may send this information in the form of digital instructions across a computer network to the pressurization control system 805. The pressure control logic may send control signals to actuator controllers that operate the air pump 802 and relief valve 803.

To increase the internal pressure in a pressurized compartment inside the vehicle body 105, the pressure relief valve 803 from the pressure tank 800 may be opened. To decrease the internal pressure in a pressurized compartment inside the vehicle body 105, the pressure relief valve 803 between the compartment inside the vehicle body 105 and the environment external to the vehicle body 105 may be opened. In both cases, a control algorithm in the pressurization control system 805 may determine the frequency and duration of opening and closing the pressure valves 803.

A pressure sensor 804 may monitor the pressure tank 800 and may send this signal periodically to the pressure control system 805. When the pressure in the pressure tank 800 may fall below a given level, as may be configured in the pressure control system 805 logic, the pressure control system 805 may issue a request to pressurize to the navigation system which, in turn, may issue a request to pressurize to the off-board mission control and on-board control system master. These systems may have logic and configurations that may determine when pressurization may be authorized. When pressurization is authorized, instructions are sent to the pressurization system to pressurize.

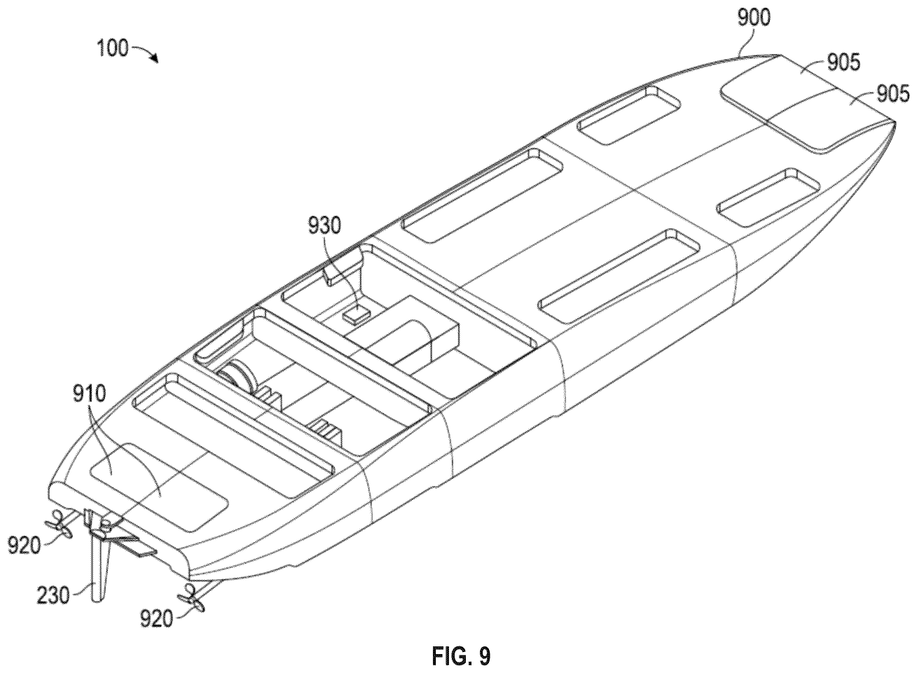

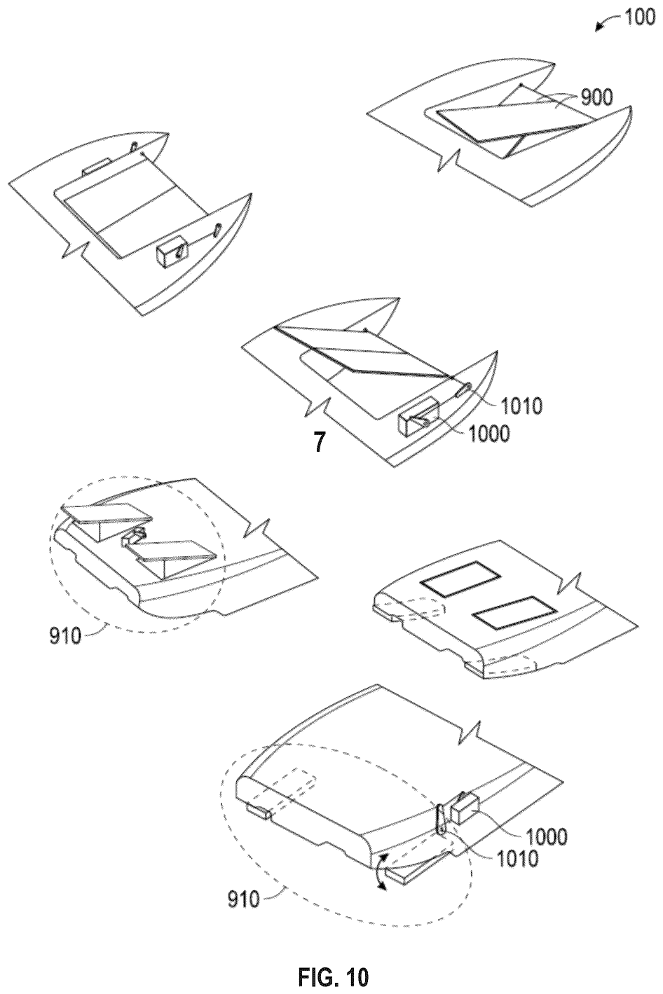

Referring now to FIGS. 9 and 10, the control surfaces 900 of the unmanned vehicle 100 according to an embodiment of the present invention will be discussed. In one embodiment of the present invention, control surfaces 900 may be affixed to the vehicle body 105 to advantageously support physical maneuvering of the unmanned vehicle 100 in the air, on the surface of the water, and below the surface of the water. The control surfaces 900, for example and without limitation, may be comprised of forward canards 905, rear trim plates 910, and rudders 230, all of which may be affixed externally to the vehicle body 105. In one embodiment, for example and without limitation, a rudder 230 may be mounted on a strut that may be positioned substantially near the stern of the vehicle body 105. The unmanned vehicle 100 may also include propeller thrusts 920 which may be vectored.

Still referring to FIGS. 9 and 10, electronic position sensors 1010 may be attached to each control surface 900 and position signals may be relayed to the control surface control system 930, which may apply control logic to determine desired control surface 900 adjustments. In one embodiment, each of the control surfaces 900 may be independently articulated by electric motor actuators 1000 in response to control signals received by that control surface 900 from the control surface control system 930. For example, and without limitation, the front canards 905 may articulate independently in two directions for a maximum roll condition, and the rear trim tabs 910 may also articulate bi-directionally.

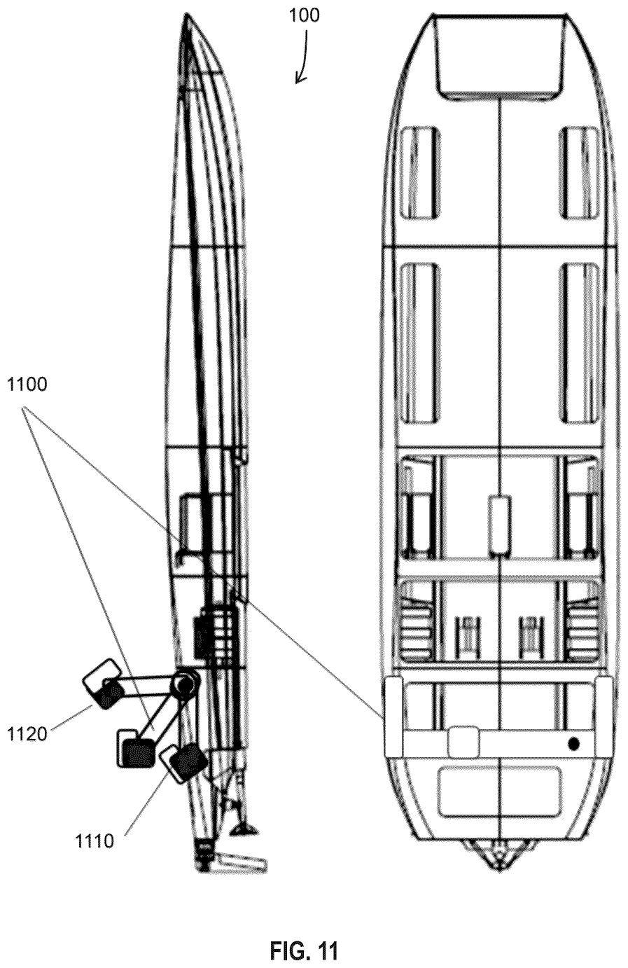

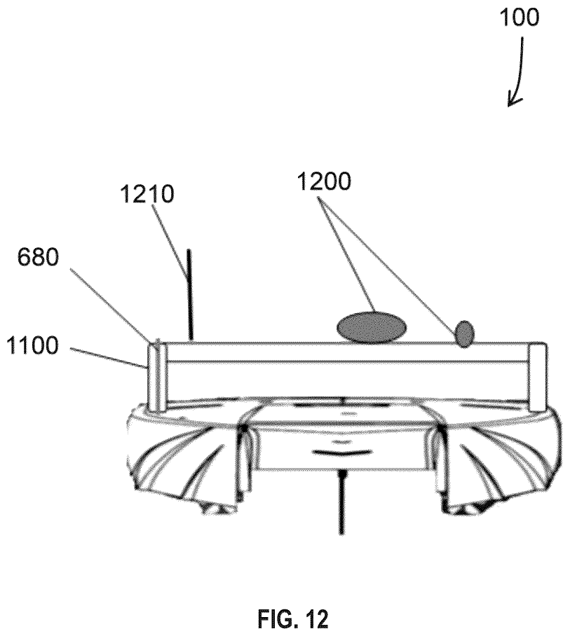

Referring now to FIGS. 11 and 12, the device rack of the unmanned vehicle 100 according to an embodiment of the present invention will be discussed. The device rack, for example and without limitation, may include a retractable mount 1100 that may articulate from the vehicle body 105 and that may hold sensors 1200, communication antennae 1210, and a ballast port 680. In one embodiment, for example and without limitation, mounting points including mechanical, power and signal mounts may be provided at the device rack for sensors 1200 and communication antennae 1210. In another embodiment, ballast ports 680 may be located on either side of the retractable mount 1100, to which electric wiring and ballast piping may be routed from inside the vehicle body 105 through pressure sealed bulkheads. The device rack may be constructed of various materials including, for example and without limitation, aramid fiber as an outer cover which may be disposed over an aluminum tube frame.

Still referring to FIG. 11, in one embodiment, for example and without limitation, the device rack may be actuated by electric motors under computer control such that the device rack can be retracted into a “down position” 1110 which may present the least drag and visibility of the unmanned vehicle 100. In another embodiment, for example and without limitation, the device rack may be actuated by electric motors under computer control such that it can be extruded into a full “up position” 1120 which may present better surveillance, communication, and ballast reach. In one embodiment, for example and without limitation, the retractable mount 1100 may be actuated in the form of a lever arm that may, to accomplish articulation and retraction, swing rotationally about a hinge that may be fixed at a mount point located substantially adjacent to the surface of the vehicle body 105. In another embodiment, for example and without limitation, the device rack may be actuated in the form of a telescoping member that may extrude and retract in a vector substantially perpendicular to the member's deployment point on the surface of the vehicle body 105. A person of skill in the art will immediately recognize that the operational value of the multi-mode vehicle 100 may be largely dependent on the payloads the vehicle 100 may carry and how effectively those payloads may be made usable to consumers. Common payloads include various sensors (e.g., cameras, sonar), communications units (e.g., radios) and electronic devices (e.g., electronic warfare). Such payloads come in many shapes, sizes, power requirements and interfaces, as well as environmental ruggedness characteristics. The unmanned vehicle 100 of the present invention may advantageously present a general-purpose platform configured to integrate many different payloads. Consumers and/or payload providers may have a need to quickly integrate different sensors into an unmanned vehicle 100.

In certain embodiments of the present invention, the unmanned vehicle 100 may be configured to carry varying types and amounts of payload in one or more operational modes, including on the surface of water, underwater, and in the air. For example, and without limitation, the vehicle 100 may be configured to carry such payloads internal to the vehicle body (e.g., internally stowed payload 150 in FIG. 1, as described above). Also, for example, and without limitation, the vehicle 100 may be configured to augment the basic hull structure and to receive a mountable payload deck to advantageously provide additional payload capacity, as described in more detail below.

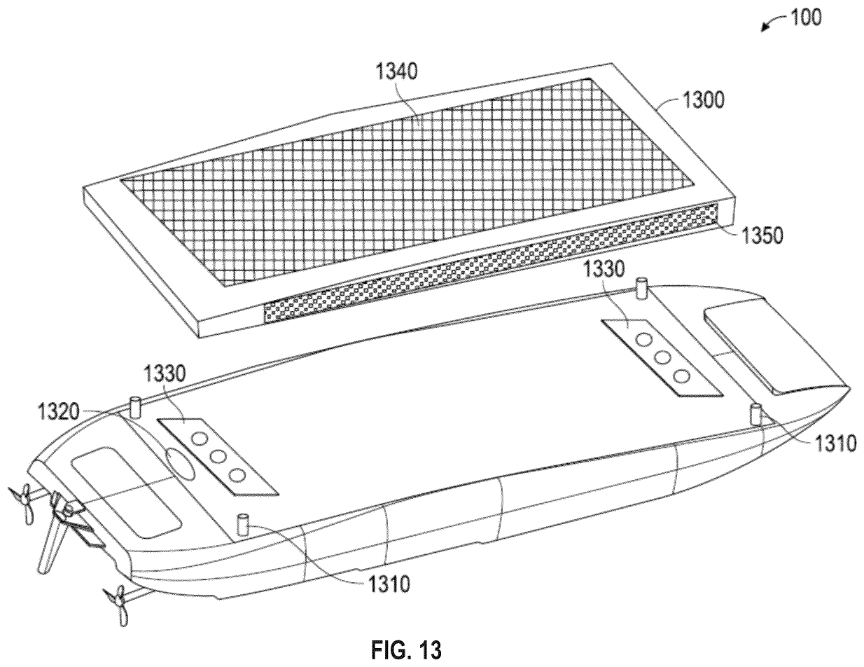

Referring now to FIG. 13, the payload deck of the unmanned vehicle 100 according to an embodiment of the present invention will be discussed. The payload deck, for example and without limitation, may provide mounting points for an interchanging payload deck 1300. In one embodiment, the mounting points may include mechanical mounting mechanisms 1310, power connections 1320, and signal connections 1330. Connections and mount points may be fully, hermetically sealed for underwater operation of the unmanned vehicle 100. The vehicle body 105 may be itself fully sealed and may operate without a payload deck. In one embodiment of the present invention, a payload deck may carry auxiliary solar panels 1340 for electrical recharge and may contain flat form factor batteries 1350 that may provide auxiliary power which may advantageously extend the operational duration of the unmanned vehicle 100.

Although FIG. 13 demonstrates the unmanned vehicle 100 having the capability to interchange payload decks directly on the vehicle body 105, the unmanned vehicle 100 may also, for example, and without limitation, include a towing apparatus for towing external payloads. For example, and without limitation, towable payloads may include transport sleds for people, material, and fuel. Such a towing apparatus may support power and signal connections to the unmanned vehicle 100 to which the apparatus is engaged, permitting advantageous employment of auxiliary towable payloads such as, for example, and without limitation, solar sleds to extend running time and sensor arrays to hunt mines and/or submarines. A towable sled, like the unmanned vehicle 100 with which the sled may be deployed, may be configured to operate underwater or on the surface of water, which may be advantageous for missions conducted in dangerous or contested environments where stealth or cover (underwater) is important.

In one embodiment of the external payload towing feature, a Mobile Unmanned Target Practice System may be characterized by mission planning and control instructions advantageously operating some number of unmanned vehicles 100, each configured with a towing apparatus and a towing sled. Current manned methodologies for positioning, simulating, and assessing military targets limit deployment options and practice locations. The unmanned target practice system described herein may advantageously enable target practice to be done in an expanded range of conditions and locations, allowing for more “organic” target practice. For example, and without limitation, such a target practice system may comprise unmanned vehicles 100 equipped with control systems and mechanical configurations for towing and releasing targets as external payloads. Such towable targets each may be configured with retractable center keels for stability in a surface water environment. The towable targets may also feature retractable target flags. Alternatively, or in addition, towable targets may also be configured as radio-controlled target vessels. For example, and without limitation, an unmanned vehicle 100 may be configured as a “relay station” to remotely operate some number of radio-controlled target vessels.

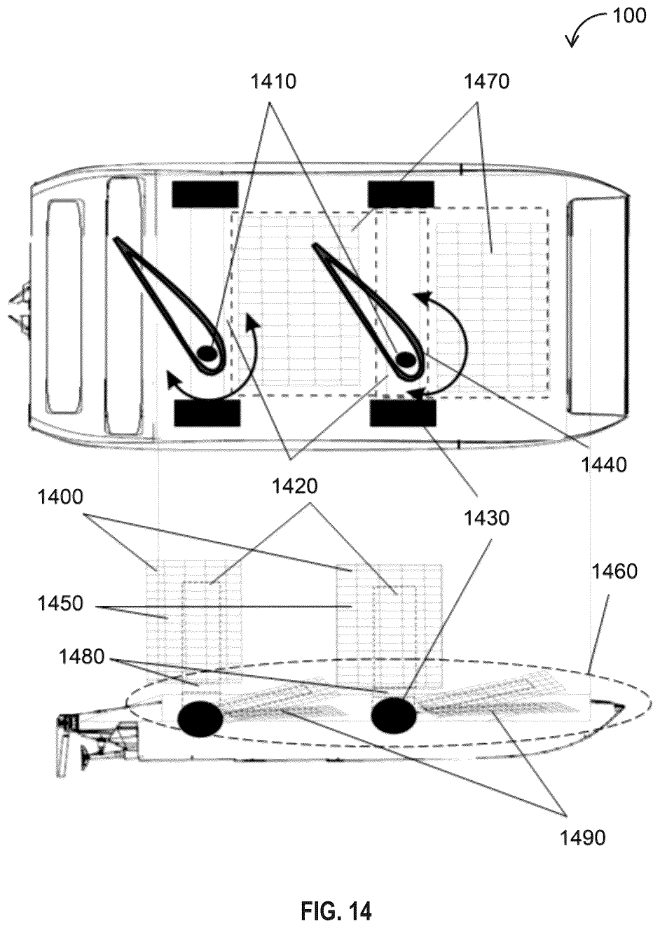

Referring now to FIG. 14, the payload deck, for example and without limitation, may provide mechanical, power, and signal connectivity for an additional form of propulsion that may be supplied by a retractable hard sail affixed to an interchangeable payload module. In one embodiment, for example and without limitation, two hard wing sails 1400 with central masts 1410 may be mounted on horizontal cylinders 1420 that may rotate and may be driven by electric motor actuators 1430. The hard wing sails 1400 may have an aerodynamic wing shape 1440 that may provide additional lift when the unmanned vehicle 100 sailing upwind on the surface of the water. The hard sails 1400 may be rotated around the axis of their mounting mast 1410, which may be accomplished by splitting the masts 1410, articulating the sections independently, and mounting electric motor actuators 1480 between mast sections 1410. The hard sails 1400 can be rotated in two axes and stowed in the payload bay in a horizontal position 1490. Position sensors may be mounted on the actuators between mast sections 1410 that may be connected to the navigation control system through a wiring connection that may run through bulkhead connectors between the payload deck and the vehicle body 105.

Still referring to FIG. 14, for example and without limitation, solar panels 1450 may be affixed to the outer surfaces of the hard sails 1400 which may provide solar recharge capability. The solar panels 1450 may be connected to the payload electrical system which may be connected to the vehicle electrical power system through a bulkhead connector between the payload deck 1460 and the vehicle body 105. Additional solar panels 1470 may be mounted in the bed of the payload deck for additional solar energy collection and also may be connected to the vehicle electrical power system. In other embodiments, the payload deck, may provide mechanical, power, and signal connectivity for payload modules that may provide auxiliary capabilities in the form of, for example and without limitation, wind energy collectors, video surveillance, and weapons systems.

As described above, the device rack and/or payload deck may provide mechanical, power, and signal connectivity for any number of interchangeable payload modules and/or auxiliary mounts. In this manner, the unmanned vehicle 100 may be outfitted with working appendages of various form and function. Such appendages may advantageously provide utility in multiple modes, as the appendages may be integrated with the body 105 of the unmanned vehicle 100 so that unmanned vehicle 100 may operate effectively in the air, on water, and underwater. Such appendages may be configured with specialized capabilities (e.g., magnetic, telescopic) or specialized tools, depending on the needs of a particular mission.

In one embodiment, for example and without limitation, the payload deck may support a single (e.g., “simple”) arm and gripper, which may be positioned in a substantially-central payload bay (e.g., interior compartment) of the unmanned vehicle 100, which may be advantageous in terms of reach capability. In another embodiment, the payload deck may support a “bat wing” configuration, which may be defined as two appendages each characterized by a shoulder, some number of arms, and some number of grippers. For example, and without limitation, a bat wing appendage configuration may include two appendages attached, respectively, to each side of the unmanned vehicle 100, and each having a “shoulder” mechanism that may support motion with three degrees of freedom. Each appendage may also include arm sections having connecting “elbows,” and each elbow may support motion with either two or three degrees of freedom. Each appendage may also include hand sections, each of which may have gripping/holding capability and may support motion with three degrees of freedom at a “wrist.” Also, for example, and without limitation, each appendage may comprise a flexible, thin film material positioned between the arm sections that form wings that may be made of (or, alternatively, coated with) thin-film solar. Advantages of “bat wing” design for use with a multi-mode unmanned vehicle 100 is that the design may provide efficient retraction and storage for surface efficiency, increased wing surface for air or sub-surface gliding, solar energy harvesting either in water surface mode or slightly sub-surface, and wind propulsion in water surface mode.

A person of skill in the art will immediately recognize that employing the unmanned vehicle 100 to carry heavy payloads, as in the examples illustrated in FIGS. 13 and 14 and subsequently described above, the vehicle 100 may be expected to experience increased displacement in the water. To counteract the negative impact on performance that increased displacement may cause, the hull design shown and described above for FIGS. 1-3 may be advantageously altered to include an additional sponson.

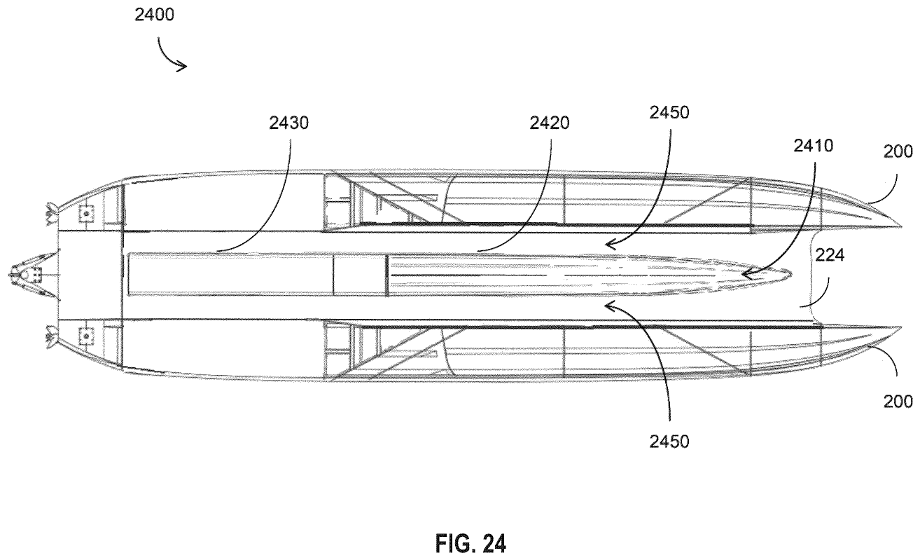

In one embodiment of the present invention, as illustrated in FIG. 24, a center sponson 2410 may be added to the hull structure of the vehicle 100 (hereinafter referred to as vehicle embodiment 2400) and may be centrally positioned between the two existing sponsons 200 to advantageously increase payload carrying capacity for the vehicle 2400 overall. More specifically, the center sponson 2410 may create additional lift through increased displacement and upward force from water flow as the center sponson 2410 moves forward through water. As a direct consequence of this upward force, high performance characteristics may be maintained because, as speed increases, the vehicle 2400 may lift onto the primary port and starboard sponsons 200 which may advantageously remove drag that may be caused by the additional surface area introduced by the center sponson 2410.

Still referring to FIG. 24, the front of the sponson 2410 toward the bow of the vehicle 2400 may be characterized by a deep V-Hull shape 2420. As the sponson 2410 transitions aft, the sponson 2410 may flatten out to a low deadrise hull and pad bottom 2430. The center sponson 2410 so designed may advantageously provide additional lift when operating on the surface of water because the sponson 2410 may provide displacement that increases as it descends below the water line. The angle and shape of the center sponson 2410 may provide lift as water flows across it from bow to stern of the vehicle 2400. On either side of the center sponson 2450, a gap 2450 may be defined between the center sponson 2410 and each side sponson 200 (port and starboard). This gap 2450 may define part of the tunnel 250 (as described above, except necessarily split by the center sponson 2450 into two generally parallel tunnels) that may allow for air flow and lift at higher speeds in such a way as to advantageously maintain good high-speed performance of the vehicle 2400.

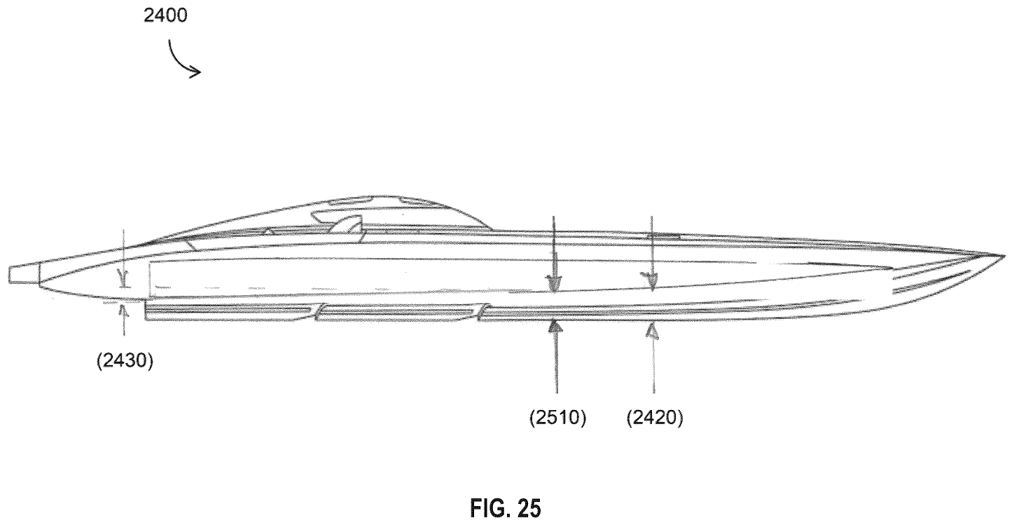

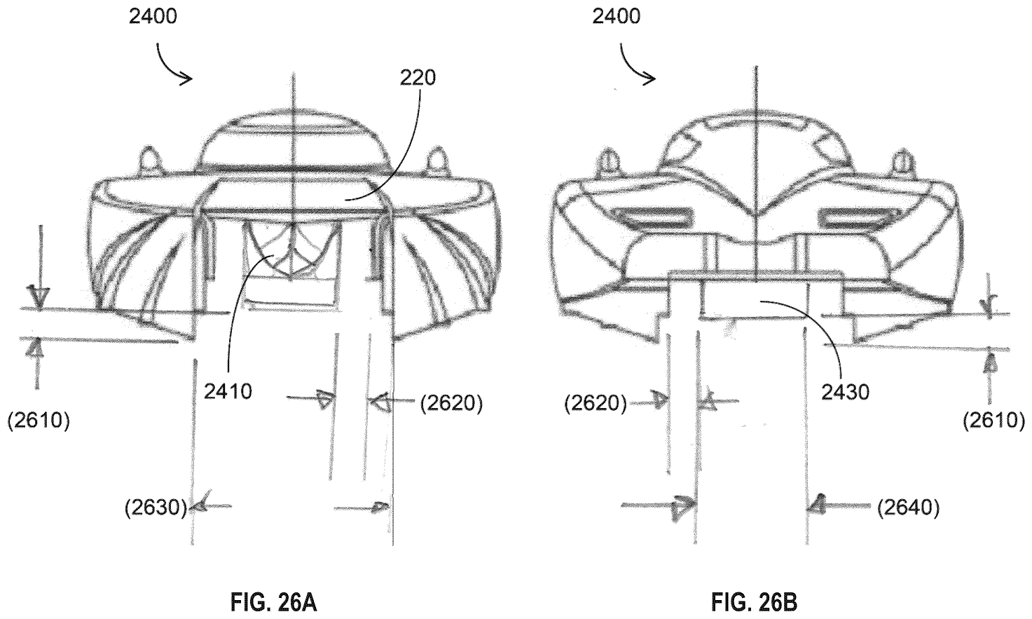

Referring to FIGS. 25, 26A, and 26B, additional characteristics of the sponson 2410 of the vehicle 2400 are now described in detail. For example, and without limitation, the center sponson 2410 may define an inclined plane as it moves aft (e.g., progress from first point 2410 through second point 2510 to third point 2430), which may advantageously provide lift in addition to displacement of the sponson 2410 when vehicle 2400 is moving. Viewed from front to rear of the vehicle 2400, the sponson pad may be above the port and bow sponson portion relative to water line (2610 such that at high speeds, the sponson 2410 may remain above the water line. The design of the sponsor 2410 is such that a gap 2620 may be maintained on either side of the center sponson 2410 to advantageously allow air flow and lift which may advantageously maintain stability with low drag. The gap 2610 may be sized relative to total tunnel volume and tunnel width (2630).

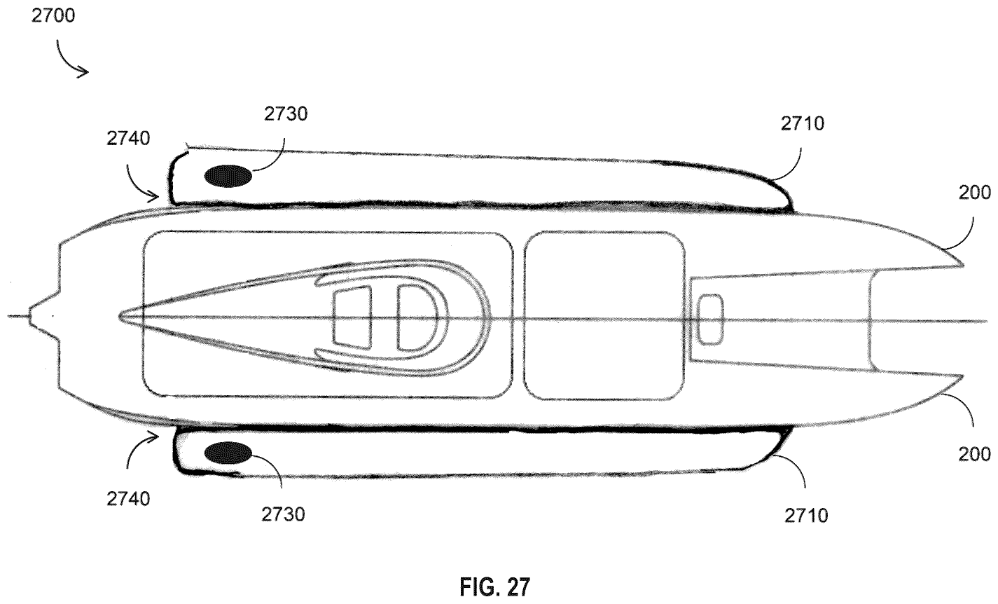

In another embodiment of the present invention, as illustrated in FIG. 27, outboard extensions 2710 may be added to the hull structure of the vehicle 100 (hereinafter referred to as vehicle embodiment 2700) on both port and starboard sponsons 200 to advantageously increase payload carrying capacity. In yet another embodiment, the sponson extensions 2710 may be removable. In yet another embodiment, the extensions 2710 may be part of the base hull mold. The addition of sponson extensions 2710 may increase the displacement of the vehicle 2700 at low speeds as payload weight increases. The addition of the extensions 2710 outboard of the current vehicle 100 profile may advantageously add roll stability at low off-plane speeds while maintaining good high-performance characteristics because a) as speed increases, the sponson extensions 2710 may rise up causing less surface contact and therefore less drag, and b) the center tunnel configuration 250 configured to control air flow and lift may be maintained. The sponson extensions 2710 may exhibit minor air drag effects at very high speeds.

For example, and without limitation, the sponson extensions 2710 may exhibit one or more of the following characteristics:
(1) positioned equilaterally port and starboard;
(2) constructed of the same aramid material as the vehicle hull (e.g., carbon fiber);
(3) shaped to follows the hull contour;
(4) each external sponson 2710 may runs aft and terminate where the vehicle transom begins (i.e., stepped hull shape ends);
(5) the front of each extension sponson 2710 may begin just aft of the vehicle sponson bow rake (i.e., where the sponsons flatten out);
(6) in one embodiment, sponson extensions 2710 may be removable (e.g., affixed to the hull with waterproof bolt assemblies);
(7) in another embodiment, external sponsons 2710 may be made as part of the hull mode (e.g., permanent);
(8) the external sponson width may be adjusted depending on the payload weight;
(9) the external sponson width may vary in width asymmetrically to allow for more displacement where the payload is located;
(10) the starboard external sponson 2740 may be characterized by through ports 2730 that may allow water to flow freely between it and the starboard main sponson (e.g., this feature may advantageously facilitate for self-righting of the vehicle 2700).

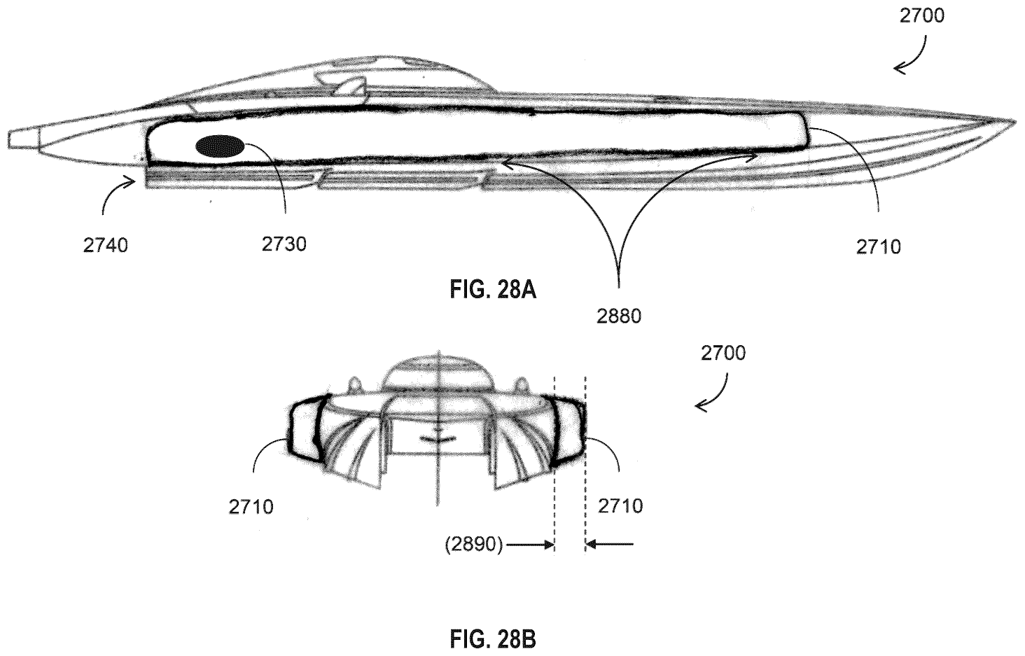

Still referring to FIG. 27, and referring additionally to FIGS. 28A and 28B, additional characteristics of the sponson extensions 2710 of the vehicle 2700 are now described in detail. For example, and without limitation, the bottom of the external sponson 2710 starts above the external “water line” step 2880 that is longitudinal along the hull 200. The aft end of the external sponson 2710 may terminate where the transom begins 2740 and may not overhang the stepped portions of the hull. The width 2890 of the external sponson 2710 may be variable depending on payload weight. A port location 2710 that allows water flow between starboard external and internal sponsons 2710 may be necessary for self-righting. (Not shown: a port side water port may be added to enable underwater multi-mode operation.)

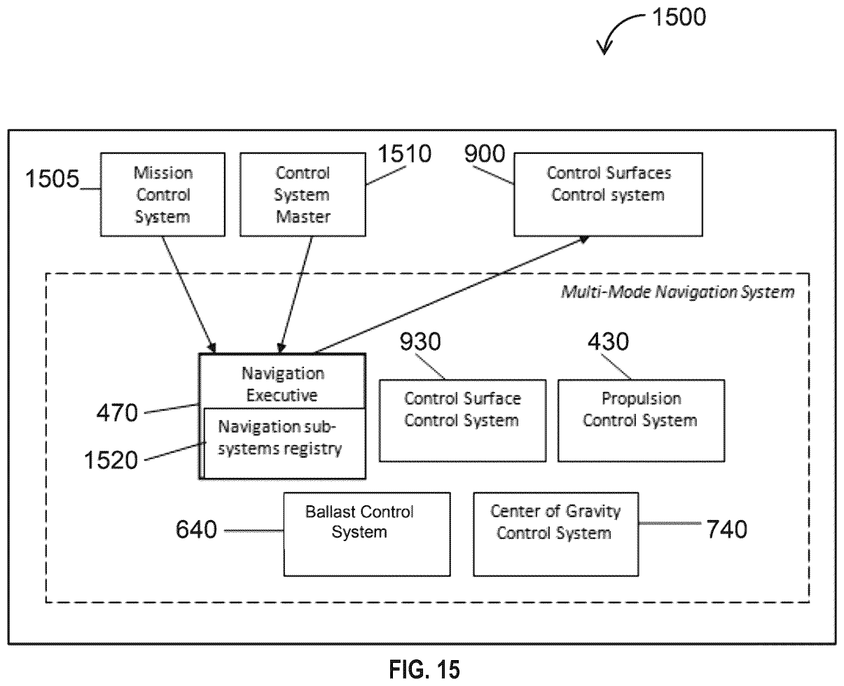

Referring now to FIG. 15, the navigation control system 1500 of the unmanned vehicle 100 according to an embodiment of the present invention will now be discussed in more detail. The navigation control system 1500, for example and without limitation, may act as the on-board governor of the speed, direction, orientation, mode, and propulsion type for operation of the unmanned vehicle 100. Navigation of the unmanned vehicle 100 includes both underwater and air glide capabilities as transit route alternatives. Underwater activity may include powered or un-powered operation (e.g., underwater glide). Advantageous underwater activity may include “sit and wait,” “power through,” or “glide until.” Advantageous air activity may include air drop into high seas, which may involve picking an angle of entry and direction of entry that may be best matched to prevalent wave patterns. Examples of advantageous use of the multi-mode navigation capabilities described above may include patrolling coastal areas in the surf zone, navigating through storm conditions, air drop search and rescue in heavy seas, optimizing energy use through all seas states, and surfing (riding) waves to save energy. Other advantageous uses of the capabilities described above may involve underwater current vectoring and may include merging with (riding) underwater currents for motion, avoiding underwater currents that oppose navigation direction, and exploiting underwater thermals.

In one embodiment, for example and without limitation, the navigation control system 1500 may order functional responses from a navigation executive 470, control surfaces 900 and control surfaces control system 930, propulsion executive 430, ballast control 640, and center of gravity 740 subsystems. The multi-mode navigation control system 1500 may enable the unmanned vehicle 100 to operate on the surface of the water, submerged under water, and in controlled glide or flight in the air by coordinated computer control of the vehicle control surfaces 900, ballast 640, center of gravity 740 and mode of propulsion 430 according to logic and sensor input that may be matched to the operating environment in which the unmanned vehicle 100 may be operating. The computer-controlled subsystems for each control activity may be connected in a computer network which may enable communication between each control subsystem and coordination by a control executive.

For example, and without limitation, navigation directives may originate from a mission control system 1505 when all systems may be operating normally, or from the on-board master control system 1510 in the event of an exception condition, for example, if the mission control system 1505 may be not operating reliably or if a critical subsystem may be operating abnormally. The navigation executive 470 may translate instructions for consumption by each subsystem. The navigation executive 470 includes a navigation sub-systems registry 1520 by which it may register and store information about the navigation subsystems that may be available on the unmanned vehicle 100, including the signal format and semantics by which instructions may be communicated to them.

As mentioned above, the navigation control system 1500 of the present invention may control navigation and orientation of the vehicle 100 in multiple modes. This capability may be exemplified by the ability to maintain direction and stability at speeds of typically between 100 to 200 knots on the surface of the water, orientation and depth control underwater, and controllable glide and flight paths in the air. The ability to control navigation and vehicle 100 orientation in multiple modes may be achieved by autonomous computer control of vehicle control surfaces 930, ballast control 640, and vehicle center of gravity control 740. The control systems of all three of these elements may themselves be under coordinated control by the multi-mode navigation control system 1500. Further, the multi-mode navigation control system 1500 may control propulsion 400 which also may affect vehicle 100 orientation in combination with the other navigation systems. The systems that control these elements may employ computer-controlled actuators and feedback sensors for closed loop real-time control.

For example, and without limitation, the multi-mode navigation control system 1500 may include optimization instructions regarding speed and orientation. The orientation control function of the navigation control system may calculate the optimal changes in control surfaces 900 and center of gravity 740 and may send instructions to the navigation executive 470 which may issue instructions to the control surface control system 930 and the center of gravity control system 740. A velocity control function of the navigation control system 1500 may calculate propulsion required and may send the signal to the propulsion control system 430 via the navigation executive 470. A flight control function of the navigation control system 1500 may enable powered flight and aerodynamic gliding.

For example, and without limitation, the mission control system 1505 may send instructions to the navigation executive 470 of the multi-mode navigation control system to initiate a mission segment that has an environmental mode of “air glide to water entry.” The navigation executive 470 may, in turn, send instructions over a computer network or internal computer bus to activate the flight control function of the navigation control system 1500 and to prompt other subsystems to become slaves to the flight control function of the navigation control system 1500. The flight control function may monitor sensor input for altitude, orientation (e.g., roll, pitch, yaw) and speed, and may send control instructions to the control surfaces control system 930 and the center of gravity control system 740. The flight control system may store parameters for optimal orientation and speed characteristics of the vehicle 100 and may also contain logic to operate the control surfaces 900 and center of gravity 740 accordingly. Altitude and infrared sensor input may be fed to the navigation executive 470 that may indicate approach to the water surface. As this approach occurs, the navigation executive 470 may issue new instructions to the flight control function of the navigation control system 1500 as to optimal orientation for entering the water, and the flight control function may issue instructions based on stored logic to the control surfaces 930 and center of gravity control 740 systems to achieve the optimal vehicle 100 orientation. Acceleration, temperature, and pressure sensor data may be fed to the navigation control systems 1500 that indicate water entry.

When water entry occurs, the navigation executive 470 may send instructions to the flight control function of the navigation control system 1500 to shutoff and may initiate logic for underwater operation that may determine characteristics to achieve stable orientation of the vehicle 100 underwater. Instructions may be sent to the control surfaces 930, center of gravity 740, and ballast control 640 systems for this purpose. Also, the navigation executive 470 may send an electronic message over the computer network to the mission control system 1505 signifying that the vehicle 100 has entered and is under the water. The mission control system 1505 may store information that indicates the next mission segment and may also contain logic to translate the segment information into environmental mode of operation, speed, orientation, direction and duration. The mission control system 1505 then may send instructions pertaining to navigation characteristics of the next segment back to the navigation executive 470. For example, and without limitation, the next segment may be water surface operation at 15 knots with a specified directional heading.

Also, for example and without limitation, the navigation executive 470 may execute logic for surfacing the vehicle 100 that includes instructions to the control surfaces 930, ballast 640, and center of gravity 740 systems. Depth, pressure, temperature and directional sensor input may be fed to the navigation executive 470 and, as the vehicle 100 surfaces atop the water, the navigation executive 470 may select the propulsion mode and may initiate propulsion according to configuration parameters stored in computer memory. Speed and direction instructions may be issued by the navigation executive 470 to the propulsion control system 400 and control surfaces control system 930. Each of these systems may accept sensor inputs, the propulsion system 400 may control the propulsion mechanisms to the determined speed, and the control surfaces control system 930 may operate the control surfaces 900 to achieve the instructed orientation.

When an unmanned vehicle 100 is autonomously navigating between two points in a transit route, the navigation control system 1500 may generate directives to other on-board control system components to change speed and direction based on detected wave activity. The navigation control system 1500 may analyze the wave activity and autonomously adjust the transit route to achieve best speed, energy efficiency, and/or vehicle safety (e.g., least likely to overturn). Alternatively, or in addition, the on-board control systems (including the navigation control system 1500) may accept instructions from a remote-control station that may notify the unmanned vehicle of weather and/or sea state conditions in order to equip the navigation control system 1500 to select the best mode of vectoring. In one embodiment, the navigation control system 1500 may be put in a “maximum endurance” mode, which may comprise executing algorithms to exploit the most efficient use of the propulsion systems 430 that the vehicle 100 has on board. In a preferred embodiment for endurance, such a configuration may include wind sail propulsion 1400, current propulsion, underwater glide propulsion, and solar recharge 1450. In such a hybrid-propulsion configuration, the time endurance of the unmanned vehicle 100 may be virtually unlimited from a motive power standpoint.

For example, and without limitation, water current external to the vehicle 100 may be determined by the navigation control system 1500 from maps and algorithms, and sensors for wind speed and direction may be activated by the navigation control system 1500 to perform data collection. The navigation control system 1500 may be configured with algorithms to choose the most effective path segments and overall plan for minimum energy consumption. For example, and without limitation, if the vehicle 100 is proximity to an ocean current moving from west to east, and also to a prevailing wind moving in substantially the same direction, the navigation control system 1500 may choose a path to tack up wind generally in a westerly direction, and then ride the current in an easterly direction without aid of wind to maximize the time of the path on current propulsion. Alternatively, or in addition, mission control system 1505 algorithms may determine that underwater glide mode is the most desirable mode with the current for surveillance reasons. In this case, the unmanned vehicle 100 may sail east to west on the surface, and then glide underwater west to east. In this mode of operation, very little energy may be consumed and, with solar recharge 1450, the unmanned vehicle 100 may actually experience a net gain in energy over this path. Employing the systems and mechanisms described above, the navigation control system 1500 may advantageously accomplish autonomous navigation of the unmanned vehicle 100 through various sea states for “fastest, cheapest, safest” patterns, which may include both surface and sub-surface patterns, and that also may include air-drop patterns of entry into an operational environment.

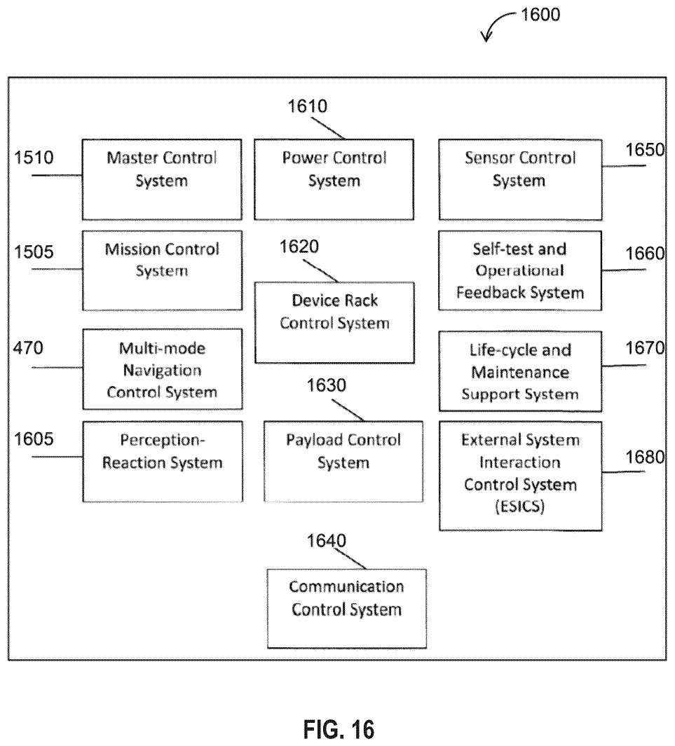

Referring now to FIG. 16, the on-board control system 1600 of the unmanned vehicle 100 according to an embodiment of the present invention will now be discussed. The on-board control system 1600 may comprise an on-board master control subsystem 1510, for example and without limitation, which may exercise local authority over all command, control and communications related to operation of the unmanned vehicle 100. In one embodiment, for example and without limitation, on board control system 1600 may interact with additional subsystems that may include a mission control system 1505, multi-mode navigation control system 470, propulsion and power control system 1610, device rack control system 1620, payload control system 1630, communication control system 1640, sensor control system 1650, as well as a perception-reaction system 1605, self-test and operational feedback control system 1660, life cycle support and maintenance system 1670, and external system interaction control system 1680. The on-board master control system 1510 may enable multi-mode operation, autonomous operation, and remote manual control of the unmanned vehicle 100.

In one embodiment, for example and without limitation, the on-board master control system 1600 of the present invention may be comprised of software programs that may reside on computer storage devices and may be executed on one or more microprocessors also referred to as central processing units (CPU). Inputs to these software control modules may originate as instructions that may be sent from other on-board control systems, as instructions that may be generated from off-board control systems and communicated to on-board systems, and as sensor data input that the control programs may monitor. The output of the software control programs may be digital control signals that may be translated to electronic control signals that may be consumable by motor-controlled actuators that may operate the mechanical components of the unmanned vehicle 100. Software control module outputs also may be connected to a computer network on the unmanned vehicle 100 and all control modules may be connected to a computer network onboard the unmanned vehicle 100.

The unmanned vehicle 100 according to embodiments of the present invention may be configured for rapid integration of various sensors by employing a “plug-in” design approach where interfaces exposed to the systems of the vehicle 100 may be standard and where interfaces exposed to the sensor are variable. The sensor interface may be translated to a standard system 100 interface which may allow the sensor to be “plugged in” to the vehicle's 100 system. This general approach to interfaces may be implemented on several levels and may apply to the following:
(1) Mechanical mounting points;
(2) Signal and Power connections;
(3) Logical interfaces;
(4) Data processing schemes; and
(5) Communication schemes.

Certain embodiments of the present invention may provide one or more of the following advantages:
(a) enablement of rapid swapping of many different payloads in the field;
(b) presentation to payload providers of a readily available integration platform (resulting in shortened development cycles on the order of days and weeks rather than weeks and months).

As described in more detail below, mechanical interfaces, which include signal and power connectors as well as mounting points may be embodied as part of an enclosure that is resistant to the multi-mode environment. A number of embodiments of payload enclosures exist that vary in size, shape and mounting locations within the vehicle 100 that accommodate various sensor interfaces, and which adhere to the standard vehicle 100 interfaces so that they may be “plugged in”. Also, as described below, “payload control” may be integrated with mechanical, signal and power interfaces and may be extended to include communications control and data processing control. Referring to the system block diagram from the original provisional patent, the architecture is the same and supports the “plug-in” model.

As described above, the on-board control system 1600 may further include the payload control system 1630 that, more specifically, may enable control of a wide variation of payloads and may coordinate the payload behavior with the behavior of the vehicle 100. For example, and without limitation, payload components may include sensor arrays, robotic devices, unmanned aerial vehicles (launch and recovery), and energy sources such as solar arrays. In certain embodiments of the present invention, the payload control system 1630 may manage multiple payloads simultaneously. A person of skill in the art may immediately recognize that the design and operation of the payload control system 1630 may be similar to the design and operation of the device rack control system 1620, except that the former 1630 may allow for multiple unknown payloads.

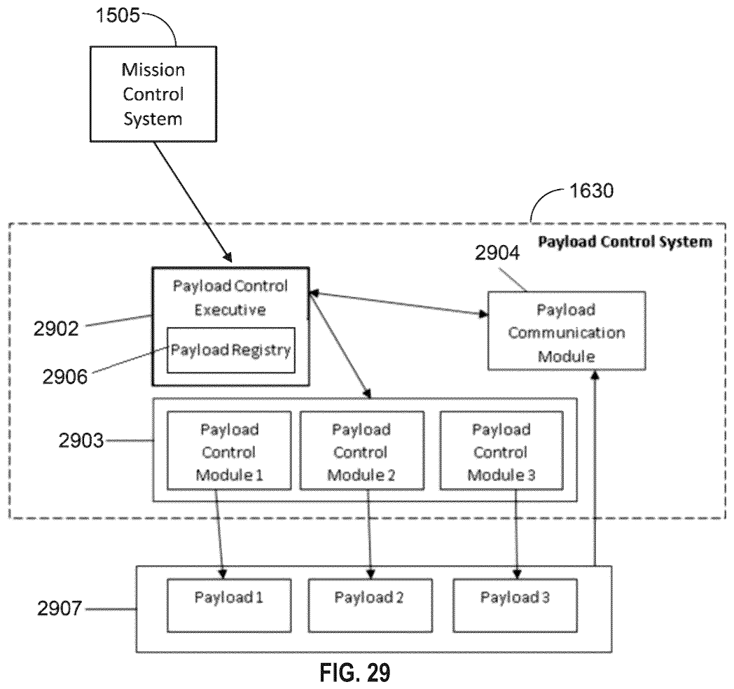

Referring now to FIG. 29, a schematic of an embodiment of the payload control system 1630 will now be discussed in detail. The payload control system 1630 may include a payload control executive 2902, individual payload component control modules 2903, and a payload communication module 2904. The payload control modules 2903 and payload communication module 2904 may be operably connected to individual payloads 2907. Using the payload registry 2906, the payload control executive 2902 may register the payload, the payload devices, the corresponding control modules 2903 and information about how to communicate 2904 to each payload module 2903. The payload control executive 2902 may receive signals from sensors and instructions from system control components as to desired operation of the payload and information requested from the payload. For example, and without limitation, the payload 2907 may include a high-resolution video camera with articulation and zoom capabilities and its own control actuators and signal processing. The mission control system 1505 may issue instructions to the payload control executive 2902 to turn the camera on and point it in a particular orientation and/or with a particular zoom level. The mission control system 1505 may issue instructions as to the routing and processing of the video information collected. The payload control executive 2902 may translate the instructions received from the mission control system 1505 into instructions and signals the video camera control system can use. Additionally, the payload control executive 2902 may route and translate signals from the vehicle sensors to the camera control system. In this case, the camera control system may be provided orientation of the vehicle 100 such that it could actuate the video camera in accordance with the instructions. The video camera data output would be collected and routed in accordance with the mission control system 1505 instructions.

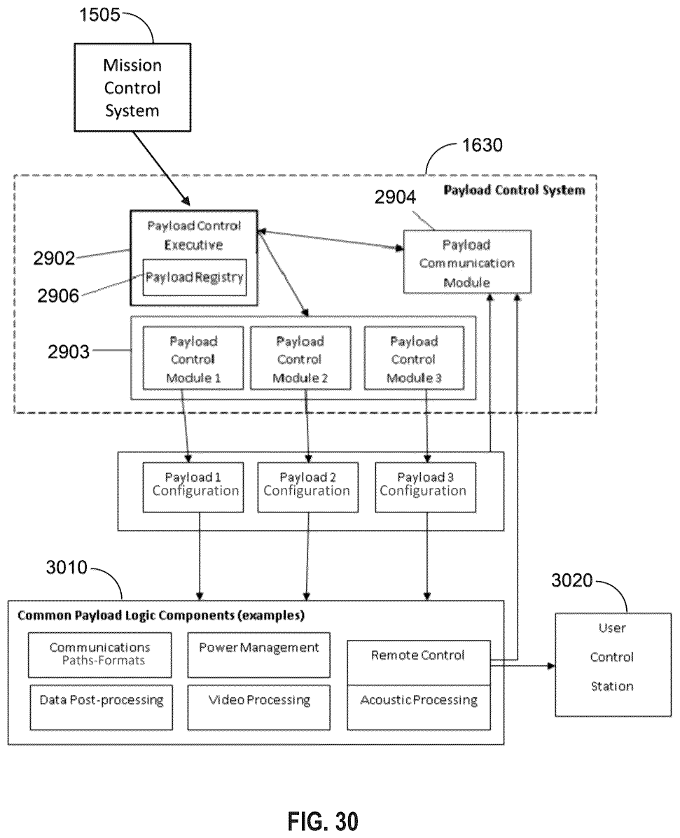

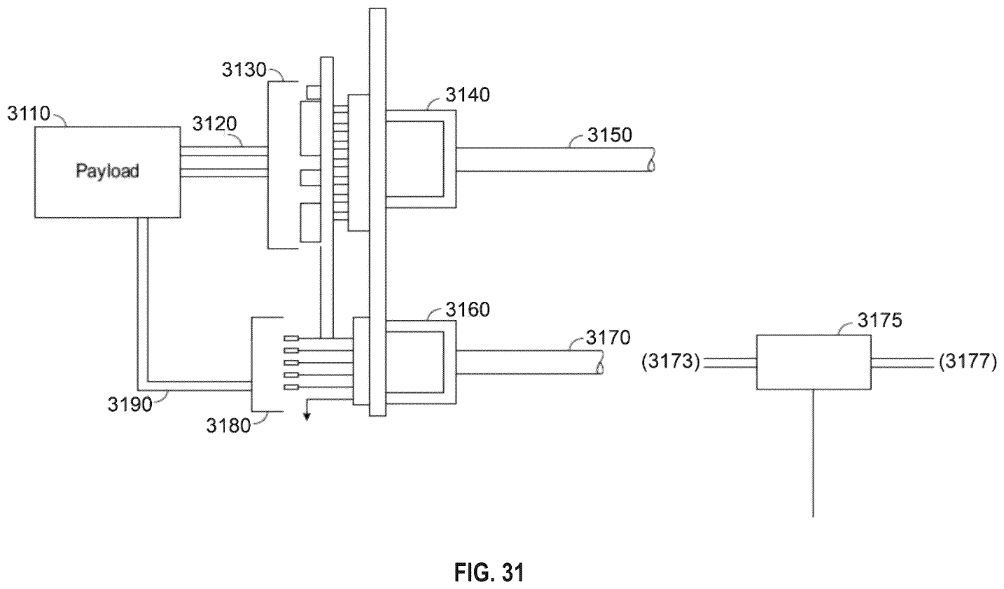

Referring additionally to FIGS. 30, 31, and 32, the following terms are significant to rapid payload integration as advantageously provided by the present invention:

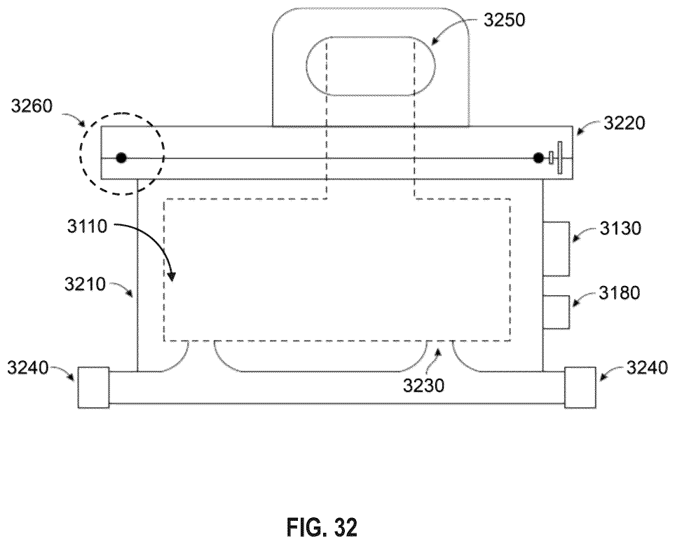

Payload Enclosure: A payload 3110 may be housed in a payload enclosure 3210 with standard connection 3130, 3180 and mechanical characteristics 3230 as described above. While the signal connection 3140, 3150 and power connection 3160, 3170, as well as internal mounting schema may be standard, the actual size, shape and external mounting characteristics 3240 may vary depending on location within the vehicle 100 and physical requirements of the sensor. In addition to providing uniform interfaces, the payload enclosure of FIG. 32 may provide protection from the multi-mode environment, and primarily protection from water incursion. For example, and without limitation, this protection may be accomplished with standard pressure seals 3260 and enclosures 3220 designed for the vehicle 100 environment. The payload enclosure of FIG. 32 may accommodate varying physical characteristics, such as clear viewing apertures 3250 for cameras and below deck mounting for heavy electronics. The following interface descriptions relate to the payload enclosure (FIG. 32) and connections to it.

Signal Interface: A payload 3110 may be housed in an enclosure 3210, 3220 with standard interfaces for power 3180 and signal 3130. Examples of standard signal interfaces connections may include USB, Ethernet, Serial (DB9) and a GIO (General IO) connection interface with standard pin configurations. These standard signal interfaces may be connected to one side of a water resistant, pressure rated bulkhead connector 3140, 3160 on the inside of the enclosure 3210, 3220. On the outside interface, the quick connect style connector 3140, 3160 may be connected to a wiring harness 3150, 3170 with known signal mapping to the internal signal inputs that may be, in turn, connected to the vehicles 100 mission control system 1505 and/or known, identified input locations.

Communications Interface: To accommodate payloads 3110 that require an independent communication channel, there may be internal connections in the enclosure for antennae connections. On the outside interface, environment-proof connectors 3140, 3160 may be connected to a wiring harness 3150, 3170 that may terminate at locations where antennae may be secured to the hull of the vehicle 100.

Power Interface: Inside the enclosure (FIG. 32) may be another set of standard interfaces for power 3180, 3190, which may feature heavier gauge wire for power transmission. Multiple sets of plus and minus paired connections 3180 may be available for various voltages and ground connection. These connectors 3180 may be joined via a bulkhead connector 3160 that may be environmentally resistant and rated for the power to be carried. On the outside interface, the quick connect style connector 3160 may be connected to a wiring harness 3170 that may be on a digitally controlled relay that may turn power off and on as needed to the payload 3110. This digitally controlled relay may be controlled from the payload control system 1630.

Mechanical Mounting: Inside the payload enclosure 3210, 3220 may be a number of standard internally threaded standoffs to which the payload 3110 may be secured. For example, and without limitation, these fasteners may take the form of directly bolting the payload 3110 to the inside of the box or fastening the payload 3110 to an intermediary plate or container that may then be fastened to the standard mounting points 3230.

Logical Control: As an extension to the original plug-in design of the payload control system 1630, advantages compared to the known art include configurable components for handling communication paths, data processing of payload generated data, power management of payload power and remote control of the payload. Remote control of the payload may be autonomous logic or direct operator control. The mechanism for this may be described as follows:

Each payload type may be registered with the payload control system 1630. Part of the registration may include a configuration of the particular payload 3110. This configuration may be read when the payload 3110 is initiated and may include directives as to which components and logic apply to the payload 3110. When a payload is installed on the vehicle 100, it may be registered and configured as “installed”. When the payload control system 1630 initiates its control sequence, it may initiate the installed payloads according to the configured logic set and may report initiation status.

Once initialized, the payload control system 1630 may run continuously and may execute according to logic and according to remote operator control. The mechanisms for remote operator control may involve a user operating a control station 3020 performing a read of the payload registration and configuration from the vehicle 100 and activating user control interfaces according to pre-programmed instructions that are part of the payload configuration. Additional remote control may be achieved when the payload has a direct communication link enabled that bypasses the vehicle 100 logic and may enables access to payload controls natively in its own metaphor.

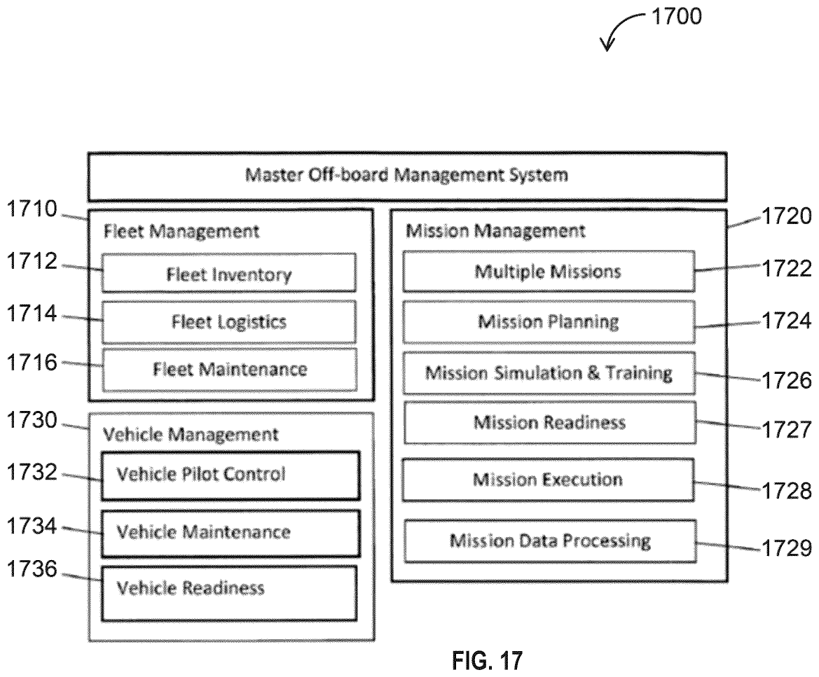

Referring now to FIG. 17, the off-board mission control system 1700 of the unmanned vehicle 100 according to an embodiment of the present invention will now be discussed. The unmanned vehicle 100 of an embodiment of the present invention may, for example and without limitation, operate in full autonomy, partial autonomy or full manual control modes. The on-board mission control system 1600 may accept signals from the off-board mission control system 1700 (also known as the Master Off-board Management System) that may indicate the degree of control and may establish operation control of the unmanned vehicle 100 by enabling or disabling the required mission control logic. The Master Off-Board Management System 1700 may provide registration, navigation, communication, and network integration of the off-board management subsystem modules and may provide a graphical user interface menu and software module navigation system that may provide access to various modules. Sub-systems may be physically separate but may be available over a network of networks, some number of which may be characterized by different protocols and bandwidth characteristics. The Master Off Board Management System 1700 may integrate various other management and control systems.

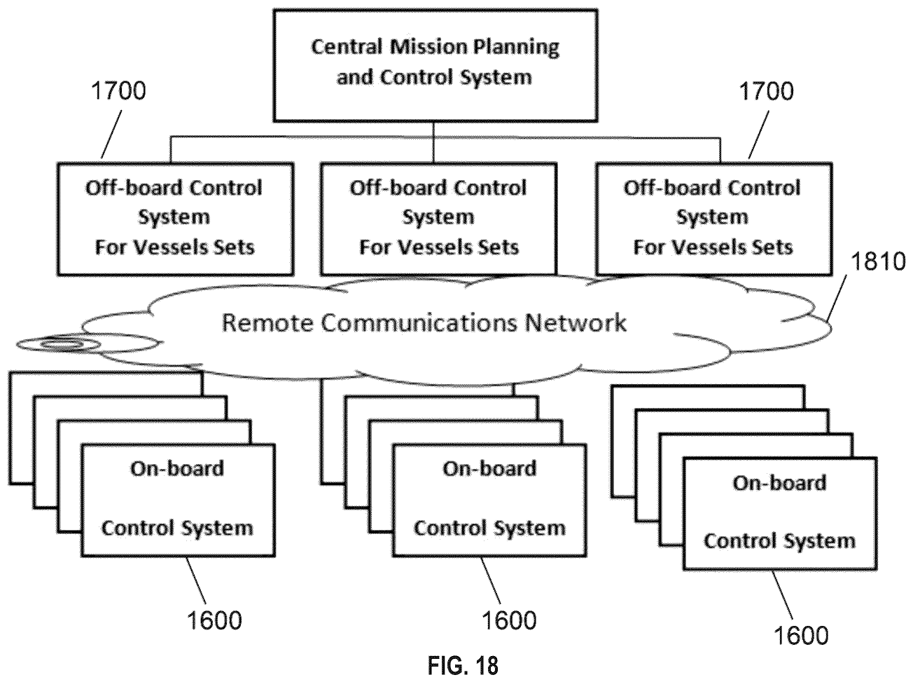

Referring now to FIGS. 17 and 18, a multi-vehicle, multi-mode planning and control system may comprise a central off-board planning and control system, a set of off-board control systems that are networked together with the central control system, a set of unmanned vehicles with on-board vessel control systems, and a networked communication system that connects on-board unmanned vehicle control systems with off-board control systems. For example, and without limitation, FIG. 17 is a schematic overview depicting an embodiment of the functional modules of the off-board mission control system 1700. The major functional modules of the off-board mission control system 1700 may include a Fleet Management Module 1710, a Mission Management module 1720, and a Vehicle Management module 1730. These and other off-board systems may be connected on a common computer network 1810 where all sub-systems may be uniquely identified, and any system may communicate with any other system to send and receive data and digital signals. Off-board control systems 1700 may include software programs and digital storage means that may enable autonomous vehicle control operations, and the off-board systems 1700 also may include human interfaces in the form of “graphical user interfaces” (GUIs) displayed on human readable devices such as flat screen monitors, tablet devices and hand-held computer and cell phone devices.

The present invention may advantageously enable coordinated operations across a large number of unmanned vehicles 100 that may be deployed across the globe. The unmanned vehicles 100 may have a number of embodiments of operational characteristics and may potentially support a large number of payload variations. The Fleet Management System 1710 may include a fleet inventory module for unmanned vehicles 100, payloads, and related utility systems. The inventory system may store information on each unmanned vehicle 100, including vehicle specifications, sub-systems, payloads, sensors, operational status, operational history, current location, and availability. Unmanned vehicle information may be provided to the system 1710 by upload from the unmanned vehicle self-test and operational feedback system, which may be initiated automatically by the unmanned vehicle (as described below). Alternatively, software program, graphical user interface, and input means may be provided by the fleet management system 1710 so that human operators may enter information into the system 1710 manually. Application program interfaces (APIs) or interface services may be provided by means of software modules in the fleet management system 1710 that may allow external computer systems to transmit and receive data without human intervention or, alternatively, with a person simply triggering the data transfer through a user interface but not actually entering the data himself. The software programs that may constitute the Fleet Management system 1710 may be modular and separable from each other, even though these programs may inter-communicate. A subset of the programs that may run logic that interacts with the unmanned vehicle self-test and operational feedback system may be executed separately on devices that may collect unmanned fleet and operational data. These data may then be uploaded to a fleet management system 1710 through a connected network 1810. Such asynchronous upload capability may be advantageous for inventory situations wherein unmanned vehicles 100 may be briefly powered up and interrogated, before losing data communication with a network 1810 that may be shared with the Fleet Management System 1710.

Continuing to refer to FIG. 17, the Fleet Management module 1710 may include a Fleet Inventory module 1712, a Fleet Logistics Management Module 1714, and a Fleet Maintenance Module 1716. The Mission Management module 1720 may include a Multiple Mission Management Module 1722, a Mission Planning module 1724, a Mission Simulation and Training module 1726, a Mission Readiness Module 1727, a Mission Execution Module 1728, and a Mission Data Processing module 1729. The Vehicle Management module 1730 may include a Vehicle Pilot Control Module 1732, a Vehicle Maintenance Module 1734, and a Vehicle Readiness Module 1736. As described above, the Fleet Management modules 1710, the Mission Management modules 1720, and the Vehicle Management modules 1730 may be characterized as software programs executing on digital computers with human readable output devices and human input devices. These modules may be connected on a common computer network 1810 and all modules and subsystems may be uniquely identified by network address and unique names that may be registered in a namespace registry with information as to how to communicate with each module. All subsystems of the off-board control system 1700 may be accessible to all other subsystems and may transmit and receive data among each other in sets or individually. Security measures may be added to control access between systems or to systems by selected users.

For example, and without limitation, the Fleet Management System 1710 may include a Fleet Logistics system 1714 that may track spare parts, orders, shipments, and vehicle process status. The Fleet Management System 1710 further may include a Fleet Maintenance System 1716 that may store maintenance records for each vehicle, self-test history, maintenance plans, maintenance orders, and maintenance status. The Fleet Maintenance System 1710 may further contain a software program module that may compare maintenance activity and status for each vehicle against the maintenance plan for each vehicle. The software program may contain algorithms to determine when maintenance events are needed or warranted for each vehicle; and may provide notification of these events by means of reports that may be retrieved by people, of proactive email alerts, or of notifications on human readable computer interfaces. The Fleet Management System 1710 may provide a software program with data retrieval and reporting algorithms, a GUI, and input means for people to interact with the system and retrieve information about the fleet of unmanned vehicles.

Still referring to FIG. 17, for example and without limitation, the off-board mission control system 1700 may include functions to remotely manage individual unmanned vehicles 100. In one embodiment, real-time tracking 1710 and video feeds may allow remote operators to control specific unmanned vehicles 100 and to monitor the status of each unmanned vehicle 100 while in mission operation 1720. In another embodiment, human interfaces for remote operators of unmanned vehicles 100 in the form of graphical user interfaces (GUIs), for example and without limitation, may be displayed on human readable devices such as flat screen monitors, tablet devices, and handheld computer and smart phone devices. Off board mission control databases and software programs may register, classify, and execute mission logic that may have inputs and outputs communicated to and from specific sets of unmanned vehicles 100 or individual unmanned vehicles 100.

As illustrated in FIG. 18, in one embodiment, the on board 1600 and off board 1700 systems that may collaborate to control one or more unmanned vehicles 100 may be linked through a common communication network protocol 1810, for example and without limitation, internet protocol (IP). The common network protocol 1810 may be a communication layer that may work in combination with multiple transmission means that may include radio frequency (RF) and satellite microwave between on board 1600 and off board 1700 systems, as well as wired means such as Ethernet on wired networks. In a further embodiment, the off-board systems 1700 may have databases and software programs that may operate in concert and on a shared network 1810 that may extend off board remote control of unmanned vehicle 100 sets. In one embodiment, for example and without limitation, a communication network may enable the off-board mission system 1700 to advantageously manage and control many unmanned vehicles 100 within communications range of the shared network 1810. In a further embodiment, on board subsystems 1600 of many unmanned vehicles 100 may exchange data and digital signals and, in series, may relay those data and digital signals to an otherwise out of range off board control system 1700, thereby advantageously extending the range of remote control and communication capability across a fleet of unmanned vehicles 100 which may result in coverage of larger operational areas with more unmanned vehicles 100 and fewer human operators.

For example, and without limitation, off-board control systems 1700, which may comprise databases and software programs, may register, classify, and execute mission logic and may exchange inputs and outputs with specific sets of unmanned vehicles or with individual unmanned vehicles 100. Such data exchange may be supported by a common network 1810 that may uniquely identify entities on the network to each other. On-board control systems 1600 may equip an unmanned vehicle 100 to behave autonomously and report events experienced by the unmanned vehicle 100. Off-board control systems 1700 may direct the operations of sets of unmanned vehicles and may have databases and software programs for storing and executing mission logic. The inputs and outputs exchanged across the network 1810 may enable management and control of many vehicles and missions by the off-board control system 1700, thereby advantageously covering larger maritime areas with more vehicles and fewer human operators. The off-board management and control systems 1700 also may advantageously enable management of maintenance and logistics of fleets of unmanned vehicles throughout multiple missions over the life cycles of many vehicles. The characteristics of the unmanned vehicle described above (e.g., autonomous multimode operation, small size, and the ability to deploy a large number of vehicles over a target area) pose a fleet, mission, and vehicle management challenge. As described above, the capability of the off-board system to integrate and communicate with the respective on-board modules of some number of unmanned vehicles may facilitate advantageous fleet management activities, such as registration, tracking, locating, and records maintenance (as described in more detail below).

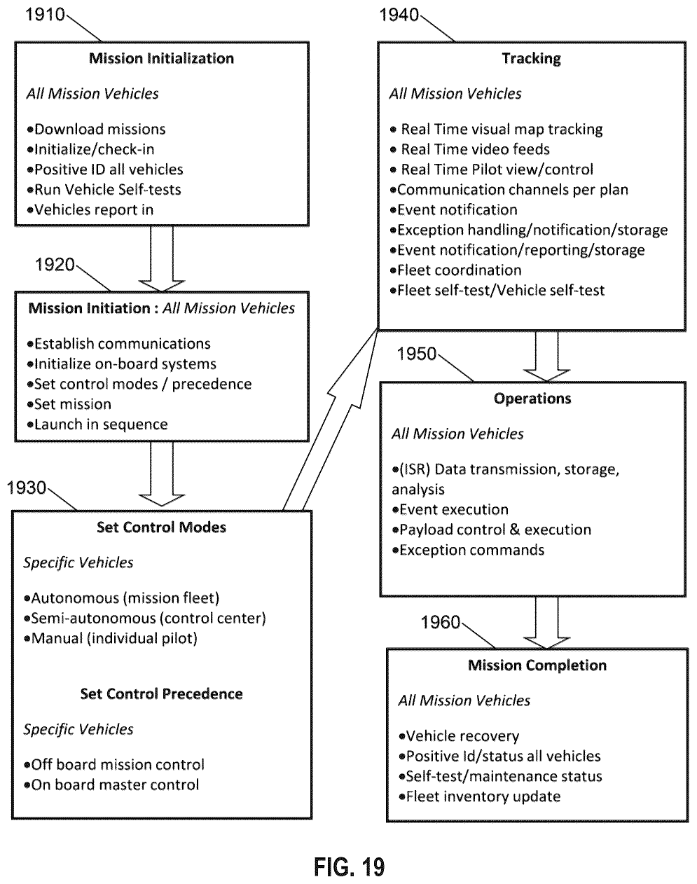

Referring now to FIG. 19, mission execution functionality is now described in more detail. A Mission Initialization module (Block 1910) may allow for an orderly and sequential initialization for all mission vehicles. Initialization may include, but is not limited to, the downloading of both critical and non-critical mission data. This data may be secure and/or partitioned data. Initialization also may include, but is not limited to, performance of a “roll call” of all vehicles. This step may provide for a check in of primary, secondary, and/or tertiary platoons of unmanned vehicles. Each vehicle 100 may respond to a roll call with its positive, unique and, as required, encrypted identification. Communication protocols may provide for redundant and periodic identification updates. Initialization also may include, but is not limited to, all unmanned vehicles 100 performing a basic power up self-test (POST) and the reporting of these results. At this stage, the unmanned vehicles 100 may enter the Mission Initiation state (Block 1920), maybe commanded into a dormant state to await further mission instructions, and/or may be outfitted with unique or mission specific payloads.

At Block 1920, mission Initiation may comprise the orderly and sequential initiation for all mission vehicles 100. For example, and without limitation, initiation may include establishing basic and enhanced communication by and between all unmanned vehicles, as well as establishing any external communications dictated by mission needs. Initiation also may include, but is not limited to, the powering up of all on-board systems 1600 and the performance of detailed diagnostic self-tests by all unmanned vehicles 100 involved in the mission (e.g., self-tests of advanced sensors, power systems, control systems, energy systems, and payload systems). At this stage, the initial control modes may be set, the mission directives may be activated, and the unmanned vehicles 100 may be launched either in sequence or in parallel, the latter being advantageous for mass/time critical mission deployment.

At Block 1930, one or more Mission Execution Control and Tracking modules may allow for the control of each unmanned vehicle 100 as an autonomous unit or units, as a semi-autonomous unit or units assisted from a control center, and/or if the situation or mission requires, as a remotely controlled unit. A remote-control unit/user interface may be implemented, for example, and without limitation, as devices such as Droids, iPhones, iPads, Netbooks, Laptops, Joysticks, and Xbox controllers. The control mode precedence may be set prior to the start of the mission. The control system master default precedence may be autonomous mode. In addition, control provisions may be made in unmanned unit logic that may allow a unit to be completely “off the grid” to perform missions that require a high level of stealth, secrecy, and/or security. More specifically, these units may act as their own master and may be programmed to initiate communications at predefined intervals that may be modified as required. These units also may have the ability to go dormant for extended periods of time, which may further support the ability for unmanned vehicles 100 to perform virtually undetectable mission execution.

At Block, 1940, the Mission Execution Control and Tracking modules also may allow for the real time tracking of all unmanned vehicles 100. This capability may include methods such as satellite tracking, GPS tracking, and transponder-based tracking. Communication channels may be redundant and may utilize various levels of military encryption. Tracking may be performed at the fleet level, yet may also support the ability to zoom in on a specific unmanned vehicle 100. The specific unmanned vehicle tracking data may be overlaid with detailed data such as live video feeds, real time pilot perspective viewing, sensor displays, and other relative data. Analysis of sensor data by on-board control systems may detect “events” of interest. Data characterizing these events may be stored in the unmanned vehicle on-board control system logic and may be reported a message transmitted to the Mission Control System. For example, and without limitation, an event may be defined as a positive identification of a particular target. Periodic vehicle and fleet level self-tests for tracking may occur as background tasks. These self-tests may flag and log exceptions detected, as well as may send a notification to the Mission Control System depending on the class of the exception.

At Block 1950, the Mission Execution Operations module may define how the unmanned units 100 perform operational tasks. During a mission, as a primary function, the unmanned vehicle 100 may monitor its ISR (or similar) sensors, as well as sensor input received from external sources (e.g., other unmanned vehicles in the fleet, Mission Control inputs) on a real time basis. As part of this monitoring process, exception handling may be performed. Computational logic may then be performed that may include analysis, decision making, and the execution of a series of tasks to fulfill mission parameters. Also, during a mission, as a secondary function, the unmanned vehicle may monitor its payload sensors. As in the case of primary monitoring, exception handling, analysis, decision making, and mission task specifically related to payload may be performed.

At Block 1960, the Mission Completion module may be designed to close out the unmanned fleet after a mission, may status all vehicles, may perform any required maintenance of the vehicles, and/or may return them to fleet inventory ready for the next mission. Vehicle recovery may be performed in multiple ways. For example, and without limitation, unmanned vehicles may be driven to a pickup point or recovered on location. The unmanned vehicles 100 may be recovered directly by military personnel, military equipment, by other vehicles in the unmanned fleet and similar recovery methods. The unmanned vehicles 100 may be recovered either above or below water, as well as shore or rivers edge, and similar locations. Before, during, or after recovery operations, the identity of each unmanned vehicle 100 may be checked, demanded self-tests may be performed, and the status may be reported. Any required vehicle maintenance may be performed including checking all internal and external systems. At this point, the unmanned vehicle may be returned to the fleet and the inventory status may be updated.

Tying the mission-level actions more specifically to on board actions in response, upon vehicle initialization (Block 1910), the Control System Master 1510 may issue a startup command across a computer network to prompt the on-board mission control system 1600 to perform self-test and operational feedback, and to send an on-line status back to the Control System Master 1510. At Block 1920, the on-board mission system 1600 then may issue start up commands to all other on-board systems. Each system may start up, perform a self-test, and forward success or failure messages across the network to the Control System Master 1510. The Control System Master 1510 may be configured 1700 to start up in autonomous or manual control mode and also may be configured with a designator of the current mission (Block 1930). If in manual control mode, a ready signal may be sent to the Control System Master 1510 and the on-board systems may await manual commands. If in autonomous control mode, the on-board control system 1600 may be activated with the designator of the current mission and the Control System Master 1510 may hand off primary control to the on-board control system 1600. The Control System Master 1510 may be given back primary control if the on-board control system aborts, is diagnosed as malfunctioning, or is over-ridden by manual control. The on-board control system 1600 may be programmed with mission segments that define navigational, sensor, and payload operating characteristics in a time and logic sequence. At Block 1950, the on-board control system 1600 may issue continually updated instructions to vehicle subsystems as to course and speed (e.g., vector), mode of operation (air, water surface, subsurface), sensor data collection, stealth, payload operation, and interaction with external environments, events and entities. The on-board control system 1600 may receive a continuous stream of data from sensors and may interrogate sensors for more granular data through instructions to the sensor system. The on-board control system 1600 may issue higher level instructions to subsystems that are decomposed by the vehicle control subsystems into more specific instructions. This decomposition of more general instructions to more specific instructions may be a multi-level process that may result in specific signals consumable by vehicle devices and mechanisms. For example, the on-board control system 1600 may issue an instruction to the navigation control system 1500 to navigate in a directional heading, within a speed range having maximum endurance. The navigation control system 1500 may execute logic and may, in turn, issue lower-level instructions over the computer network to the subsystems it controls. The on board control system 1600 may also issue instructions to a power control system 1610 for maximum endurance; a perception-reaction system 1605 as to allowable reaction parameters; the device rack control system 1620 as to device rack orientation; the payload system 1630 as to current operational behavior; the communication control system 1640 as to channels and formats of communication; the sensor control system 1650 as to the environmental sensors to activate and the parameters for each as well as the sensor data to collect; and an external system interaction control system 1680 as to current behavioral attributes. All control subsystems may provide continuous status messages to the on-board control system which may multiplex input status messages and may have logic to translate incoming message and sensor data into instructions back to the subsystems.

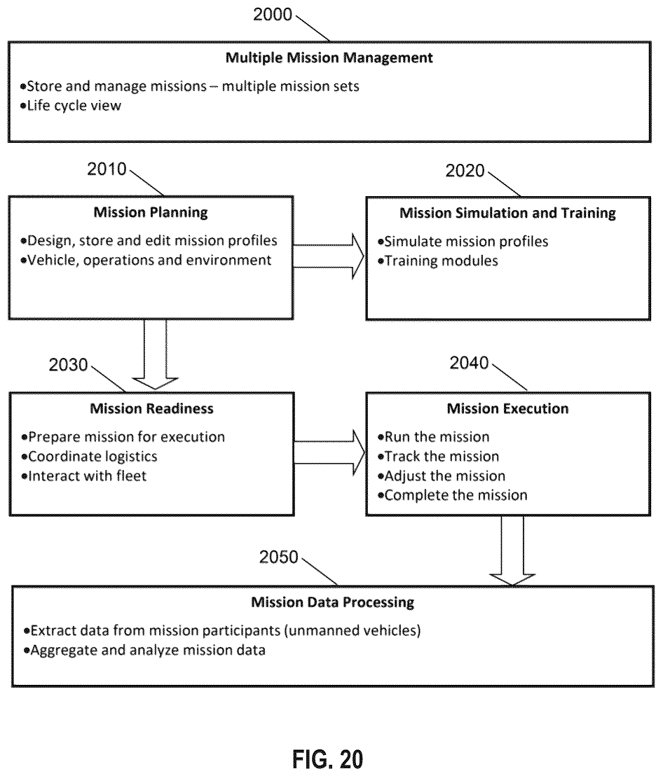

Referring now to FIG. 20, an automated Multiple Mission Management 2000 process may provide a set of sub-systems that may enable a complete, end-to-end capability for planning and executing a number of concurrent missions, which may be advantageous within a large maritime target area wherein a number of missions may be required to successfully cover the area. For example, many coastal areas are made up of a combination of a large open area, a number of zones close to shore with different characteristics, populated harbors, and riverine zones that extend well inland. In such a diverse target area, unmanned vehicles may be air dropped or deployed (man portable) to small surgical inland targets.

The concept of a “mission” may be specific to each unmanned vehicle 100, and/or may be aggregated across sets of unmanned vehicles. The Multiple Mission System may enable the management of multiple missions throughout the entire mission life cycle. When missions are initiated, they may be recorded by the Multiple Mission System and then throughout each mission life cycle may be tracked, updated, and executed. The Multiple Mission System also may manage concurrently executing missions and may provide a security capability to allow access to only authorized users. Employing the systems and methods described above, the present invention may enable the use of many unmanned vehicles 100 to cover large maritime areas with minimal operators at a fraction of the cost compared to conventional approaches to cover the same area.

Continuing to refer to FIG. 20, a Mission Planning module 2010 may support modeling of trial missions that employ unmanned vehicle capabilities. More specifically, the Mission Planning module 2010 may allow for constructing coverage grids, time-on station duty cycles, communication parameters, perception-reaction attributes, rules of engagement, rules of notification, exception handling rules, and payload operation. The Mission Planning module 2010 also may allow overlaying the vehicle 100 paths on an accurate digital map of the target coverage area and also may include underwater mapping. For example, and without limitation, the modeling capability described above may be used to simulate missions of fleets of unmanned vehicles 100. Such simulation may be advantageous for purposes of training and/or for planning and strategy.

For example, and without limitation, a Mission Simulation and Training module 2020 may enable mission plans to be “run virtually” with various scenarios including variations in weather, sea state, and external system encounters. Operators may interject simulated manual control of unmanned vehicles. The Mission Simulation and Training module 2020 may provide a valuable estimate as to the likely success of the planned mission under various scenarios.

Also, for example, and without limitation, a Mission Readiness module 2030 may enable planned missions to become ready for execution. When a planned mission is put in “prepare” mode, the mission preparation module may interact with the Fleet Management systems 1710 to determine logistics activities and may enable the user of the system to assemble a mission fleet of unmanned vehicles 100. Mission Preparation functionality may provide tracking and reporting functions to allow the user to know the state of mission readiness.

Also, for example, and without limitation, a Mission Execution System 2040 may provide the functions necessary to begin and complete a successful mission of a fleet of unmanned vehicles 100. FIG. 19 illustrates a high-level flow diagram of exemplary functions provided by the Mission Execution System modules.

Also, for example, and without limitation, a Mission Data Processing System 2050 may receive and record mission data transmitted from the unmanned vehicles 100. A majority of missions may be presumed to relate to data gathering for intelligence, surveillance and reconnaissance (ISR) purposes. The Mission Data Processing system 2050 may collect and process large amounts of data and may extract the most useful information out of the data in near real time. The Mission Data Processing system 2050 may perform complex data pattern processing in addition to raw storage and reporting.

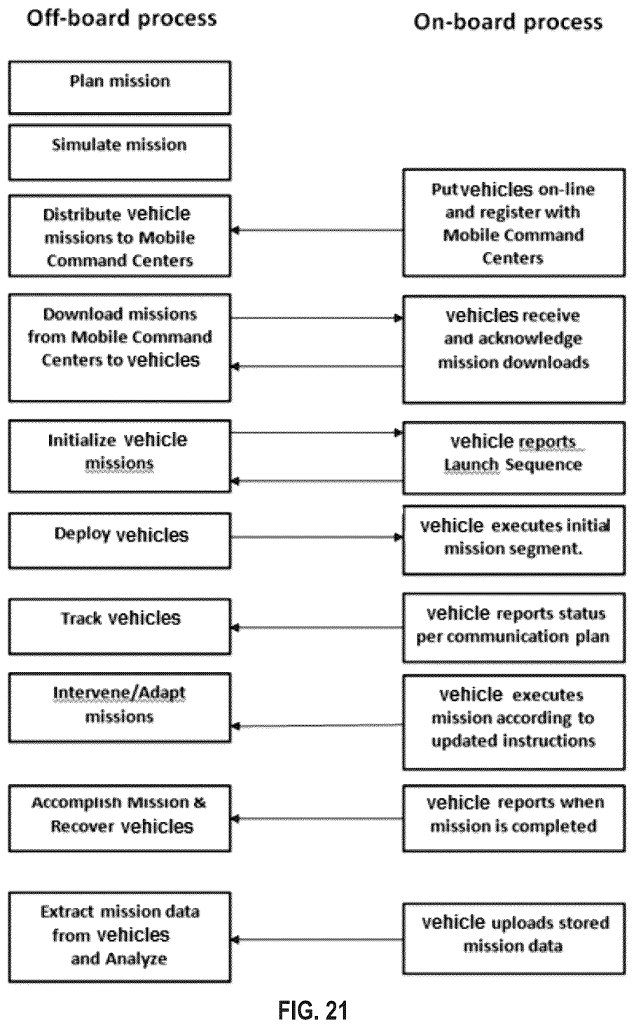

FIG. 21 illustrates an embodiment of integrating various off-board management and control processes with on board control processes of a set of unmanned vehicles 100. For example, and without limitation, a mission may be planned, and simulations of a mission may be run in a data center in the United States, subsequently the mission may be made available to a mission control center in East Africa. The mission control center may check for fleet availability to populate the mission and may transmit a request through secure communication channels for unmanned vehicles. A vehicle repository that may be, for example, and without limitation, controlled by military personnel or military subcontractors in Europe, may process the request. Unmanned vehicles in Europe may be run through maintenance diagnostics to validate readiness, then may be loaded on transport aircraft equipped with unmanned remote launch apparatus. The loaded unmanned vehicles may be flown to a target area off the coast of East Africa and may be air dropped over a pre-planned pattern in accordance with the mission planned in the United States. Mission execution responsibility may be transferred to a mission control center in the Middle East, again through secure communication channels. After the mission is concluded, fleet management may be transferred back to a control center in Europe and the unmanned vehicles may be retrieved by or driven to designated destinations (either mobile or static). Upon successful retrieval, the unmanned vehicles involved in the complete mission may be returned to the vehicle repository.

Swarming may be defined as a deliberately structured, coordinated, and strategic way to strike from all directions, by means of a sustainable pulsing of force and/or fire, close-in as well as from stand-off positions. Swarming involves the use of a decentralized force in a manner that emphasizes mobility, communication, unit autonomy, and coordination/synchronization. In the context of unmanned vehicles, “swarming” relates to coordinating a collection of vehicles such the vehicles' movements are orchestrated in relation to each other.

In one embodiment of mission planning and control, multi-mode swarm control advantageously solves the problem of having a number of unmanned vehicles each moving in its own pre-determined path in a coordinated spatial and time pattern where the unmanned vehicles are in close proximity. Unmanned vehicle swarms may locate a collection of unmanned vehicles in a target zone at desired times and locations. The unmanned vehicles may proceed at a collection of coordinated paths and speeds. Paths may be defined by geo-coordinates (e.g., latitude and longitude) and depth (e.g., altitude), so that paths may be said to be “three dimensional”. Additionally, a swarm may include a number of unmanned vehicles deployed by air drop following a pre-determined glide path. Unmanned vehicle multi-mode swarm technology may include coordinated on-board and off-board control. By contrast, conventional swarm control involves swarming in one “mode”, meaning vessels operate in one of three modes (e.g., air, surface, sub-surface) rather than in two or three modes. As described herein, multi-mode control guides unmanned vehicles in three modes. A single unmanned vehicle may traverse multiple modes executing a transit route.

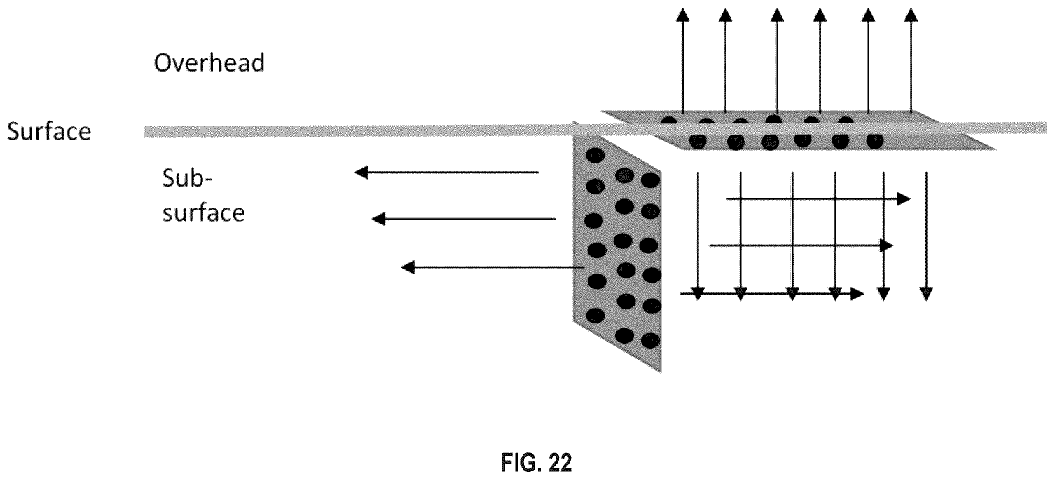

As described above, a military mission may have a specific objective in a specific area and may be time-bound. Multi-mode swarm, as described herein, may be accomplished at the mission level. As illustrated in FIG. 22, three-dimensional (3D) deployment may be considered a special category of multi-mode swarm control driven by the mission planning. 3D Deployment missions may be accomplished on a global scale, although the mission “target zone” may be in a concentrated and designated area. Swarms, in such a scenario, may be comprised of one or more groupings, and such groupings may be hierarchically organized (e.g., analogous to military units: team, platoon, squadron). A mission plan, in this same scenario, may be thought of as a set of mission maps.

For example, and without limitation, a 3D Deployment may comprise an airdrop of a squad (10) of unmanned vehicles, deployment of a platoon (40) of unmanned vehicles off of a ship, and deployment of a team (4) of unmanned vehicles out of a submarine. For example, and without limitation, each of the unmanned vehicles may be equipped with a collision avoidance system (CAS) which may provide awareness of proximate vehicles and/or objects.

In one embodiment of a basic swarm method, each unmanned vehicle may be loaded with a mission track (e.g., one or more transit paths) with location, speed, time, and path tolerance. Missions may be coordinated such that involved unmanned vehicles' paths do not collide. In the example embodiment, each group may proceed from the “drop zone” on a transit path specified by the off-board control system. At a specified time, each group may proceed to its own specified location, at which point the swarm may be considered to have achieved platoon size. Each grouping may be deployed to a location that may be a specified distance from a target. Upon a specified schedule, all mission assets (e.g., unmanned vehicles) may move toward the mission target zone, each executing planned movements in support of the mission and, as appropriate, executing autonomous movements in response to unplanned stimuli but no so as to jeopardize the mission. For example, and without limitation, planned movements may call for the air dropped squad to split off into two teams, for the platoon to split into four squads, and for the team to stay intact. In such a manner, all vessels and groups in the swarm may be coordinated over time, 3D location, and transit path.

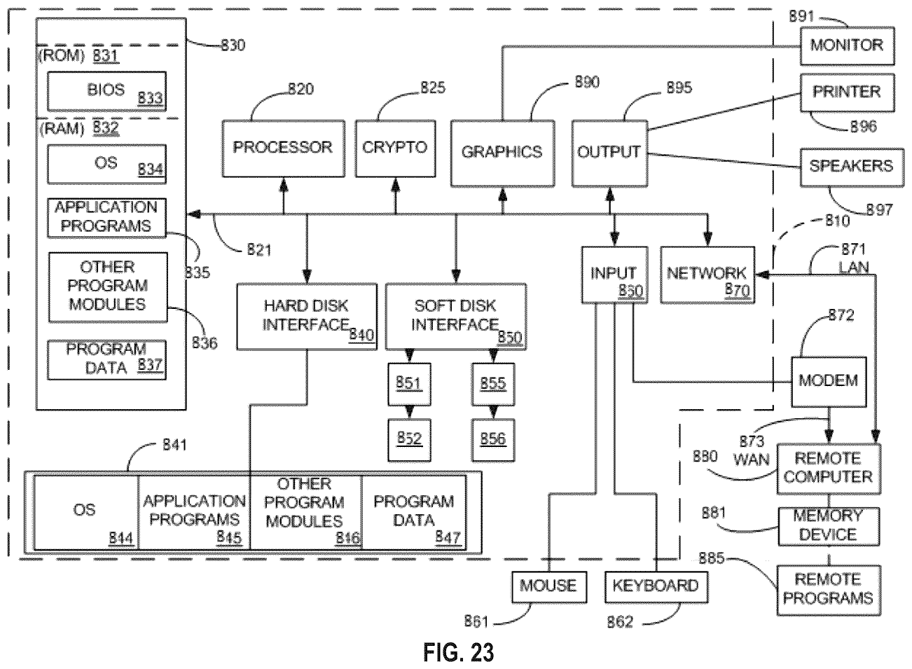

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 23 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 23 illustrates an operating system (OS) 834, application programs 835, other program modules 836, and program data 837.

The computer 810 may also include other removable/non-removable, volatile/nonvolatile computer storage media. By way of example only, FIG. 23 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 23, provide storage of computer readable instructions, data structures, program modules and other data for the computer 810. In FIG. 23, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 23. The logical connections depicted in FIG. 23 include a local area network (LAN) 871 and a wide area network (WAN) 873, but may also include other networks 140. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 23 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media. Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

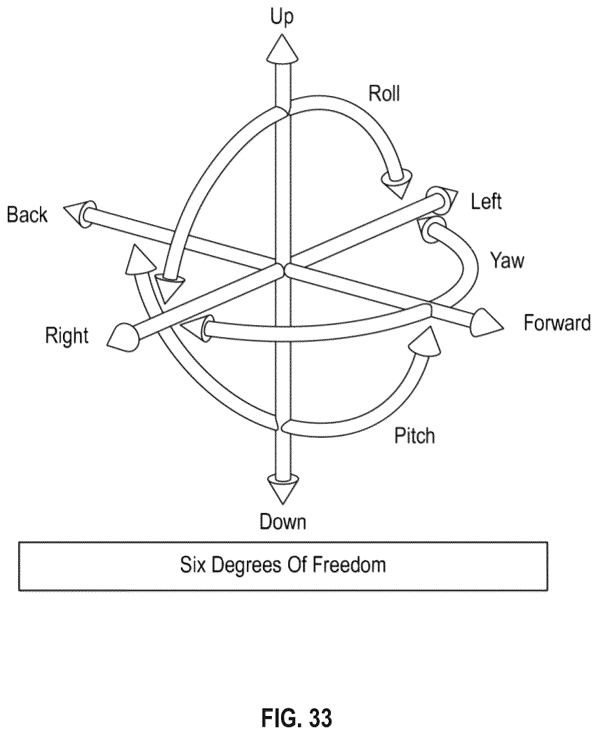

With additional reference to FIGS. 33-41, another embodiment of an unmanned vessel will be described. The unmanned vehicle according to this embodiment is configured for semi-submersible launch and recovery of payload objects. Of course, such embodiment may include any of the features described above with respect to other embodiments. As will be described in further detail below, the present embodiments include a well-deck built into a hull (e.g., a catamaran-like hull) and include the ability to flood the stern of the host vessel, the ability to control buoyancy through a buoyancy control system, and/or the ability to control water depth in the well deck and pitch of the well deck by controlling the center of buoyancy. The ability to position the host vessel in an advantageous position and orientation, may also be provided so the payload can most effectively be launched and recovered. Positioning is relative to the payload and environment which may be particularly important in higher sea states.

It should be noted that the present embodiment preferably provides the ability of the host vessel to navigate autonomously with high performance characteristics when not flooded, the ability of the host vessel to maintain headway and navigate while the well deck is flooded, and/or the ability of the host vessel to sense location and position of launched and recovered payload objects as they move away or toward the well deck.

For this description the payload objects are unmanned vessels, such as unmanned surface vessels (“USV”), unmanned underwater vessels (“UUV”) or remote operated vehicles (“ROV”) that can be free-launched or launched using a winched tethered tow, for example.

Initially, referring to FIG. 33, a diagram is shown that illustrates the six degrees of freedom related to the operation of an unmanned vehicle according to embodiments of the present invention. A position of the well deck is preferably controlled within six degrees of freedom including roll, pitch, yaw, up/down, forward/reverse and right/left.

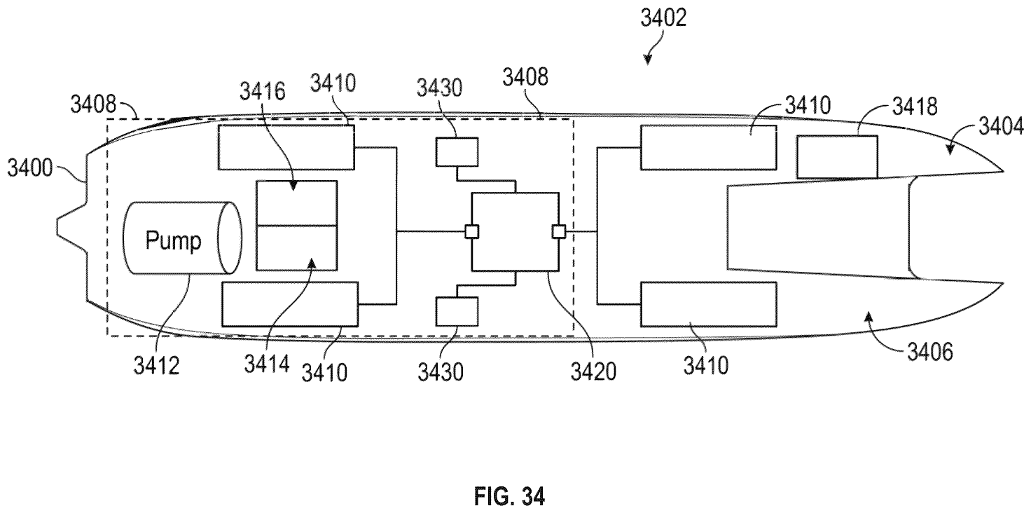

FIG. 34 is a schematic diagram illustrating the layout of a buoyancy control system 3402 for an unmanned vehicle 3400 according to an embodiment of the present invention. In this embodiment, the example of an unmanned vehicle 3400 includes many features described above but is not limited thereto. Other combinations of features described herein are contemplated as would be appreciated by those skilled in the art. Here, the vehicle body may include a pair of substantially parallel sponsons 3404, 3406 coupled together on opposite sides of a recessed well deck 3408 in a stern portion of the vehicle body. The recessed well deck 3408 is configured to stow a payload as will be described below.

Although not shown here, a propulsion system is configured to propel the unmanned vehicle 3400, a maneuvering system is configured to maneuver the unmanned vehicle, and a vehicle control system is configured to control a speed, an orientation, and a direction of travel of the unmanned vehicle in combination with the propulsion system and the maneuvering system. Various embodiments of such systems are described above with reference to FIGS. 4-15 and are not described again here. A sensor system includes a plurality of environmental sensors configured to sense environmental and operational characteristics for the unmanned vehicle, and at least one power supply is configured to provide power to the propulsion system, the maneuvering system, the vehicle control system, the buoyancy control system, and the sensor system, as also described above with respect to other embodiments.

As described above with reference to FIG. 6, the ballast system may contain mechanisms to control the volume of water and air in one or more ballast chambers to advantageously vary the buoyancy of the unmanned vehicle while submerged and to support selective submerging and re-surfacing of the unmanned vehicle. The ballast system may also be known as the buoyancy system because the system may provide for the selective submerging and re-surfacing of the unmanned vehicle by varying buoyancy. The ballast control mechanism may include piping and ports to enable the flow of water into and out of ballast chambers. Electric water pumps may be activated by the ballast control system to control ballast levels which may be monitored by ballast sensors.

For the buoyancy control system 3402, ballast containers 3410 are positioned within portions of the vehicle body. A pump 3412 and valves 3414, 3416 define a pump and valve system that is configured to vary amounts of water and air in the recessed well deck 3408. Various other pumps and valves, described above with reference to FIG. 6, may be included to vary the amount of water and/or air in the ballast containers 3410. The ballast containers 3410 preferably include at least a ballast container located forward and aft in each of the sponsons 3404, 3406 to define four quadrants of buoyancy for the unmanned vehicle 3400. More than four ballast containers 3410 is also contemplated. The buoyancy control system 3402 may include a buoyancy controller 3420 that is configured to individually control the relative buoyancy in each of the four quadrants and the total buoyancy of the unmanned vehicle 3400. Various sensors, including imaging sensors 3430, may also be provided and will be described in more detail below.

Water is filled in the recessed well deck 3408 via a combination of the water pump 3412 and actuated valves 3414, 3416 that allow water into and out of the hull. An air valve 3418 may be used to control air flow in and out of the recessed well deck 3408 of the hull. The pump 3412 may also pump water out. The recessed well deck 3408 can accept water in the hull without damaging internal components as it is designed to be flooded through the use of various seals and channels, not shown, as would be appreciated by those skilled in the art. The combination of total water in the well deck 3408 and the four-quadrant buoyancy control enables control of at least three of the six degrees of freedom: pitch, roll and up/down.

The vehicle control system or navigation control system 1500, as the on-board governor of the speed, direction, and orientation, will control the other three of the six degrees of freedom: yaw, forward/reverse and right/left.

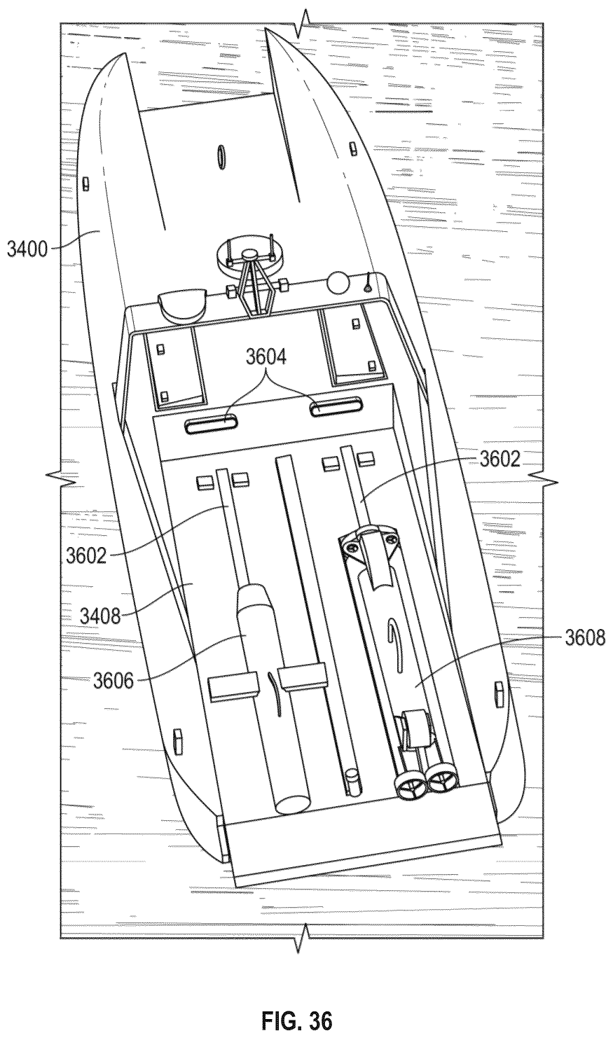

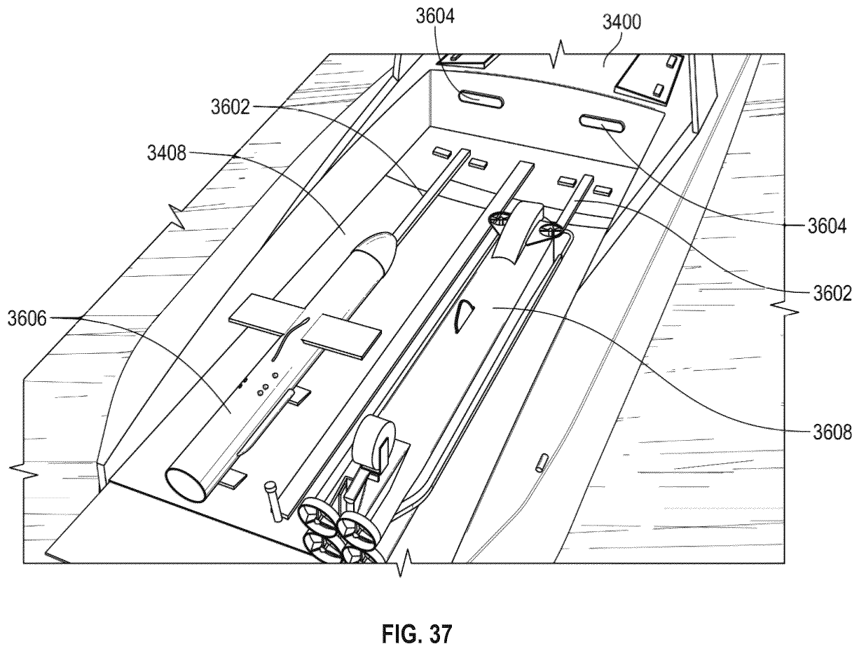

Referring additionally to FIGS. 36 and 37, the recessed well deck 3408 includes a payload securing system that may include supports 3602 or cradles or similar structures into which the payload objects 3606, 3608 (e.g., USV/UUV/ROVs) sit for stability during transit. FIG. 36 is a top view illustrating a semi-submersible launch and recovery unmanned vehicle according to an embodiment of the present invention. FIG. 37 is a perspective rear view illustrating the semi-submersible launch and recovery unmanned vehicle of FIG. 36 on the surface of the water.

The supports 3602 and may have an automated apparatus 3604 to secure the payload objects. For example, for winched tethered tow, the automated apparatus 3604 may include tether lines 3605 that connect to an autonomously controlled reel at a fixed end, and attach to the payload objects 3606, 3608 at a free end. The tether lines may be multi-purpose to both convey data and power between the USV/UUV/ROVs and the UMMV, as well as mechanically tow the USV/UUV/ROVs.

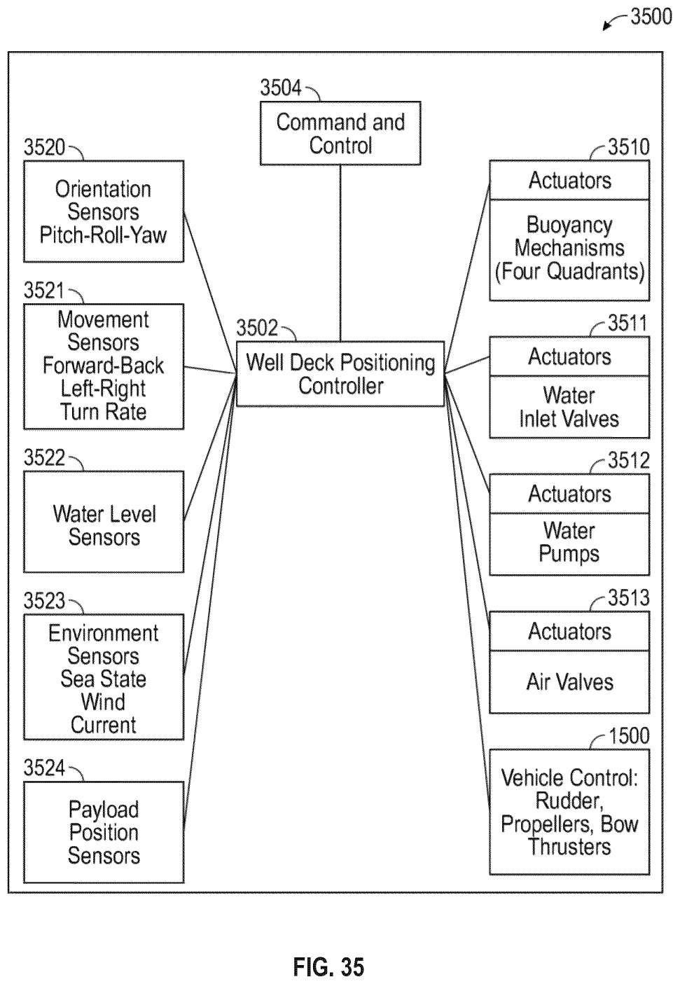

The vehicle control system 1500, the buoyancy control system 3402 and the sensor system 1650 define a well deck positioning control system 3500 (FIG. 35) configured to launch and recover objects 3606, 3608 of the payload to/from the water while the well deck 3408 is at least partially submerged in water. FIG. 35 is a schematic block diagram illustrating components defining the well deck position control system 3500 for an unmanned vehicle 3400 according to an embodiment of the present invention. The well deck positioning system 3500 may include a well deck positioning controller 3502 configured to provide output signals to actuators 3510-3513 of the buoyancy control system 3402 and to the vehicle control system 1500 in response to input signals from sensors 3520-3524 of the sensor system. Thus, the well deck positioning control system 3500 is a feedback control system taking instructions from the command-and-control block 3504 as set points, using sensor inputs to determine feedback signals and provide output signals to actuators.

The command-and-control block 3504, which may be under operator direction, or receive autonomous instructions as described above, sends positioning instructions to the well deck positioning controller 3502. Such instructions may include well deck pitch, well deck depth, well deck heading, well deck turn rate or well deck pitch rate, for example. The well deck positioning controller 3502 sends position information back to the command-and-control block 3504. The sensors may include orientation 3520, movement 3521, water level 3522, environment 3523 and payload position 3524. These sensors 3520-3524 provide feedback to the well deck position controller 3502. The actuators 3510-3513 control flooding of the well deck 3408 and ballast containers 3410 via the four buoyancy mechanisms, water inlet valves, water pumps, air valves and vehicle movement.

An embodiment at least includes the plurality of environmental sensors 3430 including, for example, water level sensors 3522 configured to sense water levels in the ballast containers 3410 and the recessed well deck 3408, and payload position sensors 3524 configured to sense the position of the payload relative to the payload securing system 3602/3604 and the recessed well deck 3408.

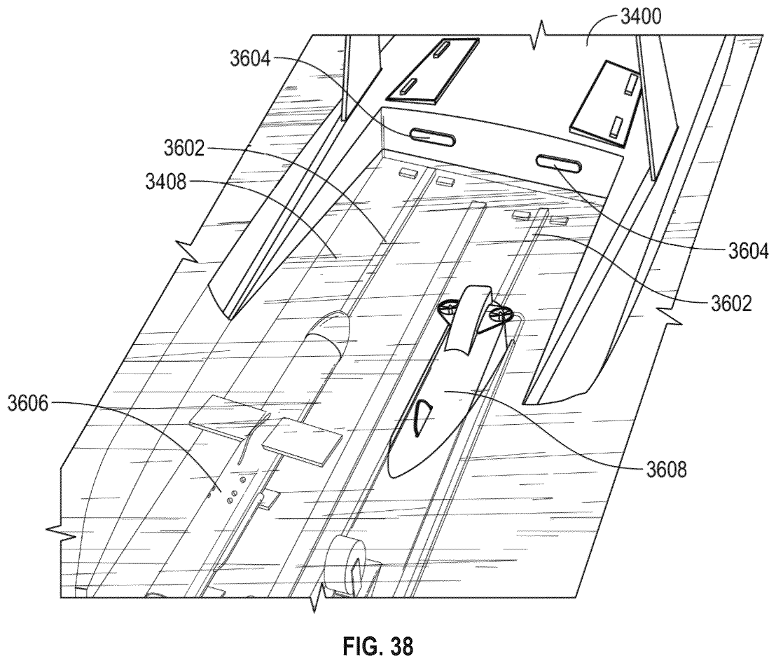

The launch process begins when the UMMV 3400 initiates a launch sequence request from a remote operator or from internal logic executing autonomous mission logic running on resident control systems as described above. The entire sequence of launch and recovery may be under control of the on-board control systems on the UMMV 3400. The UMMV 3400 floods the recessed well deck 3402, e.g., in the stern section of the vessel to the mid-ship, by opening flood valves and activating flooding pumps if faster flooding is desired. FIG. 38 is a perspective rear view illustrating the semi-submersible launch and recovery unmanned vehicle 3400 of FIG. 36 partially submerged below the surface of the water.

Water level monitoring sensors 3522 in the well deck 3408 provide feedback to the controller 3502 which also monitors pitch and roll 3520. Additionally, the buoyancy control system 3402 controls the amount and location of flotation. The buoyancy control system 3402 controls the depth of water in the well deck 3408 and the pitch of the well deck by controlling the amount of flooding and center of buoyancy while monitoring water level and pitch sensors.

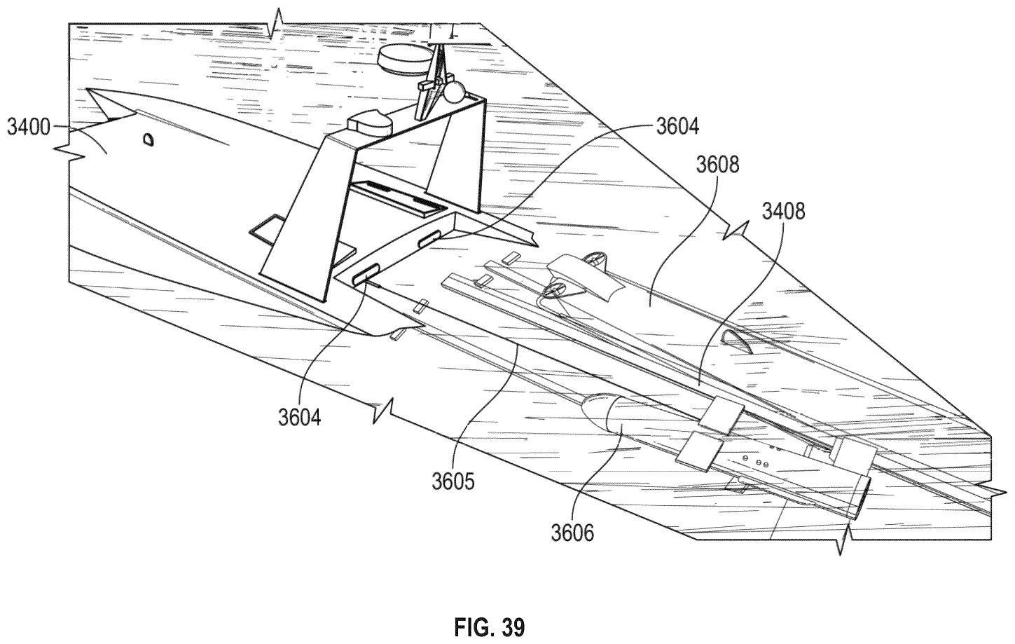

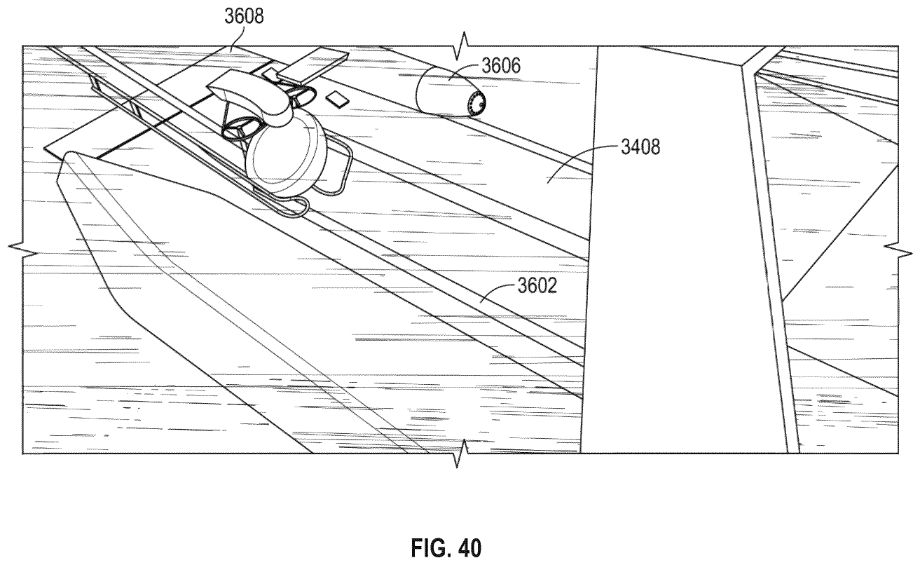

When the water in the well deck 3408 is at the desired depth and the pitch of the well deck is at the desired angle, the actual launch of the payload objects 3606, 3608 (e.g., either USV, UUV or ROV) is initiated. In this phase, the support 3602 or cradle releases the payload object(s) 3606, 3608 or the object simply floats away from its cradle. The object 3606, 3609 may or may not be tethered 3605 and may drive away from the UMMV 3400 to perform its mission. FIG. 39 is a perspective rear view illustrating the semi-submersible launch and recovery unmanned vehicle 3400 of FIG. 36 during launch and recovery of the payload object 3606, 3608. FIG. 40 is a more detailed rear view illustrating the semi-submersible launch and recovery unmanned vehicle 3400 of FIG. 36 during launch and recovery of the payload objects 3606, 3608.

It should be appreciated that the UMMV 3400 may drive away from the payload object(s) 3606, 3608, or the objects may drive away from the UMMV. Once the UMMV 3400 achieves separation from the object(s) 3606, 3608, the UMMV may stay partially submerged and navigate in that orientation, may evacuate the flooded water and continue to drive as a surface vessel, or remain floating stationary in its partially submerged orientation, for example.

Orientation sensors 3520 may include positional sensors to provide pitch-roll-yaw and depth position of the UMMV 3400. Also, sensors 3524 detect location and orientation of payload objects 3606, 3608 to provide feedback to the command-and-control block 3504 and/or positioning and payload securing systems. The payload position sensors 3524 may include imaging sensors, e.g., electro-optical or infrared (EO/IR), that are oriented toward payload objects 3606, 3608 and a remote streaming system (i.e., control and communications of imaging) may be part of the command-and-control block 3504 or the vehicle control system 1500 to provide feedback to remote human operators. Thus, the well deck positioning control system 3500, in connection with the vehicle control system, has the capability to dynamically position the UMMV 3400 relative to payload objects 3606, 3608 and may include communication (wired or wireless) between such objects and the UMMV.

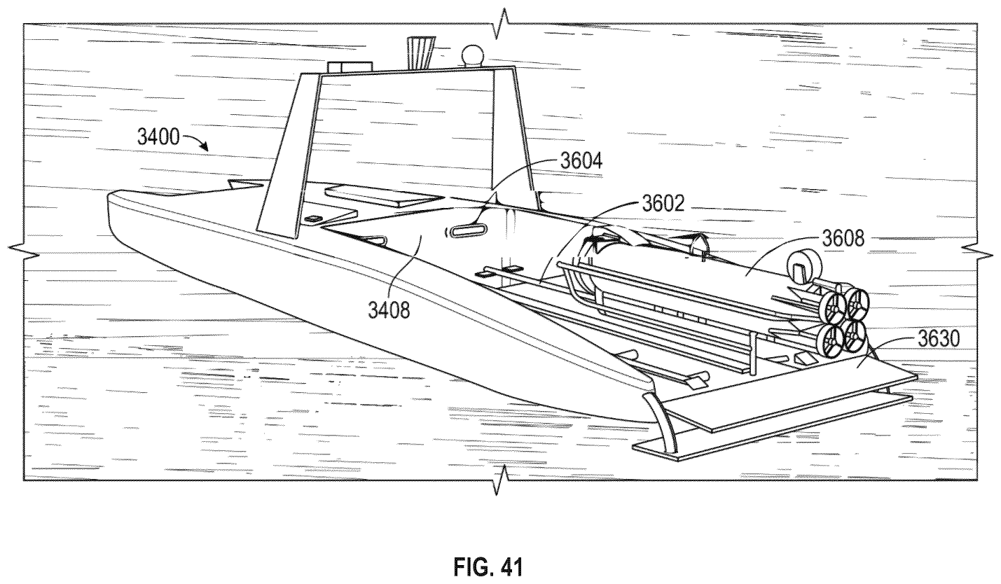

In recovery mode, the UMMV 3400 will return to its semi-submersible condition. The payload object(s) 3606, 3608 will either drive back over the well deck 3408 for capture or may be captured aft of the UMMV 3400 and then towed back into the well deck. Once the object(s) 3606, 3608 is/are in position and secured or captured in the well deck 3408, the UMMV 3400 evacuates the flooded water by pumping it out and returns to its surface operation. Sensors 3522, 3520 monitor the water level and pitch during the transition from semi-submersible to surface condition. FIG. 41 is a perspective rear view illustrating the semi-submersible launch and recovery unmanned vehicle 3400 of FIG. 36 on the surface of the water after recovery of a payload object 3608 and back on the surface of the water. As illustrated, as part of the payload securing system, a tailgate 3630 is configured to pivot between a down (or launch/recovery) position and an up (or closed/transport) position.

Once the flooded water is pumped out of the well deck 3408 and/or the ballast containers 3410, the UMMV 3400 may navigate normally and perform high speed maneuvers as desired.

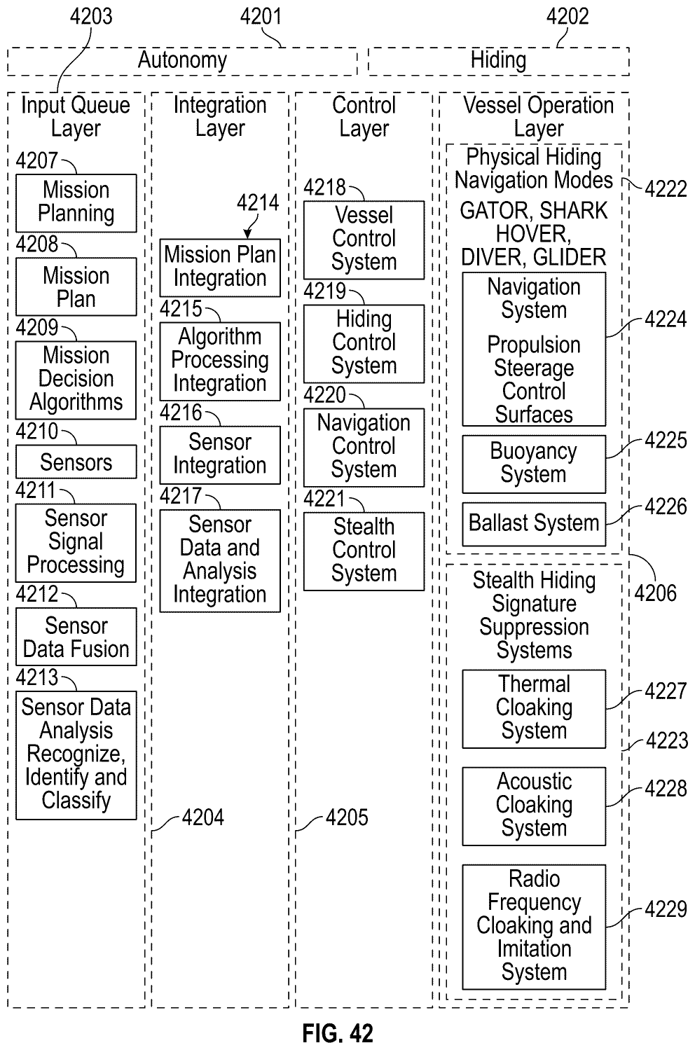

With additional reference to FIGS. 42-51, another embodiment of an unmanned vessel will be described. The unmanned vehicle according to this embodiment is configured for autonomous hiding. Of course, such embodiment may include any of the features described above with respect to other embodiments. As will be described in further detail below, the present embodiments include an autonomous hiding control system and an autonomous stealth mode executive control. The hiding control system works with the navigation mode executive control to physically position the unmanned vehicle so that it cannot be detected by an item of interest. The stealth mode executive control may provide control to a stealth control system, a thermal cloaking system, an acoustic cloaking system, a radio frequency cloaking system, or a radio frequency imitation system, which operate to prevent detection of the unmanned vehicle by an item of interest.

It should be noted that the present embodiment preferably provides the ability of the host vessel to navigate autonomously while preventing or limiting the risk of detection or harm to the vessel.

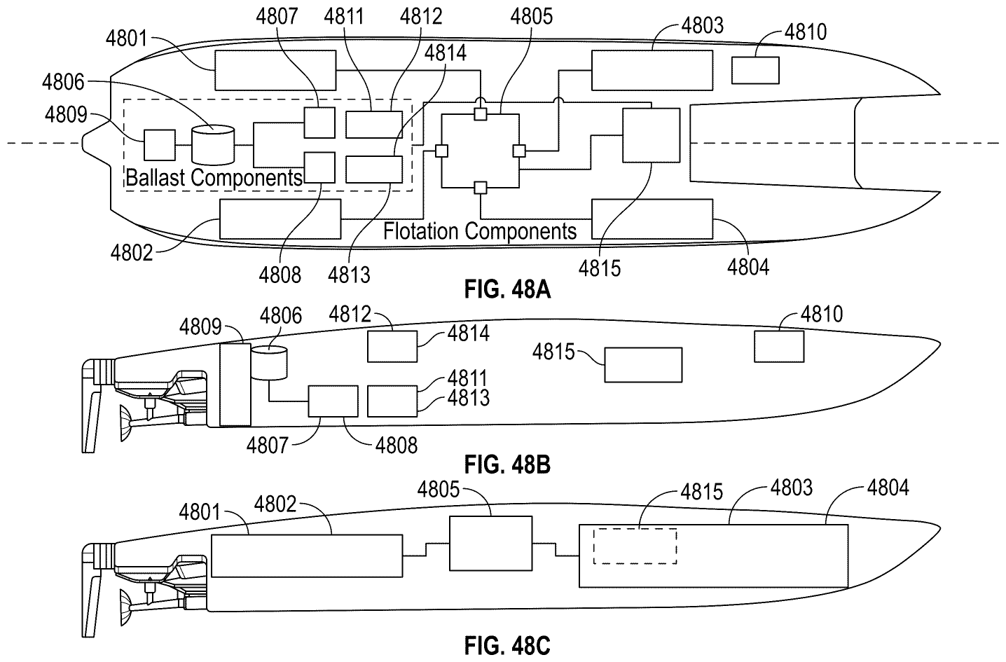

Initially, FIGS. 42-47 primarily depict processing characteristics of elements of the invention while FIGS. 48-51 primarily depict physical characteristics of elements of the invention.

Now referring to FIG. 42, a block diagram of an autonomous hiding system is shown. The autonomy hiding system is comprised of layers of related functionality. Layers providing autonomy 4201 are depicted on the left of FIG. 42, with layers providing hiding 4202 depicted on the right. There is some overlap between autonomy and hiding in the control layer 4205. The layers below the top-level autonomy and hiding designations of FIG. 42 are organized from left to right as the input queue layer 4203, integration layer 4204, control layer 4205, and vessel operation layer 4206, which provides the output.

The input queue layer 4203 includes mission planning 4207, a mission plan 4303 4208, mission decision algorithms 4209, sensors 4210, sensor signal processing 4211, sensor data fusion 4212, and sensor data analysis 4213. The input queue layer 4203 may contain inputs to the system that originate from sensors taking in external environment data, or mission information and decision logic that is pre-programmed by mission planners. The input queue layer contains elements of artificial intelligence in the form of a) mission decision algorithms and b) sensor data analysis including recognition, identification and classification.

The integration layer 4204 may include mission plan 4303 integration 4214, algorithm processing integration 4215, sensor integration 4216, and sensor data and analysis integration 4217. The integration layer 4204 conveys data generated in the Input Queue Layer 4203 to the Control Layer 4205. To accomplish this, the Input Queue Layer 4203 components must be integrated into this system with data, electrical, power, and mechanical connections. If physical integration is required, the integration may include waterproofing all components, signals and power.

The control layer 4205 may include a vessel control system 4218, hiding control system 4219, navigation control system 4220, and stealth control system 4221. The control layer 4205 may contain components that process the input data and translate to signals that control “hiding” system components and therefore hiding behavior.

The vessel operation layer 4206 may include the vessel systems that cause the vessel to perform certain behaviors. The vessel operation layer 4206 may include stealth hiding signature suppression systems 4223 and physical hiding navigation modes 4222. The stealth hiding signature suppression systems 4223 may include a thermal cloaking system 4227, an acoustic cloaking system 4228, a radio frequency cloaking system 4229, and a radio frequency imitation system 4229. They physical hiding navigation modes 4222 may include a navigation system 4224, which may include a propulsion system, a steering system, and control surfaces, a buoyancy system 4225, and a ballast system 4226. The buoyancy system 4225 and the ballast system 4226 may be components of the maneuvering system.

Turning to FIG. 43, this flowchart depicts logic used by the mission execution control 4401 in determining what hiding behaviors to execute. The process begins with a sensor 4301, 4302 and mission plan 4303 4303 input. The sensor 4301, 4302 input may be received from a transient object detection sensor 4301 or an environmental awareness sensor 4302. A transient object detection sensor 4301 may include, but is not limited to, an electro-optical sensor 4308, an infrared sensor 4309, a radar sensor 4310, a LIDAR sensor 4311, an acoustic sensor 4312, and a sonar sensor 4313. An environmental awareness sensor 4302 may include, but is not limited to, a GPS sensor 4314, a compass 4315, a gyro sensor 4316, and an inertial navigation system (INS) 4317. The inputs are processed and sent to decision algorithms that generate messages, which are provided to the hiding control system 4307.

Sensors 4301 may be attached to the unmanned vehicle for the purpose of detecting items of interest, which may be transient objects. The sensors 4301 may be referred to as transient object detection sensors. The sensors 4301 may provide data to a signal processing block 4304, which may detect an item of interest and provide an item of interest signal to an artificial intelligence block 4305, which may identify or classify the item of interest. The artificial intelligence block 4305 may be part of the vehicle control system. The artificial intelligence block 4305 may provide a classification signal. The classification signal may be provided to the mission execution control 4306 and may be utilized by the propulsion system, maneuvering system, vehicle control system, or buoyancy control system. The classification signal may be determined by the artificial intelligence block 4305 based on the item of interest classification. Items of interest may include, but are not limited to aquatic vessels, humans, mines, aerial vehicles, and chemicals. Items of interest may be classified as one of the listed types of items of interest after identification.

The unmanned vehicle may have any combination of sensors 4308, 4309, 4310, 4311, 4312, and 4313. Examples of sensor 4301 configurations include, but are not limited to, a single optical camera, some combination of sensors 4308, 4309, 4310, 4311, 4312, and 4313, and all of sensors 4308, 4309, 4310, 4311, 4312, and 4313. The enumeration of sensors 4301 may be representative of many embodiments but is not exhaustive.

Sensors 4302 may be attached to the unmanned vehicle to provide environmental information. Examples of environmental information include, but are not limited to, location on earth, vessel heading and course, and vessel orientation in water or air. Environmental information input is consumed by mission planning 4303 and execution 4306 modules. Additional sensors 4302 may be included but are not specifically enumerated in FIG. 43. Examples of additional sensors 4302, include, but are not limited to, sensors detecting the presence of chemicals or nuclear waste and sensors adapted to provide an indication of water quality. The presence or absence of particular environmental features may be defined as an item of interest. Output from the sensors 4302 may be provided to signal processing block 4304 to detect an item of interest. It is anticipated that new environmental sensors 4302 will become available and are considered within the scope of this disclosure.

Items of interest may include transient objects detected by sensors 4301, which may include ships, boats, swimmers, submarines, mines, aerial objects, including unmanned aerial vehicles and varieties of flying vehicles, as well as foreign material in the water detected by sensors 4302, which may include chemicals. Chemicals may include, but are not limited to, oil and nuclear waste.

In one embodiment of the invention, the plurality of transient object detection sensors 4301 of the sensor system may include at least one sensor adapted to detect an item of interest. The sensor data analysis 4213, sensor data and analysis integration 4217, or some combination of the two may be configured to recognize, identify, and classify one or more items of interest based of data received from one or more of the transient object detection sensors 4301 of the sensor system and provide an item of interest classification signal to the vehicle control system 4218, navigation system, hiding control system, orientation control system, stealth control system, propulsion system, maneuvering system, or buoyancy control system.

Signal processing electronics 4304 and algorithms 4305 may receive input from the sensors 4301, 4302 and determine that an item of interest or combination of items of interest have been detected. Detection may include a determination of the location, speed, heading, velocity, and/or dimension of the object of interest. Location may include any or all of the latitude, longitude, and depth of the item of interest. Sensor 4301, 4302 data and associated derivative information may be aggregated from each sensor 4301, 4301 for each item of interest and may be sent over an ethernet network to computation algorithms that may detect, identify, and classify each item of interest. This kind of recognition and classification may be particularly well suited to artificial intelligence (AI) and pattern recognition algorithms. The item of interest signal and classification signal may be provided by the artificial intelligence block 4305.

Once an item of interest has been detected, recognized, or classified that information may be sent over an ethernet network to the Mission Execution Control 4306. The Mission Execution Control 4306 may also receive input from the Mission plan 4303 4303. The Mission Execution Control 4306 may contain decision-making algorithms 4318 that may determine what hiding characteristics are desired based on the information received. Those decision-making algorithms 4318 may provide information to hiding requests 4319, which may pass command to the Hiding Control System 4307. The decision-making algorithms 4318 included in the Mission Execution Control 4306 may contain AI components.

The output of the Hiding Decision System may include Navigation Mode and Stealth Mode messages which are sent to the Hiding Control system 4307 over an ethernet network. The hiding control system 4307 may provide data to the propulsion system, maneuvering system, vehicle control system, or buoyancy control system, which, individually or collectively, may act to avoid physical, electrical, acoustic, or thermal detection of the unmanned vehicle by the item of interest.

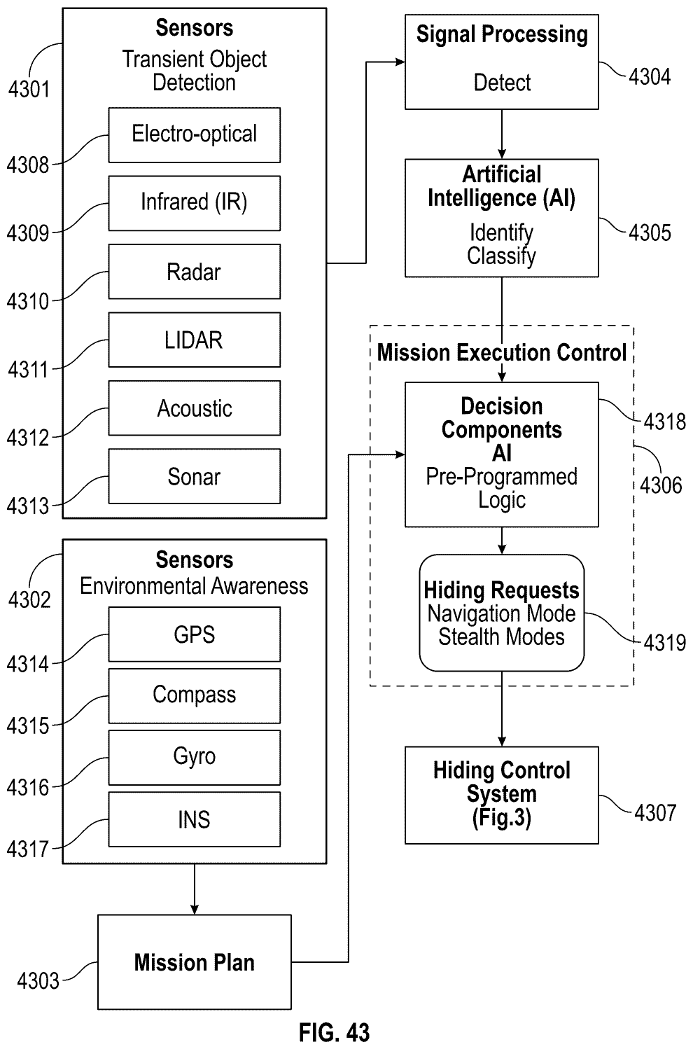

FIG. 44 depicts the flow chart of the hiding control system 4307. Data may be provided to the hiding control system 4307 from the mission execution control 4401, which is depicted in detail in FIG. 43.

FIG. 44 depicts how the hiding control system 4402 converts Hiding Request messages received from the mission execution control 4401 to Navigation Mode and Stealth mode control messages. Input to the hiding control system 4402 originates from the Mission Execution control 4306 depicted in FIG. 43, which sends hiding request messages as inputs that are processed by the hiding control system 4402 and/or the stealth mode executive control 4403.

The output of the hiding control system 4402 may be sent to the navigation mode executive control 4404, which may provide electrical and mechanical systems to direct unmanned vehicle navigation modes. The classification signal received from the mission execution control 4401 may be provided to the hiding control system 4402, which provides input to the navigation mode executive control 4404, which may then use that data to provide commands used by the maneuvering system, the buoyancy system, or the propulsion system to position the unmanned vehicle in a location calculated to prevent detection of the unmanned vehicle by the item of interest.

The hiding control system 4402 may select a desired navigation mode and provide this data to the navigation mode executive control 4404. The navigation mode executive control 4404 may process this selection and provide messages to the specific Navigation Mode Controller 4407, 4408, 4409, 4410, 4411, 4412, or 4413 necessary to implement the selected navigation mode. The navigation mode executive control 4404 may also contains control logic for transitioning between selected modes of navigation. The selected navigation mode controller 4407, 4408, 4409, 4410, 4411, 4412, or 4413 may provide date to the navigation come control command messages 4405, which are provided to navigation mode control 4406 to control systems of the unmanned vehicle. The navigation mode control 4406 may provide commands to the maneuvering system, buoyancy control system, or propulsion system. These systems may work independently or cooperatively to position the unmanned vehicle in a body of water at a depth lower than a depth of the item of interest and in an orientation in order to avoid detection by the item of interest.

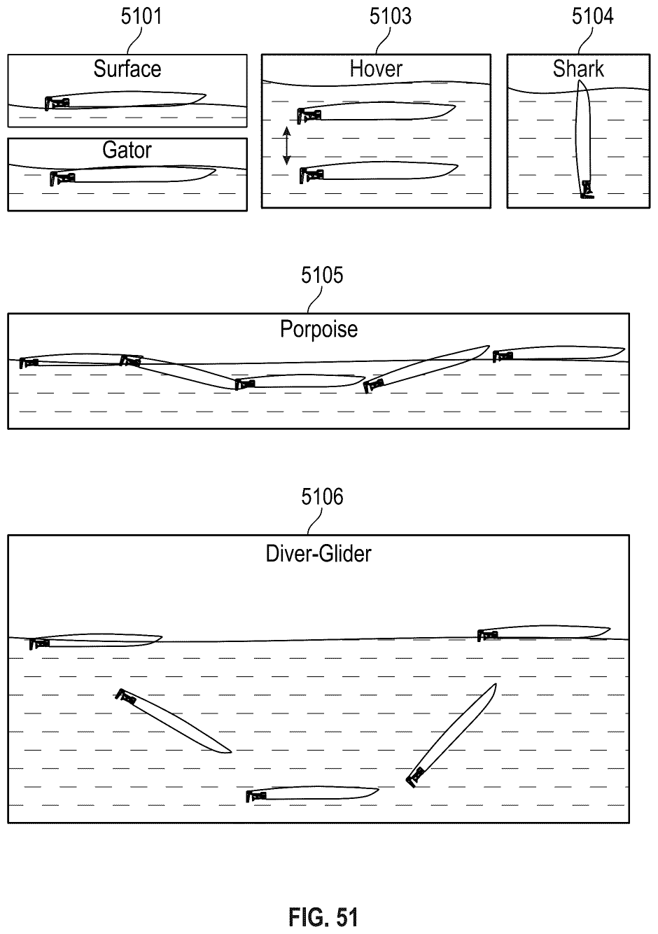

Turning to FIG. 51, the behavior of the vessel during different navigation modes is depicted. The vessel may be capable of operating in at least six different navigation modes, which may be referred to as surface mode 5101, gator mode 5102, hover mode 5103, shark mode 5104, porpoise mode 5105, and diver or glider mode 5106. The surface navigation mode control 4407 may provide navigation mode control command messages 4405 to the navigation mode control 4406 when the unmanned vehicle is in surface mode 5101. The GATOR navigation mode control 4408 may provide navigation mode control command messages 4405 to the navigation mode control 4406 when the unmanned vehicle is in GATOR mode 5102. The SHARK navigation mode control 4409 may provide navigation mode control command messages 4405 to the navigation mode control 4406 when the unmanned vehicle is in SHARK mode 5104. The HOVER navigation mode control 4410 may provide navigation mode control command messages 4405 to the navigation mode control 4406 when the unmanned vehicle is in HOVER mode 5103. The DIVER navigation mode control 4411 may provide navigation mode control command messages 4405 to the navigation mode control 4406 when the unmanned vehicle is in diver mode 5106. The glider navigation mode control 4412 may provide navigation mode control command messages 4405 to the navigation mode control 4406 when the unmanned vehicle is in glider mode 5106. The porpoise navigation mode control 4413 may provide navigation mode control command messages 4405 to the navigation mode control 4406 when the unmanned vehicle is in porpoise mode 5105. Each navigation mode may include navigation and movement characteristics along six degrees of freedom, communication methods, payload control methods, and other capabilities unique to each navigation mode. The navigation modes implement the part of multi-mode behavior that applies to surface, near surface, and submarine operations.

In surface mode 5101, the vessel may travel across the surface of a body of water. In hover mode 5103, the vessel may move to different altitudes above or below the surface of the body of water. In GATOR mode 5102, the vessel may be substantially submerged with a top of the vessel near or slightly above the surface of the water. In SHARK mode 5104, the vessel may be oriented horizontally with only the bow, or a portion of the bow, of the vessel above the waterline. In porpoise mode 5105, the vessel may move forward while alternating between a first position resting on the surface of the water and a second, completely submerged, position. In dive or glider mode 5106, the vessel may travel similarly to porpoise mode while reaching a deeper altitude when submerged below the water line.

Returning to FIG. 44, the output of the stealth mode executive control 4403, which may also be referred to as a stealth control system, may be sent to a thermal cloaking system 4414, acoustic cloaking system 4415, radio frequency cloaking system 4416, or radio frequency imitation system 4417. Each of the thermal cloaking system 4414, acoustic cloaking system 4415, radio frequency cloaking system 4416, and radio frequency imitation system 4417 may include electrical and/or mechanical systems to activate stealth capabilities that suppress the unmanned vehicle's detectable signatures. The stealth control system 4403 may use the classification signal to activate at least one of the thermal cloaking system 4414, acoustic cloaking system 4415, radio frequency cloaking system 4416, or radio frequency imitation system 4417. Any combination of stealth systems may be chosen. Each stealth system is independent from the other stealth systems. The thermal cloaking system 4414 may provide a control signal to a hull temperature suppression system 4418. The acoustic cloaking system 4415 may provide a control signal to an acoustic frequency cancelling system 4419. The radio frequency cloaking system 4416 may provide a control signal to a radio frequency suppression system 4420. The radio frequency imitation system 4417 may provide a control signal to a frequency imitation system 4421.

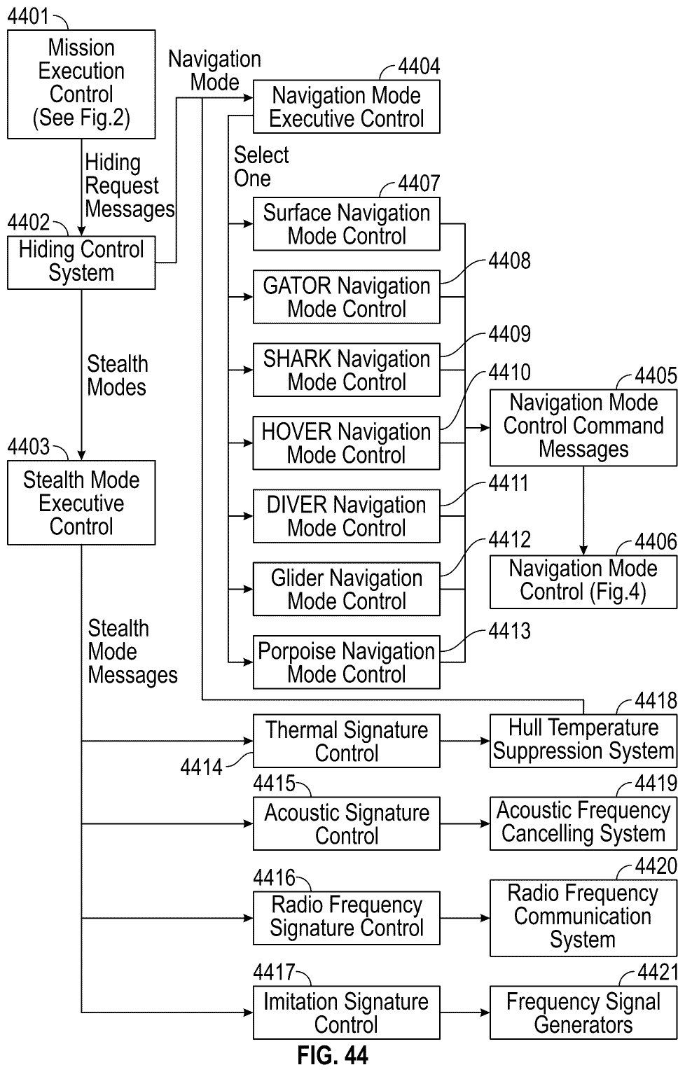

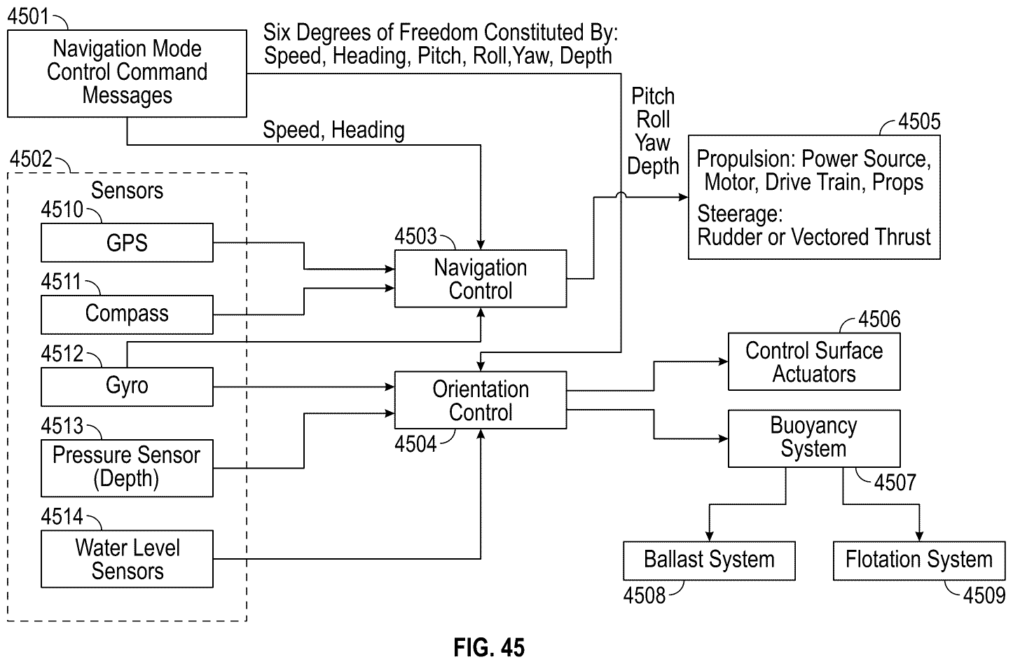

Referring to FIG. 45, the navigation mode control is depicted. The navigation mode control command messages 4501 are received and provided to navigation control 4503 and orientation control 4504. Navigation Control 4503 may control vessel speed and heading. Orientation control 4504 may control vessel pitch, roll, and depth. Together these may be referred to as controlling 6 degrees of freedom.

Navigation control 4503 and orientation control 4504 receive inputs from sensors 4502. The sensors 4503 may include, but are not limited to a GPS sensor 4510, compass 4511, gyro sensor 4512, pressure sensor 4513, and water level sensor 4514. The pressure sensor 4513 may be utilized to determine a depth of the vessel. The sensors 4502 and the environmental awareness sensors 4302 may be the same sensors. Output from the GPS sensor 4510, Compass 4511, and Gyro sensor 4512 may be provided to the navigation control 4503 to provide a feedback reference for speed, course and/or heading.

Output from the gyro sensor 4512, pressure sensor 4513, and/or water level sensor 4514 may be provided to the orientation control 4504 to provide a reference feedback for pitch, roll, depth, and water volume in the vessel.

The Navigation Control 4503 may control propulsion and steerage components 4505. The propulsion and steerage components may include, but are not limited to, a power source, drive train, motors, propellers, engines, rudders, or vectored thrust.

The Orientation Control 4504 may include control logic that generates output to control surface actuators 4506 or a buoyancy system 4507. The control surface actuators 4506 may control positions of trim tabs, canards, bow thrusters, or the like. The Buoyancy System 4507 may control the Ballast System 4508 and the Flotation System 4509.

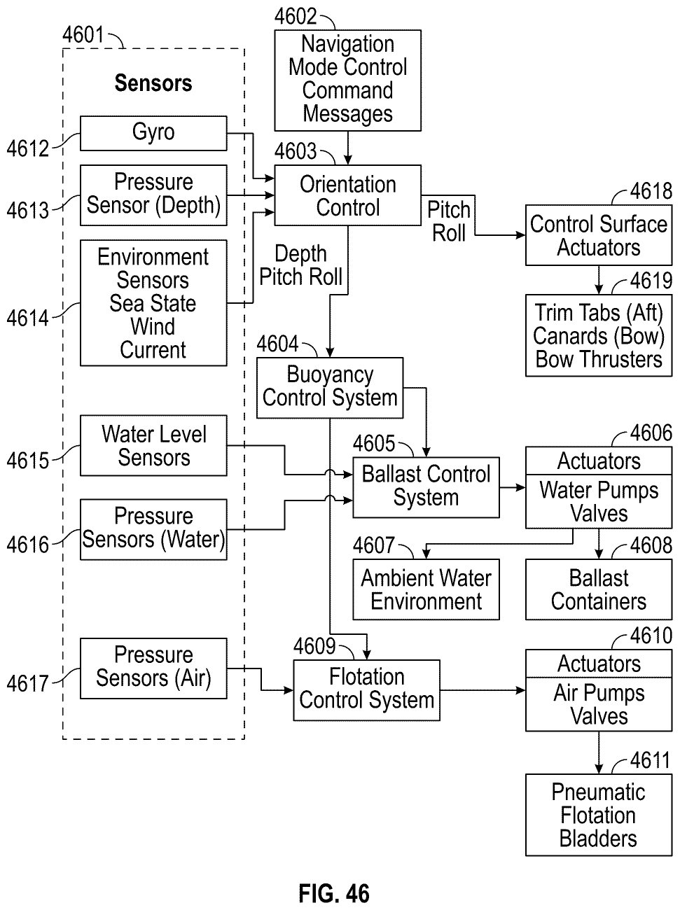

FIG. 46 provides more detail related to the orientation control 4504. The orientation control 4603 receives Navigation Mode control command messages 4602 and controls vessel pitch, roll, yaw, and depth in response. The Orientation Control 4603 contains logic that receives requests for particular orientation parameters and provides control commands in response to those requests. The orientation parameters may include pitch, roll, yaw, and depth. To achieve requested pitch and roll orientation parameters, the orientation control 4603 may send control commands to control surface actuators 4618 and the Buoyancy Control system 4604. The division of responsibilities between the control surface actuators 4618 and the buoyancy control system 4604 may be dependent upon the Navigation Mode. The control surface actuators 4618 may provide signals to one or more of the trim tabs, canards, and bow thrusters 4619 to achieve the desired pitch and roll. In one embodiment, the trim tabs may be positioned in the aft of the vessel and the canards may be positioned in the bow of the vessel.

Vessel control surfaces, including, but not limited to, trim tabs, canards, and bow thrusters 4619, may be moved by electrically controlled actuators 4618 that receive signals from the Orientation Control 4603 module. Power may be supplied by the energy source, which may be one or more batteries, and the conversion from digital signals to motive power may occur in circuitry that exists in the on-board processor or within the actuators 4618 themselves.

The Orientation Control module may receive inputs from sensors 4601. The sensors 4601 may include, but are not limited to, a gyro sensor 4612, pressure sensors 4613, 4616, 4617, environmental sensors 4614, and water level sensors 4615. The gyro sensor 4612 may be a 3-axis accelerometer. The environment sensors 4614 may detect sea state, as defined by wave motion, wind speed, wind direction, current speed, or current direction. The pressure sensors 4613, 4616, 4617 may be utilized to detect different data. At least one depth pressure sensor 4613 may detect a depth of the vessel. A water pressure sensor 4616 may detect a water pressure. An air pressure sensor 4617 may detect an air pressure.

The Buoyancy Control system 4604 may receive command and data messages from the Orientation Control 4603. These messages may contain requests for orientation parameters related to depth, pitch, or roll. These messages may also contain sensor 4601 data including information related to pitch, roll, yaw, and depth. These messages may be processed by the buoyancy control system 4604 and translated to instructions to the Ballast Control system 4605 or the floatation control system 4609.

The ballast control system 4605 may control the volume of water in the vessel and direct the systems necessary to remove water from or add water to the vessel to achieve a desired volume of water. Specifically, water may be carried in ballast containers 4608 or the hull. The Ballast Control System 4605 receives an input from water level sensors 4615 inside the vessel and water pressure sensors 4616 indicating pressure in ballast containers 4608. From this sensor data, the volume of water in the vessel or ballast containers 4608 may be determined and compared to the desired water volume as directed from the buoyancy control system 4604. Water volume may be adjusted by activating water pumps or valves 4606 to pump water into the ballast containers 4608 from the ambient water environment 4607 or to pump water out of the ballast containers 4608 into the ambient water environment 4607 until the water volume in the ballast containers 4608 matches the requested water volume. The ballast control system 4605 may convert digital signals to electrical output that drives actuators 4606 that pump the water.

The flotation control system 4609 may control the volume of air in the vessel and direct the systems necessary to remove air from or add air to the vessel to achieve the desired volume of air. Specifically, air may be carried in pneumatic flotation bladders 4611. The Flotation Control System 4609 may receive input from air pressure sensors 4617 measuring air pressure in pneumatic flotation bladders 4611. From this sensor data, the volume of air in a plurality of air bladders 4611 may be determined and compared to the desired volume of air as directed from the buoyancy control system 4604. Air volume may be adjusted by activating an actuator or valve 4610 to pump air into the pneumatic flotation bladders 4611 or to release air from the pneumatic flotation bladders 4611 until the volume of air in the air bladders 4611 matches the requested volume of air. The flotation control system 4609 may convert digital signals to electrical output that drive actuators 4610 that pump the air.

As described, the Buoyancy Control system 4604 may control two systems simultaneously to achieve accurate control of total buoyancy and center of buoyancy of the vessel which may enable multiple orientations, which are grouped as Navigation Modes described in FIG. 51.

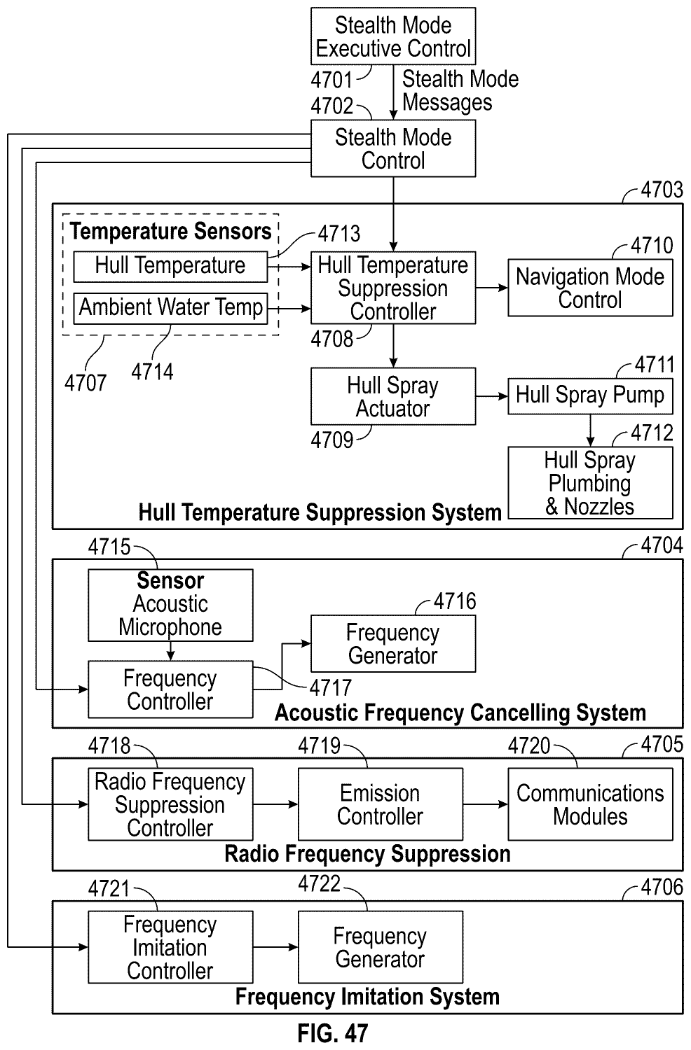

FIG. 47 depicts the stealth mode executive control 4701. The Stealth control system 4702 may receive Stealth Mode command messages, as depicted in FIG. 44. In response to the stealth mode command messages, a plurality of vessel signatures including thermal, acoustic or radio frequencies may be suppressed. Further, the stealth control system 4702 may enable the vessel to emit a signal that imitates a different kind of vessel or maritime object. The Stealth control system 4702 may activate any combination of stealth systems. The stealth systems may include a thermal cloaking system 4703, an acoustic cloaking system 4704, a radio frequency cloaking system 4705, and a radio frequency imitation system 4706.

The thermal cloaking system 4708 may provide a control signal to a hull temperature suppression system 4703. The thermal cloaking system 4708 may be adapted to decrease a temperature of the unmanned vehicle's body by activating the hull temperature suppression system 4703.

The thermal cloaking system controller 4708 may receive a message from the Stealth Control system 4702 with instructions to maintain, or limit, the maximum hull temperature to within a specified difference of the ambient water temperature. The thermal cloaking system controller 4708 may also receive a message from the stealth control system indication what Navigation Mode or Hull Spray action to take to reduce the hull temperature.

The thermal cloaking system controller 4708 may receive data from temperature sensors 4707 to determine the current hull temperature and the ambient water temperature. A hull temperature sensor 4713 may be positioned to measure and provide data related to the maximum hull temperature and an ambient water temperature sensor 4714 may be positioned to measure and provide data related to the ambient water temperature. If the difference between the ambient water temperature and the hull temperature is above the specified difference, the thermal cloaking system controller 4708 may provide a control signal to the navigation mode control 4710 to enter a navigation mode calculated to reduce the hull temperature. The navigation mode control 4710 may be a part of the vehicle control system and may control the propulsion system, maneuvering system, vehicle control system, or buoyancy control system to maintain an actual difference between the hull temperature and the ambient temperature less than the target threshold when the thermal cloaking system 4703 is activated.

Similarly, if the difference between the ambient water temperature and the hull temperature is above the specified difference, the thermal cloaking system controller 4708 may provide a control signal to the hull spray actuator 4709 to activate the hull spray pump 4711 and control the hull spray plumbing and nozzles 4712 to spray the hull with ambient water to reduce the hull temperature. The hull spray actuator 4709 may be a part of the vehicle control system and the hull spray pump 4711 and hull spray plumbing and nozzles 4712 may be a part of a water spray system. Water output from the water spray system may be directed at the exposed hull surface to maintain an actual difference between the hull temperature and the ambient temperature less than the target threshold when the thermal cloaking system 4703 is activated.

For example, if the maximum hull temperature exceeds the specified temperature threshold, the vessel may be instructed to go into PORPOISE mode until the hull decreases temperature. By way of another example, if the maximum hull temperature exceeds the specified temperature threshold, the hull spray mechanism may be activated.

The acoustic cloaking system 4704 may be adapted to cancel an acoustic frequency emitted by the unmanned vehicle. The Acoustic Frequency Controller 4717 may receive a message from the Stealth Control system 4702 with instructions to suppress the acoustic signature of the vessel. The controller 4717 may receive input from an acoustic sensor 4715. By way of example, and not as a limitation, the acoustic sensor 4715 may be a microphone or other sensor adapted to sense a detectable frequency. An algorithm may receive data detected by the acoustic sensor 4715 or control data from the frequency controller 4714 and be configured to control a frequency generator 4716 to output a cancelling frequency calculated to suppress the detectable frequency sensed by the acoustic sensor 4715. The cancelling frequency may suppress or cancel the frequencies sensed by the acoustic sensor 4715. The cancellation frequency may be sent to a frequency generator 4716 in the form of an electrical or digital signal.

The radio frequency imitation system 4706 may be adapted to recreate a target radio frequency. The radio frequency imitation system 4706 may receive a message from the Stealth Control system 4702 with instructions to imitate a known maritime vessel or other object. The object to be imitated could be man-made or natural. The imitation controller 4721 may contain a library of maritime vessel and object frequencies that are matched to the requested object and the matching frequencies may sent to a frequency generator 4722 in the form of an electrical or digital signal or controls may be provided to the frequency generator 4722 to cause the frequency generator to output the desired frequency. The frequency library may include a designation of a plurality of maritime vessels and objects, which may be referred to collectively as frequency generators, and their associated output frequencies. The frequency generator 4722 may be configured to output a frequency associated with one or the plurality of frequency generators contained in the library.

The radio frequency cloaking system 4705 may be adapted to alter the radio frequency emitted by the vessel. The Radio Frequency Suppression Controller 4718 may receive a message from the Stealth Control system 4702 with instructions for which communication frequencies to suppress. These messages may be translated and sent to an Emission Controller 4719 which has logic to determine what frequencies to suppress and the nature of the suppression from turning off those frequencies, choosing other selective frequencies or changing the bandwidth and period of communications. These parameters may be converted to instructions and sent to the vessel's communication modules 4720. The radio frequency cloaking system 4705 may be adapted to alter the emitted radio frequency of the Bessel by at least one of: suppressing an emission of the radio frequency, changing a bandwidth of the radio frequency, and changing a duration of transmission of the radio frequency.

Referring to FIGS. 48a-c, schematic diagrams illustrating the layout of the physical components of the buoyancy control system are presented. The buoyancy control system includes the ballast system and the flotation system. The ballast system controls water volume within the vessel hull. The flotation system controls the air volume within the vessel hull. These two systems work together and are coordinated by the Orientation Control System described above. The ballast system primarily controls the total buoyancy of the vessel, which changes its depth, while the flotation system is primarily used to control the center of buoyancy, which changes pitch and roll of the vessel.

The Ballast subsystem contains the following components as shown in FIGS. 48a-c:
an electronically controller diverter valve 4809 that controls water flow from external ports on the top and bottom of the vessel to,
an electronically controlled bi-directional positive displacement pump 4806 that pumps water in or out of the vessel through plumbing lines connected to ports in the bottom of the vessel and whose flow is controlled by,
electronically actuated valves 4807, 4808 with ports directing water into or out of the bottom of the hull.

Four water level sensors 4811, 4812, 4813, 4814 are located inside the vessel, two near the top to indicate that water has filled the vessel and two on the bottom, one in each sponson, to indicate that water is evacuated from the vessel.

The central processing control unit 4815 may contains a computer or other computing device for logic processing and input and output conversions between digital signals and electronic signals that are used to actuate valves and pumps in the ballast control system.

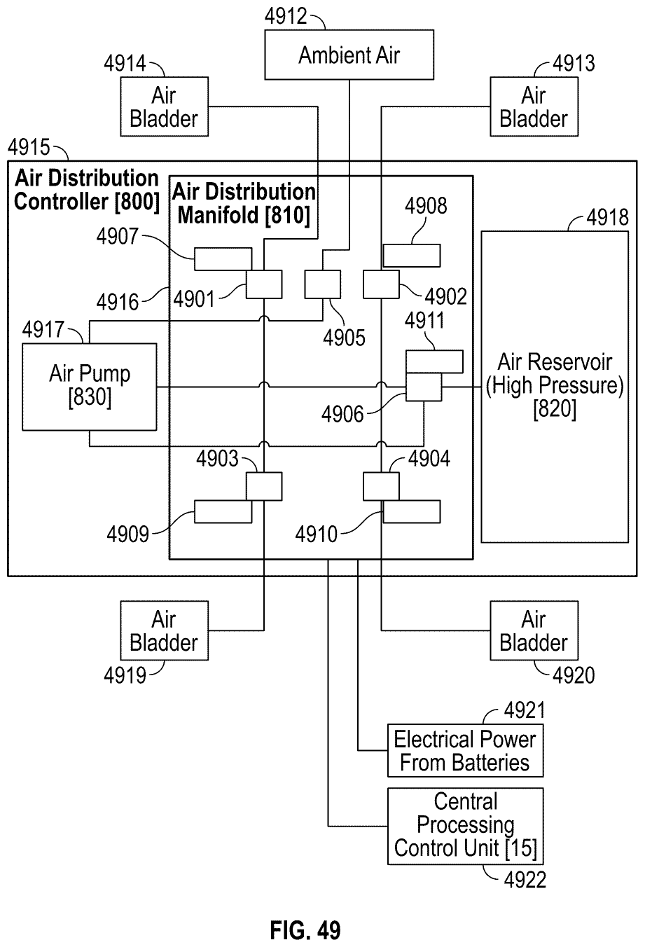

The flotation control system includes an air distribution controller 4805. The air distribution controller 4805 controls the volume of air in air bladders 4801, 4802, 4803, 4804 by pumping air in or out through air lines. The volume of air is individually controlled in each air bladder and the air bladders are distributed in four quadrants within the vessel, port, starboard, bow, aft. This may enable control to move the center of buoyancy backward and forward, and left and right, which translates to pitch and roll. The central processing control unit 4815 may send actuation signals to the air distribution controller as described in FIG. 49. The flotation control system may also include a pressure sensor 4810.

Turning to FIG. 49 a schematic diagram illustrating the physical components of the air distribution controller used to control the volume of air in each of the air bladders 4914, 4913, 4919, 4920 is shown. The air bladders 4914, 4913, 4919, 4920 distributed in the vessel allow for controlling the center of buoyancy. The air distribution controller 4915 includes an air distribution manifold 4916, an air pump 4917, and a high-pressure air reservoir 4918. The air distribution manifold 4916 may contain a set of air channels that direct air between the air bladders 4914, 4913, 4919, 4920 and either ambient air 4912 or air from the high-pressure reservoir 4918. Air channels may contain electronically activated valves 4901, 4902, 4903, 4904, 4905, 4906 that are controlled from the central processing control unit 4922. The combination of valves in open or closed positions enable distribution of air between any combination of bladders 4913, 4914, 4919, 4920 and one of the two air sources 4912, 4918. Signals from air pressure sensors 4907, 4908, 4909, 4910, 4911 are transmitted to the central processing unit 4922, which may use algorithms to determine the volume of air in each bladder 4913, 4914, 4919, 4920. The air distribution controller may receive electrical power from one or more batteries 4921.

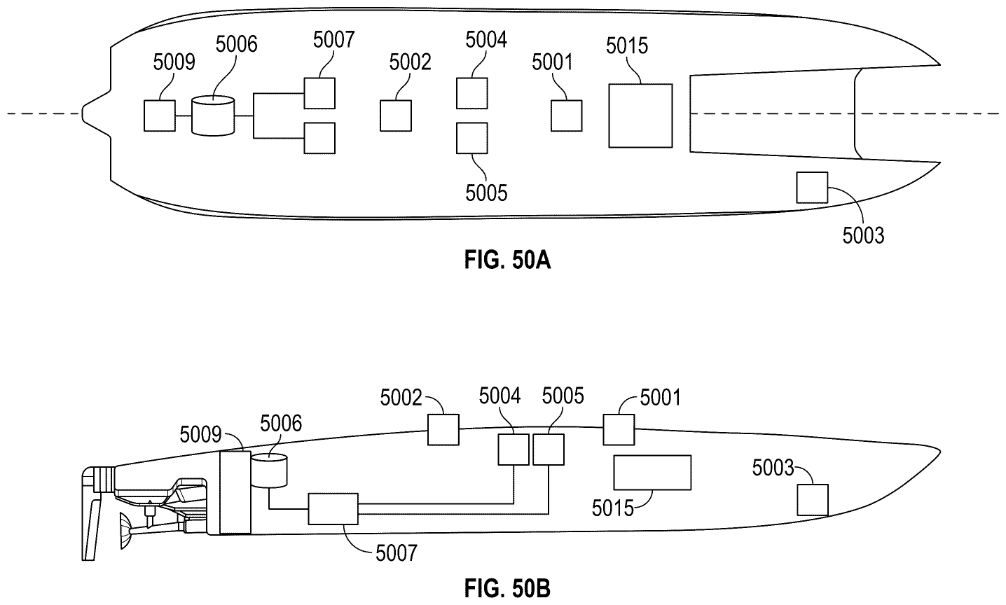

Turning to FIGS. 50a-b schematic diagrams illustrating the layout of thermal signature suppression components are depicted. Thermal signature suppression logic may be processed in the 5015 central processing unit. Temperature sensors 5001, 5002 may be placed to read exterior hull temperature at locations expected to be the highest temperatures. A temperature sensor 5003 may be placed to read ambient water temperature. The temperature sensor signals may be routed to the central processing unit 5015. When hull cooling is required, the embodiment of FIGS. 50a-b depicts a water spray system to suppress the thermal signature. When thermal suppression is called for, the central processing unit 5015 may direct the external bottom water port to be opened by opening the diverter valve 5009, actuating the water pump 5006, and opening the internal water valve 5007, which results in water flow to spray nozzles 5004, 5005. When the hull temperature is cooled sufficiently, the process may be reversed. The valves may be closed, and the water pump may be turned off.

As described above, hull temperature suppression may be achieved by employing a navigation mode that washes the hull and, in this case, the spray system may not be used.

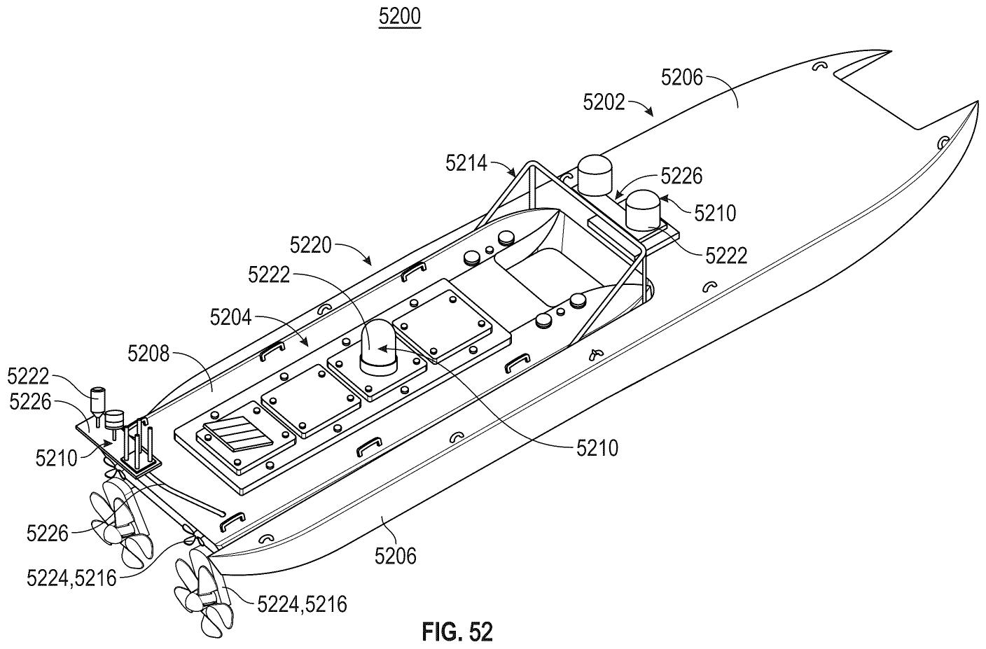

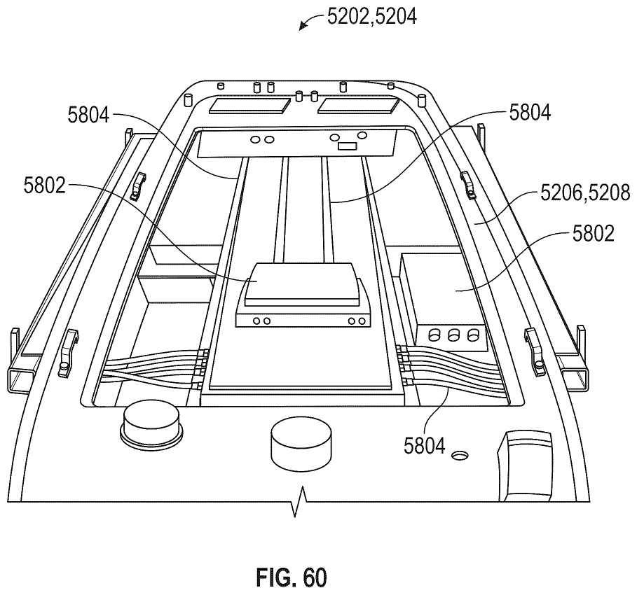

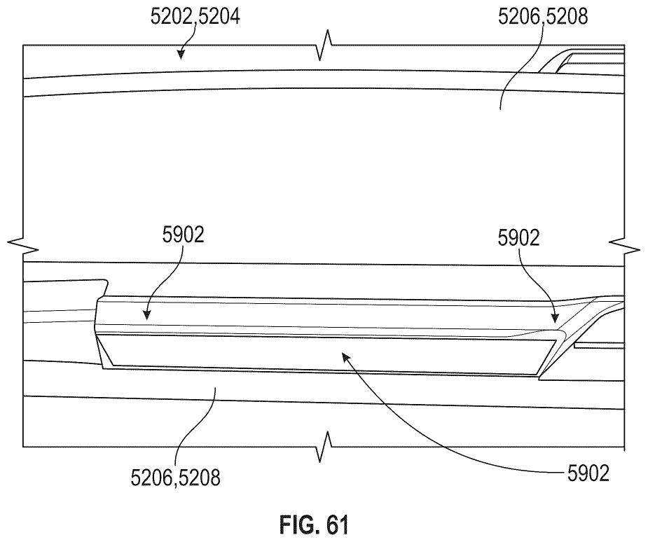

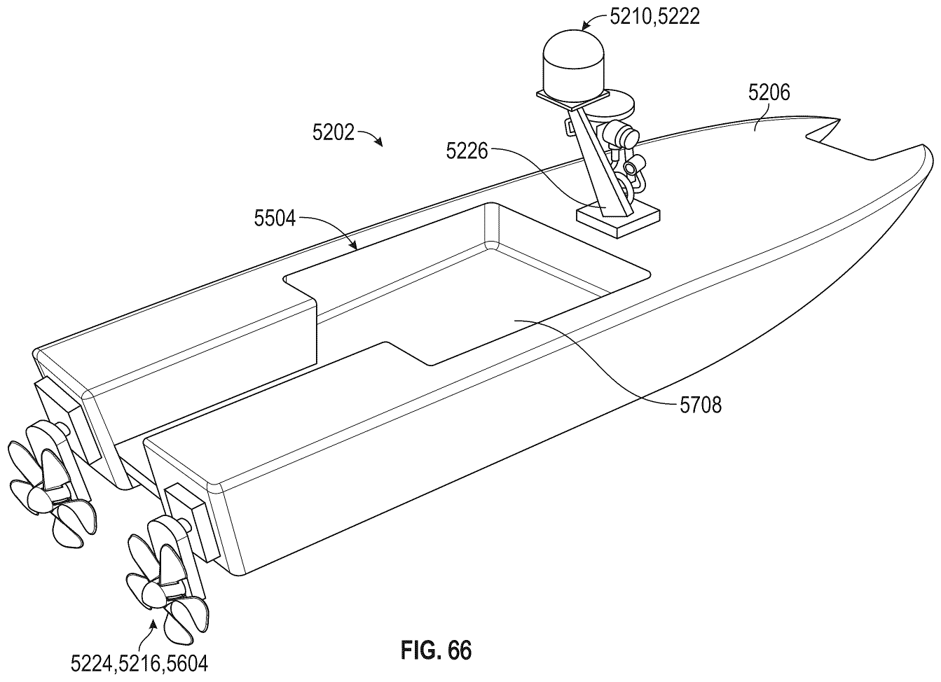

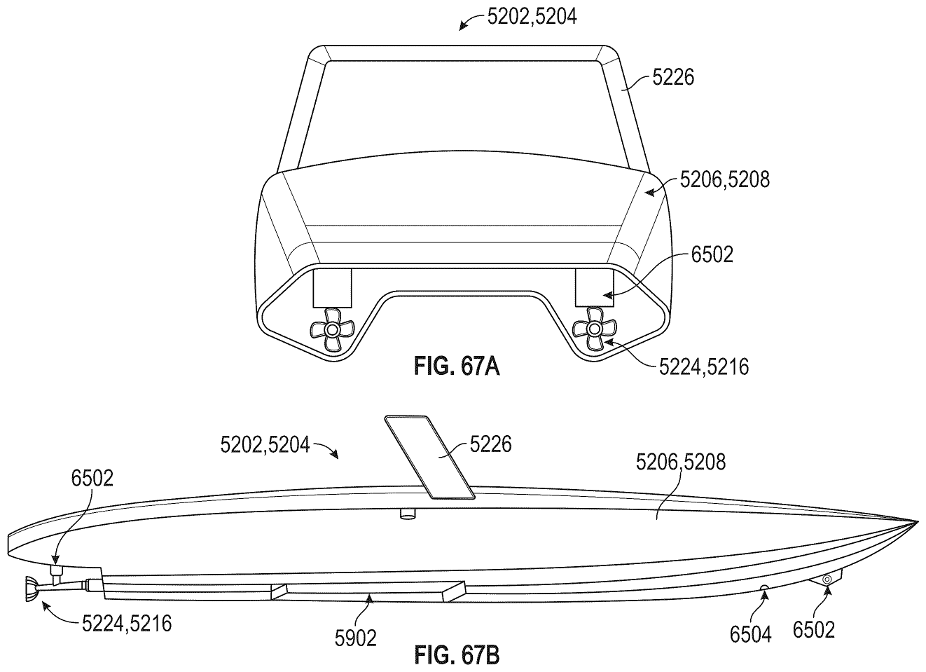

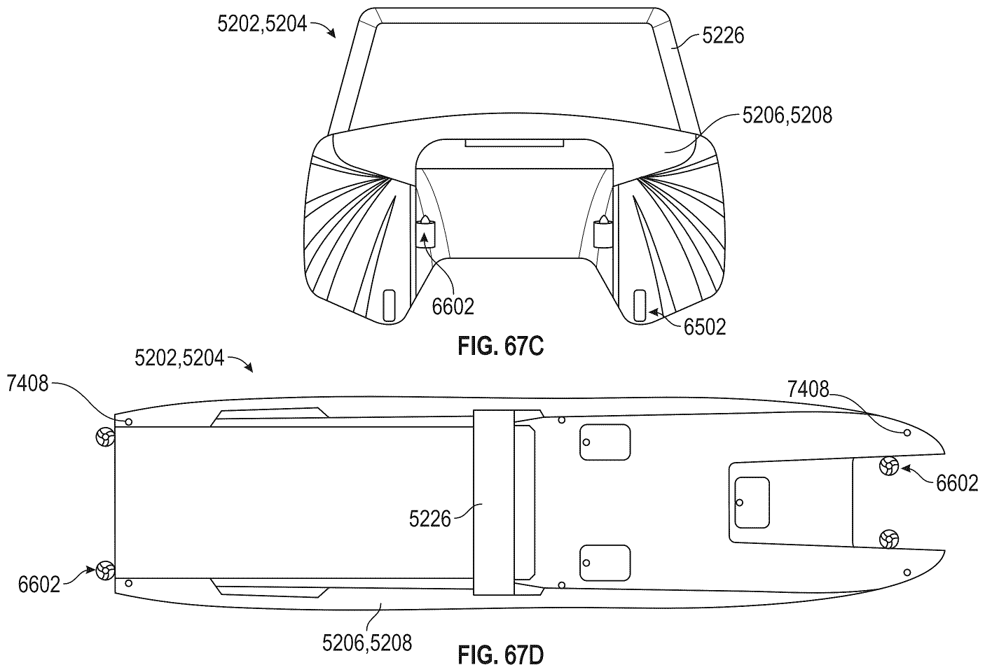

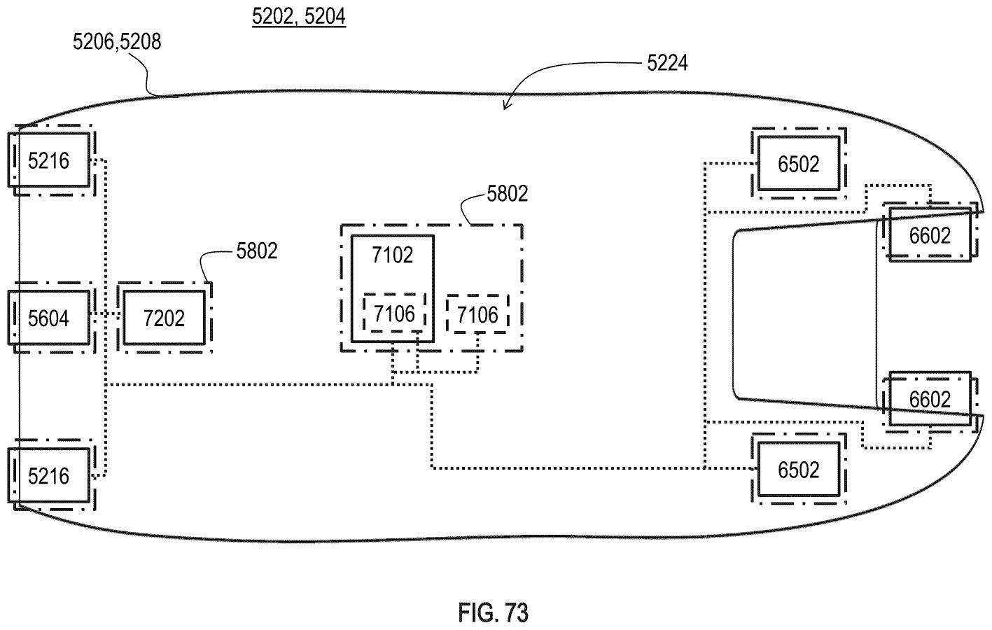

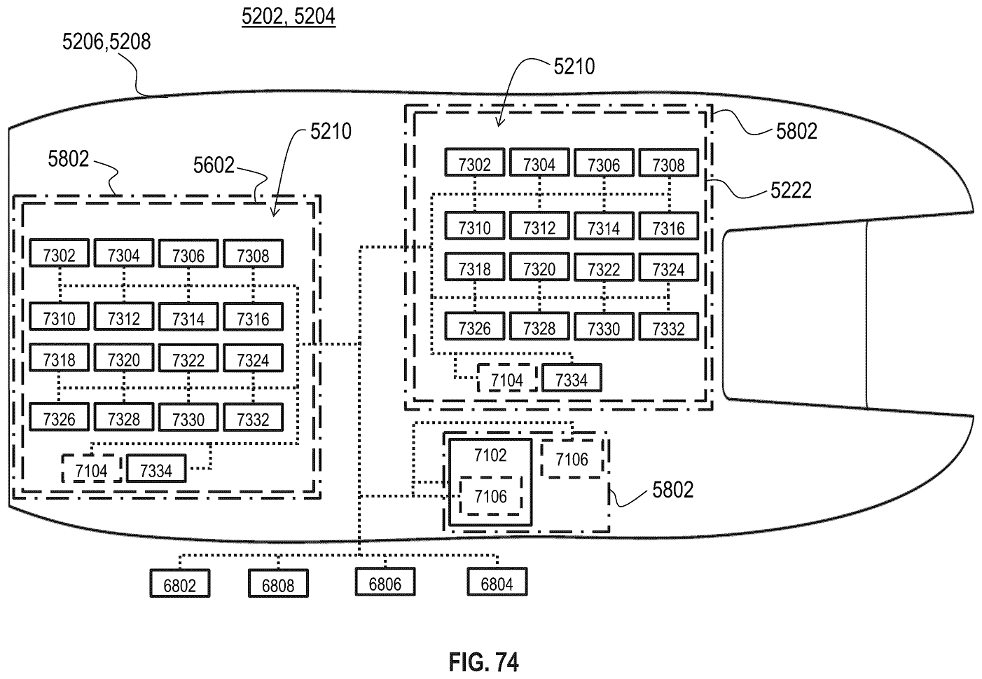

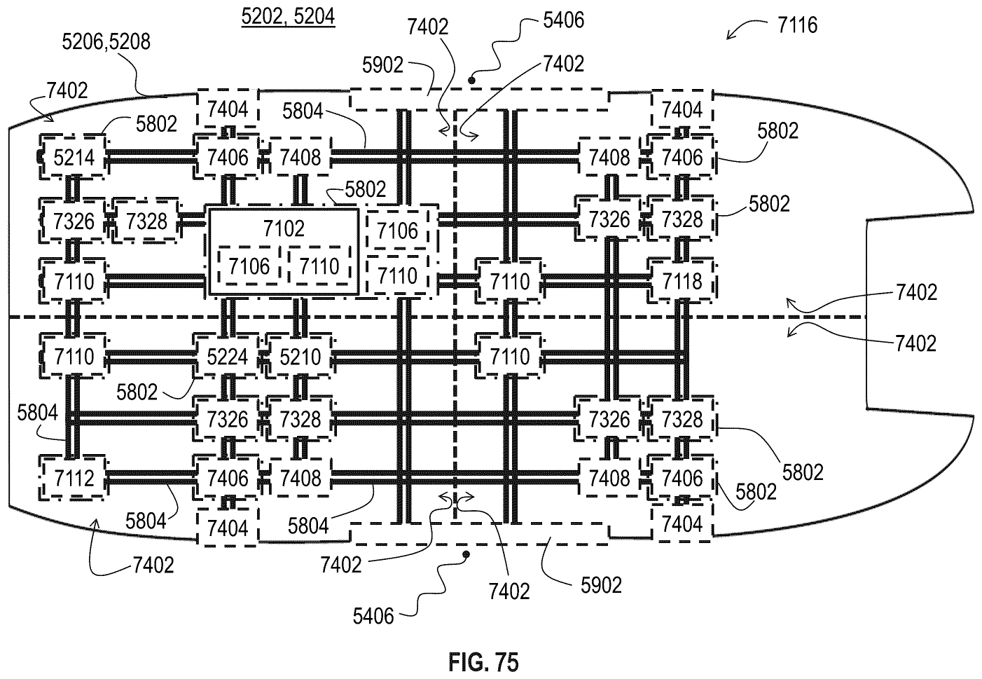

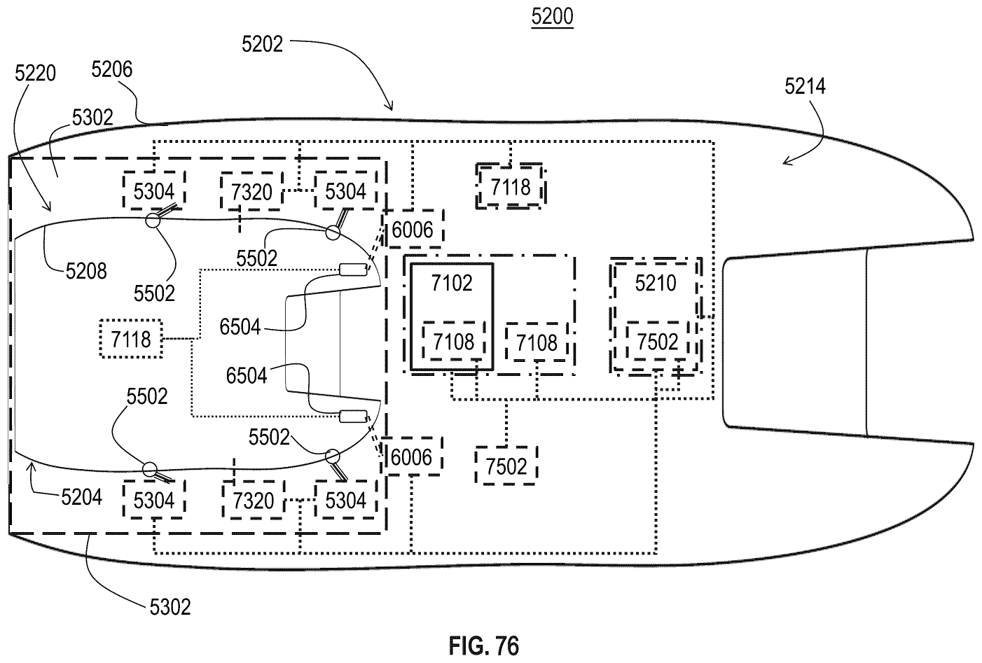

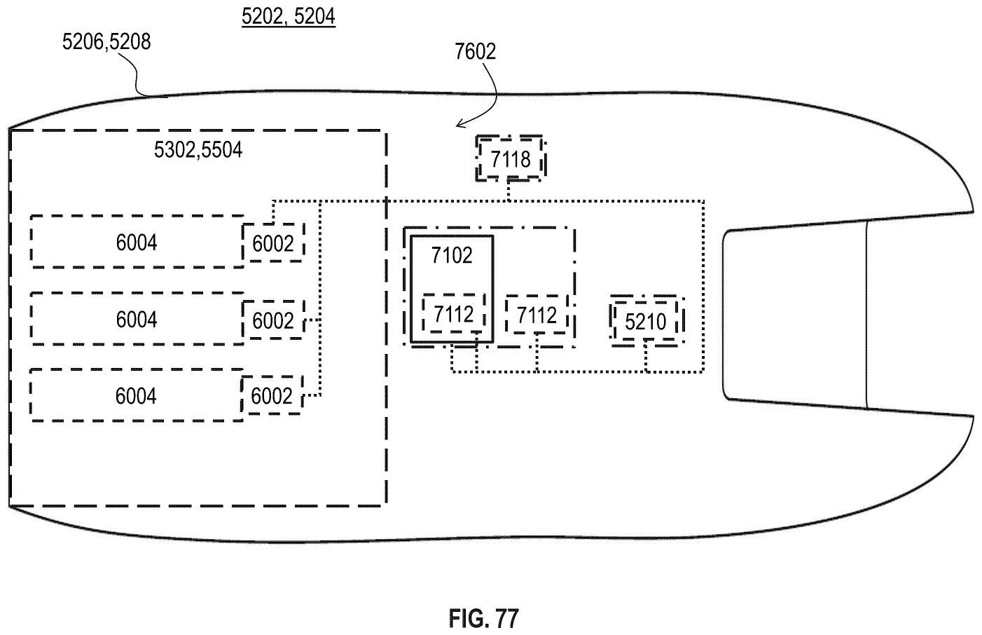

With additional reference to FIGS. 52-82C, another embodiment of an unmanned vessel will be described directed to an unmanned vehicle system 5200 that comprises at least one host vehicle 5202 and at least one guest vehicle 5204. The unmanned vehicle system 5200 according to this embodiment is configured for the deployment and recovery of one or more guest vehicle(s) 5204 by one or more host vehicles 5202. Of course, such embodiment may include any of the features described above with respect to other embodiments. As will be described in further detail below, the present embodiments of the unmanned vehicle system 5200 may be configured for mesh network communication by, between, and via host vehicles 5202, guest vehicles 5204, and/or with other vehicles and/or devices to perform one or more mission plans 4303 and mission plan tasks that are associated with at least one mission plan 4303 as a cooperative and/or as a cooperative swarm of unmanned vehicles 5202, 5204 and to share data, sensed data, and communications.

A mission plan 4303 may comprise commands and/or instructions to be executed, performed, and/or achieved by the host vehicle 5202 and/or guest vehicle 5204. A mission plan 4303 may include, without limitation, one or more of an intelligence mission plan, a surveillance mission plan, a reconnaissance mission plan, a guest vehicle 5204 deployment mission plan, a guest vehicle 5204 recovery mission plan, a unmanned aerial vehicle deployment and/or recovery mission plan, a search and rescue mission plan, a special operations mission plan, a payload 6004 deployment mission plan, a command and control evaluation mission plan, a predetermined object of interest detection mission plan, a predetermined object of interest identification mission plan, a predetermined object of interest classification mission plan, a logistics mission plan, a night operation mission plan, a maritime security mission plan, a mapping mission plan, a scouting mission plan, a data relay mission plan, a fleet security mission plan, an autonomous towing mission plan, a swarm operation mission plan, a submarine mission plan, and/or a vessel detection mission plan,

A mission plan 4303 may include one or more preselected and/or selectable modes which a host vehicle 5202 and/or guest vehicle 5204 may be operable to follow responsive to receiving the selected mode(s). A preselected and/or selectable mode may include, without limitation, one or more of a transport mode, a semi-autonomous mode, a standby mode, a manual control mode, a fully autonomous mode, a loiter mode, a protection mode, a shared manual and autonomous control mode, and/or a keep station mode. A host vehicle 5202 and/or guest vehicle 5204 may receive a selected mode from a user device 6808. In some embodiments of the unmanned vehicle system 5200, the host vehicle 5202 and/or guest vehicle 5204 may be configured to select one or more of the selectable modes upon a predetermined event. For example, without limitation, the host vehicle 5202 and/or guest vehicle 5204 may select the fully autonomous mode upon sensing, detecting, and/or determining that there is no communication between the host vehicle 5202 and/or guest vehicle 5204 with a network 6802, a user device 6808, and/or an associate device 6806.

The host vehicle 5202 may be configured to stow and/or carry at least one guest vehicle 5204 thereby in a stowed state 5220, and may be configured to deploy the one or more guest vehicles 5204 by moving the guest vehicle(s) 5204 from the stowed state 5220 to a deployed state 5404. The host vehicle 5202 and the guest vehicle 5204 also may both be operable to move between a surfaced state 5405 and a submerged state 5402. The host vehicle 5202 may be operable to recover the guest vehicle 5204 while they are both in the submerged state 5402 to have the guest vehicle 5204 move from the deployed state 5404 to the stowed state 5220.

It should be noted that the present embodiments comprising the unmanned vehicle system 5200 preferably provide the ability of the host vehicle 5202 to carry, deploy, and recover one or more guest vehicles 5204, and to cooperate with one another and implement machine learning/Artificial Intelligence (AI) to coordinate performance and fulfillment of a mission plan, which may also be via mesh communications and as a swarm with one or more other host vehicles 5205 and/or one or more other guest vehicles 5204.

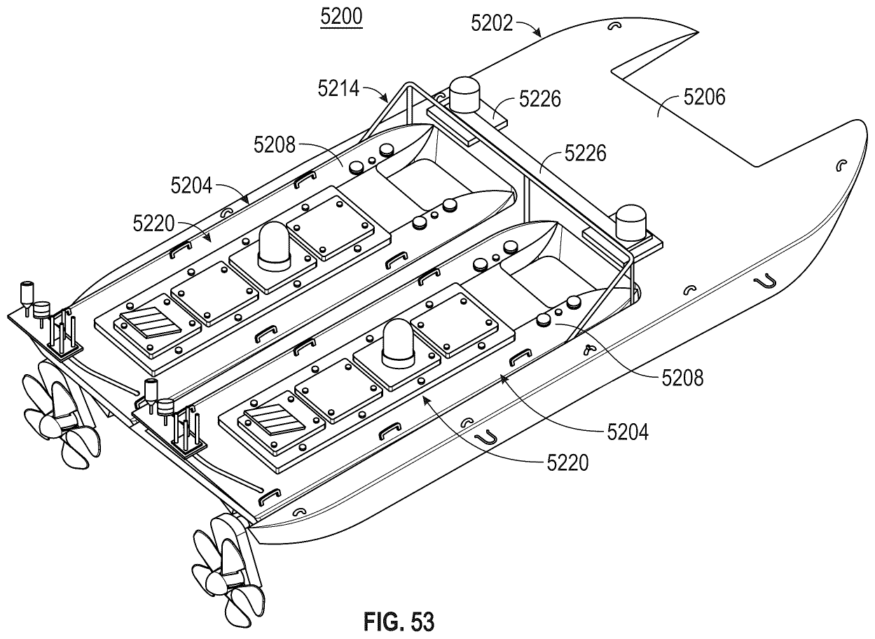

FIGS. 52-53 primarily depict a host vehicle 5202 carrying a guest vehicle 5204 in the stowed state 5220. The host vehicle 5202 may be configured to carry a single guest vehicle 5204 in the stowed state, as illustrated in FIG. 52, and the host vehicle 5202 may be configured to carry at least one guest vehicle 5204 in the stowed state. For example, without limitation, the host vehicle 5202 illustrated in FIG. 53 that is configured to carry up to two guest vehicles 5202 thereby in the stowed state.

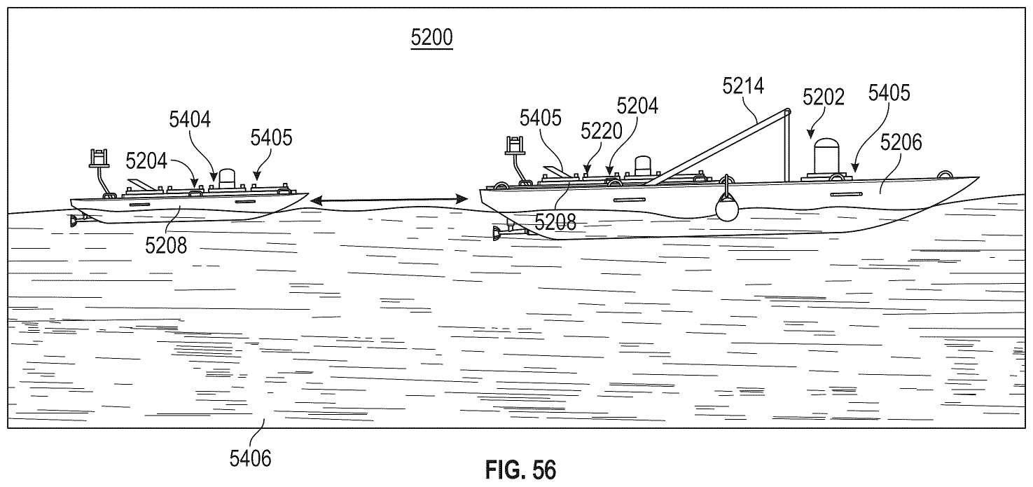

It should also be noted that the use of the terms unmanned host vehicle 5202, host vehicle 5202, host 5202, host vessel 5202, and unmanned host vessel 5202 may be used interchangeably, without limitation, as reference to an embodiment host vehicle 5202. Similarly, the same should be noted regarding the use of the term unmanned guest vehicle 5204, guest vehicle 5204, guest 5204, guest vessel 5204, and unmanned guest vessel 5204, without limitation, as reference to an embodiment of the guest vehicle 5204. It should also be noted, that throughout the description of the present invention herein, that features described regarding the host vehicle 5202 may similarly apply to the guest vehicle 5204, and that features described regarding the guest vehicle 5204 may also similarly apply to the host vehicle 5202. For instance, but without limitation, throughout the figures the embodiment(s) illustratively shown therein may be labeled as both and/or either of the host vehicle 5202 and guest vehicle 5204 to show, without limitation, that the features depicted therein may regard both and/or either the host vehicle 5202 and the guest vehicle 5204, such as FIGS. 56, 58-61, 65A-67, 71-74, and 76.

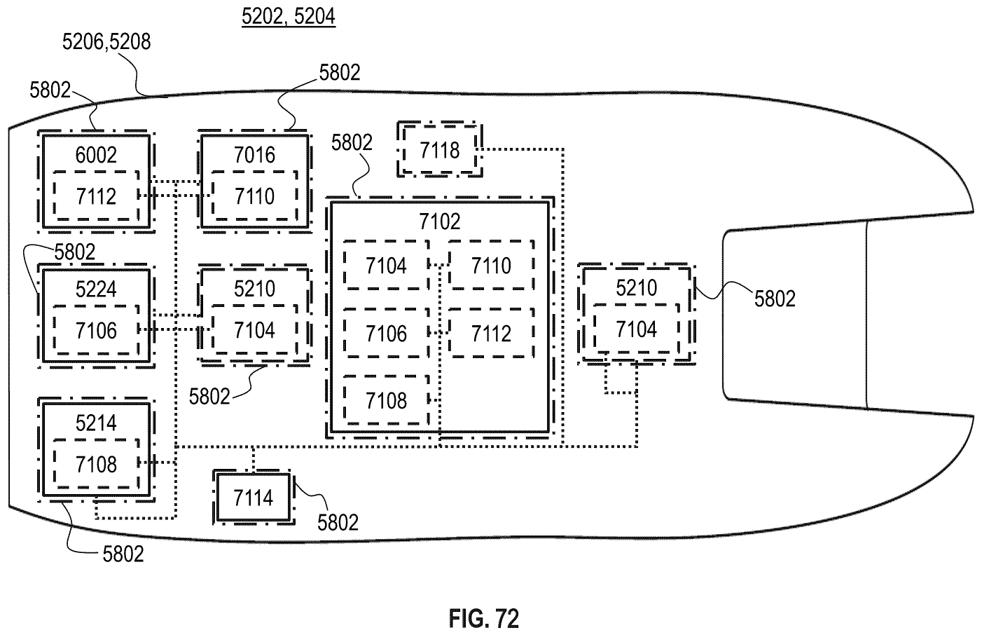

A host vehicle 5205 of the unmanned vehicle system 5200 may comprise a host vehicle body 5206 and a securing system 5214. The guest vehicle 5204 may comprise a guest vehicle body 5208 and may also comprise one or more guest securing members 5502. Also, as illustrated in FIG. 72, and as will be described in further detail below, each one of the host vehicle(s) 5202 and guest vehicle(s) 5204 may comprise a vehicle control system 7102, a vehicle maneuvering system 5224, a vehicle sensor and communication system 5210, a vehicle buoyancy system 7116, and/or an onboard power supply 7118. Each of the aforementioned components that may be shared in common, may be referred to more specifically with respect to either the host vehicle 5202 or the guest vehicle 5204 by referring to a component as being a/the “host ‘component’” and/or a/the “host vehicle ‘component.’” E.g., the “host vehicle control system 7102,” and such. However, it should be noted, that some and/or all of the description of the “host”/“host vehicle” version of a component may be similarly and/or equally applicable to the “guest”/“guest vehicle” version of that component, and vice versa, without limitation, as may be understood by those who may have skill in the art.

Now referring to FIGS. 52-57 and 72, the host vehicle maneuvering system 5210 may be in communication with the host vehicle control system 7102, and may be operable to provide propulsion to the host vehicle body 5206 and/or to the host vehicle 5202. The host vehicle sensor and communication system 5210 may be in communication with the host vehicle control system 7102. The guest vehicle control system 7102 may be positioned in communication with the host vehicle control system 7102. The guest vehicle maneuvering system 5224 may be in communication with the guest vehicle control system 7102 and/or the host vehicle control system 7102. The guest vehicle maneuvering system 5224 may be operable to provide propulsion to the guest vehicle 5204. The guest vehicle sensor and communication system 5210 may be in communication with the guest vehicle control system 7102 and/or the host vehicle control system 7102.

It should be noted, without limitation, that communications to and/or from the host vehicle 5202, and/or to and/or from one or more of the components of the host vehicle 5202, may be by and/or via the host vehicle sensor and communication system 5210. Similarly, without limitation, communications to and/or from the guest vehicle 5204, and/or to and/or from one or more of the components of the guest vehicle 5204 may be by and/or via the guest vehicle sensor and communication system 5210. E.g., without limitation, communication between the host vehicle control system 7102 and the guest vehicle control system 7102 may be via the host vehicle sensor and communication system 5210 and/or the guest vehicle sensor and communication system 5210. Moreover, without limitation, for some embodiments of the unmanned vehicle system 5200, it should be understood that a recitation, such as, “the host vehicle control system 7102 is in communication with the guest vehicle maneuvering system 5224,” may imply that the communication between the host vehicle control system 7102 and the guest vehicle maneuvering system 5224 is via the host vehicle sensor and communication system 5210 and/or the guest vehicle sensor and communication system 5210.

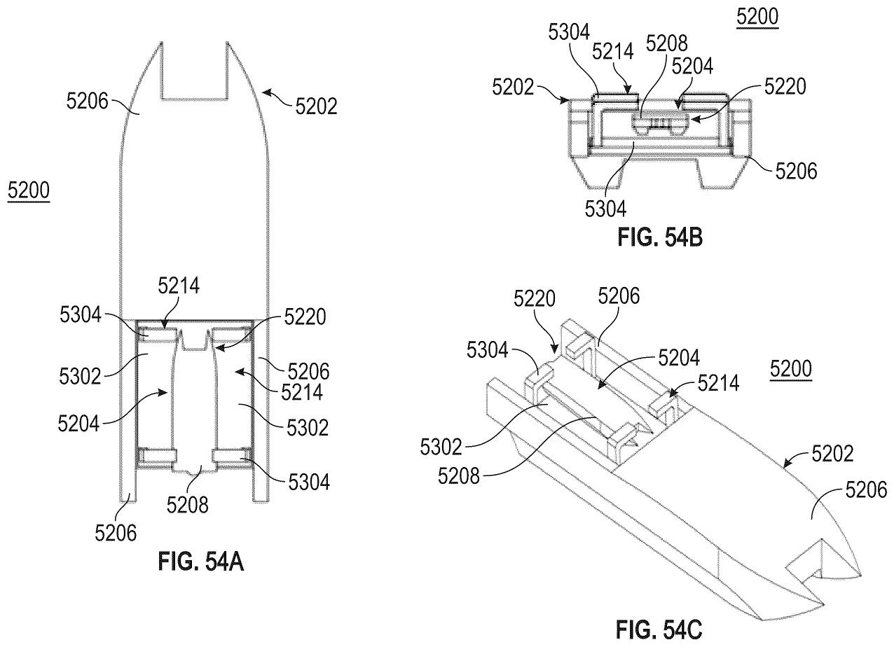

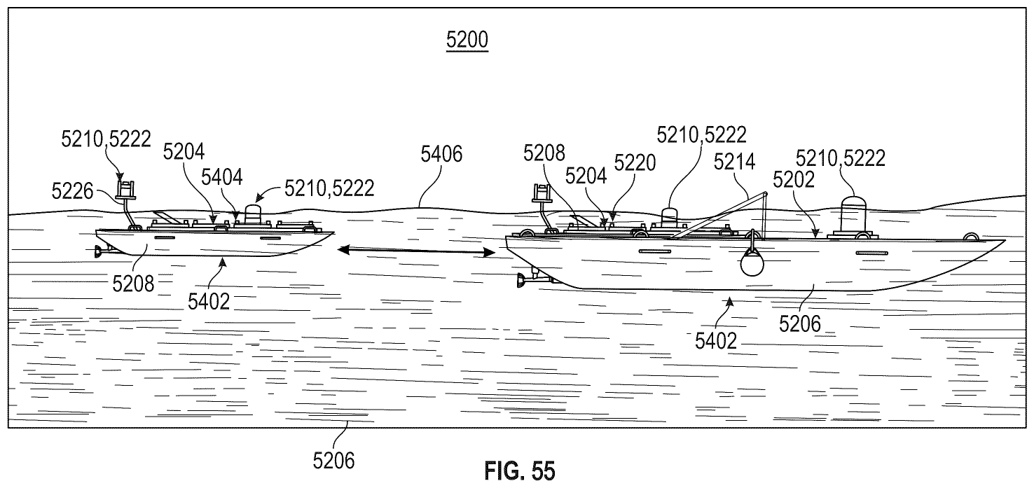

The guest vehicle 5204 may be moveable between a stowed state 5220 and a deployed state 5404, as illustratively shown in FIGS. 55 and 56. The stowed state 5220 may be defined as the guest vehicle 5204 and/or the guest vehicle body 5208 being at least partially carried by a portion of the host vehicle 5202 and/or the host vehicle body 5206. For example, without limitation, the host vehicle 5202 and/or the host vehicle body 5206 may include a cargo area, such as a cradle 5302, perhaps as best illustratively shown in FIGS. 54A-54C. The cradle 5302 may be sized and/or configured to carry a guest vehicle 5204 in the stowed state 5220. The cradle 5302 may have a size and/or configured to carry one or more guest vehicles 5204.

The cradle 5302 may also be sized and/or configured to allow for a rear portion of the guest vehicle(s) 5204 to not be extending further from the host vehicle 5202 and/or from the host vehicle body 5206 compared to a rear portion of the host vehicle 5202 and/or the host vehicle body 5206 when the guest vehicle 5204 is in the stowed state 5220. The deployed state 5404 of the guest vehicle 5204 may be defined as when the guest vehicle 5204 and/or guest vehicle body 5208 is not being carried by the host vehicle 5202 and/or the host vehicle body 5206. Also, without limitation, the deployed state 5404 of the guest vehicle 5204 may be defined as the guest vehicle 5204 and/or guest vehicle body 5208 being separate and spaced apart from the host vehicle 5202 and/or the host vehicle body 5206.

The securing system 5214 of the host vehicle 5202 may be in communication with the host vehicle control system 7102 and may be operable to selectively engage the guest vehicle(s) 5204 when the guest vehicle(s) 5204 is/are in the stowed state 5220. The securing system 5214 may be operable to move between a locked state and an unlocked state to selectively allow and/or prevent a guest vehicle 5204 carried by the host vehicle 5202 to move between the stowed state 5220 and the deployed state 5404. The locked state of the securing system 5214 may be defined as when at least a portion of the securing system 5214 is engaged with at least a portion of the guest vehicle 5204 and/or the guest vehicle body 5208, which may cause the guest vehicle 5204 and/or guest vehicle body 5208 to be prevented from moving to the deployed state 5404 from the stowed state 5220. The unlocked state of the securing system 5214 may be defined as when the securing system 5214 is not engaged with the guest vehicle 5204 and/or the guest vehicle body 5208, such that the guest vehicle 5204 and/or guest vehicle body 5208 is not prevented from moving to, from, and/or between the stowed state 5220 and the deployed state 5404.

In some embodiments of the unmanned vehicle system 5200, the guest vehicle 5204 may comprise one or more guest vehicle securing members 5502, and the securing system 5214 of the host vehicle 5202 may comprise one or more securing units 5304. The guest vehicle securing members 5502 may be positioned on/at, and/or attached to, one or more outer portions of the guest vehicle body 5208. When the guest vehicle 5204 is in the stowed state 5220, one or more of the guest vehicle securing members 5502 may be positioned adjacent to a securing unit 5304. When the securing system 5214 is in the locked state, at least one securing unit 5304 may be moved to an engaged position, which may be defined as the securing unit 5304 engaging and/or grasping a guest vehicle securing member 5502 and/or a portion of the guest vehicle 5204 and/or guest vehicle body 5208 to prevent the guest vehicle 5204 from moving to the deployed state 5404 from the stowed state 5220. When the securing system 5214 is in the unlocked state, the securing unit(s) 5304 may be moved to a disengaged position, which may be defined as the securing unit 5304 not being engaged with and/or grasping a guest vehicle securing member 5502 and/or a portion of the guest vehicle 5204 and/or guest vehicle body 5208 so the guest vehicle 5204 may be moveable between the stowed state 5220 and the deployed state 5404.

The host vehicle buoyancy system 7116 may be carried by the host vehicle body 5206 and may be in communication with the host vehicle control system 7102. The host vehicle buoyancy system 7116 may be operable to control and regulate outside environment water 5406 flowing into and out from the host vehicle body 5206 to move the host vehicle body 5206 between a surfaced state 5405 and a submerged state 5402. Similarly, the guest vehicle buoyancy system 7116 may be carried by the guest vehicle body 5208 and may be in communication with the guest vehicle control system 7102. The guest vehicle buoyancy system 7116 may be operable to control and regulate outside environment water 5406 flowing into and out from the guest vehicle body 5208 to move the guest vehicle body 5208 between a surfaced state 5405 and a submerged state 5402. The surfaced states 5405 and submerged states 5402 of the host vehicle 5202 and the guest vehicle 5204 are illustratively shown in FIGS. 55-56.

The submerged state 5402 of the host vehicle 5202 and/or host vehicle body 5206 may be defined as when an upper deck surface of the host vehicle body 5206 is below the surface of the outside environment water 5406. The submerged state 5402 of the guest vehicle 5204 and/or guest vehicle body 5208 may be defined as when an upper deck surface of the guest vehicle body 5208 being below the surface of the outside environment water 5406. The surfaced state 5405 of the host vehicle 5202 and/or host vehicle body 5206 may be defined as when at least a portion of the upper deck surface of the host vehicle body 5206 is above the surface of the outside environment water 5406, and the surfaced state 5405 of the guest vehicle 5204 and/or guest vehicle body 5208 may be defined as when at least a portion of the upper deck surface of the guest vehicle body 5208 is above the surface of the outside environment water 5406.

The host vehicle control system 7102 may be in communication with the guest vehicle buoyancy system 7116. The guest vehicle buoyancy system 7116 may be operable and controllable by the host vehicle control system 7102 to cause the guest vehicle buoyancy system 7116 to move the guest vehicle 5204 and/or guest vehicle body 5208 between the surfaced state 5405 and the submerged state 5402. The host vehicle sensor and communication system 5210 may sense and/or detect a water depth of the host vehicle body 5206. The guest vehicle sensor and communication system 5210 may sense and/or detect a water depth of the guest vehicle body 5208. The host vehicle control system 7102 may be operable to determine when the water depth of the guest vehicle body 5208 is about equal to a predetermined submerging depth and/or to a predetermined surfacing depth.

Also, the guest vehicle control system 7102 may be operable to determine when the water depth of the guest vehicle body 5208 is about equal to a predetermined submerging depth and/or to a predetermined surfacing depth. The guest vehicle control system 7102 may send a surfacing depth signal to the host vehicle control system 7102 responsive to the depth of the guest vehicle body 5208 being about equal to the predetermined surfacing depth. Also, the guest vehicle control system 7102 may send a submerging depth signal to the host vehicle control system 7102 responsive to the water depth of the guest vehicle body 5208 being about equal to the predetermined submerging depth.

The predetermined surfacing depth may be defined as at least a portion of the upper deck surface of the guest vehicle body 5208 being above the surface of the outside environment water 5406. Alternatively, without limitation, the predetermined surfacing depth may be defined as one or more air valves 7408 carried by the guest vehicle body 5208 being above the surface of the outside environment water 5406. The host vehicle 5202 may also comprise one or more air valves 7408 carried by the host vehicle body 5206. Further detail on the air valves 7408 follows below.

The host vehicle control system 7102 may be operable to cause and/or control the guest vehicle buoyancy system 7116 to move the guest vehicle body 5208 to the submerged state 5402 and/or to the surfaced state 5405 responsive to the water depth of the host vehicle body 5206 and/or the water depth of the guest vehicle body 5208 being about equal to the predetermined submerging depth and/or to the predetermined surfacing depth. For example, without limitation, when the guest vehicle 5204 and/or guest vehicle body 5208 is in the stowed state 5220 and when the host vehicle 5202 and guest vehicle 5204 are in the submerged state 5402, as the host vehicle 5202/host vehicle body 5206 is moving to the surfaced state 5405, the host vehicle control system 7102 may cause and/or control the guest vehicle buoyancy system 7116 to begin moving the guest vehicle body 5208 to the surface state 5405 responsive to the water depth of the guest vehicle body 5208 being about equal to the predetermined surfacing depth and/or responsive to the surfacing depth signal.

For another example, without limitation, when the guest vehicle 5204 and/or guest vehicle body 5208 is in the stowed state 5220 and when the host vehicle 5202 and guest vehicle 5204 are in the surfaced state 5405, as the host vehicle 5202/host vehicle body 5206 is moving to the submerged state 5402, the host vehicle control system 7102 may cause and/or control the guest vehicle buoyancy system 7116 to begin moving the guest vehicle body 5208 to the submerged state 5402 responsive to the water depth of the guest vehicle body 5208 being about equal to the predetermined submerging depth and/or responsive to the submerging depth signal. Additional details on the buoyancy systems 7116 of the host vehicle 5202 and guest vehicle 5204 follows further below.

The guest vehicle 5204 and/or the guest vehicle body 5208 may be movable between the stowed state 5220 and the deployed state 5404 when the securing system 5214 is in the unlocked state and when the host vehicle 5202 and guest vehicle 5204 are both in the submerged state 5402 and/or are both in the surfaced state 5405. However, without limitation, in some embodiments of the present invention the guest vehicle 5204 and/or guest vehicle body 5208 may only be able to move between the stowed state 5220 and the deployed state 5404 when both the host vehicle 5202 and guest vehicle 5204 are in the submerged state 5402, and while the securing system 5214 is in the unlocked state. Those skilled in the art may notice and appreciate that both the guest vehicle 5204 and host vehicle 5202 being able to be in the submerged state 5402 advantageously allows for the guest vehicle 5204 to move between the stowed state 5220 and the deployed state 5404 while the weight of the guest vehicle 5204 is being supported by the outside environment water 5406 such that the guest vehicle 5204 may move between the stowed state 5220 and the deployed state 5404 at substantially low speeds and without the guest vehicle body 5208 exerting a substantial force against the host vehicle body 5206, and such that the chances of detection of the guest vehicle 5204 and/or host vehicle 5202 are lower compared to if the guest vehicle body 5208 applied a substantial force against the host vehicle body 5206 when moving between the stowed state 5220 and the deployed state 5404.

In some embodiments of the unmanned vehicle system 5200, the host vehicle control system 7102 may be the centralized controller and/or commander of the host vehicle 5202 and the guest vehicle 5204 to move the guest vehicle 5204/guest vehicle body 5208 between the stowed state 5220 and the deployed state 5404. For example, without limitation, when moving the guest vehicle 5204 to the deployed state 5404 from the stowed state 5220, the host vehicle control system 7102 may command and control each of the host vehicle buoyancy system 7116, the host vehicle maneuvering system 5224, the securing system 5214, the guest vehicle buoyancy system 7116, and the guest vehicle maneuvering system 5224 until the guest vehicle 5204/guest vehicle body 5208 is in the deployed state 5404 and/or until the host vehicle control system 7102 determines that the guest vehicle 5204/guest vehicle body 5208 is a predetermined distance away from the host vehicle 5202/host vehicle body 5206.

For another example, without limitation, when moving the guest vehicle 5204 to the stowed state 5220 from the deployed state 5404, the host vehicle control system 7102 may command and control each of the host vehicle buoyancy system 7116, the host vehicle maneuvering system 5224, the securing system 5214, the guest vehicle buoyancy system 7116, and the guest vehicle maneuvering system 5224 until the guest vehicle 5204/guest vehicle body 5208 is in the stowed state 5220. The host vehicle control system 7102 may be operable to the commence command and control of the guest vehicle 5204 to move to the stowed state 5220 responsive to the host vehicle control system 7102 determining that the guest vehicle 5204/guest vehicle body 5208 is at a relative distance from the host vehicle 5202/host vehicle body 5206 that is within a predetermined proximity.

The host vehicle sensor and communication system 5210 may be operable to detect a relative distance between the host vehicle 5202 and other objects, such as, between the host vehicle 5202 and the guest vehicle 5204. The host vehicle sensor and communication system 5210 may send a relative distance signal to the host vehicle control system 7102 relating to the relative distance detected, and the host vehicle control system 7102 may determine if the relative distance between the host vehicle 5202 and the guest vehicle 5204 is within the predetermined proximity based on the relative distance detected/the relative distance signal received thereby.

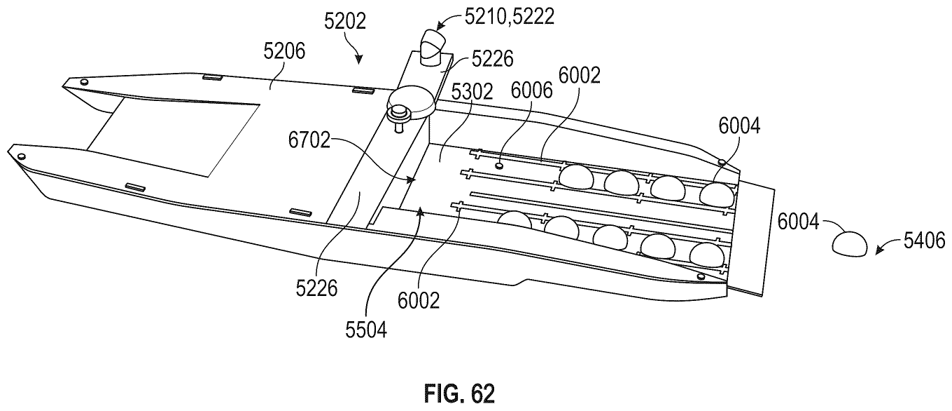

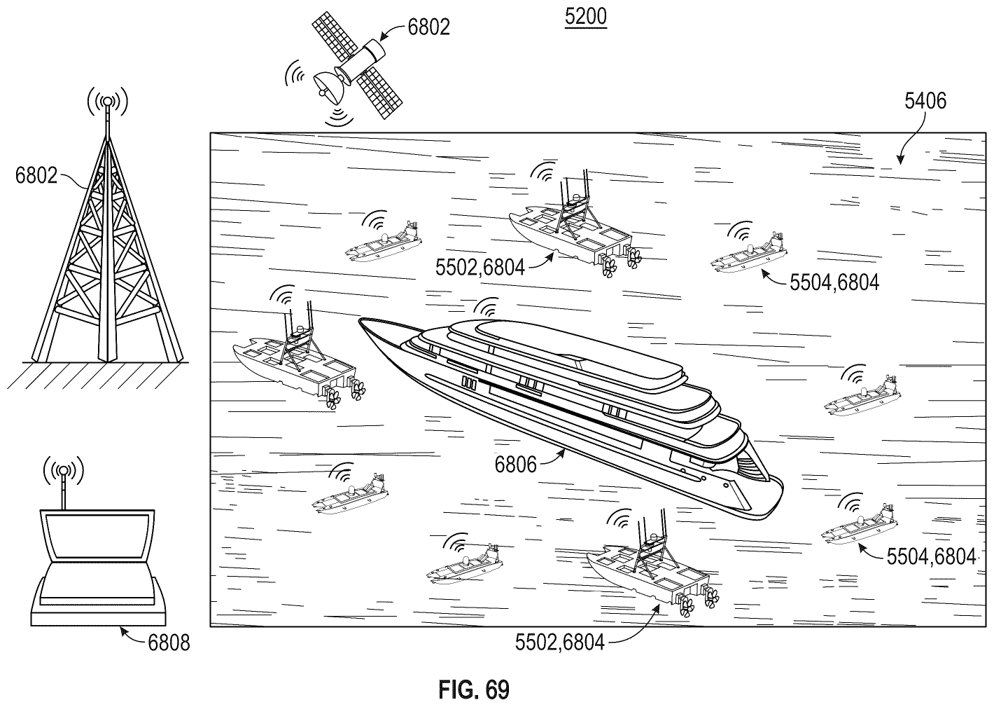

With reference to FIG. 69, some embodiments of the unmanned vehicle system 5200 may include a host vehicle 5202 that may be operable to be in communication with multiple guest vehicles 5204. The communication between the host vehicle 5202 and the guest vehicles 5204 may be centralized on the host vehicle 5202. The host vehicle 5202 may command and control each one of the guest vehicles 5204 that the host vehicle 5202 is in communication therewith. For example, without limitation, the host vehicle 5202/host vehicle control system 7102 may control and command the guest vehicle control system 7102, the guest vehicle sensor and communication system 5210, the guest vehicle maneuvering system 5224, the guest vehicle buoyancy system 7116 of the guest vehicles 5204 in communication with the host vehicle 5202. Additionally, in some embodiments of the unmanned vehicle system 5200, the host vehicle(s) 5202 and/or guest vehicle(s) 5204 may include a payload deployment system 6002 and/or one or more action units 7114 as illustrated in FIGS. 62, 68, and 72. In some of these embodiments, the host vehicle 5202/host vehicle control system 7102 may be operable to command and control the action unit(s) 7114 and/or payload deployment systems 6002 of each guest vehicle 5204 in communication with the host vehicle 5202.

In some embodiments of the present invention, the host vehicle(s) 5202 and guest vehicle(s) 5204 may be operable to be in communication with one or more of a network 6802, a user device 6808, an associate device 6806, and/or another vehicle 6804. The communications to, from, and/or between each of the host vehicle(s) 5202, the guest vehicle(s) 5204, the user device(s) 6808, the associate device(s) 6806, and the other vehicle(s) 6804 may be by direct communications and/or via the network 6802. The host vehicle(s) 5202 and/or guest vehicle(s) 5204 may be operable to be commanded and controlled by the user device(s) 6808, the associate device(s) 6806, and/or the other vehicle(s) 6804. The network 6802 may comprise a wireless network that utilizes communication via signals that may comprise radio signals, infrared signals, microwave signals, acoustic signals, visible light signals, and/or via satellite communications.

In some embodiments of the present invention, the unmanned vehicle system 5200 may include a plurality of guest vehicles 5204. One or more of the guest vehicles 5204 may be operable to send operation signals to one or more of the other guest vehicles 5204 to command and control the guest vehicles 5204 that receive the operation signal(s). Additionally, some embodiments of the unmanned vehicle system 5200 may include more than one host vehicle 5202 and/or more than one guest vehicle 5204. Each host vehicle 5202 and/or each guest vehicle 5204 may be operable to be in communication with one another and each other to form and/or define a mesh network. One or more of the host vehicles 5202 and/or one or more of the guest vehicles 5204 within the mesh network may command and control the other host vehicles 5202 and/or guest vehicles 5204 a part of the mesh network. Each host vehicle 5202 and/or guest vehicle 5204 within the mesh network may be operable to share and coordinate all data, commands, and controls to, from, and/or between one another via the mesh network.

The host vehicle(s) 5202 and/or guest vehicle(s) 5204 of the mesh network may also be in communication with one or more of a user device 6808, an associate device 6806, and/or another vehicle 6804, which may be communication via direct communication with one or more of the host vehicle(s) 5202 and/or guest vehicle(s) 5204 a part of the mesh network, and/or may comprise the user device(s) 6808, the associate device(s) 6806, and/or the other vehicle(s) 6804 being included within the mesh network. One or more host vehicle 5202 and/or guest vehicle 5204 of the mesh network may be operable to share data with and/or relay data to the user device(s) 6808, the associate device(s) 6806, and/or the other vehicle(s) 6804. The data shared and/or relayed to the user device(s) 6808, the associate device(s) 6806, and/or the other vehicle(s) 6804 may comprise live data and/or recorded data provided by the vehicle sensor and communication system 5210 of at least one host vehicle 5202 and/or guest vehicle 5204 a part of the mesh network.

The associate device(s) 6806 may comprise may include third party devices or systems able to be in communication with at least one host vehicle 5202 and/or guest vehicle 5204. Examples of an associate device 6806 include, without limitation, a ship, a vessel, a boat, a vehicle, a command center, and/or other maritime vessels. For example, an associate device 6806 may include a ship and/or maritime vessel as illustrated in FIG. 69.

The other vehicle(s) 6804 may comprise one or more embodiments of a host vehicle 5202 or guest vehicle 5204. For the purposes of the description of the embodiments of the present invention herein, without limitation, it should be understood that the use of the term “other vehicle 6804” or “other vehicles 6804” may mean, and may be used interchangeably with “guest vehicle 5204” or “host vehicle 5202.” As such, without limitation, the use of the term other vehicle 6804 may be used interchangeably with and/or instead of reciting “another” host vehicle 5202 and/or guest vehicle 5204 or “other” host vehicle 5202 and/or guest vehicle 5204.

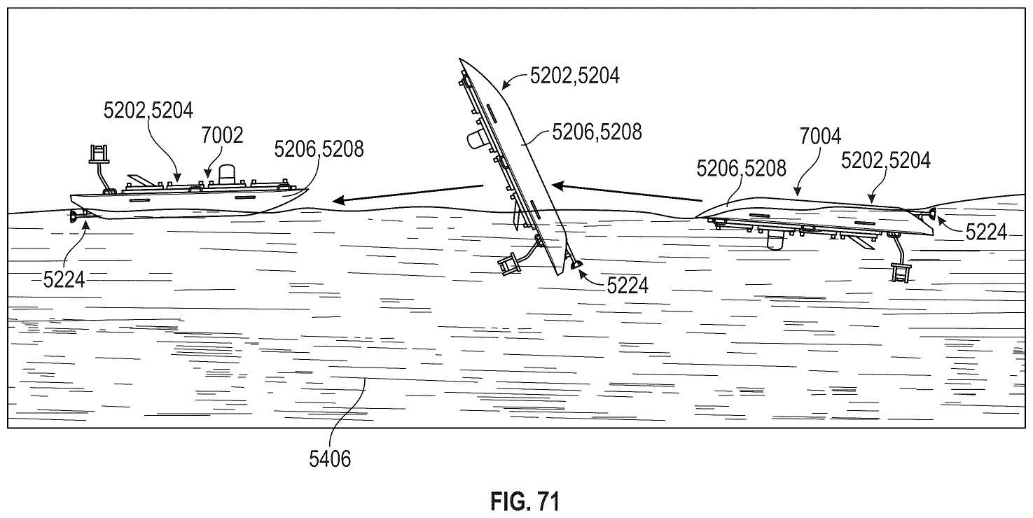

Now referring to FIG. 71 more specifically, the host vehicle 5202 and/or guest vehicle 5204 may be able to move between an upright state 7002 and a turned-over state 7004. Specifically, the host vehicle 5202 and/or guest vehicle 5204 may be able to “self-right” itself to the upright state 7002 from the turned-over state 7004. When the host vehicle 5202 and/or guest vehicle 5204 is in the turned-over state 7004, the host vehicle control system 7102/guest vehicle control system 7102 may be operable to control the host vehicle maneuvering system 5224/guest vehicle maneuvering system 5224 to propel the host vehicle body 5206/guest vehicle body 5208 so that the host vehicle 5202/guest vehicle 5204 may flip-over and/or move from the turned-over state 7004 to the upright state 7002. The guest vehicle sensor and communication system 5210 and/or host vehicle sensor and communication system 5210 may detect the orientation of the host vehicle body 5206 and/or guest vehicle body 5208 to detect whether the host vehicle body 5206/guest vehicle body 5208 is in the upright state 7002 or the turned-over state 7004.

The upright state 7002 may be defined as when a lower face of the host vehicle 5202/host vehicle body 5206 and/or guest vehicle 5204/guest vehicle body 5208 is at least partially facing in a downwards direction with respect to the direction of gravity. The turned-over state 7004 may be defined as when the lower face of the host vehicle 5202/host vehicle body 5206 and/or guest vehicle 5204/guest vehicle body 5208 is at least partially facing in an upwards direction with respect to the direction of gravity.

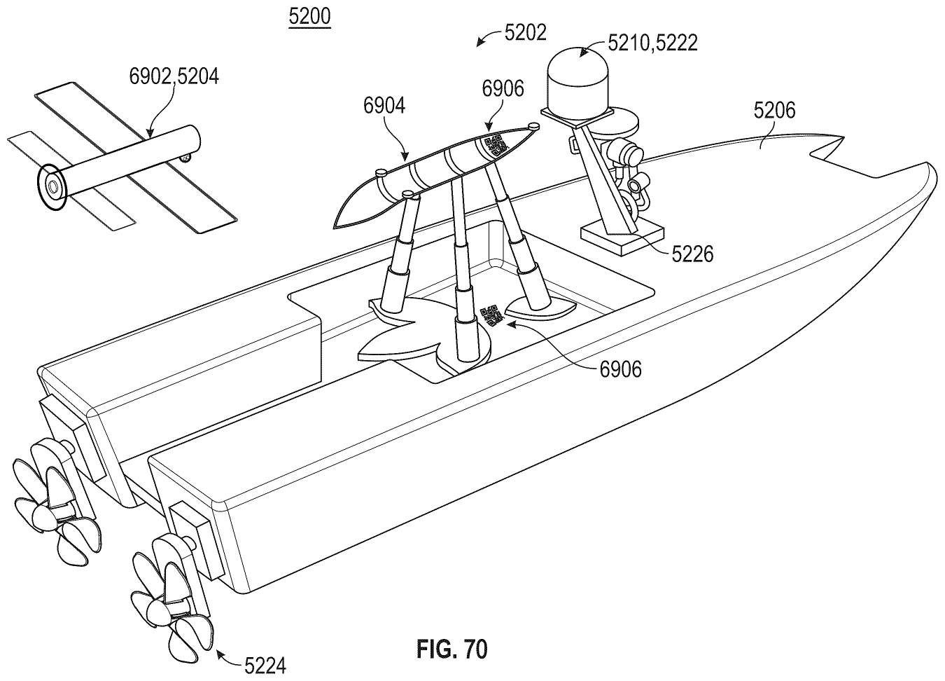

Now referring to FIG. 70, in some embodiments of the unmanned vehicle system 5200, the host vehicle 5202 and/or the guest vehicle 5204 may include an aerial vehicle pad 6904. The aerial vehicle pad 6904 may be carried by the host vehicle body 5206. The aerial vehicle pad 6904 may be sized and adapted to catch the aerial vehicle 6902. The aerial vehicle pad 6904 may have support legs and a catching portion that may have a shape and size similar to a fuselage of the aerial vehicle 6902. The aerial vehicle pad 6904 may be operable by the host vehicle control system 7102 to releasably secure the aerial vehicle 6902 when the aerial vehicle 6902 is landed on the aerial vehicle pad 6904.

Examples of the aerial vehicle 6902 include, without limitation, an aerial drone, and an unmanned aerial vehicle. The aerial vehicle pad 6904 may include an identification code 6906 displayed on an upper portion of the aerial vehicle pad 6904. In some embodiments, the identification code 6906 may be displayed on an upper portion of the host vehicle 5202. The aerial vehicle 6902 may be configured to identify and track the identification code 6906 to identify and track the host vehicle 5202 and to use as a guide to orient and land the aerial vehicle 6902 on the aerial vehicle pad 6904.

Now referring to FIG. 72, as mentioned above the host vehicles 5202 and/or guest vehicles 5204 of embodiments of the unmanned vehicle system 5200 may comprise a vehicle control system 7102, a vehicle maneuvering system 5224, a vehicle sensor and communication system 5210, and a vehicle buoyancy system 7116. In some embodiments, the host and/or guest vehicle 5204 may also include an onboard power supply 7118, a payload deployment system 6002, and an action unit 7114. Also, in some embodiments the host vehicle 5202 may include an aerial vehicle pad 6904 and/or a securing system 5214. It should be understood, that although FIG. 72 is a schematic illustration of components of both the host vehicle 5202 and guest vehicle 5204 and also includes a depiction of a securing system 5214, embodiments of the guest vehicle 5204 may or may not also include a securing system 5214 as described for some embodiments of the host vehicle 5202 herein. However, in some preferred embodiments, the guest vehicle 5204 does not include a securing system 5214.

The host vehicle control system 7102 may be operable to command, control, monitor, commands, and manage each one of the host vehicle maneuvering system 5224, the host vehicle sensor and communication system 5210, the securing system 5214, the host vehicle buoyancy system 7116, the onboard power supply 7118, payload deployment system 6002, the aerial vehicle pad 6904, and/or the action unit 7114. The guest vehicle control system 7102 may be operable to control, monitor, command, and manage each one of the guest vehicle maneuvering system 5224, the guest vehicle sensor and communication system 5210, the guest vehicle buoyancy system 7116, the guest vehicle 5204 onboard power supply 7118, the guest vehicle 5204 payload deployment system 6002 and the guest vehicle 5204 action unit 7114.

The host vehicle control system 7102 and the guest vehicle control system 7102 may be operable to send, receive, read, write, store, encrypt, decrypt, compute, execute, run, interpret, and/or manage machine-readable code, information, executables, commands, and/or data. The host vehicle control system 7102 and/or guest vehicle control system 7102 may include, without limitation, one or more of a processor, a controller, a microcontroller, a field-programmable gate array, a non-field-programmable gate array, a graphics processing unit, a random-access memory, a non-volatile machine readable memory, a volatile machine readable memory, a data storage unit, a communication bus, a co-processor, an audio processing unit, and/or any other component as may be understood by those who may have skill in the art.

The host vehicle control system 7102 and/or the guest vehicle control system 7102 may be operable to be in communication with one or more user devices 6808 to send real-time video captured by the host vehicle sensor and communication system 5210 and/or the guest vehicle sensor and communication system 5210. The host vehicle control system 7102 and/or guest vehicle control system 7102 may be in communication with user devices 6808 via the network 6802 and/or via the host vehicle sensor and communication system 5210 and/or guest vehicle sensor and communication system 5210.

In some embodiments of the present invention the control systems 7102 and/or sensor and communication systems 5210 may be operable to authenticate communication therewith and/or to filter communication therewith. For example, without limitation, the control systems 7102 and/or sensor and communication systems 5210 may authenticate communication therewith and/or to filter communication therewith by disallowing and/or filtering communication(s) received thereby which do not include one or more predetermined authentication characteristics and/or predetermined authentication keys.

In some embodiments of the present invention the control systems 7102 and/or sensor and communication systems 5210 may be positionable in communication with third-party hardware devices (not shown). The control systems 7102 and/or sensor and communication systems 5210 may be configured to adapt to the communication type, data type, input type, and output type of a third-party hardware positioned in communication with the control system 7102 and/or sensor and communication system 5210 of the host vehicle 5202 and/or guest vehicle 5204, such that the third-party hardware may be integrated with and operable by the host vehicle 5202 and/or guest vehicle 5204.

The communication between the third-party hardware and the control systems 7102 and/or sensor and communication systems 5210 may be via a rail system 5804 carried by the host vehicle 5202 and/or guest vehicle 5204, and the third-party hardware may be housed by one or more internal housings 5802 which may be mounted on the rail system 5804. In some embodiments, the third-party hardware may be mounted on the host vehicle body 5206 and/or guest vehicle body 5208, and/or the third-party hardware may be mounted on a support body 5226 carried by the host vehicle 5202 and/or guest vehicle 5204. Details on the internal housings 5802, the rail system 5804, and the support body 5226 follows further below.

Now referring to FIGS. 52, 58, 64-65, 67A-67D, and 72-73, the host vehicle maneuvering system 5224 may be carried by the host vehicle body 5206 and may be in communication with the host vehicle control system 7102, the host vehicle sensor and communication system 5210, the host vehicle buoyancy system 7116, and host vehicle 5202 onboard power supply 7118, and/or the securing system 5214. The host vehicle maneuvering system 5224 may comprise one or more of a rudder 5604, a propeller 5216, a bow or aft thruster 6502, a vertical thruster 6602, and/or a drive unit 7202. The host vehicle maneuvering system 5224 may be operable to provide propulsion to, and control the movement and orientation of, the host vehicle 5202/host vehicle body 5206.

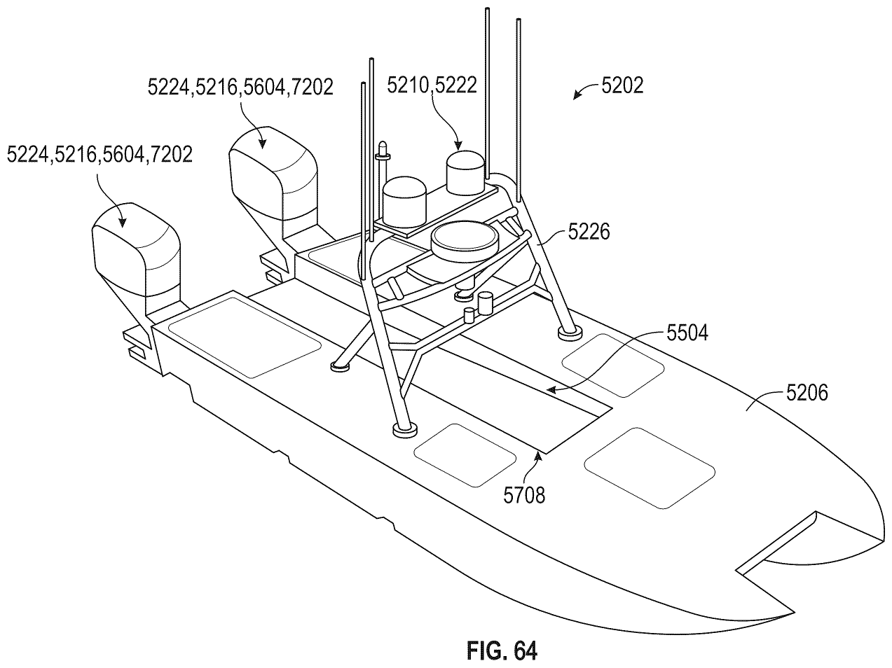

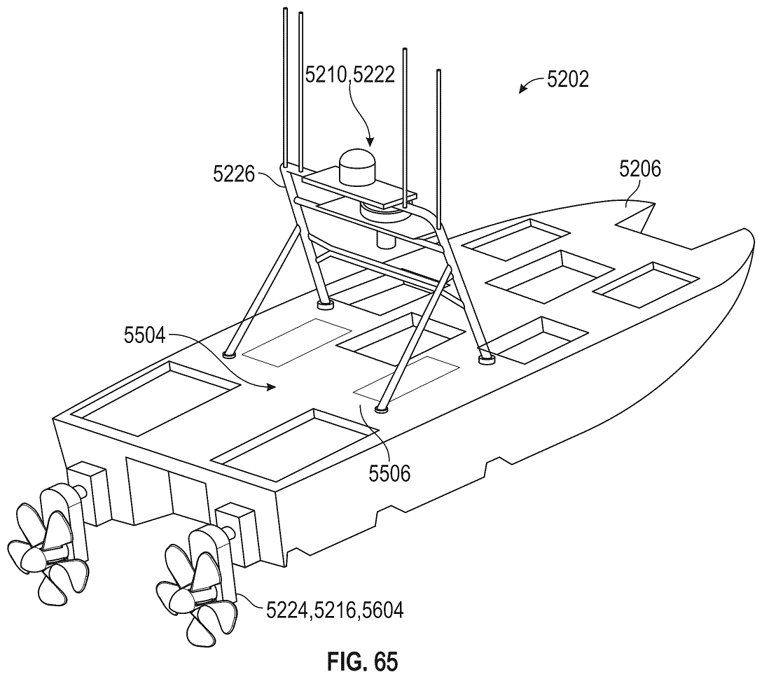

In some embodiments, the rudder 5604, propeller 5216, and drive unit 7202 may be comprise a single monolithic unit as illustrated in FIG. 64, similar to and outboard motor unit as may be understood by those who may have skill in the art. In other embodiments, the rudder 5604 and propeller 5216 may comprise a single monolithic unit as illustrated in FIG. 65, similar to an inboard motor unit as may be understood by those who may have skill in the art. The drive unit 7202 of the host vehicle 5202 may be utilized to provide for control and power to the rudder(s) 5604 and propeller(s) 5216. Examples of the drive unit 7202, without limitation, include a combustion fuel engine, a transmission, a gear box, and an electric motor.

The guest vehicle maneuvering system 5224 may be carried by the guest vehicle body 5208 and may be in communication with the guest vehicle control system 7102, the guest vehicle sensor and communication system 5210, the guest vehicle buoyancy system 7116, and/or the guest vehicle 5204 onboard power supply 7118. The guest vehicle maneuvering system 5224 may comprise one or more of a rudder 5604, a propeller 5216, a bow or aft thruster 6502, a vertical thruster 6602, and/or a drive unit 7202. The guest vehicle maneuvering system 5224 may be operable to provide propulsion to, and control the movement and orientation of, the guest vehicle 5204/guest vehicle body 5208.

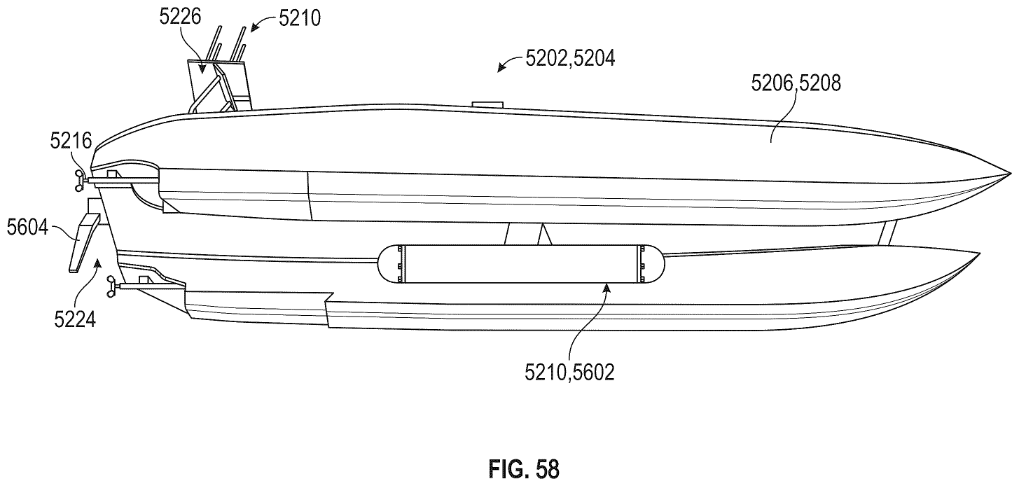

In some embodiments, the rudder 5604 and propeller 5216 of the guest vehicle 5204 may comprise a single monolithic unit as illustrated in FIG. 58, similar to an inboard motor unit as may be understood by those who may have skill in the art. The propellers 5216 may comprise turn-screw style propellers. The drive unit 7202 of the guest vehicle 5204 may be utilized to provide for control and power to the rudder(s) 5604 and propeller(s) 5216. Examples of the drive unit 7202, without limitation, include a combustion fuel engine, a transmission, a gear box, and an electric motor. However, in some preferred embodiments, the guest vehicle maneuvering system 5224 and/or drive unit 7202 comprises an electric motor.

The host vehicle maneuvering system 5224 may be operable to propel the host vehicle 5202 at a speed up to 80 knots and/or up over at least 140 knots. The host vehicle maneuvering system 5224 may be operable to provide the host vehicle 5202 with a travel range up to and between about 250 and 1,100 nautical miles. In some embodiments of the present invention, the host vehicle 5202 may comprise the dimensions of about a 24-foot length, a 10-foot width, a 3.5-foot hull height, and/or a 14-inch draft. In some embodiments, the host vehicle 5202 may comprise the dimensions of about a 38-foot length, an 11-foot width, a 4.5-foot hull height, and/or a 14-inch draft. In some embodiments, the host vehicle 5202 may have a weight of about 8,500 pounds and/or about 12,000 pounds. The host vehicle 5202 may be adapted to carry about 1,800 pounds of additional weight and/or about 3,500 pounds of additional weight. In some embodiments, the host vehicle 5202 may be adapted to have an ocean survivability level (SS“#”) up to SS5 and SS7, as may be understood by one who may have skill in the art. In some embodiments, the host vehicle 5202 may be adapted to include manual controls and to carry and allow for one or more crewmembers to operate and control the host vehicle 5202.

The guest vehicle maneuvering system 5224 may be operable to propel the guest vehicle 5204 at a speed up to about 30 knots. The guest vehicle maneuvering system 5224 may be operable to provide the guest vehicle 5204 with a travel range of about 43 nautical miles. The guest vehicle 5204 may comprise a guest vehicle body 5208 that may have the dimensions of about a 12-foot length, a 3-foot width, a 14-inch height, and/or a 7-inch draft. Also, the guest vehicle 5204 may have a guest vehicle body 5208 that has the dimensions of about an 18-foot length, a 71-inch beam, a 50-inch height, a 28-inch deck height, and/or a 7-inch draft. Some embodiments of the guest vehicle 5204 may have a weight of about 405 pounds and/or 2,200 pounds, and some embodiments of the guest vehicle 5204 may be adapted to carry 140 pounds of additional weight and/or 750 pounds of additional weight. Some embodiments of the guest vehicle 5204 may be adapted to have an ocean survivability level (SS“#”) up to SS3 and/or SS4, as may be understood by one who may have skill in the art. In some embodiments, the guest vehicle 5204 may be adapted to include manual controls and to carry and allow for one or more crewmembers to operate and control the host vehicle 5202.

In some embodiments, the host vehicle maneuvering system 5224/guest vehicle maneuvering system 5224 of the host vehicle 5202 and/or guest vehicle 5204 may comprise one or more bow/aft thrusters 6502. The bow/aft thrusters 6502 may be mounted on an outer portion of the host vehicle body 5206 and/or guest vehicle body 5208. Also, one or more bow/aft thrusters 6502 may be mounted on one or more forward outer portions of the host vehicle body 5206 and/or guest vehicle body 5208, which may be referred to as bow thrusters 6502. Moreover, one or more bow/aft thrusters 6502 may be mounted on one or more rearward outer portions of the host vehicle body 5206 and/or guest vehicle body 5208, which may be referred to as aft thrusters 6502.

The bow/aft thrusters 6502 may be operable to control the orientation of the host vehicle body 5206 and/or guest vehicle body 5208 substantially along a horizontal plane of the host vehicle body 5206 and/or guest vehicle body 5208. For example, without limitation, the bow/aft thrusters 6502 may control the sway and/or yaw orientation(s) of the host vehicle body 5206 and/or guest vehicle body 5208, as may be understood by those who may have skill in the art. The bow/aft thrusters 6502 may be in communication with and operable by the host vehicle control system 7102 and/or the guest vehicle control system 7102. The bow/aft thrusters 6502 may be in communication with an onboard power supply 7118 and/or the drive unit 7202 to receive power therefrom. More detail on the onboard power supply 7118 follows below.

In some embodiments, the host vehicle maneuvering system 5224/guest vehicle maneuvering system 5224 of the host vehicle 5202 and/or the guest vehicle 5204 may include vertical thrusters 6602. The vertical thrusters 6602 may be mounted on one or more outer portions of the host vehicle body 5206 and/or of the guest vehicle body 5208. The vertical thrusters 6602 may be in communication with and be operable by the host vehicle control system 7102/guest vehicle control system 7102. The vertical thrusters 6602 may be operable to propel the host vehicle 5202/the host vehicle body 5206 and/or the guest vehicle 5204/guest vehicle body 5208 in a direction that may be in an upwards and/or a downwards facing direction. The vertical thrusters 6602 may also be operable to control orientation of the host vehicle 5202/host vehicle body 5206 and/or guest vehicle 5204/guest vehicle body 5208. For example, without limitation, the vertical thrusters 6602 may be operable to control the heave, pitch, and/or roll orientation(s) the host vehicle body 5206 and/or guest vehicle body 5208, as may be understood by those who may have skill in the art.

In some embodiment of the present invention, the guest vehicle maneuvering system 5224, the guest vehicle 5204, the host vehicle maneuvering system 5224, and/or the host vehicle 5202 may include a maneuvering system controller 7106. The maneuvering system controller 7106 may be in communication with one or more of the rudder 5604, the propellers 516, the bow/aft thrusters 6505, the vertical thrusters 6602, and/or the drive unit 7202. The maneuvering system controller 7106 may be incorporated into the vehicle control systems 7102 of the host vehicle 5202 and/or guest vehicle 5204, and the maneuvering system controller 7106 may be separate and apart from and in communication with the vehicle control systems 7102 of the host vehicle 5202 and/or guest vehicle 5204. The maneuvering system controller 7106 may be and operable to control one or more of the rudder 5604, the propellers 516, the bow/aft thrusters 6505, the vertical thrusters 6602, and/or the drive unit 7202.

The maneuvering system controller 7106 may be in communication with the guest vehicle sensor and communication system 5210 and/or host vehicle sensor and communication system 5210 and may be operable to control one or more of the rudder 5604, the propellers 516, the bow/aft thrusters 6505, the vertical thrusters 6602, and/or the drive unit 7202 based on signals received from the sensor and communication system(s) 5210. Also, the maneuvering system controller 7106 may be operable to control one or more of the rudder 5604, the propellers 516, the bow/aft thrusters 6505, the vertical thrusters 6602, and/or the drive unit 7202 based on commands received from the vehicle control systems 7102 of the host vehicle 5202 and/or guest vehicle 5204. Additionally, some embodiments of the present invention may not include a maneuvering system controller 7106 and may instead include and/or incorporate one or more of the functions and/or limitations of the maneuvering system controller 7106 into the host vehicle control system 7102/guest vehicle control system 7102 and utilized/operated thereby.

In some embodiments, the maneuvering system controller 7106 may include and/or incorporate a position instruction calculator. The position instruction calculator may be operable to determine an optimal position of the host vehicle 5202 and the guest vehicle 5204 when the host vehicle 5202 and guest vehicle 5204 are maneuvering and/or propelling themselves. The position instruction calculator may also be operable to determine an approach path for the host vehicle 5202 and/or guest vehicle 5204 with respect to a determined and/or predetermined location.

The determined location and/or predetermined location may be associated with a mission plan 4303. The determined location and/or predetermined location may be identified and/or determined by the host vehicle 5202, host vehicle control system 7102, guest vehicle 5204, and/or guest vehicle control system 7102 based on the mission plan 4303 and/or one or more operation factors that are described further below.

Continuing to refer to FIG. 72, the host vehicle 5202 and/or guest vehicle 5204 may comprise an onboard power supply 7118. The onboard power supply 7118 may be in communication with each and/or one or more of the components of the host vehicle 5202 and/or guest vehicle 5204. The onboard power supply 7118 may be operable to provide power to the components in communication therewith. Examples of the onboard power supply 7118 include, without limitation, power cells, batteries, a power generator, a power converter, a power transformer, a power regulator, photovoltaic members, a power distributor, a combustion engine, an electric motor, a gearbox, and/or a transmission. In some embodiments of the present invention, the onboard power supply 7118 of the host vehicle 5202 may include a combustion engine to provide power to the host vehicle maneuvering system 5224. Also, in some embodiments of the present invention, the onboard power supply 7118 of the guest vehicle 5204 may comprise an electric motor to provide power to the guest vehicle maneuvering system 5224.

Now referring to FIGS. 54A-54C, 62, 67B-67C, 72, and 76, some embodiments of the present invention may also include interfaces 6006, 6504. The host vehicle 5202 may include one or more interfaces 6006 in communication with the onboard power supply 7118 and/or the drive unit 7202 that is/are carried by the host vehicle 5202/host vehicle body 5206. The guest vehicle 5204 may include one or more interfaces 6504 in communication with the onboard power supply 7118 and/or drive unit 7202 that is/are carried by the guest vehicle 5204/guest vehicle body 5208. The interfaces 6006 of the host vehicle 5202 may be positioned on a reward surface of the host vehicle 5202. Also, in some embodiments, the host vehicle 5202/host vehicle body 5206 may comprise a cradle 5302 that may be sized and adapted to carry cargo and/or one or more guest vehicles 5204. The interfaces 6006 may be positioned within the cradle 5302, and in some embodiments one or more of the interfaces 6006 may be positioned within a forward portion of the cradle 5302.

The interfaces 6504 of the guest vehicle 5204 may be positioned on a frontal portion of the guest vehicle 5204/guest vehicle body 5208. Also, the interfaces 6504 of the guest vehicle 5204 may be positioned one a lower frontal portion of the guest vehicle 5204/guest vehicle body 5208. The interfaces 6006 of the host vehicle 5202 and the interfaces 6504 of the guest vehicle 5204 may be adapted to be in contact and/or communication with one another when the guest vehicle 5204 is in the stowed state 5220. When the interfaces 6006, 6504 are in contact/communication with one another, the interfaces 6006, 6504 may allow for power to be transferred from an onboard power supply 7118 of the host vehicle 5202 to the onboard power supply 7118 of the guest vehicle 5204 while the guest vehicle 5204 is in the stowed state 5220.

Additionally, in some embodiments of the present invention, the interfaces 6006 may be in communication with the host vehicle control system 7102 and/or the host vehicle sensor and communication system 5210, and the interfaces 6504 may be in communication with the guest vehicle control system 7102 and/or the guest vehicle sensor and communication system 5210, and may allow and/or facilitate communication between the host vehicle control system 7102, the host vehicle sensor and communication system 5210, the guest vehicle control system 7102, and the guest vehicle sensor and communication system 5210, when the guest vehicle 5204 is in the stowed state 5220.

Now referring to FIGS. 52, 57-58, 72, 74, the host vehicle 5202 and guest vehicle 5204 may each comprise sensor and communication systems 5210. The sensor and communication systems 5210 may be utilized to sense, detect, identify, and/or determine one or more measurements and/or characteristics. For example, without limitation, the sensor and communication systems 5210 of the host vehicle 5202 and/or the guest vehicle 5204 may comprise one or more of a sonar emitter 7302, a sonar detector 7304, an ultra-sonic range detector 7306, and optical emitter 7308, an electro-optical camera 7310, an inertial navigation system/inertial measurement unit 7334, an orientation sensor 7312, a movement senor 7314, a depth sensor 7316, an environment sensor 7318, and/or a force sensor 7320.

In some embodiments of the present invention, the sensor and communication systems 5210 may include one or more of a proximity sensor 7322, a wireless communication device 7324, a water level sensor 7326, an air volume sensor 7328, a location sensor 7330, and/or a g-force sensor 7332. Each of the aforementioned sensors of which the host vehicle sensor and communication system 5210 and/or guest vehicle sensor and communication system 5210 may comprise, without limitation, may be referred to collectively, individually, and/or in any combination(s) thereof, as the “sensors of the sensor and communication system 5210.”

The sensor and communication systems 5210 may be positioned at and/or carried by an upper portion and/or a lower portion of the host vehicle 5202/host vehicle body 5206 and/or guest vehicle 5204/guest vehicle body 5208. In some embodiments, the host vehicle 5202 and/or guest vehicle 5204 may comprise an upper housing 5222. The upper housing 5222 may be carried by and/or positioned on the host vehicle 5202/host vehicle body 5206 and/or the guest vehicle 5204/guest vehicle body 5208 at an upper portion thereof. In some embodiments of the present invention the host vehicle 5202 and/or guest vehicle 5204 may include one or more of a support body 5226. The support body 5226 may be extending from an upper portion of the host vehicle 5202/host vehicle body 5206 and/or guest vehicle 5204/guest vehicle body 5208 in an upwards direction, and the upper housing 5222 may be carried by the support body 5226 at an upper end of the support body 5226. The upper housing 5222 may be adapted to carry at least a portion of and/or one or more of the sensors of the sensor and communication system 5210 of the host vehicle 5202 and/or guest vehicle 5204.

In some embodiments, the host vehicle 5202 and/or guest vehicle 5204 may comprise a lower housing 5602. The lower housing 5602 may be carried by and/or positioned on the host vehicle 5202/host vehicle body 5206 and/or the guest vehicle 5204/guest vehicle body 5208 at lower portion thereof. Also, the lower housing 5602 may be attached to and extending from a lower portion of the host vehicle body 5206 and/or guest vehicle body 5208, perhaps as best illustrated in FIG. 58. The lower housing 5602 may be adapted to carry at least a portion of and/or one or more of the sensors of the sensor and communication system 5210 of the host vehicle 5202 and/or guest vehicle 5204.

The lower housing 5602 may be positioned and adapted to be extending from the host vehicle body 5206 and/or guest vehicle body 5208 such that the one or more sensors of the sensor and communication system 5210 may be submerged below the surface of outside environment water 5406 which the host vehicle 5202 and/or guest vehicle 5204 may be floating thereupon. Also, the lower housing 5602 may be adapted to allow, facilitate, not interfere with, and/or at least interfere a negligible amount with signals sent and/or to be received by the of the sensor(s) of the sensor and communication system 5210.

For example, without limitation, the lower housing may be adapted to allow, facilitate, not interfere with, and/or at least interfere a negligible amount with signals sent and/or to be received by the of the sensor(s) of the sensor and communication system 5210 such that the signals sent and/or to be received by the sensor(s) of the sensor and communication system 5210 may not be blocked, distorted, absorbed, corrupted, muffled, and/or significantly changed by the lower housing 5602 such that the signals cannot be received and/or successfully received by the sensor(s) of the sensor and communication system 5210 and such that the sensor(s) of the sensor and communication system 5210 is able to obtain the same content from the signal whether the sensor(s) of the sensor and communication system 5210 is carried by or not carried by the lower housing 5602.

The sensor and communication system 5210 and/or the sonar 7302, 7304 may be utilized to send, receive, sense, emit, detect, read, and compute signals, such as, acoustic and/or sound wave signals, which may comprise machine-readable data and/or information. The sensor and communication system 5210 and/or the sonar 7302, 7304 of the host vehicle 5202 and the guest vehicle 5204 may be utilized to allow and facilitate the host vehicle 5202 and guest vehicle 5204 to communicate with one another via acoustic and/or sound wave signals sent via the outside environment water 5406.

The sensor and communication system 5210 and/or the ultra-sonic range detector 7306 may be utilized to sense and/or detect distances and/or positions of physical objects and surfaces, as may be understood by those who may have skill in the art. For example, the sensor and communication system 5210 and/or the ultra-sonic range detector 7306 may be utilized to sense and/or detect a distance and/or position of a surface or object that may be above and/or below a surface of the outside environment water 5406.

In some embodiments of the present invention the sensor and communication system 5210 may be adapted and/or operable to sense and/or detect an audible noise received by the sensor and communication system 5210, and the sensor and communication system 5210 and/or vehicle control system 7102 may be operable to identify and/or determine the cause of the audible noise and/or the direction of the source of the audible noise. The vehicle control system 7102 may be operable to generate and store a sensed audio data based on the audible noise received, and the vehicle control system 7102 may access, utilize, and/or reference the stored sensed audio data to identify and/or determine another audible noise received by the sensor and communication system 5210.

The sensor and communication system 5210 and/or the optical emitter 7308 may be adapted to use one or more wavelengths of light to sense and detect the position and/or size of objects, such as other vessels and/or a, or another, guest vehicle 5204/host vehicle 5202. Also, the sensor and communication system 5210 and/or the optical emitter 7308 may be adapted to use one or more wavelengths to sense and detect the relative distance between and/or proximity of the other vessel, which may be relative to a current position of the sensor and communication system 5210/the optical emitter 7308, the host vehicle 5202, the host vehicle body 5206, the guest vehicle 5204, and/or the guest vehicle body 5208.

The sensor and communication system 5210 and/or the electro-optical camera 7310 may be operable and/or adapted to sensed and/or detect light emitted, such as light emitted from a vessel. For example, without limitation, the sensor and communication system 5210 and/or the electro-optical camera 7310 may sense and/or detect light emitted from a light carried by a vessel, such as a boat or a ship, and/or may sense and/or detect light received comprising one or more wavelengths of the light, such as, and without limitation, visible light, infrared, ultraviolet, thermal, radio, microwave, x-ray, and/or gamma ray. The sensor and communication system 5210 and/or the electro-optical camera 7310 may be operable to emit a light detection signal responsive to sensing and/or detecting light received thereby. The sensor and communication system 5210 and/or the electro-optical camera 7310 may also to sense, detect, and record visual information from an outside environment surrounding the host vehicle 5202/guest vehicle 5204.

The sensor and communication system 5210 and/or the orientation sensor 7312 may be utilized to sense, detect, and/or determine the orientation of the host vehicle body 5206/guest vehicle body 5208 in the three-dimensional space. For example, without limitation, the sensor and communication system 5210 and/or the orientation sensor 7312 may be adapted to sense, detect, and/or determine the pitch, roll, and/or yaw of the host vehicle body 5206/guest vehicle body 5208 in three-dimensional space.

The sensor and communication system 5210 and/or the movement sensor 7314 may be adapted to sense, detect, monitor, and/or determine the movement of the host vehicle body 5206/guest vehicle body 5208. The sensor and communication system 5210 and/or the movement sensor 7314 and be adapted to sense, detect, monitor, and/or determine the movement of the host vehicle body 5206/guest vehicle body 5208 based on a movement of the host vehicle body 5206/guest vehicle body 5208 relative to an outside environment. Also, the sensor and communication system 5210 and/or the movement sensor 7314 and be adapted to sense, detect, monitor, and/or determine the movement of the host vehicle body 5206/guest vehicle body 5208 by sensing, detecting, monitoring, and/or determining a speed and/or velocity of the host vehicle 5202/guest vehicle 5204 and/or an acceleration force and/or inertial force on the host vehicle 5202/guest vehicle 5204 and/or on the sensor and communication system 5210 and/or movement sensor 7314.

The sensor and communication system 5210 and/or the depth sensor 7316 may be adapted and/or utilized to sense, determine, and/or detect a depth of the outside environment water 5406. The sensor and communication system 5210 and/or the depth sensor 7316 may also, and/or instead, be adapted and/or utilized to sense, determine, and/or detect a depth of the outside environment water 5406 that may be immediately below the host vehicle 5202/guest vehicle 5204 and/or immediately below the sensor and communication system 5210 and/or the depth sensor 7316.

The sensor and communication system 5210 and/or the environment sensor 7318 may be adapted and/or utilized to sense, detect, monitor, and/or determine one or more environmental characteristics, such as environmental characteristics adjacent to, near, and/or within view of the host vehicle 520/guest vehicle 5204 and/or the sensor and communication system 5210 and/or the environment sensor 7318. For example, without limitation, the sensor and communication system 5210 and/or the environment sensor 7318 may be adapted to sense, detect, monitor, and/or determine environmental characteristics including one or more of a water current, a wave height, a wave period, a wind speed, a wind direction, a temperature, a humidity, and/or an amount of sunlight. The sensor and communication system 5210 and/or the environment sensor may include and/or utilize one or more of optical sensors, electrical resistance sensors, voltage sensors, capacitance sensors, inductance sensors, rotors, and/or turbines to detect, monitor, and/or determine the one or more environmental characteristics.

The sensor and communication system 5210 and/or the inertial navigation system/inertial measurement unit 7334 (“INS/IMU 7334”) may be adapted to sense, monitor and log the inertial forces, acceleration forces, movement, and orientation of the host vehicle 5202/guest vehicle 5204 to determine a position and/or estimated position of the host vehicle 5202/guest vehicle 5204 within a geographical area. The INS/IMU 7334 may include and/or incorporate the same and/or similar functions and/or features of the orientation sensor 7312, movement sensor 7314, depth sensor 7316, environment sensor 7318, and/or the ultra-sonic range detector 7306 as they are described above to sense, detect, monitor, and/or determined the to determine a position and/or estimated position of the host vehicle 5202/guest vehicle 5204. In some embodiments of the present invention, the INS/IMU 7334 may be in communication with, and receive sensed, detected, monitored, and/or determined data from, one or more of the orientation sensor 7312, movement sensor 7314, depth sensor 7316, environment sensor 7318, and/or the ultra-sonic range detector 7306 to sense, detect, monitor, and/or determined the to determine a position and/or estimated position of the host vehicle 5202/guest vehicle 5204.

The sensor and communication system 5210 and/or the force sensor 7320 of the host vehicle 5202 may be adapted and/or utilized to determine if and when a guest vehicle 5204 is in the stowed state 5220. The force sensor 7320 may be positioned at a rearward portion of the host vehicle 5202/host vehicle body 5206, and the force sensor 7320 may be in communication with the host vehicle control system 7102. The force sensor 7320 may also be positioned within and/or adjacent to the cradle 5302 of the host vehicle 5202/host vehicle body 5206. The force sensor 7320 may be adapted to sense and/or detect when the guest vehicle 5204 and/or the guest vehicle body 5208 is adjacent to, in proximity with, and/or abutting the force sensor 7320. For example, without limitation, the force sensor 7320 may be positioned and adapted to engage with a portion of the guest vehicle 5204 when the guest vehicle 5204 is in the stowed state, and may be adapted to detect when the portion of the guest vehicle 5204 is engaged with the force sensor 7320.

The force sensor 7320 may be adapted to emit a stowed signal to the host vehicle control system 7102 responsive to sensing and/or detecting the guest vehicle 5204/guest vehicle body 5208 is in the stowed state and/or responsive to a portion of the guest vehicle 5204 being engaged with the force sensor 7320. The host vehicle control system 7102 may be operable to control and/or command the securing system 5214 to engage with a portion of the guest vehicle 5204 and/or to move to the locked state from the unlocked state responsive to receiving the stowed signal from the force sensor 7320. Also, the securing system 5214 may be operable to move to the locked state from the unlocked state responsive to receiving the stowed signal from the force sensor 7320.

In some embodiments of the present invention, the sensor and communication system 5210 of the host vehicle 5202/guest vehicle 5204 may include a sensor unit 7104, which also, without limitation, may be alternatively referred to as a sensor fusion unit 7104. The sensor unit 7104 may be in communication with one or more of the sensors of the sensor and communication system 5210. The sensor unit 7104 may be adapted to operate and/or control one or more of the sensors of the sensor and communication system 5210. Also, the sensor unit 7104 may be operable to receive, read, compute, condense, process, interpret, compress, and/or parse data, information, and/or signals sensed, detected, monitored, and/or determined by and from one or more of the sensors of the sensor and communication system 5210 to be sent and/or emitted as condensed sensor data.

The sensor unit 7104 may send the condensed sensor data to one or more of the host vehicle control system 7102, the host vehicle sensor and communication system 5210, the host vehicle maneuvering system 5224, the host vehicle buoyancy system 7116, and/or the securing system 5214 and/or the guest vehicle control system 7102, the guest vehicle sensor and communication system 5210, the guest vehicle maneuvering system 5224, and/or the guest vehicle buoyancy system 7116. However, without limitation, in some embodiments of the present invention one or more of the functions and/or features of the sensor unit 7104 as described herein may be incorporated into and/or included by the control system 7102 of the host vehicle 5202/guest vehicle 5204, such that the embodiment may not include a sensor unit 7104 or a sensor unit 7104 separate from the control system 7102.

As mentioned above, in some embodiments of the present invention the sensor and communication systems 5210 of the host vehicle 5202 and/or guest vehicle 5204 may include one or more of a proximity sensor 7322, a wireless communication device 7324, a water level sensor 7326, an air volume sensor 7328, a location sensor 7330, and/or a g-force sensor 7332. The sensor and communication systems 5210 and/or proximity sensor 7332 may be adapted and/or utilized to sense, detect, and/or determine the presence and/or position of objects, surfaces, structures, and/or formations near, adjacent to, and/or in proximity with the sensor and communication system 5210, the proximity sensor 7332, the host vehicle 5202 and/or the guest vehicle 5204. For example, without limitation, the sensor and communication system 5210 and/or proximity sensor 7332 of a host vehicle 5202 may sense, detect, and/or determine the presence or position of a guest vehicle 5204, and associate device 6806, and/or another vehicle 6804 near, adjacent to, and/or in proximity with the sensor and communication system 5210, the proximity sensor 7332, the host vehicle 5202 and/or the guest vehicle 5204.

The sensor and communication systems 5210 and/or the wireless communication device 7324 may be in communication with the host vehicle control system 7102 and/or the guest vehicle control system 7102. The sensor and communication systems 5210 and/or the wireless communication device 7324 may also be in communication with one or more other sensor and communication systems 5210 of one or more other host vehicle(s) 5202/guest vehicle(s) 5204, and the sensor and communication systems 5210 and/or the wireless communication device 7324 may be in communication with one or more of the network 6802, a user device 6808, an associate device 6806, and/or another vehicle 6804.

The sensor and communication systems 5210 and/or the wireless communication device 7324 may be adapted and/or utilized to receive, send, transmit, transfer, read, write, translate, compute, and/or emit one or more signals that may comprise machine-readable information and/or data. Examples of the wireless communication device 7324 include, without limitation, a receiver, a transmitter, a transceiver, an antenna, a communication relay, a communication dish, and any combination(s) thereof as may be understood by those who may have skill in the art.

The sensor and communication systems 5210 and/or the water level sensor 7326 may be adapted and/or utilized to sense, detect, determine, and/or monitor an amount of water and/or an amount of outside environment water 5406 that maybe present within an interior area of the guest vehicle body 5208 and/or the host vehicle body 5206. The sensor and communication systems 5210 and/or the water level sensor 7326 may be in communication with one or more of the host vehicle control system 7102, the guest vehicle control system 7102, the buoyancy control unit 7110, the host vehicle buoyancy system 7116, the guest vehicle buoyancy system 7116, the host vehicle maneuvering system 5224, and/or the guest vehicle maneuvering system 5224. The sensor and communication systems 5210 and/or the water level sensor 7326 may be operable to emit a water level signal based on the amount of water and/or outside environment water 5406 sensed, detected, determined, and/or monitored to be present with in the interior area of the host vehicle body 5206/guest vehicle body 5208.

The sensor and communication systems 5210 and/or the air volume sensor 7328 may be adapted and/or utilized to sensed, detect, determine, and/or monitor an amount of air and/or a volumetric amount of air that may be present within the interior area of the host vehicle body 5206 and/or the guest vehicle body 5208. The sensor and communication systems 5210 and/or the air volume sensor 7328 may be in communication with one or more of the host vehicle control system 7102, the guest vehicle control system 7102, the buoyancy control unit 7110, the host vehicle buoyancy system 7116, the guest vehicle buoyancy system 7116, the host vehicle maneuvering system 5224, and/or the guest vehicle maneuvering system 5224. The senor and communication systems 5210 and/or the air volume sensor 7328 may be operable to emit an air volume level signal based on the amount of air and/or the volumetric amount of air sensed, detected, determined, and/or monitored to be present with in the interior area of the host vehicle body 5206/guest vehicle body 5208.

The sensor and communication systems 5210 and/or the location sensor 7330 may be adapted and/or utilized to detect, track, and/or monitor the location of the host vehicle 5202 and/or guest vehicle 5204, such as, without limitation, the detect, track, and/or monitor the geographic location of the host vehicle 5202 and/or guest vehicle 5204. The sensor and communication systems 5210 and/or the location sensor 7330 may be configured to emit a location signal related to the location of the host vehicle 5202 and/or guest vehicle 5204 detected, tracked, and/or monitored thereby. The sensor and communication systems 5210 and/or the location sensor 7330 may be in communication with one or more of a network 6802, an associate device 6806, and another vehicle 6804, and the sensor and communication systems 5210 and/or the location sensor 7330 may receive location data via the network 6802. Examples of the location sensor 7330 include, without limitation, a global positioning satellite (GPS) unit.

The sensor and communication systems 5210 and/or the g-force sensor 7332 may be adapted and/or utilized to sense, detect, and/or determine an amount of gravitational force (g-force) applied to one or more of the sensor and communication systems 5210, the g-force sensor 7332, the host vehicle 5202, the guest vehicle 5204, the host vehicle body 5206, and/or the guest vehicle body 5208. For example, without limitation, the sensor and communication systems 5210 and/or the g-force sensor 7332 may be adapted and/or utilized to sense, detect, and/or determine the amount of g-force applied to the vehicle body 5206/5208 during maneuvering of the vehicle body 5206/5208 by one of the maneuvering systems 5224. The sensor and communication systems 5210 and/or the g-force sensor 7332 may be adapted to emit a g-force signal related to the amount of g-force sensed, detected, and/or determined thereby.

Referring now to FIGS. 55-56, 67B, 67D, and 75, the buoyancy system(s) 7116 of the host vehicle 5202 and guest vehicle 5204 may now be described with more and/or additional detail. As discussed above, the host vehicle 5202 may comprise a host vehicle buoyancy system 7116 and the guest vehicle 5204 may comprise a guest vehicle buoyancy system 7116. Embodiments of the host vehicle buoyancy system 7116 and the guest vehicle buoyancy system 7116 may include features and/or limitations that may be the same as and/or similar to one another, and as such, the host vehicle buoyancy system 7116 and the guest vehicle buoyancy system 7116 may be referred to, collectively, individually, or in any combination(s) thereof, as the vehicle buoyancy system 7116 or vehicle buoyancy systems 7116, without limitation.

The vehicle buoyancy systems 7116 may include one or more water valves 7404, water pumps 7406, and air valves 7408. The water valves 7404 may each be extending through one or more portions of the host vehicle body 5206 and/or the guest vehicle buoyancy system 7116. Also, the water valves 7404 may each be extending through one or more lower portions of the host vehicle body 5206 and/or guest vehicle body 5208. The water pumps 7406 may each be carried within an interior area of the host vehicle body 5206 and/or the guest vehicle body 5208, and may be in fluid communication with one or more of the water valves 7404 and with the interior area of the host vehicle body 5206/guest vehicle body 5208.

The air valves 7408 may each be extending through one or more portions of the host vehicle body 5206 and/or the guest vehicle body 5208. Also, the air valves 7408 may be extending through one or more upper portions of the host vehicle body 5206 and/or guest vehicle body 5208. The air valves 7408 may be adapted to only allow gases to pass therethrough, such that the air valves 7408 may not allow liquids, such a water and/or outside environment water 5406 to pass through the air valve 7408.

The water pumps 7406 may be in communication with one or more of the onboard power supply 7118, the host vehicle maneuvering system 5224, the guest vehicle maneuvering system 5224. The host vehicle control system 7102, and/or the guest vehicle control system 7102. The water pumps 7406 may be operable to allow, cause, control, and regulate outside environment water 5406 from moving into and out from the interior area of the host vehicle body 5206/host vehicle body 5206 to move the host vehicle 5202 and/or guest vehicle 5204 between the surfaced state 5405 and the submerged state 5402. To move the host vehicle 5202 and/or guest vehicle 5204 between the surfaced state 5405 and the submerged state 5402, the water pumps 7406 may pump water, such as the outside environment water 5406, into and out from the interior area of the host vehicle body 5206/guest vehicle body 5208 via one or more of the water valves 7404 that the water pump 7406 is in fluid/fluidic communication therewith. The air valves 7408 may be adapted to allow gases, such as ambient air, to pass and/or move therethrough caused by a change in pressure within the interior area which may be caused by the water pumps 7406 pumping outside environment water 5406 into and out from the interior area.

Some embodiments of the host vehicle 5202 and/or guest vehicle 5204 may include buoyancy quadrants 7402 formed within the interior area of the host vehicle body 5206 and/or guest vehicle body 5208. Examples of the buoyancy quadrants 7402 may be seen as the four sectioned interior areas of the interior area of the host vehicle body 5206/guest vehicle body 5208 illustratively shown by the two intersecting robust dotted/segmented lines laying horizontally and vertically. Each buoyancy quadrant 7402 may define a portion of the interior area of the vehicle body 5206/5208, and each buoyancy quadrant 7402 may be adapted to prevent water and outside environment water 5406 from moving between each buoyancy quadrant 7402, such that water and outside environment water 5406 present within one buoyancy quadrant 7402 may be prevented from moving to another buoyancy quadrant 7402. Each buoyancy quadrant 7402 may house one or more water pumps 7406, and each buoyancy quadrant 7402 may be in fluid communication with one or more of the air valves 7408 and/or the water valves 7404.

The water pumps 7406 in each buoyancy quadrant 7402 may be selectively controlled to move outside environment water 5406 into and out from the buoyancy quadrant 7402 associated with that water pump 7406. The water pumps 7406 may be selectively controlled by the host vehicle control system 7102 and/or guest vehicle control system 7102 to cause outside environment water 5406 to be moved into and out from one or more of the buoyancy quadrants 7402 to cause and/or control an orientation of the host vehicle 5202, host vehicle body 5206, guest vehicle 5204, and/or guest vehicle body 5208. For example, without limitation, the water pumps 7406 may be selectively controlled to move outside environment water 5406 into and/or out from one or more of the buoyancy quadrants 7402 to cause an increase and/or decrease in buoyancy of the portion(s) of the host vehicle body 5206/guest vehicle body 5208 surrounding the buoyancy quadrant(s) 7402, such that the host vehicle body 5206/guest vehicle body 5208 may lean more or less rightwards, leftwards, frontwards, backwards, and any combination(s) thereof and/or have the pitch and/or roll of the host vehicle body 5206/guest vehicle body 5208 be oriented or changed.

In some embodiments of the present invention, the buoyancy control systems 7116 of the host vehicle 5202 and/or guest vehicle 5204 may include a buoyancy control unit 7110. The buoyancy control unit 7110 may be in communication with one or more of the water pumps 7406, the host vehicle control system 7102/guest vehicle control system 7102, the host vehicle maneuvering system 5224/guest vehicle maneuvering system 5224, the host vehicle sensor and communication system 5210/guest vehicle sensor and communication system 5210, the onboard power supply 7118, and/or the drive unit 7202. The buoyancy control unit 7110 may be operable to selectively control one or more of the water pumps 7406 to cause one or more of the water pumps 7406 to move outside environment water 5406 into and out from the interior area of the host vehicle body 5206/guest vehicle body 5208 and/or into and out from one or more of the buoyancy quadrants 7402.

The buoyancy control unit 7110 may be operable by the host vehicle control system 7102/guest vehicle control system 7102 to selectively control one or more of the water pumps 7406 responsive to a water pump signal received from the host vehicle control system 7102/guest vehicle control system 7102. In some embodiments of the present invention, without limitation, one or more of the features and limitations of the buoyancy control unit 7110 described herein may be incorporated into the host vehicle control system 7102/guest vehicle control system 7102 such that the embodiment may not include a buoyancy control unit 7110 and/or that that buoyancy control unit 7110 itself is incorporated into the host vehicle control system 7102/guest vehicle control system 7102.

Some embodiments of the present invention may also include one or more interior housings 5802, rail systems 5804, and external cooling plates 5902. The interior housings 5802 may be carried by the host vehicle 5202 and/or the guest vehicle 5204. Each of the interior housings 5802 may be adapted to carry at least a portion of one or more of the host vehicle control system 7102, the host vehicle maneuvering system 5224, the host vehicle sensor and communication system 5210, the securing system 5214, the host vehicle body 5206, the onboard power supply 7118, the interface(s) 6006, 6504, the water pump 7406, the buoyancy control unit 7110, the guest vehicle control system 7102, the guest vehicle sensor and communication system 5210, the guest vehicle maneuvering system 5224, and/or the guest vehicle buoyancy system 7116. Also, in some embodiments, each of the interior housings 5802 may be adapted to carry at least a portion of a payload deployment system 6002 and an action unit 7114. Details on the payload deployment system 6002 and the action unit 7114 follow further below.

The interior housings 5802 may be adapted to prevent liquids, such as, and without limitation, water or outside environment water 5406. Each of the host vehicle 5202 and guest vehicle 5204 may include a rail system 5804. The rail system 5804 may be carried by the host vehicle body 5206/guest vehicle body 5208 within an interior area of the host vehicle body 5206/guest vehicle body 5208. The rail system 5804 may comprise a pattern and/or grid-like pattern of rails. Each of the rails of the rail system 5804 may be in communication with at least one other rail, and each of the rails may be in fluid communication with at least one other rail. Each of the interior housings 5802 may be adapted to be mounted on a portion of the rail system 5804, and/or each of the interior housings 5802 may be adapted to slidably engage to a portion of the rail system 5804.

The rail system 5804 may be adapted and/or utilized to allow and/or facilitate communications between one or more of the interior housings 5802 within the host vehicle body 5206 and/or guest vehicle body 5208, and/or the rail system 5804 may be adapted and/or utilized to allow and/or facilitate communications between one or more of the components that may be carried by one or more of the interior housings 5802 that are mounted on and/or slidably engaged with the rail system 5804. Those skilled in the art may notice and appreciate that the use of the interior housings 5802 and the rail system 5804 may allow for the components to be shielded from water and outside environment water 5406 that may be within one or more portions of the interior area of the host vehicle body 5206/guest vehicle body 5208, such as when an embodiment of the host vehicle 5202/guest vehicle 5204 moves between the surfaced state 5405 and the submerged state 5402.

The external cooling plate(s) 5902 may be positioned on one or more exterior portions and/or exterior surfaces of the host vehicle body 5206 and/or guest vehicle body 5208. The external cooling plate(s) 5902 may be in fluidic communication with the rail system 5804, and/or the external cooling plate(s) 5902 may be in communication with one or more of the water pumps 7406. The rail system 5804 may be configured to house one or more fluids, such as coolant or water, and one or more of the water pumps 7406 may be utilized to circulate the fluid throughout the rail system 5804 and between the rail system 5804 and the external cooling plate(s) 5902. It should be understood that a water pump 7406 in fluid communication with the rail system 5804 may not also be in fluid communication with any of the water valves 7404. However, it should also be understood that in some embodiments a water pump 7406 in fluid communication with the rail system 5804 may also be in fluid communication with one or more of the water valves 7404 to flow and circulate the outside environment water 5406 into, throughout, and out from the rail system 5804.

The external cooling plate(s) 5902 may be adapted to allow for a transfer of energy, such as thermal energy, to take place through the external cooling plate(s) 5902 and between outside environment water 5406 located external from the host vehicle body 5206/guest vehicle body 5208 and the fluid housed by the rail system 5804 circulated through the external cooling plate(s) 5902. For the purposes of the present invention, it should be understood that the recitation of the external cooling plate(s) 5902 being adapted to allow for a transfer of thermal energy between the outside environment water 5406 and the fluid circulated through the external cooling plate(s) 5902 may be defined as the external cooling plate(s) 5902 having a significantly high amount of thermal conductivity and thermal transfer therethrough.

Now referring to FIGS. 52-57 and 76, the securing system 5214 of some embodiments of the present invention may be described with additional detail. As mentioned above, the securing system 5214 may be operable to move between a locked state and an unlocked state to selectively allow and/or prevent a guest vehicle 5204 carried by the host vehicle 5202 to move between the stowed state 5220 and the deployed state 5404. The locked state of the securing system 5214 may be defined as when at least a portion of the securing system 5214 is engaged with at least a portion of the guest vehicle 5204 and/or the guest vehicle body 5208, which may cause the guest vehicle 5204 and/or guest vehicle body 5208 to be prevented from moving to the deployed state 5404 from the stowed state 5220. The unlocked state of the securing system 5214 may be defined as when the securing system 5214 is not engaged with the guest vehicle 5204 and/or the guest vehicle body 5208, such that the guest vehicle 5204 and/or guest vehicle body 5208 is not prevented from moving to, from, and/or between the stowed state 5220 and the deployed state 5404.

The securing system 5214 may be carried by a host vehicle 5202 and/or the host vehicle body 5206, however, in some embodiments of the present invention it is contemplated that a guest vehicle 5204 may also carry a securing system 5214. The securing system 5214 may comprise one or more securing units 5304. The securing units 5304 may be carried by the host vehicle 5202 and/or host vehicle body 5206, perhaps as best illustratively shown in FIGS. 54A-54C. However, it should be understood that although FIGS. 54A-54C show a host vehicle 5202 carrying four securing units 5304, embodiments of the present invention may include any number of securing units 5304. The securing units 5304 may each be operable to move between a locked state and an unlocked state to selectively allow and/or prevent a guest vehicle 5204 carried by the host vehicle 5202 to move between the stowed state 5220 and the deployed state 5404.

The locked state of the securing units 5304 may be defined as when at least a portion of one or more of the securing units 5304 is engaged with at least a portion of the guest vehicle 5204 and/or the guest vehicle body 5208. Also, and/or alternatively, without limitation, the locked state of the securing units 5304 may be defined as when one or more of the securing units 5304 is engaged with one or more guest securing members 5502 that may be mounted on the guest vehicle 5204 and/or the guest vehicle body 5208. When one or more of the securing units 5304 are in the locked state, the securing units 5403 may cause the guest vehicle 5204 and/or guest vehicle body 5208 to be prevented from moving to the deployed state 5404 from the stowed state 5220 and/or from moving between the deployed state 5404 and the stowed state 5220.

The unlocked state of the securing units 5304 may be defined as when the securing units 5304 are not engaged with the guest vehicle 5204 and/or the guest vehicle body 5208. Also, and/or alternatively, without limitation, the unlocked state of the securing units 5304 may be defined as when the securing units 5304 are not engaged with one or more guest securing members 5502 mounted on the guest vehicle 5204 and/or guest vehicle body 5208. When the securing units 5304 are in the unlocked state, the guest vehicle 5204 and/or guest vehicle body 5208 may not be prevented from moving to, from, and/or between the stowed state 5220 and the deployed state 5404.

Now additionally referring to FIG. 72, in some embodiments of the present invention, the securing system 5214 may comprise a relative position system 7502 and/or a securing control computer 7108. The relative position system 7502 may be carried by the host vehicle 5202 and/or the guest vehicle 5204, and the relative position system 7502 may be housed by the upper sensor housing 5222 and/or the lower sensor housing 5602. The relative position system 7502 may be in communication with one or more of the securing units 5304, the host vehicle control system 7102, the host vehicle sensor and communication system 5210, the guest vehicle control system 7102, and/or the guest vehicle sensor and communication system 5210. The relative position system 7502 may be adapted and/or utilized to track the position and/or the relative positions of the host vehicle 5202 and/or the guest vehicle 5204, and the relative position system 7502 may be adapted to emit a tracked position signal related to the position and/or relative positions of the host vehicle 5202 and/or guest vehicle 5204.

The securing control computer 7108 may be in communication with one or more of the control system(s) 7102, the maneuvering system(s) 5224, the sensor and communication system(s) 5210, the onboard power supply 7118, and/or the buoyancy system(s) 7116. The securing control computer 7108 may be adapted to control one or more of the maneuvering system(s) 5224, and the securing control computer 7108 may be operable to control one or more of the maneuvering system(s) 5224 based on the tracked position signal received from the sensor and communication system(s) 5210 and/or the relative position system(s) 7502 of the host vehicle 5202 and/or guest vehicle 5204. However, without limitation, it is contemplated that some embodiments of the present invention may not include a securing control computer 7108, and that the functions and limitations of the securing control computer 7108 described herein may be partially and/or entirely incorporated by and/or included in the host vehicle control system 7102 and/or the guest vehicle control system 7102.

Now referring to FIGS. 62-63, 68, 72, and 77, some embodiments of the present invention may include one or more of a payload deployment system 6002. The payload deployment system 6002 may be carried by the host vehicle 5202, the host vehicle body 5206, the guest vehicle 5204, the guest vehicle body 5208, and the payload deployment system 6002 may be carried by and within the cradle 5302. The payload deployment system 6002 may be in communication with the host vehicle control system 7102 and/or the guest vehicle control system 7102. The payload deployment system 6002 may be adapted, operable, and/or utilized to carry and selectively deploy one or more payloads 6004. The payload deployment system 6002 may be operable to move one or more payloads 6004 between a carried position and a deployed state.

The carried position of a payload 6004 may be defined as when the payload 6004 is slidably carried by the payload deployment system 6002 and/or when the payload 6004 is carried by a portion of the host vehicle 5202, the host vehicle body 5206, the guest vehicle 5204, and/or the guest vehicle body 5208. The deployed state of a payload 6004 may be defined as the payload 6004 being separate from the payload deployment system 6002, the host vehicle 5202, the host vehicle body 5206, the guest vehicle 5204, and/or the guest vehicle body 5208. The deployed state of the payload 6004 may also and/or alternatively be defined as when the payload 6004 is separate from the host vehicle 5202 and/or guest vehicle 5204 and is deployed in and/or on outside environment water 5406. The payload deployment system 6002 may be operable to be controlled by the host vehicle control system 7102 and/or the guest vehicle control system 7102 to move one or more of the payloads 6004 between the carried position and the deployed state.

In some embodiments of the present invention, the payload deployment system 6002 may include a payload control unit 7112. The payload control unit 7112 may be in communication with one or more of the payload deployment system 6002, the host vehicle control system 7102, the host vehicle sensor and communication system 5210, the guest vehicle control system 7102, the guest vehicle sensor and communication system 5210, and/or the onboard power supply 7118. The payload control unit 7112 may be operable to control the payload deployment system 6002 to move one or more of the payloads 6004 between the carried position and the deployed state.

Also, the payload control unit 7112 may be operable to control the payload deployment system 6002 to move one or more of the payloads 6004 between the carried position and the deployed state based on sensor data received from the sensor and communication system(s) 5210 and/or based on a command received from the vehicle control system(s) 7102. It is contemplated that some embodiments of the present invention may not include a payload control unit 7112, and in some embodiments one or more of the functions and/or limitations of the payload control unit 7112 described herein may be incorporated and/or included by the host vehicle control system 7102 and/or the guest vehicle control system 7102.

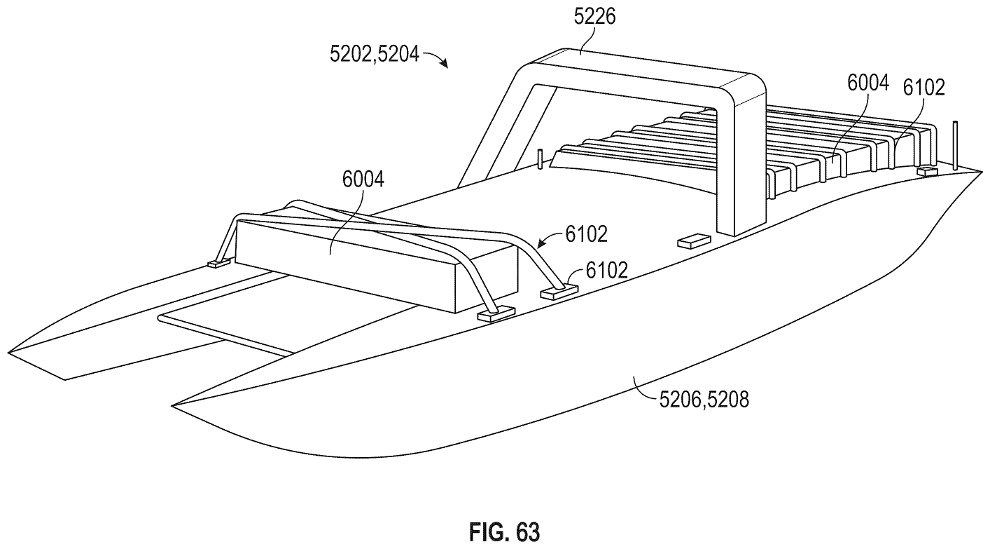

Some embodiments of the present invention may include one or more cargo attachment member(s) 6102. The cargo attachment member(s) 6102 may be carried by and/or mounted on one or more portions of the host vehicle 5202 and/or the guest vehicle 5204. The cargo attachment member(s) 6102 may include one or more attachment points and/or one or more attachment lines, perhaps ad best illustratively shown in FIG. 63. The cargo attachment member(s) 6102 may be utilized to secure, strap, attached, and/or hold one or more payloads 6004 onto the host vehicle 5202 and/or guest vehicle 5204 so that the payload(s) 6004 may be removably carried by the host vehicle 5202 and/or the guest vehicle 5204.

Some embodiments of the present invention may include one or more action unit(s) 7114. The action unit 7114 may comprise one or more of an audio device, a laser device, a flare launcher, and/or a smoke deployer. The action unit 7114 may be in communication with the host vehicle control system 7102, the guest vehicle control system 7102, and/or the onboard power supply 7118. The action unit 7114 may be adapted to be selectively controlled by the host vehicle control system 7102 and/or guest vehicle control system 7102 to cause the action unit 7114 to perform a predetermined action. Examples of a predetermined action performed by the action unit 7114 include, without limitation, one or more of emitting a predetermined audio sound, emitting a laser, controlling the direction a laser is emitted therefrom, deploying a flare signal, and/or deploying a smoke signal and/or a smoke screen.

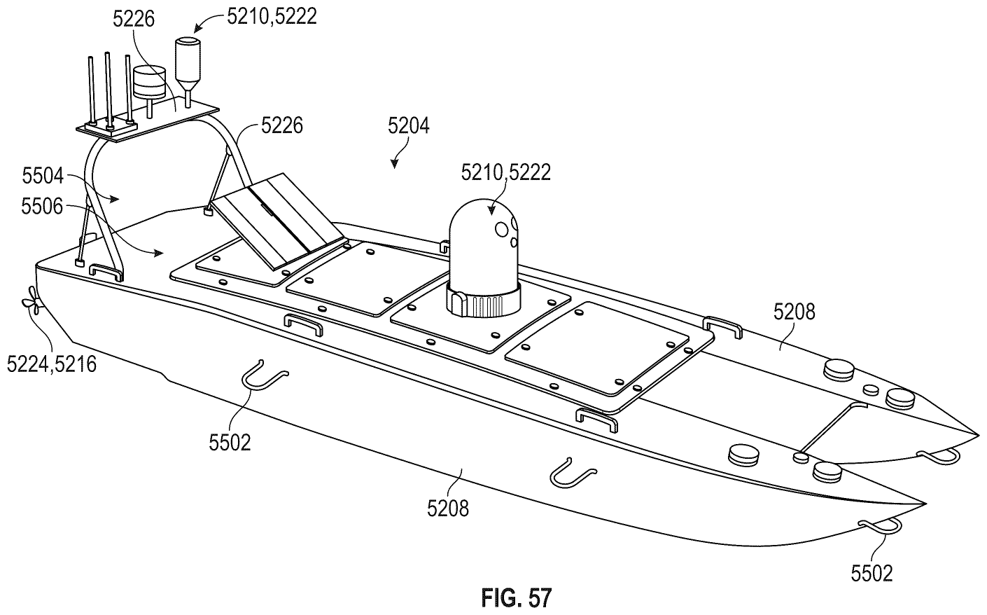

Now referring to FIGS. 57, 59, 62, 64-66, and 68, some embodiments of the present invention may include a deck plan 5504 for the host vehicle(s) 5202 and/or the guest vehicle(s) 5204. Alternatively, without limitation, in some embodiments of the present invention the cradle 5302 may comprise a deck plan 5504. The deck plan 5504 may comprise a flat deck plan 5506, a slant deck plan 5708, and/or an open deck plan 6702. The deck plan 5504 of a host vehicle 5202 and/or guest vehicle 5204 may define the shape, size, layout, and form of at least a portion of an upper area of the host vehicle 5202, host vehicle body 5206, guest vehicle 5204, and/or guest vehicle body 5208, which may be referred to collectively, individually, and/or in any combination(s) thereof as the upper area portion(s) of a vehicle body 5202, 5204, without limitation. Also, and/or alternatively, the deck plan 5504 may define the shape, size, layout, and form of the cradle 5302.

A flat deck plan 5506 may define the upper area portion(s) of a vehicle body 5202, 5204 to be flat, such that the upper area portion(s) of the vehicle body 5202, 5204 may not include any significant vacant areas, open spaces, and/or apertures which may be extending into the upper area portion(s) of a vehicle body 5202, 5204. Examples of a flat deck plan 5506, without limitation, for a guest vehicle 5204 is illustratively shown in FIG. 57, and a flat deck plan 5506 for a host vehicle 5202 is illustratively shown in FIG. 65.

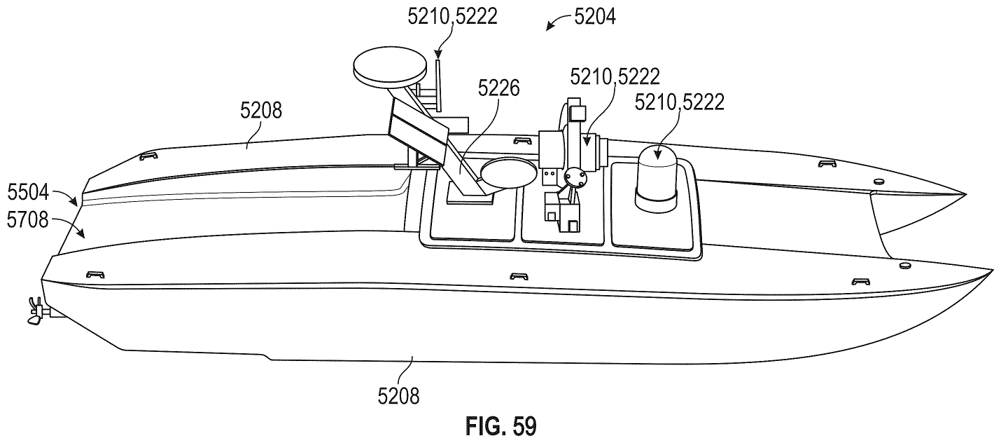

A slant deck plan 5708 may define the upper area portion(s) of a vehicle body 5202, 5204 as including an open space extended into the upper area portion(s) of the vehicle body 5202, 5204, which may extend towards and out a rear portion of the vehicle body 5202, 5204, and which may comprise a lower surface that may have a slant and/or gradient height from a frontal end to a rear end of the lower surface, which may be with respect to an upper surface plane of the vehicle body 5202, 5204. Examples of a slant deck plan 5708, without limitation, for a guest vehicle 5204 may be illustratively shown in FIG. 59, and a slant deck plan 5708 for a host vehicle 5202 may be illustratively shown in FIG. 64.

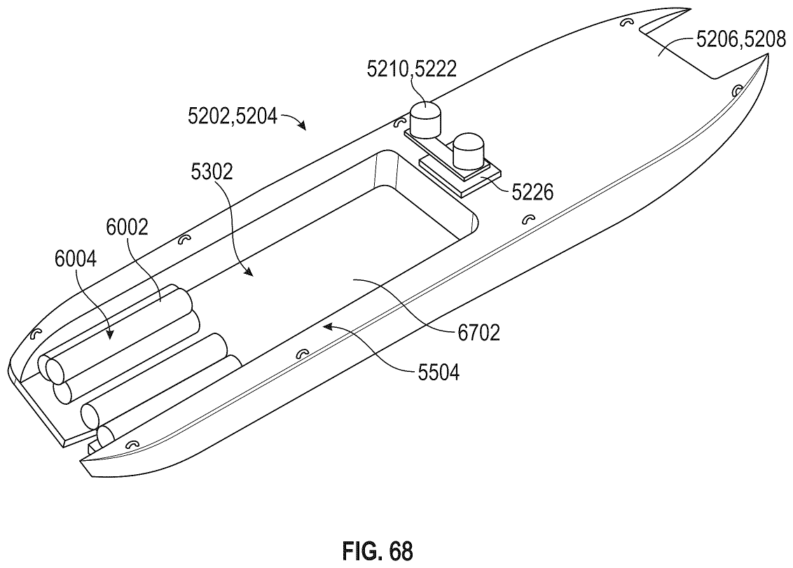

An open deck plan 6702 may define the upper area portion(s) of a vehicle body 5202, 5204 as including an open space extended into the upper area portion(s) of the vehicle body 5202, 5204, and which may extend towards and out a rear portion of the vehicle body 5202, 5204. In embodiments of the present invention, the lower surface of an open deck plan 6702 may be substantially parallel to the upper area portion(s) of the vehicle body 5202, 5204. Examples of an open deck plan 6702, without limitation, for a guest vehicle 5204 may be illustratively shown in FIG. 68, and an open deck plan 6702 for a host vehicle 5202 may be illustratively shown in FIGS. 64 and 68.

It is contemplated that embodiments of the present invention may include many alternative deck plans in addition or in the alternative to the deck plans 5504 described above, and as may be understood by someone whom may have skill in the art, As such, embodiments of the host vehicle 5202, guest vehicle 5204, host vehicle body 5206, guest vehicle body 5208, and/or the cradle 5302 may not comprise one or more of the flat deck plan 5506, slant deck plan 5708, and/or open deck plan 6702 described above.

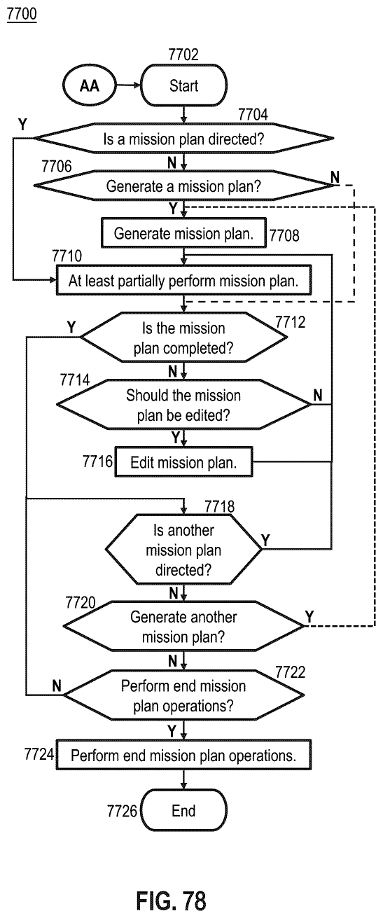

Now referring to FIG. 78, in addition to one or more of the features and/or limitations of the various embodiments of the present invention listed and described above, a method aspect of the present invention for a method for performance of a mission plan 4303 4303 using an embodiment of the present invention may now be described. For the purposes of the description of the embodiments of the present invention and of the method aspects herein, without limitation, it should be understood that reference to an embodiment of the unmanned vehicle system 5200 performing one of the method aspects described herein may refer to the method aspect(s) being performed by one or more embodiment(s) of host vehicle(s) 5202 and/or embodiment(s) of guest vehicle(s) 5204 as described herein, and/or may also and/or alternatively refer to the method aspect(s) being performed by one or more of the component(s), member(s), and/or unit(s) of one or more of the embodiment(s) of the host vehicle(s) 5202 and/or embodiment(s) of guest vehicle(s) 5204 as described herein. Such as, but without limitation, one or more of the host vehicle control system 7102, the host vehicle maneuvering system 5224, the host vehicle sensor and communication system 5210, the securing system 5214, the host vehicle buoyancy system 7116, the onboard power supply 7118, the guest vehicle control system 7102, the guest vehicle maneuvering system 5224, the guest vehicle sensor and communication system 5210, and/or the guest vehicle body 5208.

For method 7700, an embodiment of the unmanned vehicle system 5200 may commence and/or start the method 7700 at Block 7702 and move to Block 7704 to determine if a mission plan 4303 4303 is directed. For example, a mission plan 4303 4303 may be directed if a mission plan 4303 4303 has been received by a host vehicle 5202 and/or guest vehicle 5204, such as a mission plan 4303 4303 sent from a user device 6808, an associate device 6806, and/or another vehicle 6804. For another example, a mission plan 4303 4303 may be directed if there is an existing mission plan 4303 4303 has not yet been completed by the host vehicle 5202 and/or guest vehicle 5204. If, at Block 7704, it is determined that no mission plan 4303 4303 is directed, the unmanned vehicle system 5200 may move from Block 7704 to Block 7706 to determine if a mission plan 4303 4303 should be generated.

For example, without limitation, the unmanned vehicle system 5200 may determine that a mission plan 4303 4303 should be generated based upon one or more operation factors that may include, without limitation, one or more of a danger factor, task factor, location factor, capability factor, time factor, an operation limit factor, and/or an identified task factor. Danger factors may include one or more of calculated damage risks, identified or calculated risk of path obstructions, current and/or predicted environmental conditions, and/or calculated risk of adversarial encounter(s). Task factors may include one or more of the number of tasks to complete regarding the mission instruction, an order of completion for each task of a mission instruction, and the calculated feasibility of completing each task. Location factors may include one or more of the current location of one or more host vehicle(s) 5202, guest vehicle(s) 5204, associate device(s) 6806, other vehicle(s) 6804, and known or estimated locations of tasks associated with the mission operation.

Capability factors may include one or more of the current payload and/or loadout of the host vehicle(s) 5202 and/or guest vehicle(s) 5204 compared to a loadout and/or payload requirement of the mission operation, the current range capabilities of the host vehicle(s) 5202 and/or guest vehicle(s) 5204, the current condition of the host vehicle(s) 5202 and/or guest vehicle(s) 5204, and/or the total count of host vehicle(s) 5202 and/or guest vehicle(s) 5204 compared to a total vehicle requirement of the mission operation. The time factors may include one or more of a time window of completion associated with the mission operation, a predetermined mission operation time completion deadline, and/or a predetermined total operation time limit of the host vehicle(s) 5202 and/or guest vehicle(s) 5204. The operation limit factor may include one or more of an end operation command received, an end operation command generated by the host vehicle(s) 5202 and/or guest vehicle(s) 5204, and/or a predetermined total completed mission operation limit. The identified task factor may include one or more of an identified target, identified target characteristics, identified target location, an identified friendly target, identified friendly target characteristics, and/or an identified friendly target location.

If, at Block 7706, the unmanned vehicle system 5200 determined that a mission plan 4303 4303 should be generated, then the unmanned vehicle system 5200 may continue the method 7700 from Block 7706 to Block 7708 to generate a mission plan 4303. If, however, at Block 7706, it is determined that a mission plan 4303 4303 should not be generated, then the unmanned vehicle system 5200 may continue the method 7700 from Block 7706 to Block 7712 to determine if the mission plan 4303 4303 is completed. From Block 77008, the unmanned vehicle system 5200 may continue the method 7700 to Block 7710 to perform at least a portion of the mission plan 4303.

If, however, at Block 7704, the unmanned vehicle system 5200 determines that a mission plan 4303 4303 is directed, then the unmanned vehicle system 5200 may continue directly from Block 7704 to Block 7710 to at least partially perform the mission plan 4303. From Block 7710, the unmanned vehicle system 5200 may continue the method 7700 to Block 7712 to determine if the mission plan 4303 4303 is completed. If, at Block 7712, it is determined that the mission plan 4303 4303 is not completed, then the unmanned vehicle system 5200 may continue the method 7700 from Block 7712 to Block 7714 to determine if the mission plan 4303 4303 should be edited. For example, without limitation, the unmanned vehicle system 5200 may determine if the mission plan 4303 4303 should be edited based on the mission plan, completed task(s) of the mission plan, uncompleted task(s) of the mission plan, and/or based on one or more operation factors.

If it is determined at Block 7714 that the mission plan 4303 4303 should not be edited, the unmanned vehicle system 5200 may continue the method 7700 from Block 7714 to Block 7710 to perform at least a portion of the mission plan 4303. If, however, at Block 7714 it is determined that the mission plan 4303 4303 should be edited, then the unmanned vehicle system 5200 may continue the method 7700 from Block 7714 to Block 7716 to edit the mission plan 4303. At Block 7716 the unmanned vehicle system 5200 may continue the method 7700 to Block 7710 to perform at least a portion of the mission plan 4303.

If, however, at Block 7712, it is determined that the mission plan 4303 4303 is completed, the unmanned vehicle system 5200 may continue the method to Block 7718 to determine if another mission plan 4303 4303 is directed. For example, without limitation, the unmanned vehicle system 5200 may determine that another mission plan 4303 4303 is directed if there were multiple mission plans 4303 received by the unmanned vehicle system 5200, and/or if there were multiple mission plans 4303 generated by the unmanned vehicle system 5200, and that one or more of the multiple mission plans 4303 have not been completed. If, at Block 7718, it is determined that another mission plan 4303 4303 is directed, the unmanned vehicle system 5200 may continue the method 770 from Block 7718 to Block 7710 to perform at least a portion of the mission plan 4303.

If, however, at Block 7718, it is determined that another mission plan 4303 4303 is not directed, then the unmanned vehicle system 5200 may continue the method 7700 from Block 7718 to Block 7720 to determine is another mission plan 4303 4303 should be generated. For example, without limitation, the unmanned vehicle system 5200 may determine if another mission plan 4303 4303 should be generated based on one or more operation factors. If, at Block 7720, it is determined that another mission should be generated, the unmanned vehicle system 5200 may continue the method 7700 to Block 7708 to generate a mission plan, which may be based on one or more operation factors. If, however, at Block 7720, it is determined that another mission plan 4303 4303 should not be generated, the unmanned vehicle system 5200 may continue the method 7700 to Block 7722 to determine if end mission plan 4303 4303 operations should be performed.

The unmanned vehicle system 5200 may determine if end mission plan 4303 4303 operations should be performed based on one or more operation factors. If, at Block 7722 it is determined that end mission plan 4303 4303 operations should be performed, then unmanned vehicle system 5200 may continue the method 7700 to Block 7724 to perform the end mission plan 4303 4303 operations. End mission plan 4303 4303 operations may include, without limitation, one or more of, moving one or more host vehicle(s) 5202 and/or guest vehicle(s) 5204 between the surfaced state 5405 and the submerged state 5402, moving one or more guest vehicle(s) 5204 between the stowed state 5220 and the deployed state 5404, propelling one or more of the host vehicle(s) 5202 and/or guest vehicle(s) 5204, moving one or more of the host vehicle(s) 5202 and/or guest vehicle(s) 5204 from the turned over state 7004 to the upright state 7002, and/or propelling one or more of the host vehicle(s) 5202 and/or guest vehicle(s) 5204 to a predetermined location. The predetermined location may include, without limitation, a safe zone and/or a pickup zone.

From Block 7724, the unmanned vehicle system 5200 may continue the method 7700 to Block 7726 to end the method 7700. If, however, at Block 7722, the unmanned vehicle system 5200 determined that end mission operations should not be performed, the unmanned vehicle system 5200 may continue the method 7700 to Block 7712 to determine if the mission plan 4303 4303 is completed. From Block 7712, the unmanned vehicle system 5200 may continue the method 7700 as detailed above.

Now referring to FIG. 78, a method aspect of some embodiments of the present invention may now be described directed to a method 7800 for using an embodiment of the unmanned vehicle system 5200 to have a host vehicle 5202 to move one or more guest vehicle(s) 5204 between the stowed state 5220 and the deployed state 5404. Beginning the method at Block 7802, and embodiment of the unmanned vehicle system 5200 may continue to Block 7804 to determine if a guest vehicle 5204 is in the stowed state 5220. If at Block 7804 it is determined that a guest vehicle 5204 is not in the stowed state 5220, then the unmanned vehicle system 5200 may continue the method 7800 to Block 7824 to end the method 7800. If, however, at Block 7804 it is determined that a guest vehicle 5204 is in the stowed state 5220, then the unmanned vehicle system 5200 may continue the method 7800 to Block 7806 to determine if the guest vehicle 5204 should be moved to the deployed state 5404 from the stowed state 5220.

For example, without limitation, the unmanned vehicle system 5200 and/or the host vehicle 5202 may be operable to determine if one or more guest vehicle(s) 5204 should be moved to the deployed state 5404 from the stowed state 5220 based on one or more of the operation factors, and/or based on one or more mission plans 4303. If, at Block 7806, the unmanned vehicle system 5200 and/or host vehicle 5202 determines that a guest vehicle 5204 should not be moved to the deployed state 5404 from the stowed state 5220, then the unmanned vehicle system 5200 may continue the method 7800 from Block 7806 to Block 7824 to end the method 7800.

If, however, at Block 7806 the unmanned vehicle system 5200 and/or host vehicle 5202 determined that one or more guest vehicle(s) 5204 should be moved to the deployed state 5404 from the stowed state 5220, the unmanned vehicle system 5200 may continue the method 7800 from Block 7806 to Block 7808 to determine if deployment conditions are satisfied. For example, without limitation, the unmanned vehicle system 5200 and/or the host vehicle 5202 may determine if deployment conditions are satisfied based on one or more of the operation factors, the mission plan, and/or data generated and sensed by one or more of the sensor and communication system(s) 5210. The deployment conditions may include, without limitation, a location, a damage control status, a time constraint, a risk assessment, a deployment necessity check, and/or a feasibility assessment.

If, at Block 7808 the unmanned vehicle system 5200 and/or host vehicle 5202 determines that the deployment conditions are not satisfied, the unmanned vehicle system 5200 and/or host vehicle 5202 may continue the method 7800 from Block 7808 to Block 7818 to determine if the deployment conditions are able to be satisfied by the unmanned vehicle system 5200 and/or the host vehicle 5202. For example, without limitation, the unmanned vehicle system 5200 and/or host vehicle 5202 may determine if the deployment conditions are able to be satisfied based on one or more of the operation factors and/or the mission plan 4303. If, at Block 7818, the unmanned vehicle system 5200 and/or host vehicle 5202 determines that the deployment conditions are not satisfiable, the unmanned vehicle system 5200 and/or host vehicle 5202 may end the method 7800 at Block 7824.

If, however, at Block 7818 the unmanned vehicle system 5200 and/or host vehicle 5202 determines that the deployment conditions are able to be satisfied, the unmanned vehicle system 5200 and/or host vehicle 5202 may continue the method 7800 from Block 7818 to Block 7820 to satisfy the deployment conditions. For example, without limitation, to satisfy the deployment conditions the unmanned vehicle system 5200 and/or host vehicle 5202 may be operable to cause, and/or one or more of the vehicle control system(s) 7102 may operate, control, and/or command one or more of the other components, members, and/or units of the host vehicle(s) 5202 and/or guest vehicle(s) 5204 to cause, one or more host vehicle(s) 5202 and/or guest vehicle(s) 5204 to move between the surfaced state 5405 and the submerged state 5402 and/or to move to a predetermined location. The predetermined location may be determined by the unmanned vehicle system 5200 and/or the host vehicle 5202 based on one or more of the operation factors and/or the mission plan 4303.

From Block 7820, the unmanned vehicle system 5200 and/or host vehicle 5202 may continue the method 7800 to Block 7810 to determine if the host vehicle 5202 and/or the guest vehicle 5204 (that is in the stowed state 5220) is in the submerged state 5402. If, however, at Block 7810, the unmanned vehicle system 5200 and/or host vehicle 5202 determined that the deployment conditions are satisfied, the unmanned vehicle system 5200 and/or host vehicle 5202 may continue the method 7800 directly from Block 7808 to Block 7810 to determine if the host vehicle 5202 and/or guest vehicle 5204 (that is in the stowed state 5220) is in the submerged state 5402. If, at Block 7810, the unmanned vehicle system 5200 and/or host vehicle 5202 determines that the host vehicle 5202 and/or guest vehicle 5204 is not in the submerged state 5402, the unmanned vehicle system 5200 and/or host vehicle 5202 may move from Block 7810 to Block 7812 to move the host vehicle 5202 and/or guest vehicle 5204 from the surfaced state 5405 to the submerged state 5402.

For example, without limitation, if the host vehicle 5202 is in the surfaced state 5405 the host vehicle 5202 may move to the submerged state 5402, and if the guest vehicle 5204 in the stowed state 5220 is in the surfaced state 5405, the host vehicle 5202 may command the guest vehicle 5204 to move to the submerged state 5402 with the host vehicle 5202. The unmanned vehicle system 5200 and/or host vehicle 5202 may continue the method 7800 from Block 7812 to Block 7814 to move the securing system 5214 of the host vehicle 5202 to the unlocked state from the locked state. If, however, at Block 7810 it is determined that the host vehicle 5202 and guest vehicle 5204 that is in the stowed state 5220 are in the submerged state 5402, the unmanned vehicle system 5200 and/or host vehicle 5202 may continue the method 7800 directly from Block 7810 to Block 7814 to move the securing system 5214 from the locked state to the unlocked state.

The unmanned vehicle system 5200 and/or host vehicle 5202 may continue the method 7800 from Block 7814 to Block 7816 to command the guest vehicle 5204 that is in the stowed state 5220 to move to the deployed state 5404. For example, the guest vehicle 5204 may utilized the guest vehicle maneuvering system 5224 to propel the guest vehicle 5204 away from the host vehicle 5202 to move the guest vehicle 5204 from the stowed state 5220 to the deployed state 5404. For another example, without limitation, the host vehicle 5202 may also and/or alternative utilized the host vehicle maneuvering system 5224 to propel the host vehicle 5202 to cause the guest vehicle 5204 to move from the stowed state 5220 to the deployed state 5404.

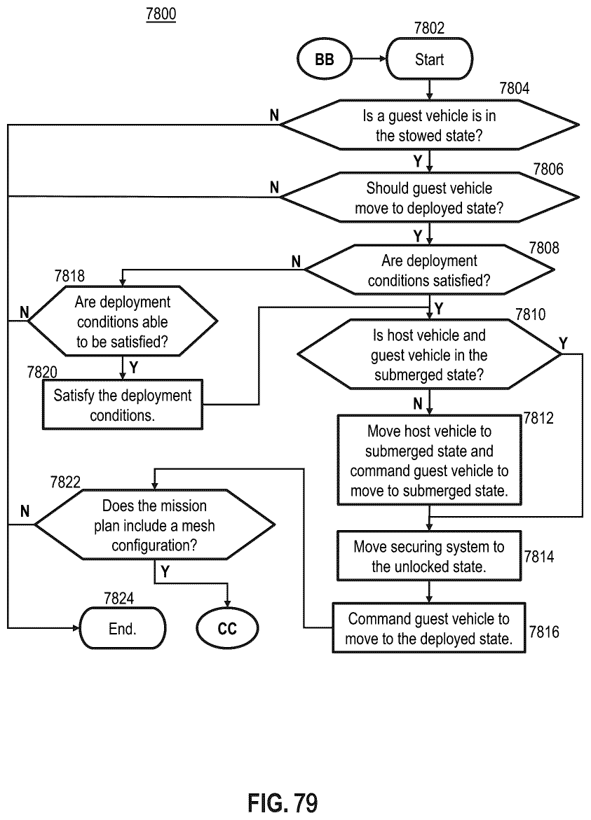

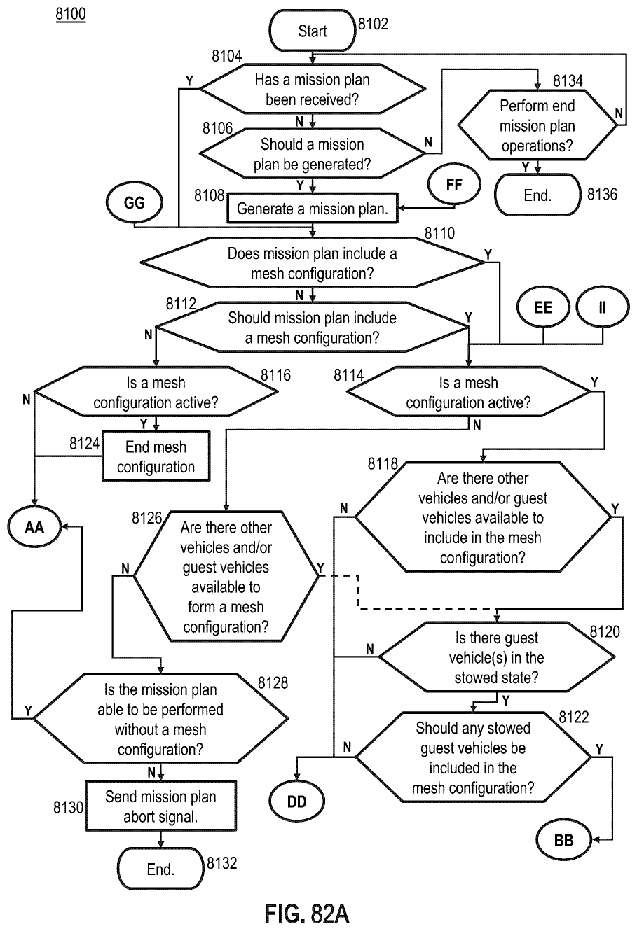

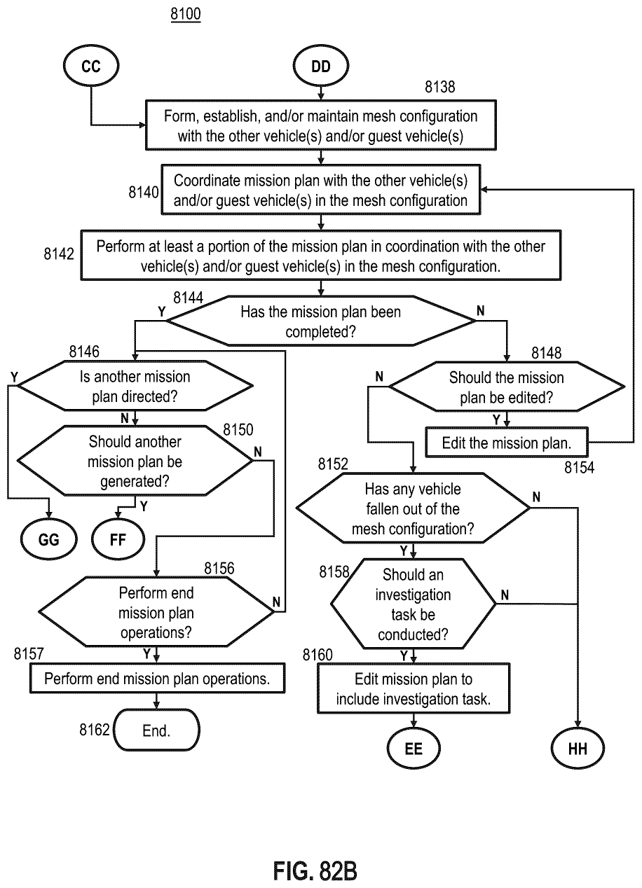

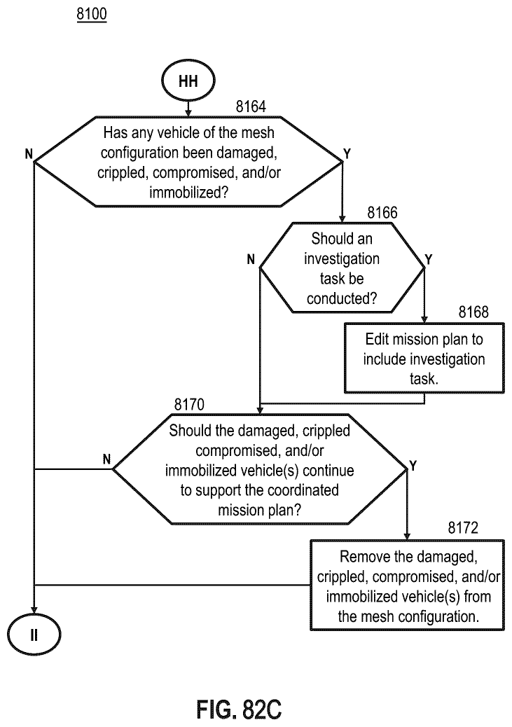

At Block 7816, the unmanned vehicle system 5200 and/or host vehicle 5202 may continue the method 7800 to Block 7822 to determine if the mission plan 4303 4303 includes a mesh configuration. If it is determined that the mission plan 4303 4303 includes a mesh configuration, the unmanned vehicle system 5200 and/or host vehicle 5202 may continue the method 7800 via path CC to Block 8138 of a method 8100 illustrated on FIG. 82B to form, establish, and/or maintain a mesh configuration with the guest vehicle 5204, and continue the method 8100 from Block 8138, which is detailed more further below. If should be understood, but without limitation, although the method 7800 is illustrated in FIG. 79 as including the step of Block 7822, the method 7800 may not include Block 7822 if the method 7800 is commenced originally and/or directly from the start at Block 7802.

For example, without limitation, the method 7800 may only include the step of Block 7822 if the method 7800 is indirectly commenced by an embodiment of the present invention moving to Block 7802 from Block 8122 via path BB of the method 8100 illustrated on FIG. 82A. For instances in which the method 7800 does not include the step of Block 7822, then embodiments of the present invention may continue the method 7800 from Block 7816 directly to Block 7824 to end the method 7800. If, however, at Block 7822, the unmanned vehicle system 5200 and/or host vehicle 5202 determines that the mission plan 4303 4303 does not include a mesh configuration, and/or determines that there is no mission plan 4303 4303 at that time, the unmanned vehicle system 5200 and/or host vehicle 5202 may move from Block 7822 to Block 7824 to end the method 7800.

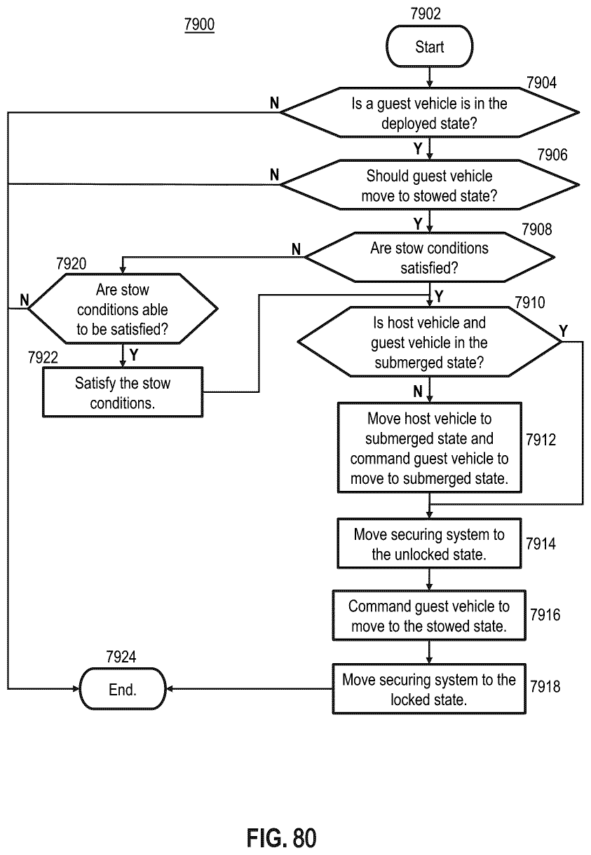

Now referring to FIG. 80, a method aspect of some embodiments of the present invention may now be described which may be directed to a method 7900 for moving an embodiments of the guest vehicle 5204 from the deployed state 5404 to the stowed state 5220. An embodiment of the present invention may commence the method 7900 at Block 7902, and may continue to Block 7904 to determine if a guest vehicle 5204 is in the deployed state 5404. For example, one or more of the host vehicle(s) 5202 may detect and/or determine if a guest vehicle 5204 is in the deployed state 5404, such as, without limitation, by detecting and/or determining if a guest vehicle 5204 is in the stowed state 5220 from sensed/detected data generated by a host vehicle sensor and communication system 5210. Another example, without limitation, one or more of the host vehicle(s) 5202 may detect and/or determine if a guest vehicle 5204 is in the deployed state 5404 based on a current state signal received from the guest vehicle 5204.

At Block 7904, if it is determined that a guest vehicle 5204 is not in the deployed state 5404, the method 7900 may continue to Block 7924 to end the method 7900. If, however, at Block 7904, an embodiment of the present invention determines that a guest vehicle 5204 is in the deployed state 5404, the method 7900 may be continued to Block 7906 to determine if the guest vehicle 5204 should be moved from the stowed state 5220 to the deployed state 5404. For example, without limitation, a host vehicle 5202 may determine if the guest vehicle 5204 should be moved from the deployed state 5404 to the stowed state 5220 based on one or more of a mission plan, an operation factor, and/or based on a stowed request received by the host vehicle 5202 from the guest vehicle 5204. If, at Block 7906, it is determined that the guest vehicle(s) 5204 should not be moved to the stowed state 5220 from the deployed state 5404, the unmanned vehicle system 5200 may continue the method 7900 to Block 7924 to end the method 7900.

If, however, at Block 7906, the unmanned vehicle system 5200 determines that one or more guest vehicle(s) 5204 should be moved from the deployed state 5404 to the stowed state 5220, the unmanned vehicle system 5200 may continue the method 7900 to Block 7908 to determine if stow conditions may be satisfied. An embodiment of the unmanned vehicle system 5200 may determine if stow conditions are satisfied based on one or more of a mission plan 4303 4303 and/or operation factors in comparison with the stow conditions. The stow conditions may include, without limitation, if the host vehicle 5202 is able to carry a, and/or another, guest vehicle 5204 in the stowed state 5220, if the host vehicle 5202 and/or guest vehicle 5204 are capable of moving to the submerged state 5402 from a surfaced state 5405, if the securing system 5214 and/or maneuvering systems 5224 of the host vehicle 5202/guest vehicle 5204 are operational, and/or if the guest vehicle 5204 and host vehicle 5202 are near one another.

If, at Block 7908, the unmanned vehicle system 5200 determines that the stow conditions are not satisfied, the method 7900 may be continued to Block 7920 to determine if the stow conditions are able to be satisfied. For example, without limitation, an embodiment of the unmanned vehicle system 5200 may determine if the stow conditions are able to be satisfied, such as, if the guest vehicle buoyancy system 7116 is nonoperational but the guest vehicle 5204 is already in the submerged state 5402, if the guest vehicle maneuvering system 5224 is nonoperational but at least the host vehicle maneuvering system 5224 is operational, and/or if the securing system 5214 is at least partially operational (such as, without limitation, at least one securing unit 5304 being operable). The unmanned vehicle system 5200 may also determine if the stow conditions are able to be satisfied based upon the mission instruction and/or one or more operation factor. Also, the unmanned vehicle system 5200 may determine if the stow conditions are able to be satisfied by comparing the stow conditions to one or more operation factor.

If, at Block 7920, the unmanned vehicle system 5200 determines that the stow conditions are unable to be satisfied, the system 5200 may end that method 7900 at Block 7924. If, however, it is determined at Block 7920 that the stow conditions are able to be satisfied, the unmanned vehicle system 5200 may continue to Block 7922 to satisfy the stow conditions. At Block 7922, the unmanned vehicle system 5200 may move to Block 7910 to determine if the host vehicle 5202 and guest vehicle 5204 are in the submerged state 5402. If, however, at Block 7908, the unmanned vehicle system 5200 determined that the stow conditions are satisfied, the unmanned vehicle system 5200 may continue the method 7900 directly from Block 7908 to Block 7910 to determine if the host vehicle 5202 and guest vehicle 5204 are in the submerged state 5402.

At Block 5402, if it is determined that either the host vehicle 5202 or guest vehicle 5204 are not in the submerged state 5402, the unmanned vehicle system 5200 may continue the method 7900 to Block 7912 to move the host vehicle 5202 to the submerged state 5402 and/or for the host vehicle 5202 to command the guest vehicle 5204 to move to the submerged state 5402. The unmanned vehicle system 5200 may continue the method 7900 from Block 7912 to 7914 to move the securing system 5214 to the unlocked state. If, however, at Block 7910, it is determined that the host vehicle 5202 and the guest vehicle 5204 are both in the submerged state 5402, the unmanned vehicle system 5200 may directly continue the method 7900 from Block 7910 to Block 7914 to move the securing system 5214 to the unlocked state.

The unmanned vehicle system 5200 may continue the method 7900 from Block 7914 to Block 7916 to command the guest vehicle 5204 to move from the deployed state 5404 to the stowed state 5220. For example, without limitation, the guest vehicle 5204 may propel itself using the guest vehicle maneuvering system 5224 to move the guest vehicle 5204 from the deployed state 5404 to the stowed state 5220 responsive to a stow command received by the guest vehicle 5204 from the host vehicle 5202. In some embodiment of the present invention, if the guest vehicle maneuvering system 5224 is at least significantly nonoperational, the guest vehicle 5204 may be moved from the deployed state 5404 to the stowed state 5220 by the host vehicle maneuvering system 5224 propelling the host vehicle 5202 towards the guest vehicle 5204 to move the guest vehicle 5204 from the deployed state 5404 to the stowed state 5220.

From Block 7916, the unmanned vehicle system 5200 may continue the method 7900 to Block 7918 to move the securing system 5214 from the unlocked state to the locked state. At Block 7918, the unmanned vehicle system 5200 may continue the method 7900 to Block 7924 to end the method 7900.

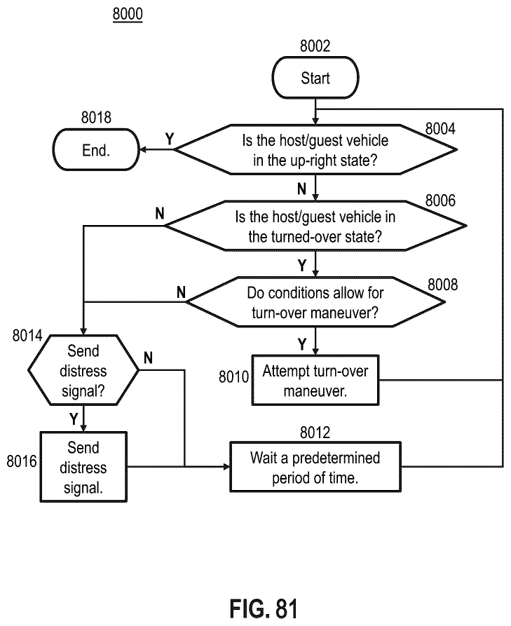

Now referring to FIG. 81, a method aspect of some embodiments of the present invention may be described, which may be directed to a method 8000 of moving the host vehicle 5202 and/or guest vehicle 5204 from the turned-over state 7004 to the upright state 7002. Starting at Block 8002, and embodiment of the unmanned vehicle system 5200 may continue the method 8000 to Block 8004 to determine if the host vehicle 5202/guest vehicle 5204 is in the upright state 7002. If it is determined at Block 8004 that the host vehicle 5202/guest vehicle 5204 is in the upright state 7002, the unmanned vehicle system 5200 may continue the method 8000 to Block 8018 to end the method 8000.

If, however, at Block 8004, it is determined that the host vehicle 5202/guest vehicle 5204 is not in the upright state 7002, the unmanned vehicle system 5200 may continue the method to Block 8006 to determine if the host vehicle 5202/guest vehicle 5204 is in the turned-over state 7004. If it is determined at Block 8006 that the host vehicle 5202/guest vehicle 5204 is not in the turned-over state 7004, the unmanned vehicle system 5200 may continue the method 8000 to Block 8014 to determine if the host vehicle 5202/guest vehicle 5204 should send and/or emit a distress signal. For example, without limitation, instances where the host vehicle 5202/guest vehicle 5204 are neither in the upright state 7002 nor the turned-over state 7004 may be when the host vehicle 5202/guest vehicle 5204 are one or more of beached, has crippled mobility, immobile, stuck, captured, snared, snagged, and/or otherwise unable and/or incapable to freely move as may be understood by one who may have skill in the art.

If, at Block 8014, the unmanned vehicle system 5200 determines that a distress signal should be sent and/or emitted, the method 8000 may be continued to Block 8016 for the host vehicle 5202/guest vehicle 5204 to send and/or emit a distress signal. The distress signal may be related to, the restricted mobility and/or immobility of the host vehicle 5202/guest vehicle 5204, and/or the location of the host vehicle 5202/guest vehicle 5204, which may be determined by the host vehicle 5202/guest vehicle 5204 based on data sensed, detect, and/or generated by the guest vehicle sensor and communication system 5210/host vehicle sensor and communication system 5210 and the guest vehicle control system 7102/host vehicle control system 7102. From Block 8016 the unmanned vehicle system 5200 may continue the method 8000 to Block 8012 to wait a predetermined period of time.

If, however, at Block 8014, the unmanned vehicle system 5200 determines that a distress signal should not be sent and/or emitted, the method 8000 may be continued by the unmanned vehicle system 5200 directly from Block 8014 to Block 8012 to wait a predetermined period of time. From Block 8012, the method 8000 may be continued to Block 8004. At Block 8004, the unmanned vehicle system 5200 may continue the method 8000 steps as previously described above.

Now referring to FIGS. 82A-82C, a method aspect of some embodiments of the present invention may now be described, which may comprise a method 8100 for performance of one or more mission plans 4303 by an embodiment of the unmanned vehicle system 5200 that may comprise one or more host vehicle 5202 and/or one or more guest vehicle 5204. The unmanned vehicle system 5200 may start the method 8100 at Block 8102 and continue to Block 8104 to determine if a mission plan 4303 4303 has been received, such as, received by a host vehicle 5202 and/or guest vehicle 5204. If, at Block 8104, it is determined that a mission plan 4303 4303 has not been received, the unmanned vehicle system 5200 may continue the method 8100 to Block 8106 to determine if a mission plan 4303 4303 should be generated.

If it is determined at Block 8106 that a mission plan 4303 4303 should not be generated, the unmanned vehicle system 5200 may continue the method 8100 to Block 8134 to determine if end mission plan 4303 4303 operations should be performed. If it is determined at Block 8134 that the end mission plan 4303 4303 operations should be performed, the unmanned vehicle system 5200 may end the method 8100 at Block 8136. If, however, at Block 8134 it is determined by the unmanned vehicle system 5200 that end mission plan 4303 4303 operations should not be performed, the unmanned vehicle system 5200 may move to Block 8104 to continue the method 8100 from Block 8104 as described herein. If, however, at Block 8106 the unmanned vehicle system 5200 determines that a mission plan 4303 4303 should be generated, the unmanned vehicle system 5200 may continue the method 8100 to Block 8108 to generate a mission plan 4303.

From Block 8108, the unmanned vehicle system 5200 may continue to Block 8110 to determine if the mission plan 4303 4303 includes a mesh configuration. If, however, at Block 8104 it is determined that a mission plan 4303 4303 has been received, the unmanned vehicle system 5200 may continue the method 8100 directly from Block 8104 to Block 8110 to determine if the mission plan 4303 includes a mesh configuration. If it is determined at Block 8110 that the mission plan 4303 does not include a mesh configuration, the unmanned vehicle system 5200 may continue the method 8100 to Block 8112 to determine if the mission plan 4303 should include a mesh configuration. For example, without limitation, the unmanned vehicle system 5200 may determine if the mission plan 4303 should include a mesh configuration based on a comparison between the mission plan 4303 and one or more operation factors.

If, at Block 8112, the unmanned vehicle system 5200 determined that the mission plan 4303 should not include a mesh configuration, the method 8100 may be continued to Block 8116 to determine if a mesh configuration is active. If, at Block 8116, it is determined that a mesh configuration is active, the unmanned vehicle system 5200 may continue the method 8100 to Block 8124 to end the mesh configuration. From Block 8124, the unmanned vehicle system 5200 may continue the method 8100 through path AA to Block 7702 illustrated in FIG. 78 to start and perform the method 7700 as described herein. If, however, at Block 8116 it is determined by the unmanned vehicle system 5200 that a mesh configuration is not active, the unmanned vehicle system 5200 may directly continue the method 8100 from Block 8116 to Block 7702 illustrated in FIG. 78 to start and perform the method 7700 as described herein.

If, however, at Block 8112, the unmanned vehicle system 5200 determines determined that the mission plan 4303 should include a mesh configuration, the unmanned vehicle system 5200 may continue the method 8100 to Block 8114 to determine if a mesh configuration is active. If, however, at Block 8110, the unmanned vehicle system 5200 determined that the mission plan 4303 does include a mesh configuration, the unmanned vehicle system 5200 may continue the method 8100 directly from Block 8110 to Block 8114 to determine if a mesh configuration is active. If, at Block 8114, the unmanned vehicle system 5200 determines that a mesh configuration is not active, the unmanned vehicle system 5200 may continue to Block 8126 to determine if a mesh configuration may be formed between more than one host vehicle 5202, guest vehicle 5204, associate device 6806, and/or another vehicle 6804.

If, at Block 8126, the unmanned vehicle system 5200 determines that a mesh configuration cannot be formed, the unmanned vehicle system 5200 may continue the method 8100 to 8128 to determine if the mission plan 4303 may be performed without a mesh configuration. If, at Block 8128, it is determined that the mission plan 4303 cannot be performed without a mesh configuration, the unmanned vehicle system 5200 may continue to Block 8130 to send and/or emit a mission plan 4303 abort signal. From Block 8130, the unmanned vehicle system 5200 may end the method 8100 at Block 8132. If, however, at Block 8128, the unmanned vehicle system 5200 determines that the mission plan 4303 can be performed without a mesh configuration, the unmanned vehicle system 5200 may continue the method 8100 from Block 8128 to Block 7702 illustrated in FIG. 78 to start and perform the method 7700 as described herein.

If, however, at Block 8126, the unmanned vehicle system 5200 determined that it is able to form a mesh configuration, the unmanned vehicle system 5200 may continue the method 8100 to Block 8120 to determine if there is one or more guest vehicle(s) 5204 that may be in the stowed state 5220. If, however, at Block 8114, the unmanned vehicle system 5200 determines that a mesh configuration is active, the unmanned vehicle system 5200 may continue the method 8100 from Block 8114 to Block 8118 to determine if there is/are any other host vehicle 5202, guest vehicle 5204, associate device 6806, and/or other vehicle 6804 that may be included in the mesh configuration. If the unmanned vehicle system 5200 determines an answer of yes at Block 8118, the unmanned vehicle system 5200 may continue the Block 8120 to determine if there is any guest vehicle 5204 in the stowed state 5220.

If, at Block 8120, the unmanned vehicle system 5200 determines that there is/are one or more guest vehicle 5204 in the stowed state 5220, the unmanned vehicle system 5200 may continue to Block 8112 to determine if the one or more guest vehicle(s) 5204 in the stowed state 5220 should be included in the mesh configuration. If the unmanned vehicle system 5200 determines an answer of no at Block 8112, the unmanned vehicle system 5200 may continue the method 8100 through path DD to Block 8138 illustrated in FIG. 82B. If, however, at Block 8120, the unmanned vehicle system 5200 determined an answer of no, the unmanned vehicle system 5200 may continue the method 8100 directly from Block 8120 through path DD to Block 8138 illustrated in FIG. 82B. Moreover, and however, if at Block 8118 the unmanned vehicle system 5200 determined an answer of no, the unmanned vehicle system 5200 may continue the method 8100 directly from Block 8118 through path DD to Block 8138 illustrated in FIG. 82B.

If, however, at Block 8122, the unmanned vehicle system 5200 determines that the guest vehicle(s) 5204 in the stowed state 5220 should be included in the mesh configuration, the unmanned vehicle system 5200 may continue the method 8100 from Block 8122 through path BB to Block 7802 illustrated in FIG. 79 to start and perform the method 7800 as described herein. When some embodiments of the present invention start and perform the method 7800 via the path BB, some embodiments may determine an answer of yes to Block 7822 and continue from Block 7822 through path CC to Block 8138 illustrated in FIG. 82B to continue the method 8100 therefrom.

At Block 8138, the unmanned vehicle system 5200 may form, establish, and/or maintain a/the mesh configuration with the more than one host vehicle(s) 5202, guest vehicle(s) 5204, associate device(s) 6806, and/or other vehicle(s) 6804. At Block 8138, the unmanned vehicle system 5200 may continue the method 8100 to Block 8140 to coordinate the mission plan 4303 with the host vehicle(s) 5202, guest vehicle(s) 5204, associate device(s) 6806, and/or other vehicle(s) 6804 that are in and/or a part of the mesh configuration. From Block 8140, the unmanned vehicle system 5200 may continue the method 8100 to Block 8142 to perform at least a portion of the mission plan 4303 in coordination with the host vehicle(s) 5202, guest vehicle(s) 5204, associate device(s) 6806, and/or other vehicle(s) 6804 that are in and/or a part of the mesh configuration.

From Block 8142, the unmanned vehicle system 5200 may continue the method 8100 to Block 8144 to determine if the mission plan 4303 has been completed. If, at Block 8144, the unmanned vehicle system 5200 determines an answer of yes, the unmanned vehicle system 5200 may continue the method 8100 to Block 8146 to determine if another mission plan 4303 has been directed. If the unmanned vehicle system 5200 determines an answer of yes at Block 8146, the unmanned vehicle system 5200 may continue the method 8110 from Block 8146 through path GG to Block 8110 illustrated in FIG. 82A to continue the method 8100 therefrom as described herein. If, however, at Block 8146 the unmanned vehicle system 5200 determines that another mission plan 4303 has not been and/or is not directed, the unmanned vehicle system 5200 may continue the method 8100 from Block 8146 to Block 8150. At Block 8150, the unmanned vehicle system 5200 may determine if another mission plan 4303 should be generated. If the unmanned vehicle system 5200 determines that another mission plan 4303 should be generated, the unmanned vehicle system 5200 may continue the method 8100 from Block 8150 through path FF to Block 8108 illustrated in FIG. 82A to continue the method 8100 therefrom as described herein.

If, however, at Block 8150 the unmanned vehicle system 5200 determines that another mission plan 4303 should not be generated, the unmanned vehicle system 5200 may continue from Block 8150 to Block 8156 to determine if end mission plan 4303 operations should be performed. At Block 8156, if the unmanned vehicle system 5200 determines an answer of yes, the unmanned vehicle system 5200 may continue the method 8100 to Block 8157 to perform the end mission plan 4303 operations and end the method 8100 at Block 8162. If, however, at Block 8156, the unmanned vehicle system 5200 determines that the end mission plan 4303 operations should not be performed, the unmanned vehicle system 5200 may continue the method 8100 from Block 8156 to Block 8146 to continue the method 8100 therefrom as described herein.

However, if at Block 8144, the unmanned vehicle system 5200 determines that the mission plan 4303 has not been completed, the unmanned vehicle system 5200 may continue the method 8100 to Block 8148 to determine if the mission plan 4303 should be edited. For example, without limitation, the unmanned vehicle system 5200 may determine if the mission plan 4303 should be edited based on the mission plan, any completed portions of the mission plan, any non-completed portions of the mission plan, and/or based on one or more operation factors. If the unmanned vehicle system 5200 determines an answers of yes at Block 8148, the unmanned vehicle system 5200 may continue from Block 8148 to Block 8154 to edit the mission plan 4303. At Block 8154, the unmanned vehicle system 5200 may continue the method 8100 to Block 8140 to continue the method 8100 therefrom as described herein.

If, however, at Block 8148 the unmanned vehicle system 5200 determines that the mission plan 4303 should not be edited, the unmanned vehicle system 5200 may continue the method 8100 from Block 8148 to Block 8152 to determine if any vehicle (5202, 5204, 6806, and/or 6804) has fallen out of the mesh configuration. For example, without limitation, the unmanned vehicle system 5200, host vehicle 5202, and/or guest vehicle 5204 may determine if any vehicle (5202, 5204, 6806, and/or 6804) has fallen out of the mesh configuration if a vehicle (5202, 5204, 6806, and/or 6804) is, and/or is no longer, in communication with the mesh configuration, and/or is, and/or is not longer, operable to communicate via the mesh configuration. In some embodiments of the unmanned vehicle system 5200, the host vehicle 5202 and/or guest vehicle 5204 may be operable to determine if a vehicle (5202, 5204, 6806, and/or 6804) has fallen out of the mesh configuration based on data that may be at least one of received from, sensed by, detected by, determined by, and/or communicated from one or more vehicle control system 7102, sensor and communication system 5210, host vehicle 5202, guest vehicle 5204, associate device 6806, and/or other vehicle 6804.

If, at Block 8152, it is determined that any vehicle (5202, 5204, 6806, and/or 6804) has fallen out of the mesh configuration, the unmanned vehicle system 5200 may continue the method 8100 to Block 8158 to determine if an investigation task should be conducted. For example, without limitation, the unmanned vehicle system 5200 may determine if an investigation task should be conducted based on one or more of the mission plan, any completed portions of the mission plan, any non-completed portions of the mission plan, one or more operation factors, and/or data that may be at least one of received from, sensed by, detected by, determined by, and/or communicated from one or more vehicle control system 7102, sensor and communication system 5210, host vehicle 5202, guest vehicle 5204, associate device 6806, and/or other vehicle 6804. If the unmanned vehicle system 5200 determines an answer of yes at Block 8158, the unmanned vehicle system 5200 may continue the method to Block 8160 to edit the mission plan 4303 to include an investigation task.

For example, and without limitation, an investigation task may include one or more host vehicle 5202 and/or guest vehicle 5204 maneuvering, searching, detecting, determining, and/or identifying one or more of the location of any vehicle (5202, 5204, 6806, and/or 6804) that has fallen out of the mesh configuration, what may have caused the vehicle(s) (5202, 5204, 6806, and/or 6804) to fall out of the mesh configuration. Also, without limitation, an investigation task may include recovery operations to be performed by the unmanned vehicle system 5200, host vehicle(s) 5202, and/or guest vehicle(s) 5204 to recover any vehicle (5202, 5204, 6806, and/or 6804) that has fallen out of the mesh configuration.

From Block 8160, the unmanned vehicle system 5200 may continue the method 8100 through path EE to Block 8114 illustrated in FIG. 82A to continue the method 8100 therefrom as described herein. If, however, at Block 8158, the unmanned vehicle system 5200 determines that an investigation task should not be conducted, the unmanned vehicle system 5200 may continue the method 8100 from Block 8158 through path HH to Block 8164 illustrated in FIG. 82C. If, however, at Block 8152 the unmanned vehicle system 5200 determines that no vehicle (5202, 5204, 6806, and/or 6804) has fallen out of the mesh configuration, the unmanned vehicle system 5200 may continue the method 8100 directly from Block 8152 through path HH to Block 8164 illustrated in FIG. 82C.

At Block 6184, the unmanned vehicle system 5200 may determine if any vehicle (5202, 5204, 6806, and/or 6804) of the mesh configuration have been one or more of damaged, crippled, compromised, and/or immobilized. For example, without limitation, the unmanned vehicle system 5200, a host vehicle 5202, and/or a guest vehicle 5204 may determine if any vehicle (5202, 5204, 6806, and/or 6804) of the mesh configuration have been one or more of damaged, crippled, compromised, and/or immobilized based on one or more operation factors, and/or data that may be at least one of received from, sensed by, detected by, determined by, and/or communicated from one or more vehicle control system 7102, sensor and communication system 5210, host vehicle 5202, guest vehicle 5204, associate device 6806, and/or other vehicle 6804. If the unmanned vehicle system 5200 determines an answer of yes at Block 8164, the unmanned vehicle system 5200 may continue the method 8100 to Block 8166 to determine if an investigation task should be conducted.

If, at Block 8166, the unmanned vehicle system 5200 determines that an investigation task should be conducted, the unmanned vehicle system 5200 may continue the method 8100 to Block 8168 to edit the mission plan 4303 to include an investigation task. From Block 8168, the unmanned vehicle system 5200 may continue to Block 8170 to determine if any damaged, crippled, compromised, and/or immobilized vehicle (5202, 5204, 6806, and/or 6804) should continue to support the coordinated mission plan 4303. If, however, at Block 8166, the unmanned vehicle system 5200 determined that an investigation task should not be conducted, the unmanned vehicle system 5200 may continue the method 8100 directly from Block 8166 to Block 8170.

Without limitation, the unmanned vehicle system 5200, a host vehicle 5202, and/or a guest vehicle 5204 may be operable to determine if any damaged, crippled, compromised, and/or immobilized vehicle (5202, 5204, 6806, and/or 6804) should continue to support the coordinated mission plan 4303 based on one or more of the mission plan, any completed portions of the mission plan, any non-completed portions of the mission plan, one or more operation factors, and/or data that may be at least one of received from, sensed by, detected by, determined by, and/or communicated from one or more vehicle control system 7102, sensor and communication system 5210, host vehicle 5202, guest vehicle 5204, associate device 6806, and/or other vehicle 6804. If, at Block 8170 the unmanned vehicle system 5200 determines an answer of yes, the unmanned vehicle system 5200 may continue the method 8100 from Block 8170 to Block 8172 to remove the damaged, crippled, compromised, and/or immobilized vehicle (5202, 5204, 6806, and/or 6804) from the mesh configuration.

From Block 8172 the unmanned vehicle system 5200 may continue the method 8100 through path II to Block 8114 illustrated in FIG. 82B to continue the method 8100 therefrom as described herein. If, however, at Block 8164 the unmanned vehicle system 5200 determines that no vehicle (5202, 5204, 6806, and/or 6804) is damaged, crippled, compromised, and/or immobilized, the unmanned vehicle system 5200 may continue the method 8100 directly from Block 8164 through path II to Block 8114 illustrated in FIG. 82B to continue the method 8100 therefrom as described herein.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

The claims in the instant application are different than those of the parent application or other related applications. Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. An unmanned vehicle system comprising:
a host vehicle comprising:
a host vehicle body;
a host vehicle control system;
a host vehicle maneuvering system in communication with the host vehicle control system and operable to provide propulsion to the host vehicle;
a host vehicle sensor and communication system in communication with the host vehicle control system; and
a securing system carried by the host vehicle body and in communication with the host vehicle control system; and
a guest vehicle comprising:
a guest vehicle body;
a guest vehicle control system positioned in communication with the host vehicle control system;
a guest vehicle maneuvering system in communication with at least one of the guest vehicle control system and the host vehicle control system, the guest vehicle maneuvering system being operable to provide propulsion to the guest vehicle; and
a guest vehicle sensor and communication system in communication with at least one of the guest vehicle control system and the host vehicle control system; and
wherein the guest vehicle is moveable between a stowed state and a deployed state;
wherein the stowed state of the guest vehicle is defined as the guest vehicle being at least partially carried by a portion of the host vehicle;
wherein the deployed state of the guest vehicle is defined as the guest vehicle being spaced apart from the host vehicle;
wherein the securing system is operable to move between a locked state and an unlocked state to selectively engage the guest vehicle;
wherein when the guest vehicle is in the stowed state, the securing system is in the locked state; and
wherein movement of the securing system from the locked state to the unlocked state allows for the guest vehicle to be moved from the stowed state to the deployed state.

2. The system of claim 1, further comprising a host vehicle buoyancy system in communication with the host vehicle control system and operable to control a flow of water comprising outside environment water into and out of a portion of the host vehicle body to cause the host vehicle to move between a surfaced state and a submerged state.

3. The system of claim 2, further comprising a guest vehicle buoyancy system in communication with the guest vehicle control system and operable to control a flow of water comprising outside environment water into and out of a portion of the guest vehicle body to cause the guest vehicle to move between a surfaced state and a submerged state.

4. The system of claim 3, wherein the host vehicle and the guest vehicle are moveable between the surfaced state and the submerged state when the guest vehicle is in the stowed state; and wherein the guest vehicle buoyancy system is in communication with the host vehicle control system to be operable by and responsive to command signals received from the host vehicle control system.

5. The system of claim 4, wherein the command signals include maneuvering command signals; wherein the guest vehicle maneuvering system is in communication with the host vehicle control system to be operable by and responsive to the maneuvering command signals received; and wherein the guest vehicle maneuvering system is operable when the guest vehicle is in the stowed state to provide propulsion to the host vehicle.

6. The system of claim 4, wherein the securing system is moveable between the locked state and the unlocked state when the host vehicle is in the submerged state to allow the guest vehicle to move between the stowed state and the deployed state when the guest vehicle is in the submerged state.

7. The system of claim 1, wherein the guest vehicle comprises an onboard power supply in communication with at least one of the guest vehicle control system, the guest vehicle maneuvering system, and the guest vehicle sensor and communication system; and wherein the onboard power supply is operable to be charged by the host vehicle when the guest vehicle is in the stowed state.

8. The system of claim 1, wherein the guest vehicle comprises a plurality of guest vehicles; wherein each of the plurality of guest vehicles are operable to move between the stowed state and the deployed state; wherein at least one of the plurality of guest vehicles is in communication with the host vehicle; and wherein each of the plurality of guest vehicles are operable to communicate with one another.

9. The system of claim 8, wherein the host vehicle is adapted to carry more than one of the plurality of guest vehicles.

10. The system of claim 8, wherein the host vehicle and the plurality of guest vehicles are in communication with a network; and wherein the host vehicle and the plurality of guest vehicles are operable to be remotely commanded and controlled via the network.

11. The system of claim 8, wherein each one of the plurality of guest vehicles are operable to transmit command signals to each of the plurality of guest vehicles.

12. The system of claim 8, wherein the communication between the host vehicle and the plurality of guest vehicles is defined as a mesh network; and wherein the host vehicle control system and the guest vehicle control systems of each of the plurality of guest vehicles are operable to communicate with one another via the mesh network.

13. The system of claim 12, wherein the host vehicle comprises a plurality of host vehicles; wherein each of the plurality of host vehicles is adapted to carry at least one of the plurality of guest vehicles; and wherein each of the plurality of host vehicles are in communication with one another to further define the mesh network.

14. The system of claim 1, wherein the guest vehicle maneuvering system is operable to move the guest vehicle from a turned over state to an upright state; and wherein the host vehicle maneuvering system is operable to move the host vehicle from the turned over state to the upright state.

15. The system of claim 1, further comprising a plurality of housings that are each carried by at least one of the host vehicle body and the guest vehicle body; and wherein each of the plurality of housings are adapted to carry at least a portion of at least one of the host vehicle control system, the host vehicle maneuvering system, the host vehicle sensor and communication system, the securing system, the guest vehicle control system, the guest vehicle maneuvering system, and the guest vehicle sensor and communication system.

16. The system of claim 15, wherein the host vehicle and the guest vehicle each comprise a rail system; and wherein each of the plurality housings are adapted to slidably engage to the rail system.

17. An unmanned vehicle system comprising:
a host vehicle comprising:
a host vehicle body;
a host vehicle control system;
a host vehicle maneuvering system in communication with the host vehicle control system and operable to provide propulsion to the host vehicle;
a host vehicle sensor and communication system in communication with the host vehicle control system;
a securing system carried by the host vehicle body and in communication with the host vehicle control system; and
a host vehicle rail system; and
a plurality of guest vehicles, each one of the plurality of guest vehicles comprising:
a guest vehicle body;
a guest vehicle control system positioned in communication with the host vehicle control system;
a guest vehicle maneuvering system in communication with the guest vehicle control system, the guest vehicle maneuvering system being operable to provide propulsion to the guest vehicle;
a guest vehicle sensor and communication system in communication with at least one of the guest vehicle control system and the host vehicle control system; and
a guest vehicle rail system; and
a plurality of housings that are each carried by at one of the host vehicle body and the guest vehicle body of one of the plurality of guest vehicles;
wherein each of the plurality of housings are adapted to carry at least a portion of at least one of the host vehicle control system, the host vehicle maneuvering system, the host vehicle sensor and communication system, the securing system, the guest vehicle control system, the guest vehicle maneuvering system, and the guest vehicle sensor and communication system;
wherein each one of the plurality of guest vehicles are operable to be in communication with the host vehicle and with at least another one of the plurality of guest vehicles;
wherein each of the plurality housings are adapted to slidably engage to the rail system;
wherein each one of the plurality of guest vehicles are operable to move between a stowed state and a deployed state;
wherein the stowed state of each guest vehicle of the plurality of guest vehicles is defined as the guest vehicle being at least partially carried by a portion of the host vehicle;
wherein the deployed state of each guest vehicle of the plurality of guest vehicles is defined as the guest vehicle being spaced apart from the host vehicle;
wherein the securing system is operable to move between a locked state and an unlocked state to selectively engage at least one guest vehicle of the plurality of guest vehicles;
wherein when at least one of the plurality of guest vehicles is in the stowed state, the securing system is in the locked state; and
wherein movement of the securing system from the locked state to the unlocked state allows for at least one of the plurality of guest vehicles to be moved from the stowed state to the deployed state.

18. The system of claim 17, wherein the host vehicle comprises a host vehicle buoyancy system in communication with the host vehicle control system and operable to control a flow of water comprising outside environment water into and out of a portion of the host vehicle body to cause the host vehicle to move between a surfaced state and a submerged state; and wherein each guest vehicle of the plurality of guest vehicles comprises a guest vehicle buoyancy system in communication with the guest vehicle control system and operable to control a flow of water comprising outside environment water into and out of a portion of the guest vehicle body to cause the guest vehicle to move between a surfaced state and a submerged state.

19. The system of claim 18, wherein the host vehicle and the plurality of guest vehicles are moveable between the surfaced state and the submerged state when at least one of the guest vehicles of the plurality of guest vehicles is in at least one of the stowed state and the deployed state; and wherein the guest vehicle buoyancy systems of the plurality of guest vehicles are in communication with the host vehicle control system to be operable by and responsive to commands received from the host vehicle control system.

20. The system of claim 19, wherein the command signals include maneuvering command signals; wherein the guest vehicle maneuverings systems are in communication with the host vehicle control system to be operable by and responsive to the maneuvering command signals received; and wherein the guest vehicle maneuvering system of each guest vehicle of the plurality of guest vehicles is operable when the guest vehicle is in the stowed state to provide propulsion to the host vehicle.

21. The system of claim 19, wherein the securing system is moveable between the locked state and the unlocked state when the host vehicle is in the submerged state to allow at least one of the plurality of guest vehicles to move between the stowed state and the deployed state when the at least one guest vehicle is in the submerged state.

22. The system of claim 17, wherein each one of the plurality of guest vehicles comprises an onboard power supply in communication with at least one of the guest vehicle control system, the guest vehicle maneuvering system, and the guest vehicle sensor and communication system; and wherein the onboard power supply is operable to be charged by the host vehicle when the guest vehicle is in the stowed state.

23. The system of claim 17, wherein the host vehicle is adapted to carry more than one of the plurality of guest vehicles.

24. The system of claim 17, wherein the host vehicle and the plurality of guest vehicles are in communication with a network; and wherein the host vehicle and the plurality of guest vehicles are operable to be remotely commanded and controlled via the network.

25. The system of claim 17, wherein each one of the plurality of guest vehicles are operable to transmit command signals to each of the plurality of guest vehicles.

26. The system of claim 17, wherein the communication between the host vehicle and the plurality of guest vehicles is defined as a mesh network; and wherein the host vehicle control system and the guest vehicle control systems of each of the plurality of guest vehicles are operable to communicate with one another via the mesh network.

27. The system of claim 26, wherein the host vehicle comprises a plurality of host vehicles; wherein each of the plurality of host vehicles is adapted to carry at least one of the plurality of guest vehicles; and wherein each of the plurality of host vehicles are in communication with one another to further define the mesh network.

28. The system of claim 17, wherein the guest vehicle maneuvering systems of each of the plurality of guest vehicles are operable to move the guest vehicle from a turned over state to an upright state; and wherein the host vehicle maneuvering system is operable to move the host vehicle from the turned over state to the upright state.

29. An unmanned vehicle system comprising:
a plurality of host vehicles, each host vehicle of the plurality of host vehicles comprising:
a host vehicle body;
a host vehicle control system;
a host vehicle maneuvering system in communication with the host vehicle control system and operable to provide propulsion to the host vehicle;
a host vehicle sensor and communication system in communication with the host vehicle control system;
a securing system carried by the host vehicle body and in communication with the host vehicle control system; and
a host vehicle buoyancy system in communication with the host vehicle control system and operable to control a flow of water comprising outside environment water into and out of a portion of the host vehicle body to cause the host vehicle to move between a surfaced state and a submerged state; and
a plurality of guest vehicles, each guest vehicle of the plurality of guest vehicles comprising:
a guest vehicle body;
a guest vehicle control system positioned in communication with at least one of the host vehicle control systems;
a guest vehicle maneuvering system in communication with the guest vehicle control system and at least one of the host vehicle control systems, the guest vehicle maneuvering system being operable to provide propulsion to the guest vehicle;
a guest vehicle sensor and communication system in communication with the guest vehicle control system and at least one of the host vehicle control systems; and
a guest vehicle buoyancy system in communication with the guest vehicle control system and operable to control a flow of water comprising outside environment water into and out of a portion of the guest vehicle body to cause the guest vehicle to move between a surfaced state and a submerged state; and
wherein each one of the plurality of host vehicles is adapted to carry one of the plurality of guest vehicles;
wherein each of the plurality of guest vehicles are moveable between a stowed state and a deployed state;
wherein the stowed state of each guest vehicle of the plurality of guest vehicles is defined as the guest vehicle being at least partially carried by a portion of one of the plurality of host vehicles;
wherein the deployed state of each guest vehicle of the plurality of guest vehicles is defined as the guest vehicle being spaced apart from the plurality of host vehicles;
wherein the securing system of each host vehicle of the plurality of host vehicles is operable to move between a locked state and an unlocked state to selectively engage one of the plurality of guest vehicles;
wherein when at least one of guest vehicles of the plurality of guest vehicles are in the stowed state, the securing system of at least one of the plurality of host vehicles is in the locked state;
wherein movement of the securing systems from the locked state to the unlocked state allows for the plurality of guest vehicles to be moved from the stowed state to the deployed state; and
wherein each of the plurality of host vehicles and the plurality of guest vehicles are operable to communicate with one another.

30. The system of claim 29, wherein each host vehicle of the plurality of host vehicles and each guest vehicle of the plurality of guest vehicles are moveable between the surfaced state and the submerged state when the guest vehicle is in the stowed state and when the guest vehicle is in the deployed state; and wherein each guest vehicle buoyancy system is in communication with one of the host vehicle control systems to be operable by and responsive to command signals received from the host vehicle control system.

31. The system of claim 30, wherein the command signals include maneuvering command signals; wherein each guest vehicle maneuvering system is in communication with one of the host vehicle control systems to be operable by and responsive to the maneuvering command signals received from the host vehicle control system; and wherein the guest vehicle maneuvering system of each guest vehicle of the plurality of guest vehicles is operable when the guest vehicle is in the stowed state to provide propulsion to an associated carrier host vehicle of the plurality of host vehicles.

32. The system of claim 31, wherein the securing system of each host vehicle of the plurality of host vehicles is moveable between the locked state and the unlocked state when the host vehicle is in the submerged state to allow at least one of the plurality of guest vehicles to move between the stowed state and the deployed state when the guest vehicle is in the submerged state.

33. The system of claim 29, wherein each guest vehicle of the plurality of guest vehicles comprises an onboard power supply in communication with at least one of the guest vehicle control system, the guest vehicle maneuvering system, and the guest vehicle sensor and communication system of the guest vehicle; and wherein the onboard power supply is operable to be charged by one of the plurality of host vehicles when the guest vehicle is in the stowed state.

34. The system of claim 29, wherein at least one of the plurality of host vehicles is adapted to carry more than one of the plurality of guest vehicles.

35. The system of claim 29, wherein the plurality of host vehicles and the plurality of guest vehicles are in communication with a network; and wherein the plurality of host vehicles and the plurality of guest vehicles are operable to be remotely commanded and controlled via the network.

36. The system of claim 29, wherein each one of the plurality of guest vehicles are operable to transmit command signals to each of the plurality of guest vehicles.

37. The system of claim 29, wherein the communication between the plurality of host vehicles and the plurality of guest vehicles is defined as a mesh network; and wherein each of the host vehicle control systems and the guest vehicle control systems are operable to communicate with one another via the mesh network.

38. The system of claim 29, wherein the guest vehicle maneuvering system of each guest vehicle of the plurality of guest vehicles is operable to move the guest vehicle from a turned over state to an upright state; and wherein the host vehicle maneuvering system of each host vehicle of the plurality of host vehicles is operable to move the host vehicle from the turned over state to the upright state.

39. The system of claim 29, further comprising a plurality of housings that are each carried by at least one of the host vehicle bodies and the guest vehicle bodies; and wherein each of the plurality of housings are adapted to carry at least a portion of at least one of the host vehicle control systems, the host vehicle maneuvering systems, the host vehicle sensor and communication systems, the securing systems, the host vehicle buoyancy systems, the guest vehicle control systems, the guest vehicle maneuvering systems, the guest vehicle sensor and communication systems, and the guest vehicle buoyancy systems.

40. The system of claim 39, wherein each one of the plurality of host vehicles and each one of the plurality of guest vehicles comprise a rail system; and wherein each of the plurality housings are adapted to slidably engage to one of the rail systems.
